(19) United States
(12) Patent Application Publication
(10) Pub. No.: US 2011/0213655 A1
(43) Pub. Date: Sep. 1, 2011

(54) HYBRID CONTEXTUAL ADVERTISING AND RELATED CONTENT ANALYSIS AND DISPLAY TECHNIQUES

(75) Inventors: Assaf Henkin, Tel Aviv (IL); Yoav Shaham, Raanana (IL); Itai Brickner, Tel Aviv (IL); Stas Krichevsky, Petah Tiqwa (IL)

(73) Assignee: KONTERA TECHNOLOGIES, INC., San Francisco, CA (US)

(21) Appl. No.: 12/693,433

(22) Filed: Jan. 25, 2010

Related U.S. Application Data
(60) Provisional application No. 61/147,076, filed on Jan. 24, 2009.
(60) Provisional application No. 61/258,618, filed on Nov. 6, 2009.
(60) Provisional application No. 61/249,955, filed on Oct. 8, 2009.

(51) Int. Cl. G06Q 30/00; G06F 17/30

(52) U.S. Cl. 705/14.49; 707/748; 707/E17.108; 707/E17.061

(57) ABSTRACT

Different types of Hybrid contextual advertising and related content analysis and display techniques are disclosed for facilitating on-line contextual advertising operations and related content delivery operations implemented in a computer network. At least some embodiments may be configured or designed enabling advertisers to provide contextual advertising promotions to end-users based upon real-time analysis of web page content which may be served to an end-user's computer system. In at least one embodiment, the information obtained from the real-time analysis may be used to select, in real-time, contextually relevant related information, advertisements, and/or other content which may then be displayed to the end-user, for example, via real-time insertion of textual markup objects and/or dynamic display of additional content such as, for example, via use of one or more customized overlay layers.

### RELATED APPLICATION DATA

The present application claims benefit, pursuant to the provisions of 35 U.S.C. §119, of U.S. Provisional Application Ser. No. 61/147,076 (Attorney Docket No. KABAP012X1P), titled “HYBRID CONTEXTUAL ADVERTISING TECHNIQUE”, naming Henkin et al. as inventors, and filed Jan. 24, 2009, the entirety of which is incorporated herein by reference for all purposes.

The present application claims benefit, pursuant to the provisions of 35 U.S.C. §119, of U.S. Provisional Application Ser. No. 61/258,618 (Attorney Docket No. KABAP012P2), titled “HYBRID CONTEXTUAL ADVERTISING AND RELATED CONTENT ANALYSIS AND DISPLAY TECHNIQUES”, naming Henkin et al. as inventors, and filed Nov. 6, 2009, the entirety of which is incorporated herein by reference for all purposes.

The present application claims benefit, pursuant to the provisions of 35 U.S.C. §119, of U.S. Provisional Application Ser. No. 61/249,955 (Attorney Docket No. KAPAP013P) titled “FLOATING-TYPE ADVERTISEMENT TECHNIQUE”, by Henkin et al., filed Oct. 8, 2009, the entirety of which is incorporated herein by reference for all purposes.

### BACKGROUND

Over the past decade the Internet has rapidly become an important source of information for individuals and businesses. The popularity of the Internet as an information source is due, in part, to the vast amount of available information that can be downloaded by almost anyone having access to a computer and a modem. Moreover, the internet is especially conducive to conduct electronic commerce, and has already proven to provide substantial benefits to both businesses and consumers.

Many web services have been developed through which vendors can advertise and sell products directly to potential clients who access their websites. To attract potential consumers to their websites, however, like any other business, requires target advertising. One of the most common and conventional advertising techniques applied on the Internet is to provide advertising promotions (e.g., banner ads, pop-ups, ad links) on the web page of another website which directs the end user to the advertiser's site when the advertising promotion is selected by the end user. Typically, the advertiser selects websites which provide context or services related to the advertiser's business.

Conventionally, the process of adding contextual advertising promotions to web page content is both resource intensive and time intensive. In recent years the process has been somewhat automated by utilizing software applications such as application servers, ad servers, code editors, etc. Despite such advances, however, the fact remains that conventional contextual advertising techniques typically require substantial investments in qualified personnel, software applications, hardware, and time.

Furthermore, conventional on-line marketing and advertising techniques are often limited in their ability to provide contextually relevant material for different types of web pages.

As access to the Internet becomes more available, there is a greater potential to gather data relating to user behaviors and activities, and to present contextually relevant advertisements to different markets of people who are able to access the Internet.

### BRIEF DESCRIPTION OF THE DRAWINGS

Various drawings, figures and/or screenshots are provided herein which generally relate to various aspects, features, data flows, processes, information, etc., relating to one or more of the various Hybrid techniques disclosed or referenced herein.

FIG. 1 shows a block diagram of a computer network portion 100 which may be used for implementing various aspects described or referenced herein in accordance with a specific embodiment.

FIG. 2A shows a block diagram of various components and systems of a Hybrid System 200 which may be used for implementing various aspects described or referenced herein in accordance with a specific embodiment.

FIG. 2B shows an example block diagram illustrating various portions 290 which may form part of the related repository 230 and/or index 252 of Hybrid System 200, and which may be used for implementing various aspects described or referenced herein. At least a portion of the functionalities of various components shown in FIG. 2A are described below. It will be noted, however, other embodiments of the Hybrid System may include different functionality than that shown and/or described with respect to FIG. 2A.

FIG. 2C shows an alternate example embodiment of a client system 290c which may be operable to implement various aspects, techniques, and/or features disclosed herein.

FIGS. 3A-M show different flow diagrams of Hybrid Contextual Advertising Processing and Markup Procedures in accordance with different embodiments.

FIGS. 4A-G provide examples of various screen shots which illustrate different techniques which may be used for modifying web page displays in order to present additional contextual advertising information.

FIGS. 5A-E illustrate various types of information which may be stored at one or more of data structures of the Dynamic Taxonomy Database and/or Related Content Corpus.

FIGS. 6 and 7A-B illustrate specific example embodiments of different examples of floating type ads which may be displayed to a user via at least one electronic display.

FIG. 8 shows an example of an alternate embodiment of a graphical user interface (GUI) which may be used for implementing various aspects of the hybrid contextual advertising techniques described herein.

FIG. 9 shows an example of an alternate embodiment of a graphical user interface (GUI) which may be used for implementing various aspects of the hybrid contextual advertising techniques described herein.

FIG. 10 shows an example procedural flow of a Hybrid-based ad bidding process 1050 in accordance with a specific embodiment.

FIG. 11A illustrates an example flow diagram of an Ad Selection Analysis Procedure 1150 in accordance with a specific embodiment.

FIG. 11B illustrates an example flow diagram of an Related Content Selection Analysis Procedure 1100 in accordance with a specific embodiment.

FIGS. 12A-14 generally relate to various aspects of EMV, ERV, and Layout analysis processes.

FIG. 16A shows an example of a Hybrid Ad Selection Process 1600 in accordance with a specific embodiment.

FIG. 16B shows an example of a Hybrid Related Content Selection Process 1600 in accordance with a specific embodiment.

FIG. 15 shows a specific embodiment of a network device 1560 suitable for implementing various techniques and/or features described herein.

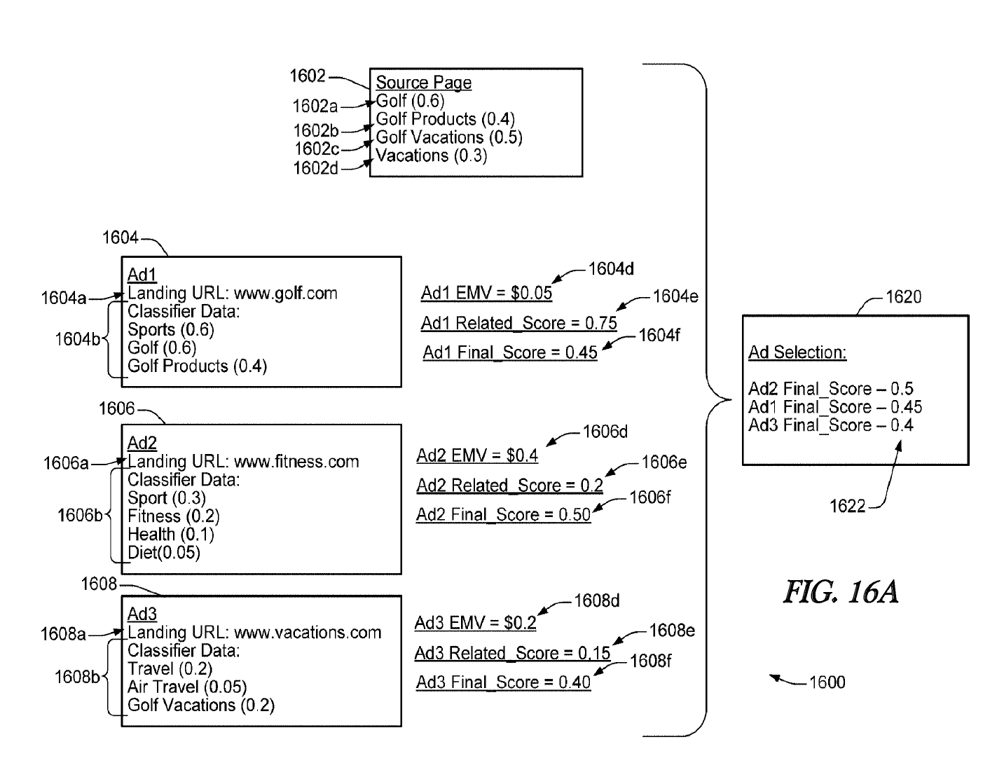

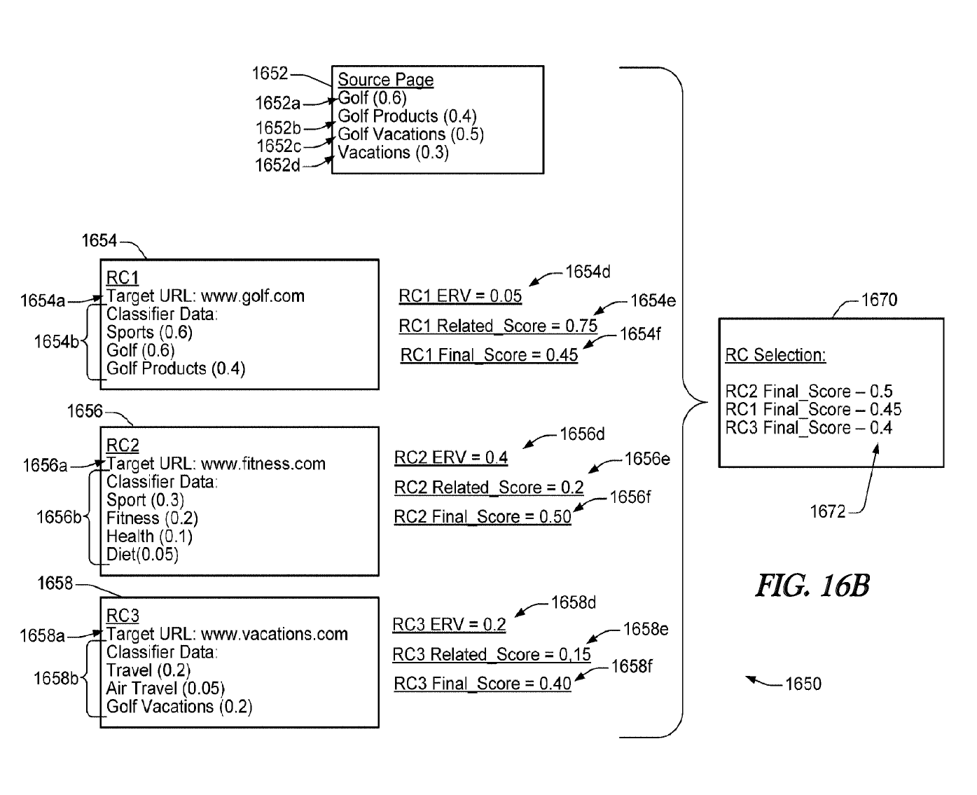

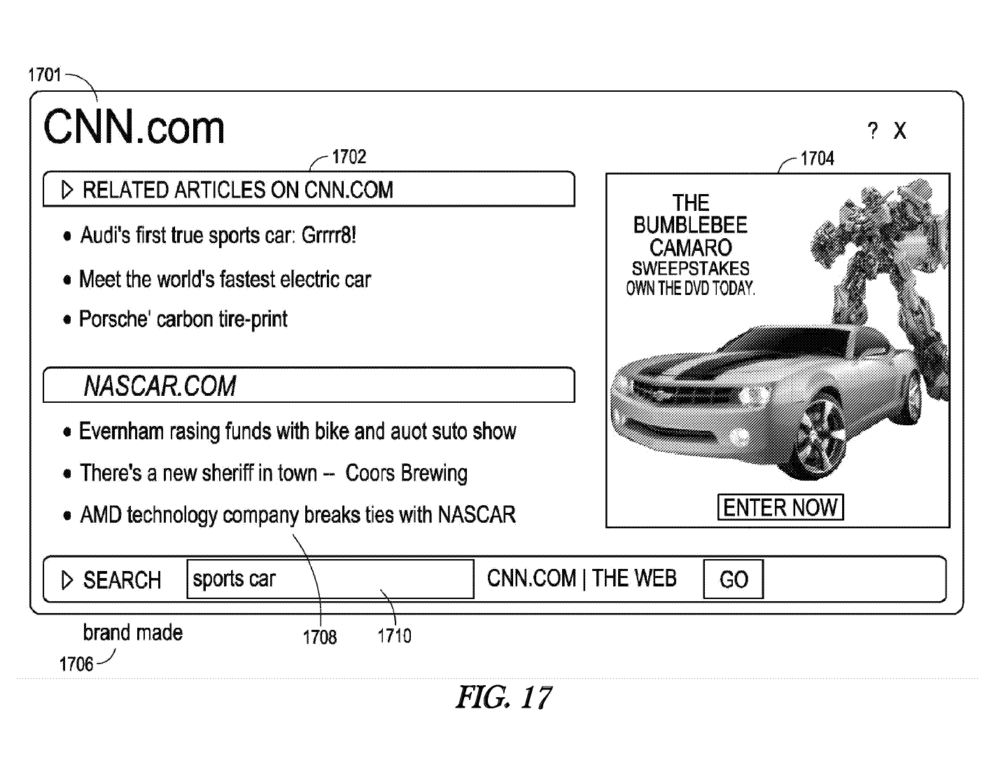

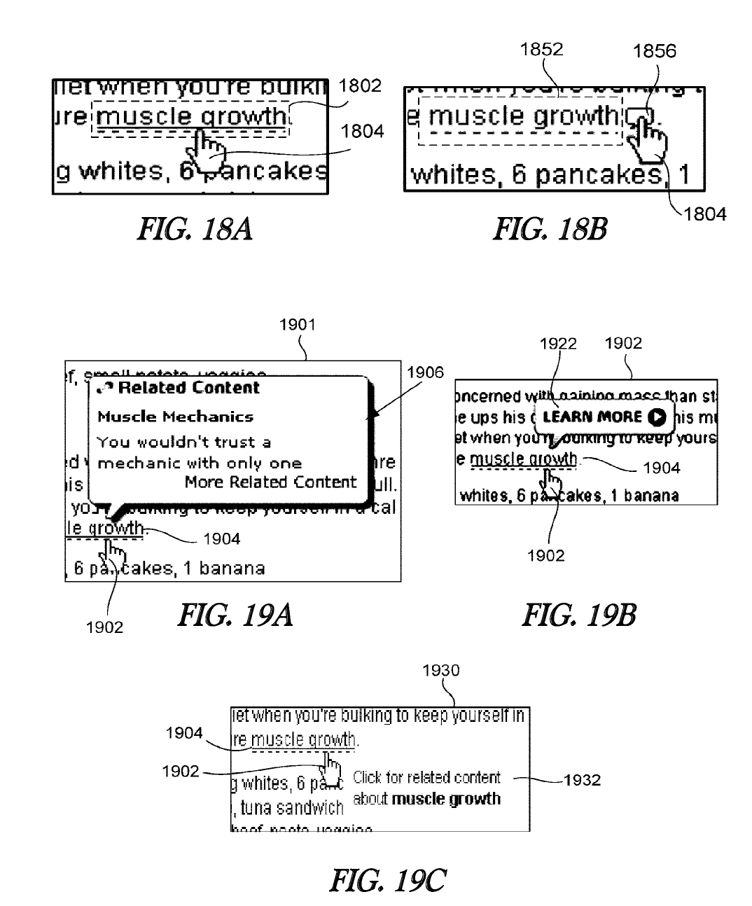

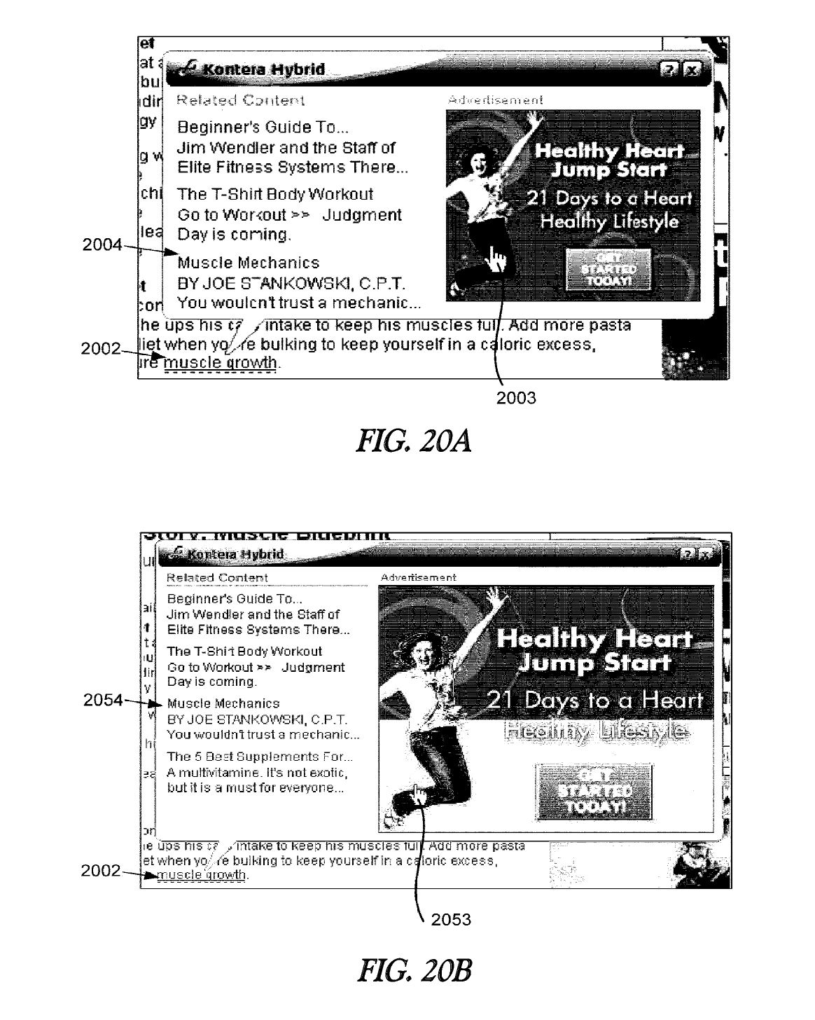

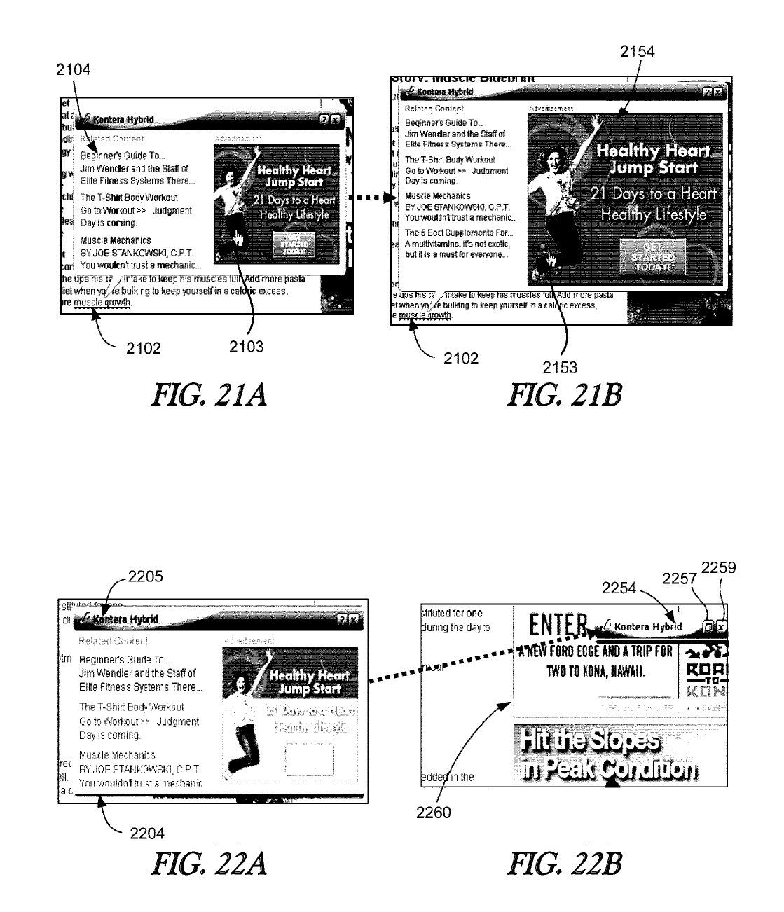

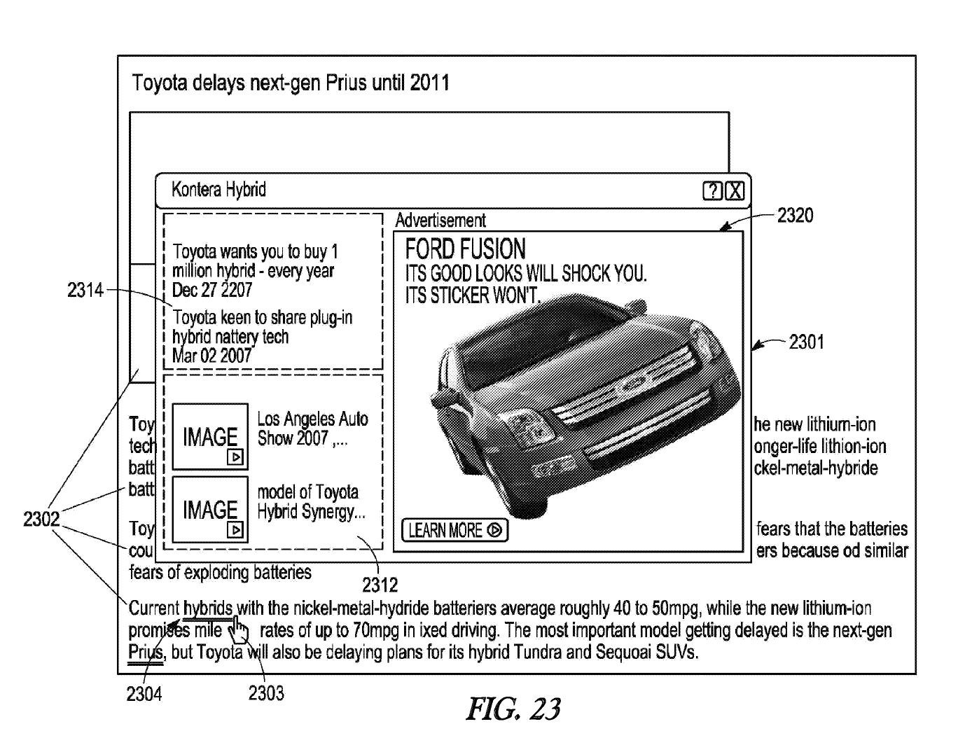

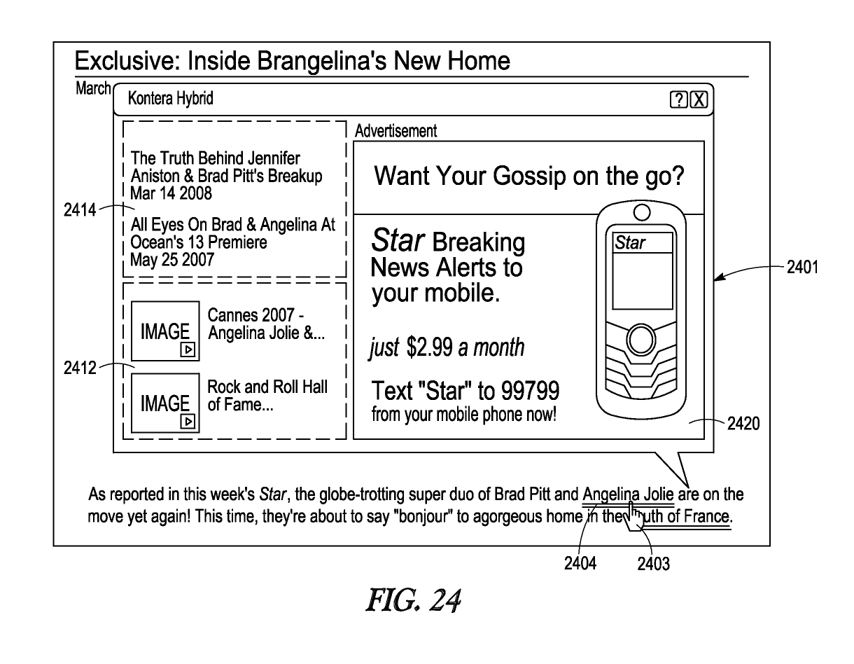

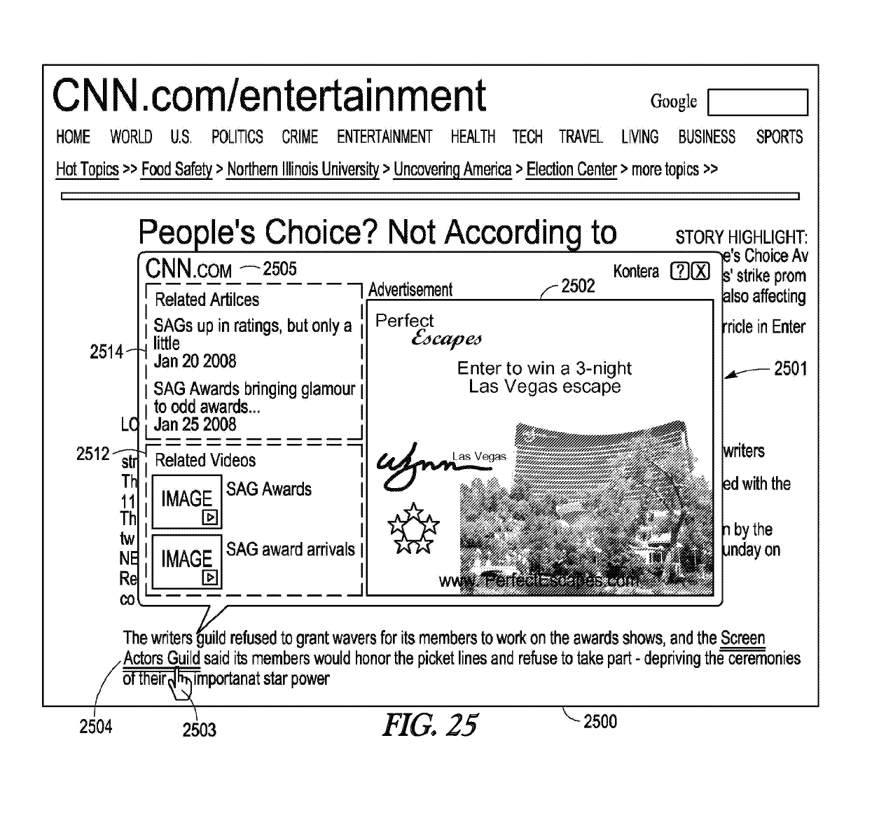

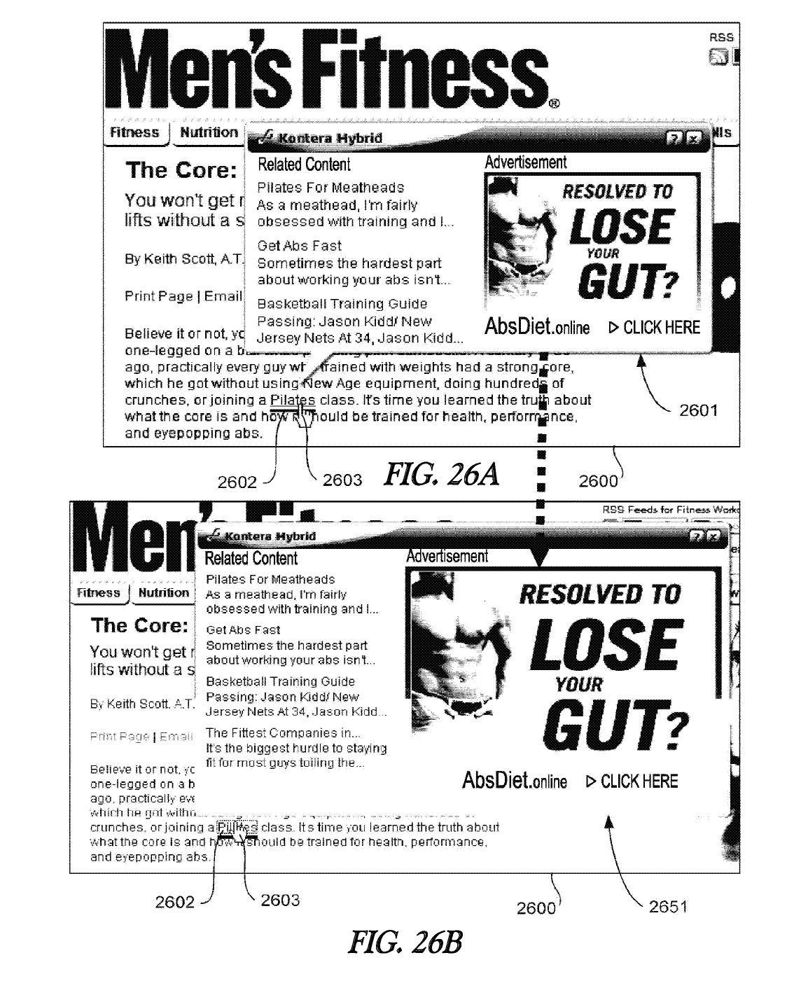

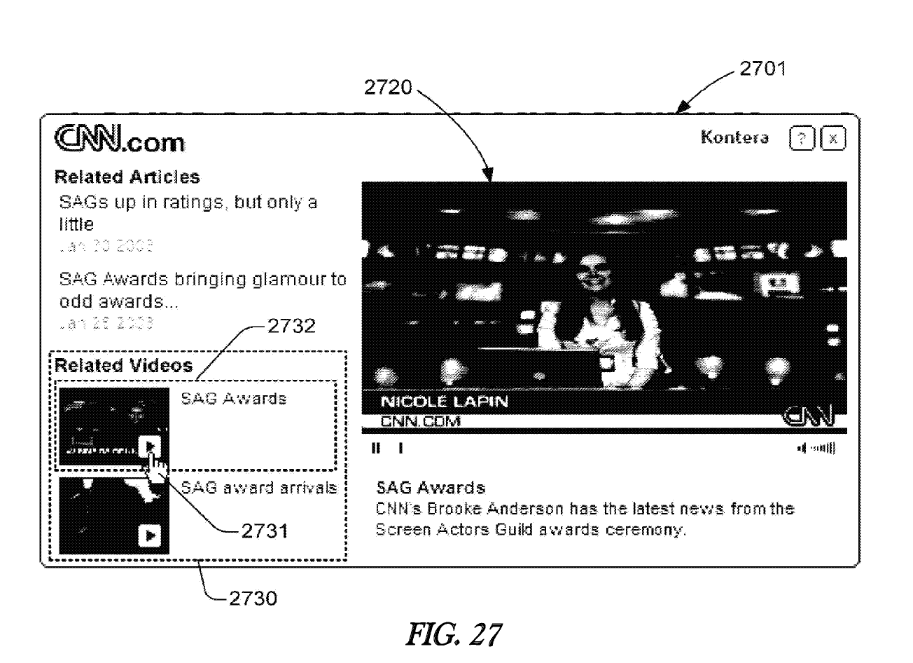

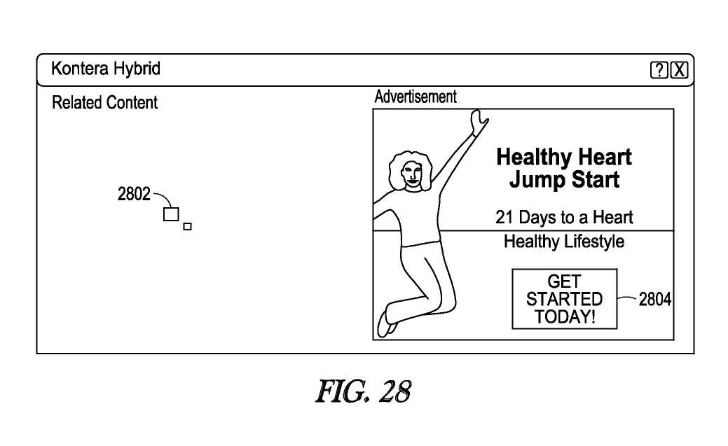

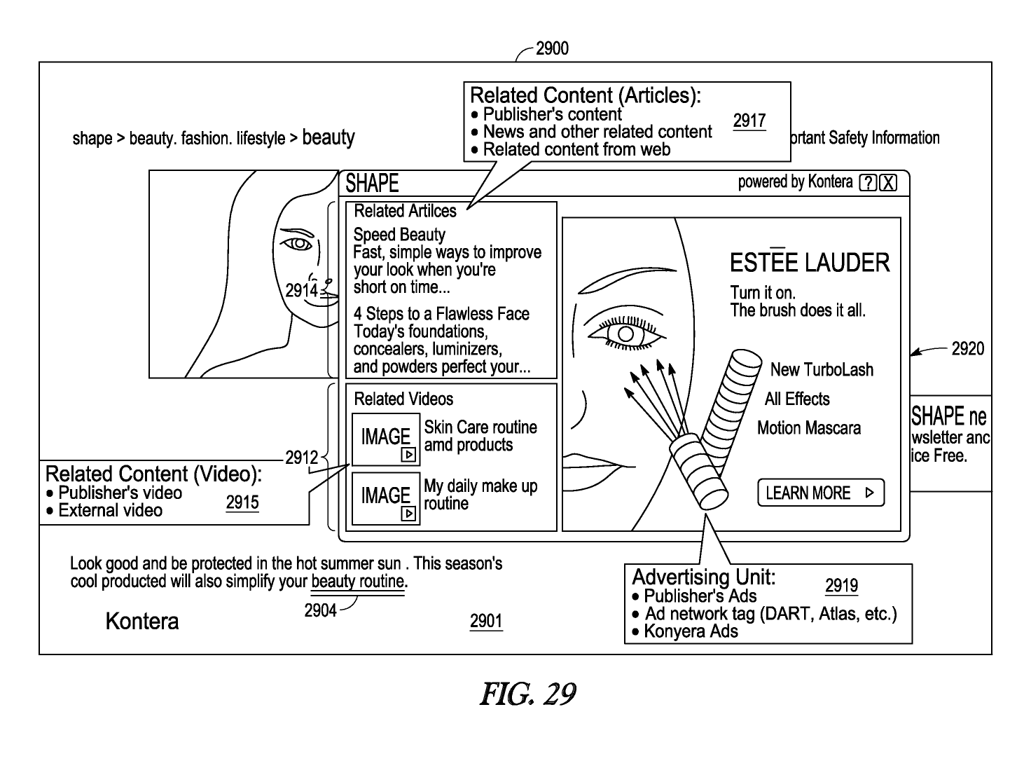

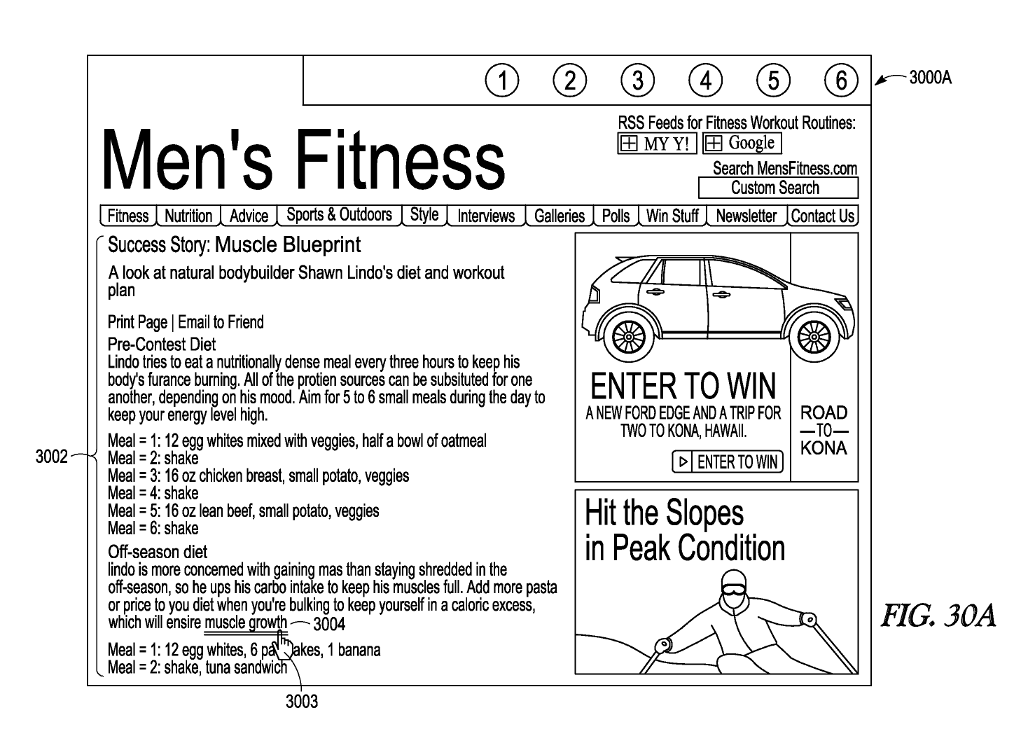

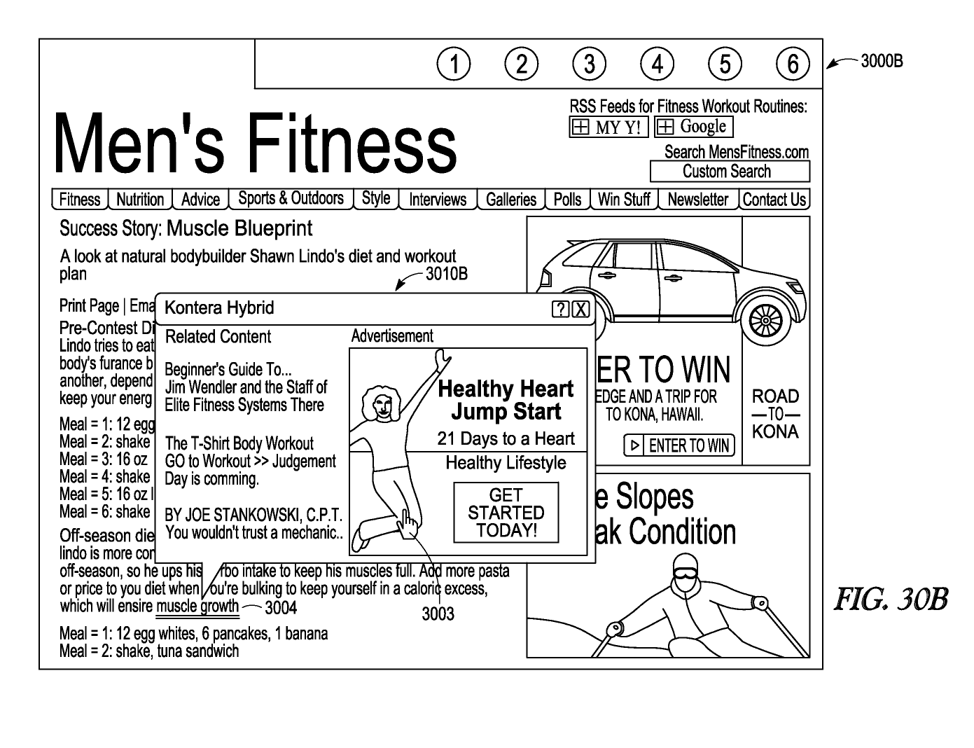

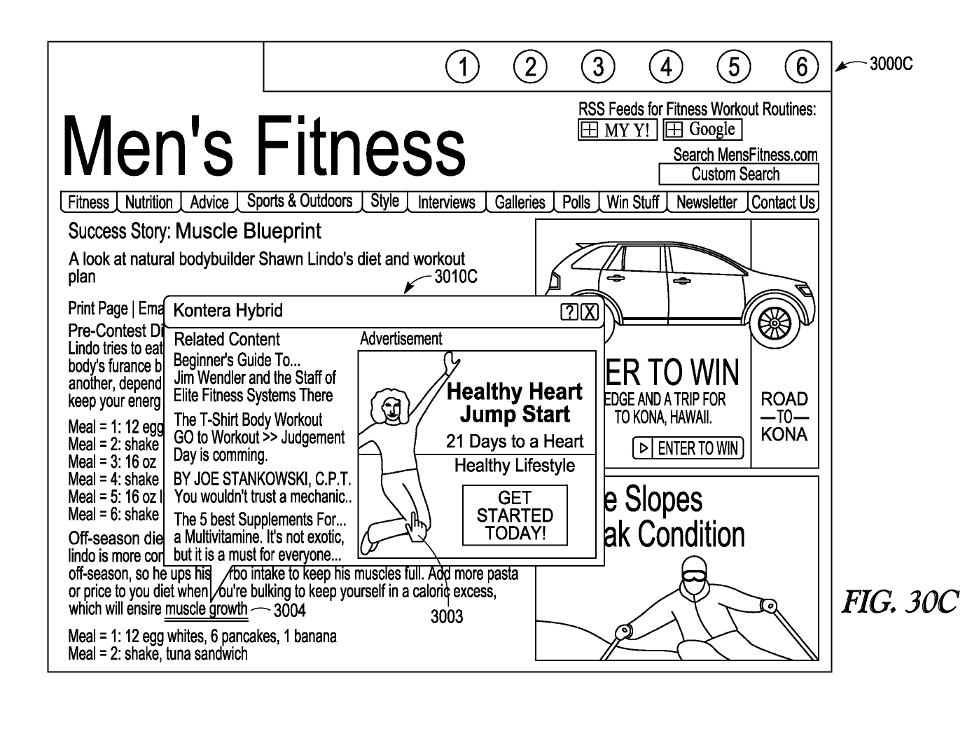

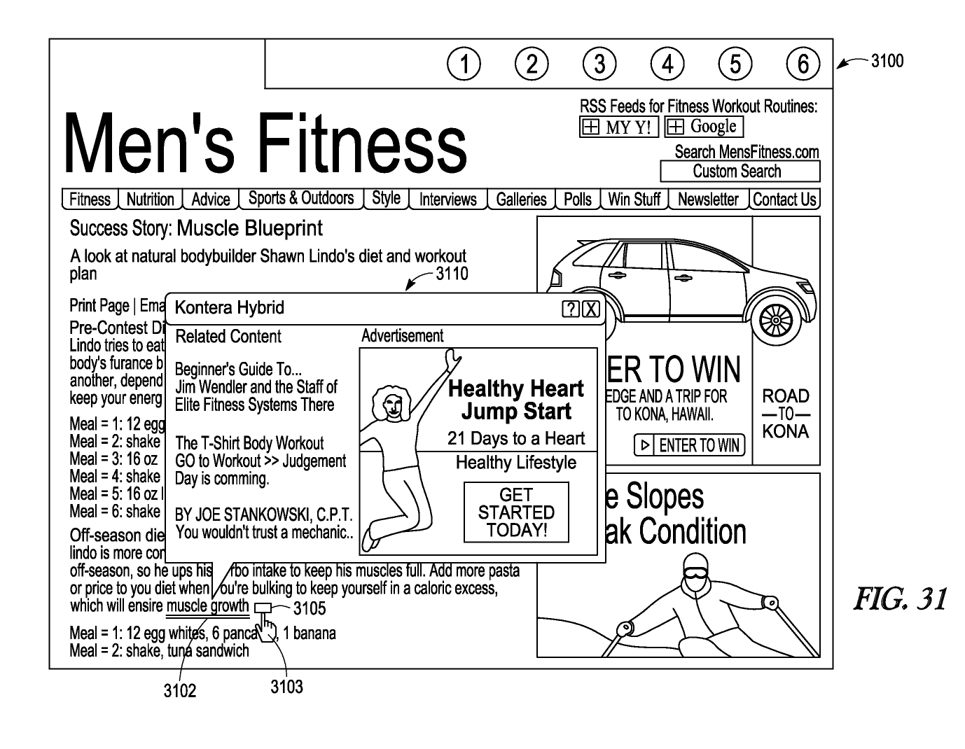

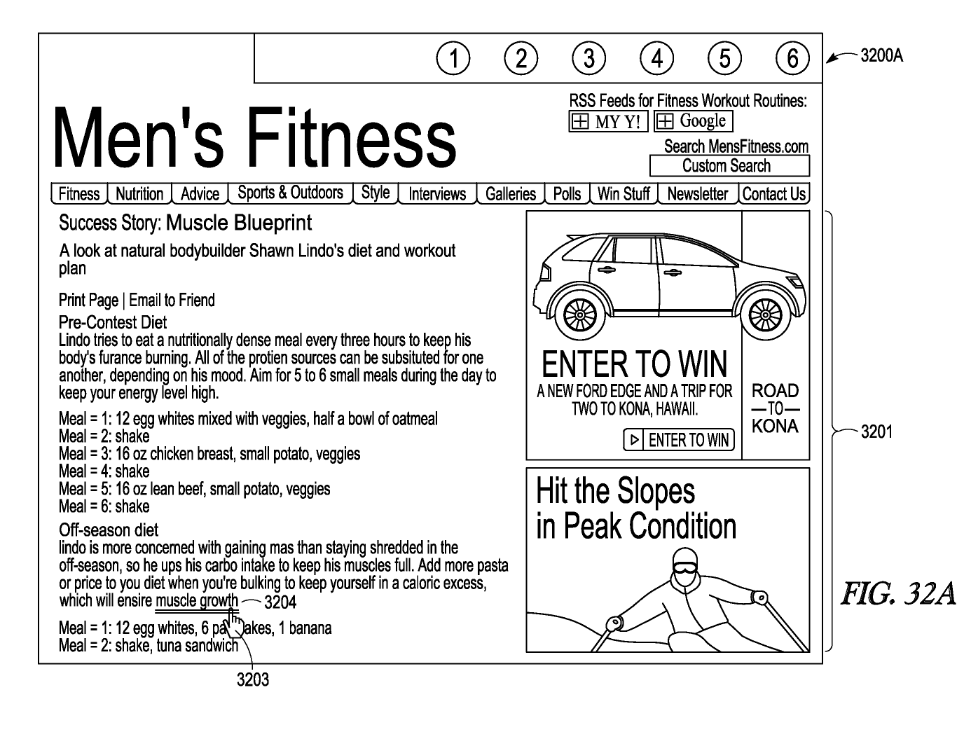

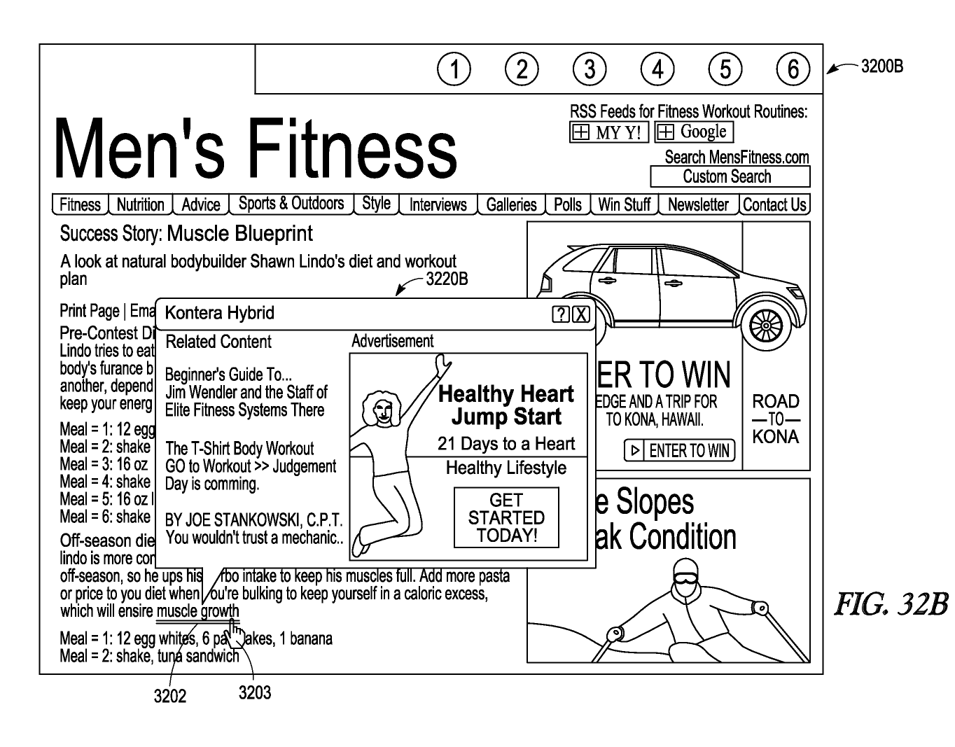

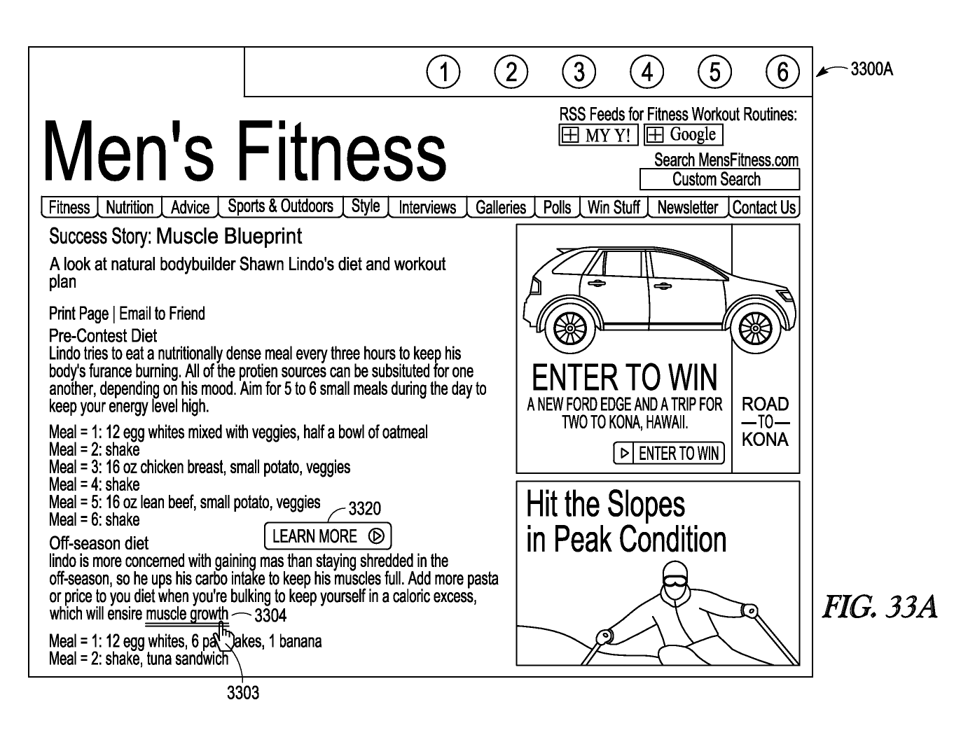

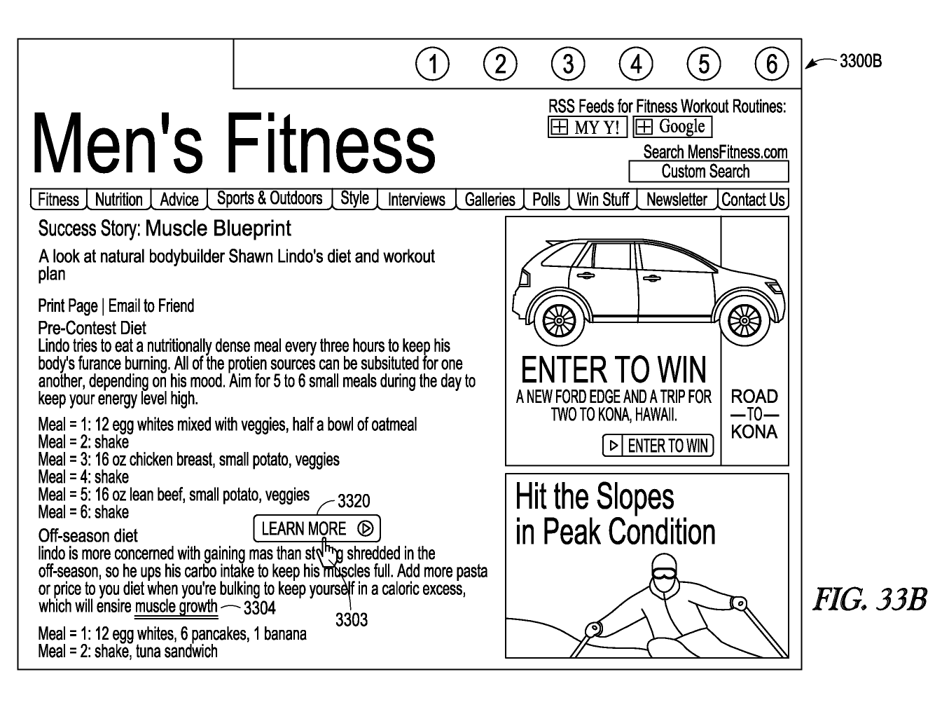

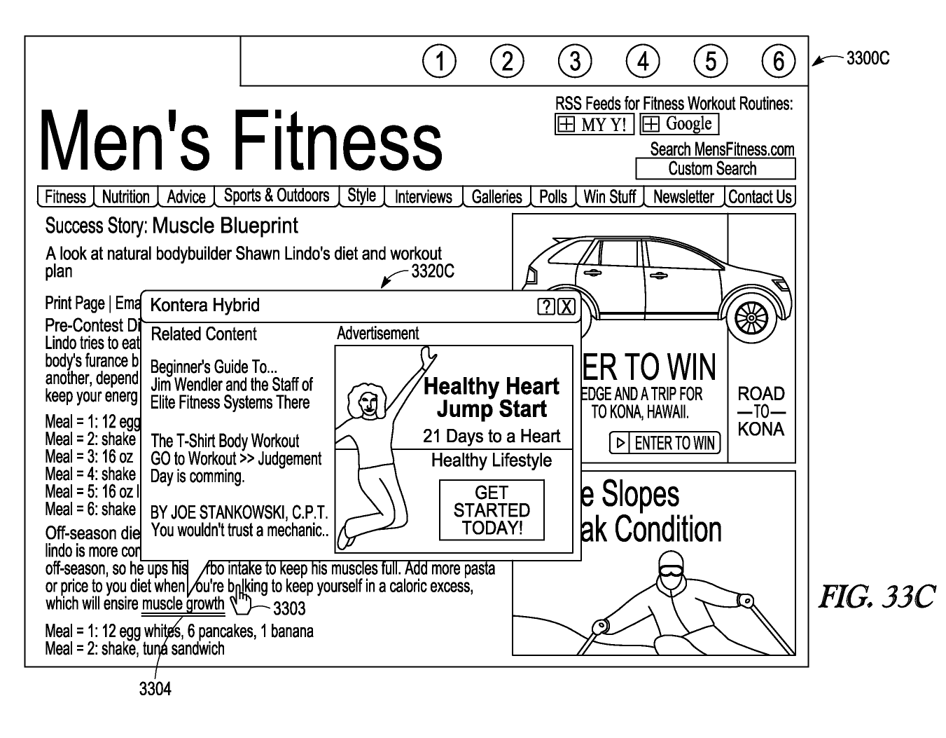

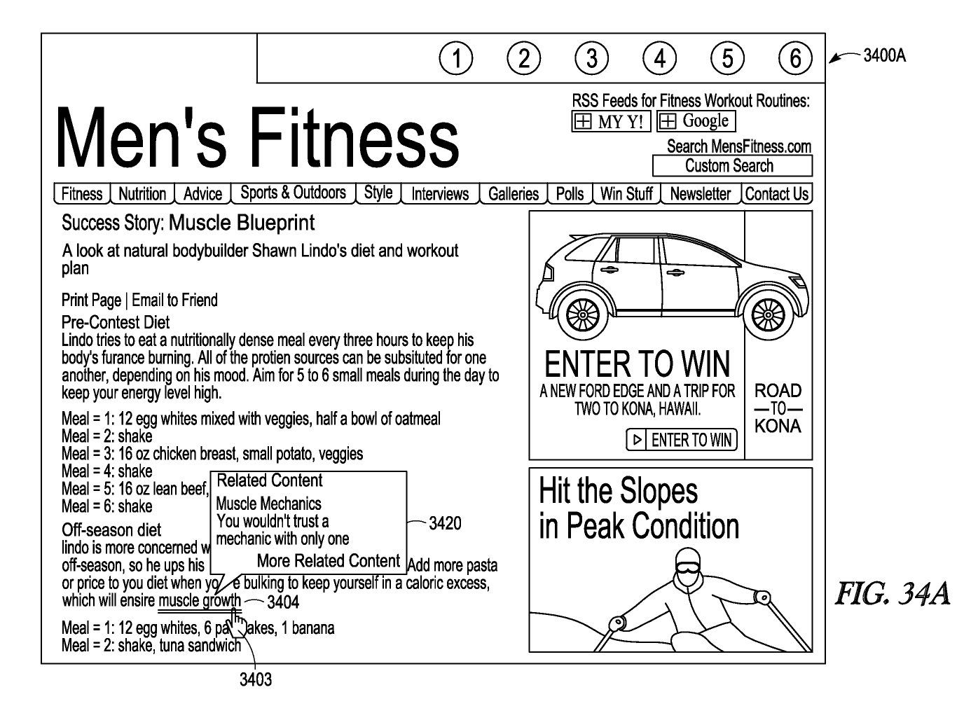

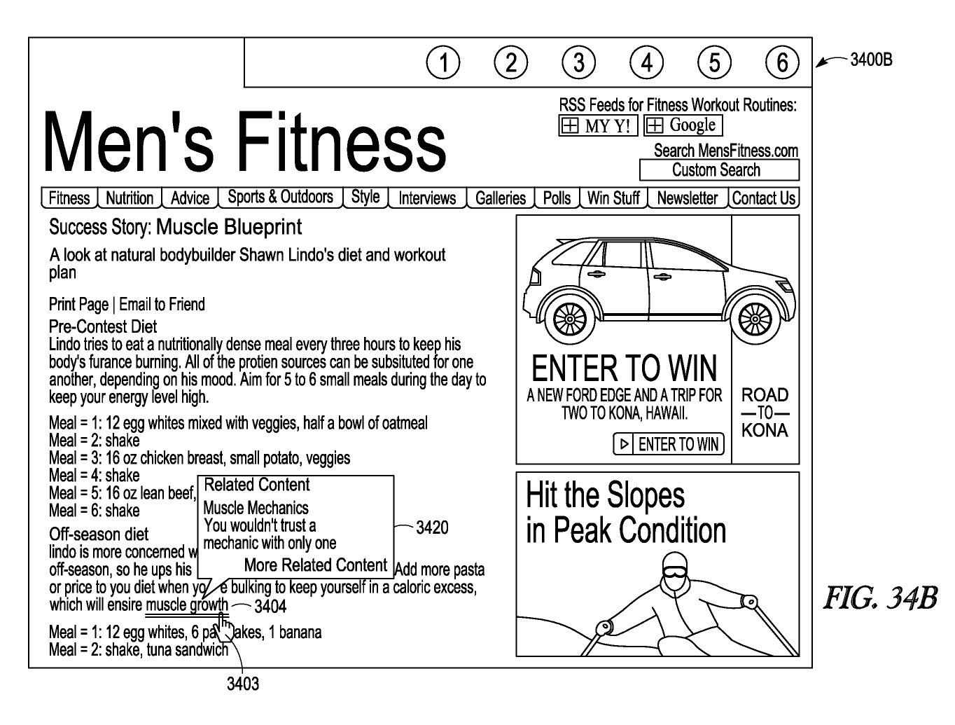

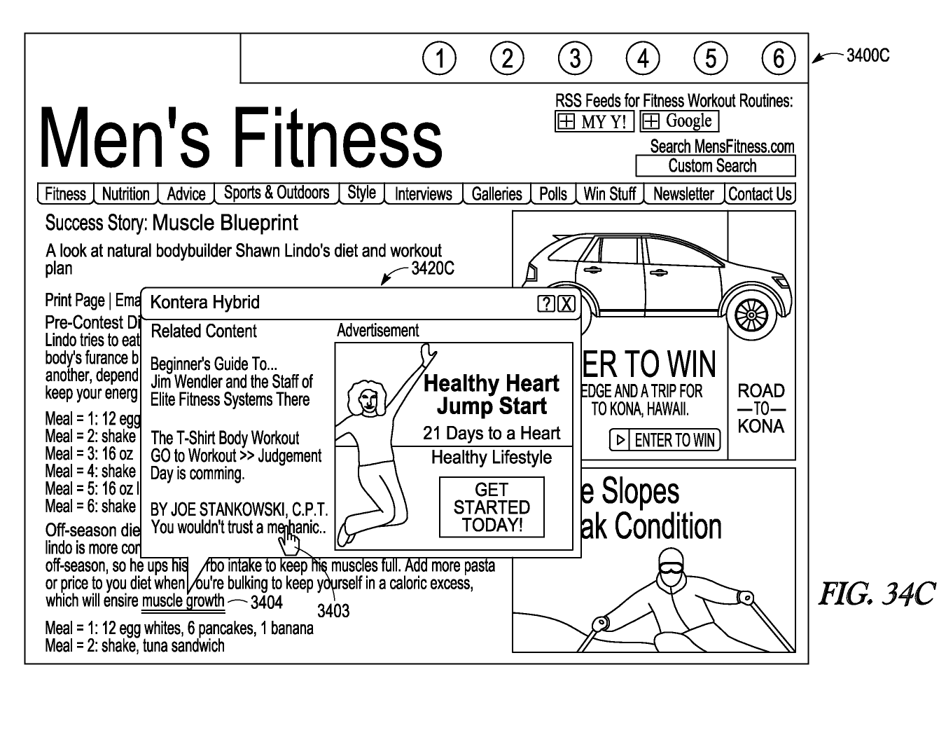

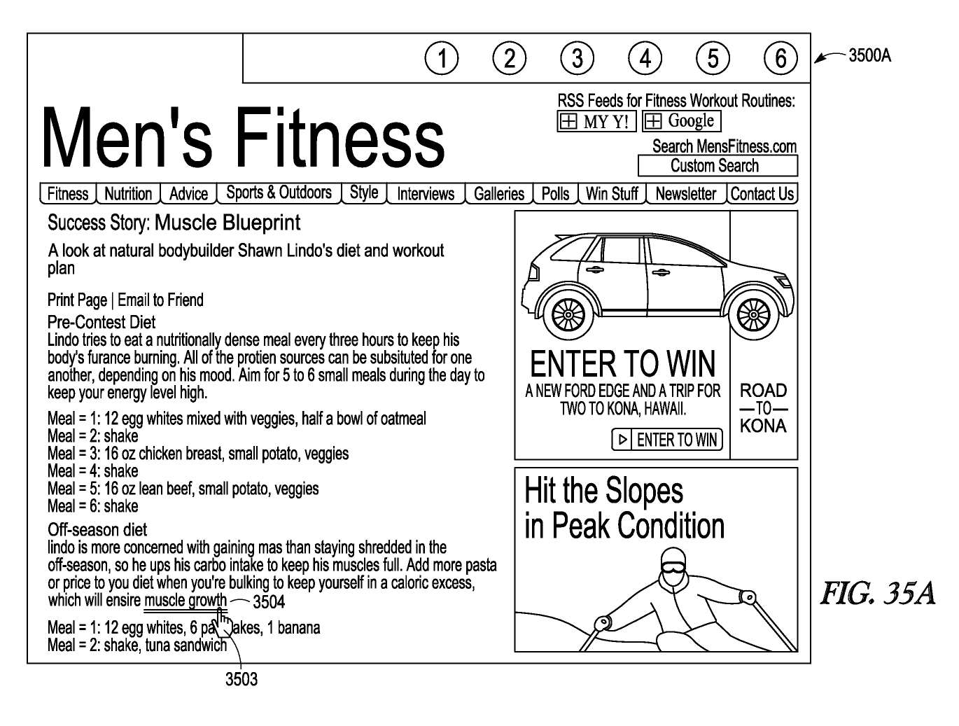

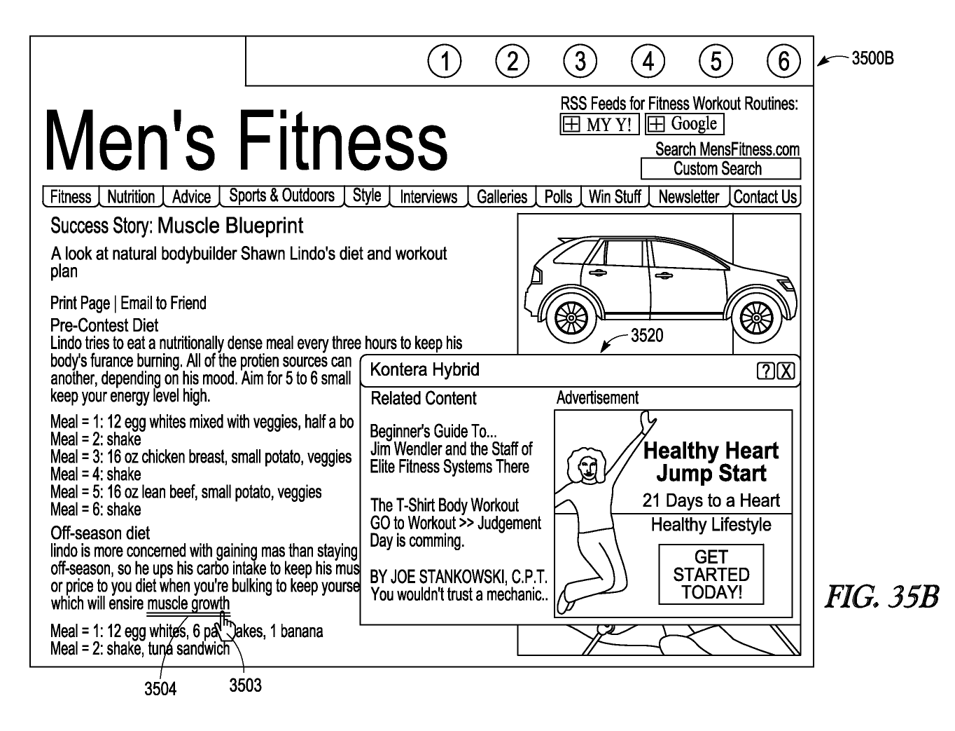

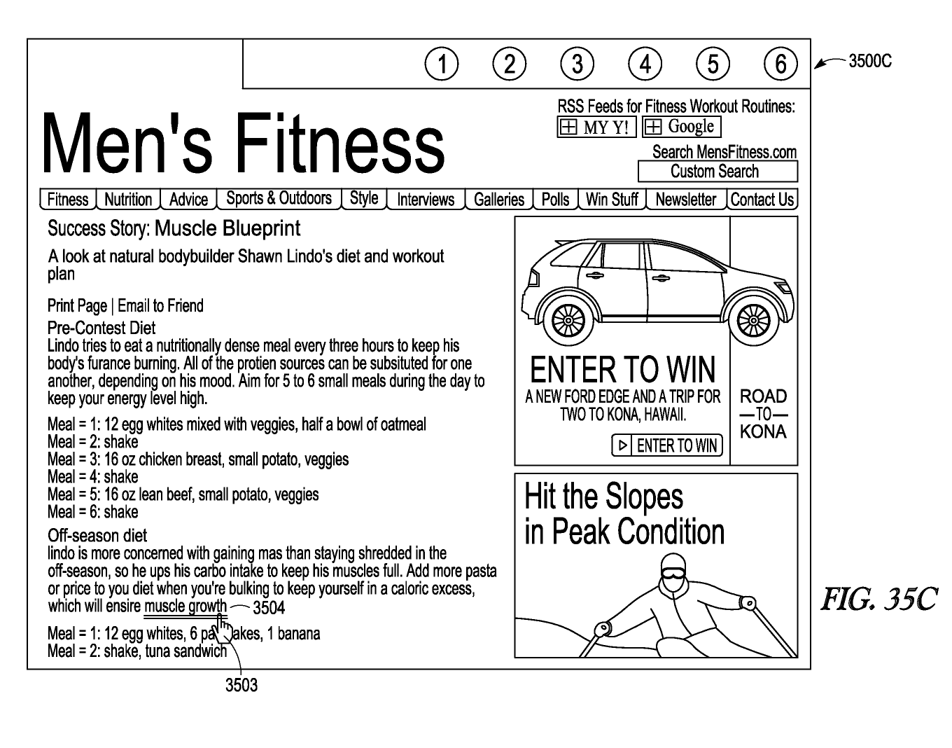

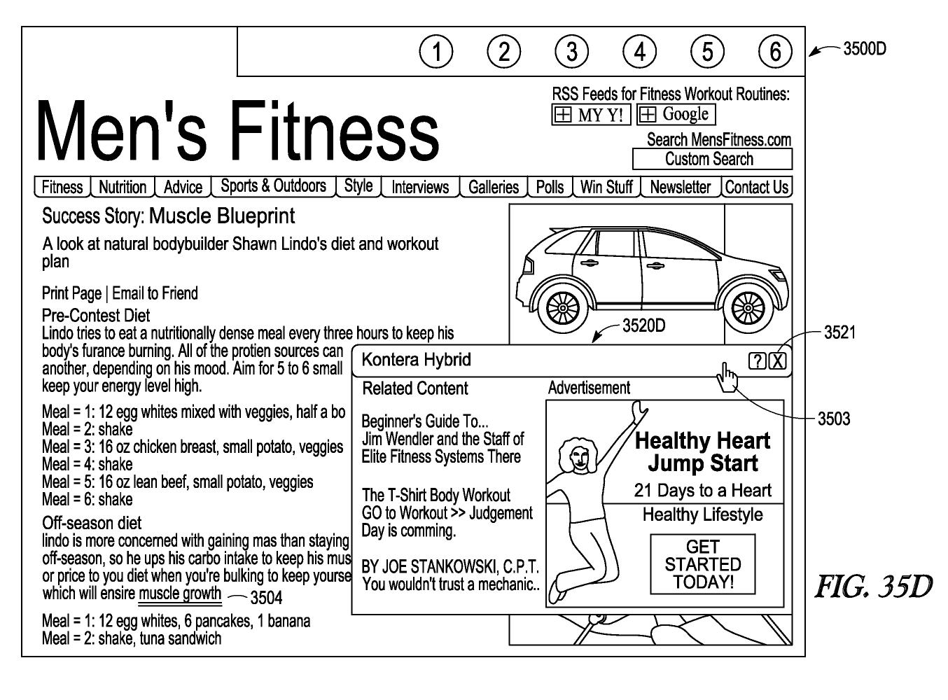

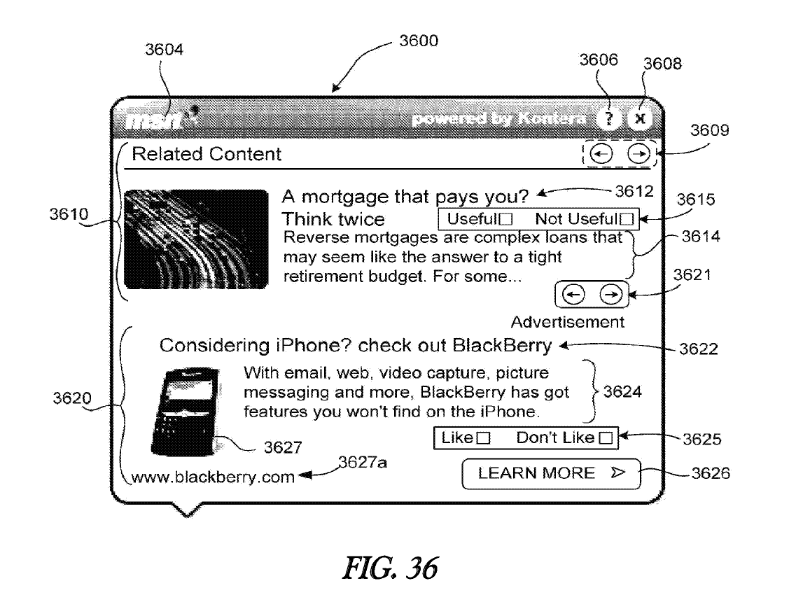

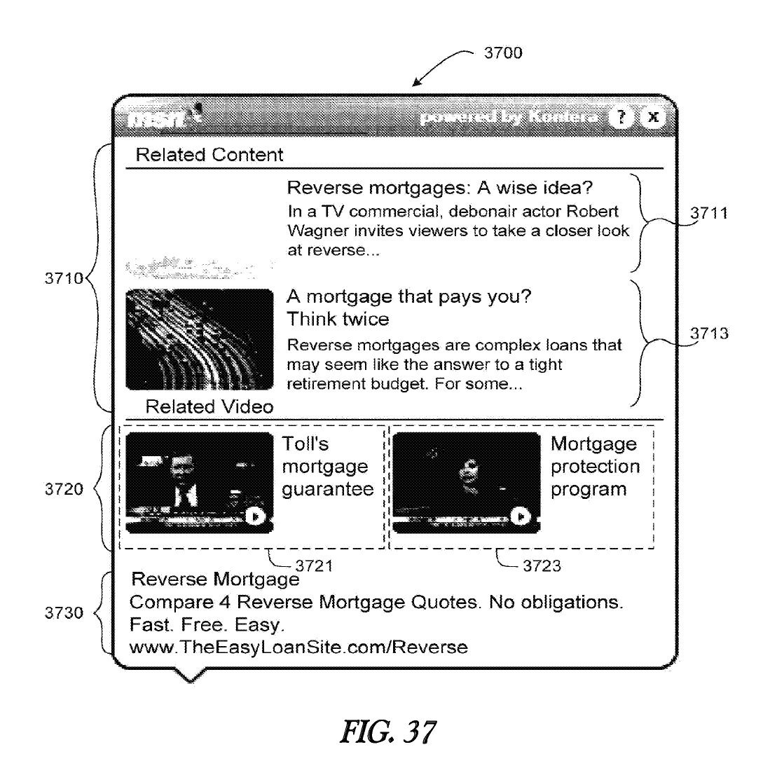

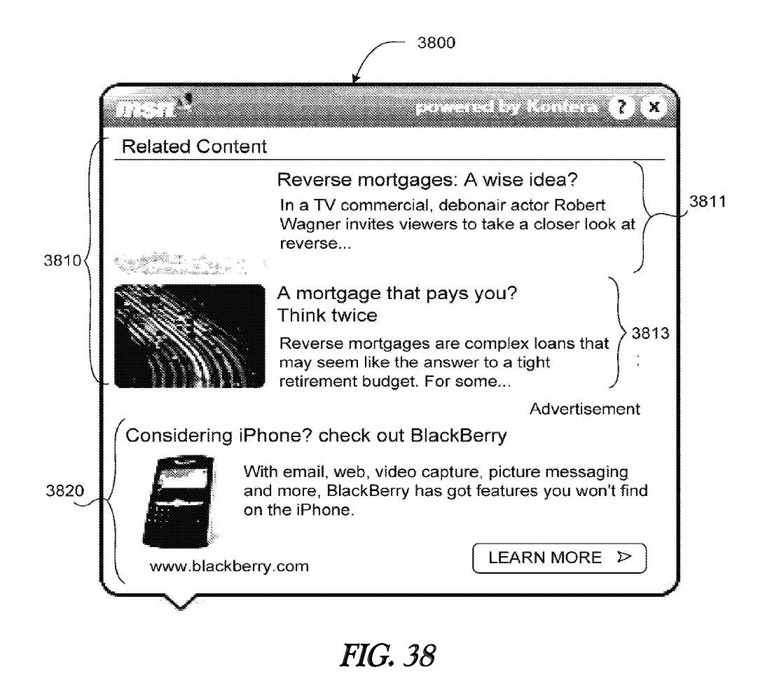

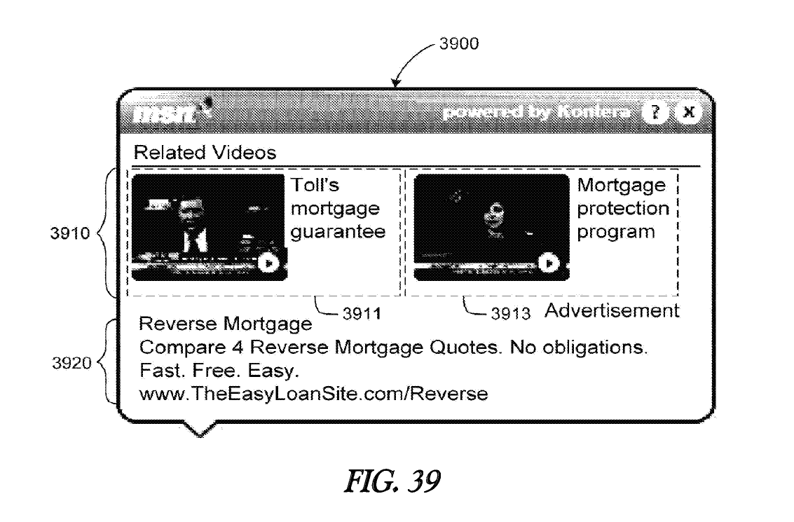

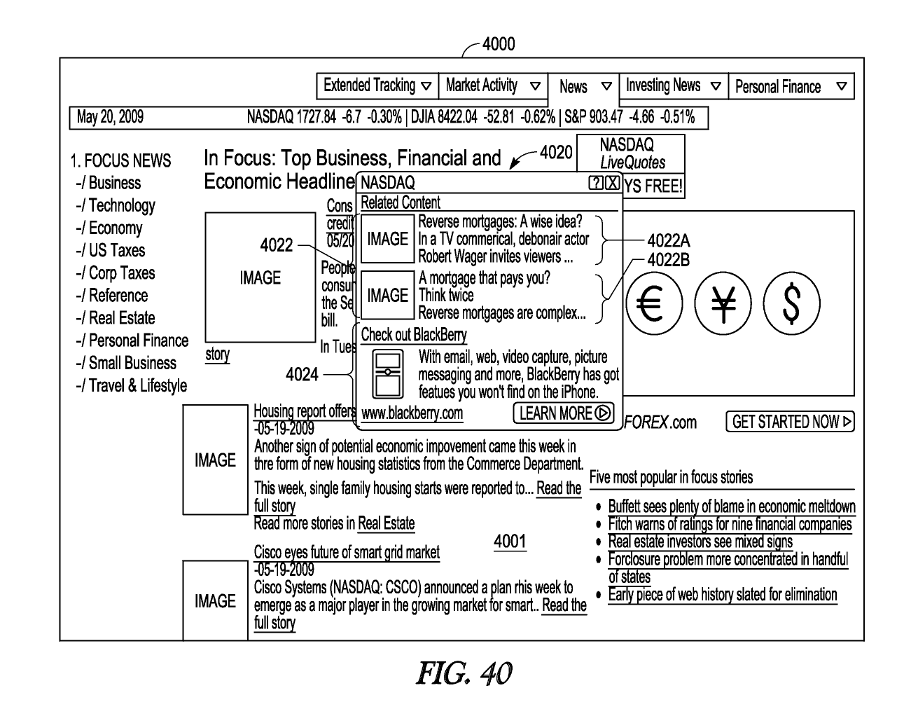

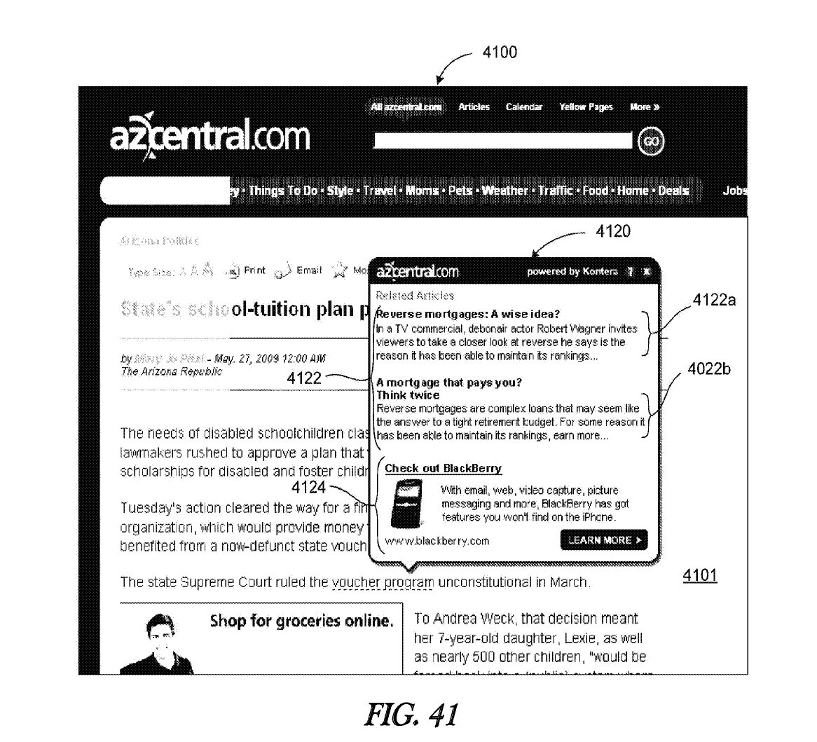

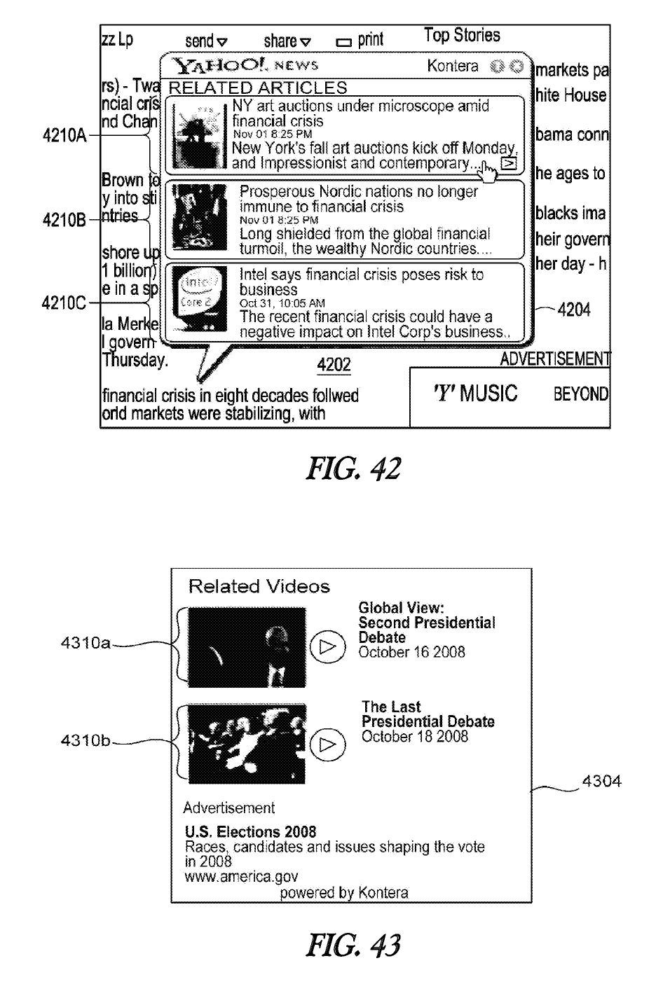

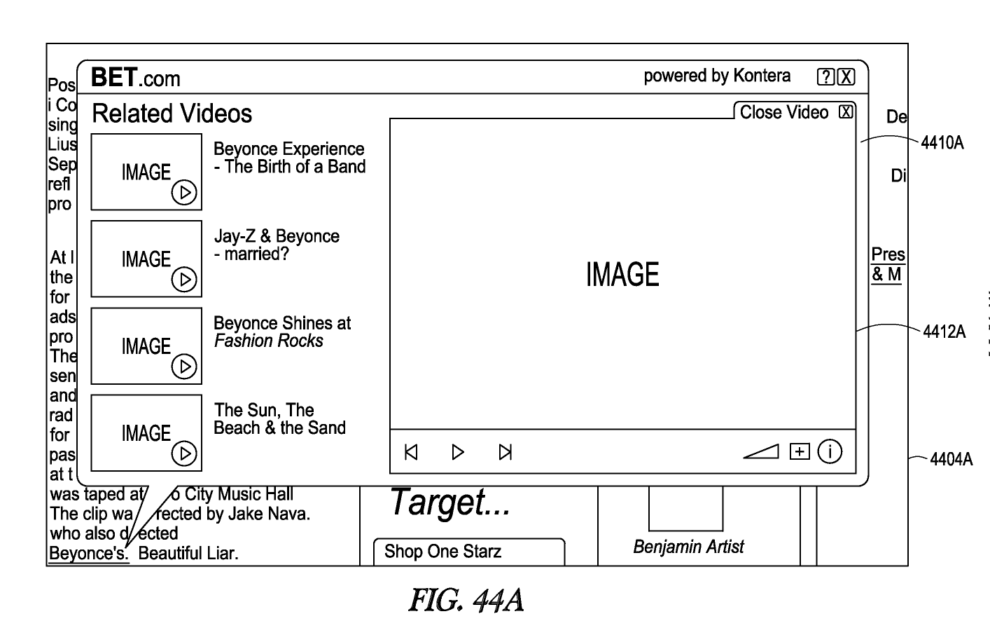

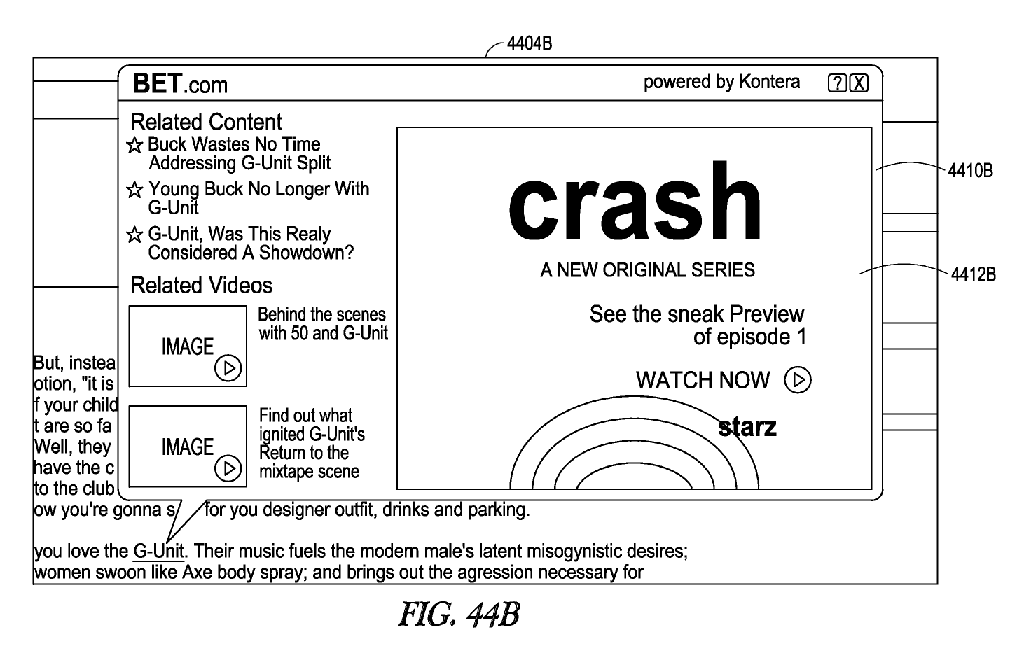

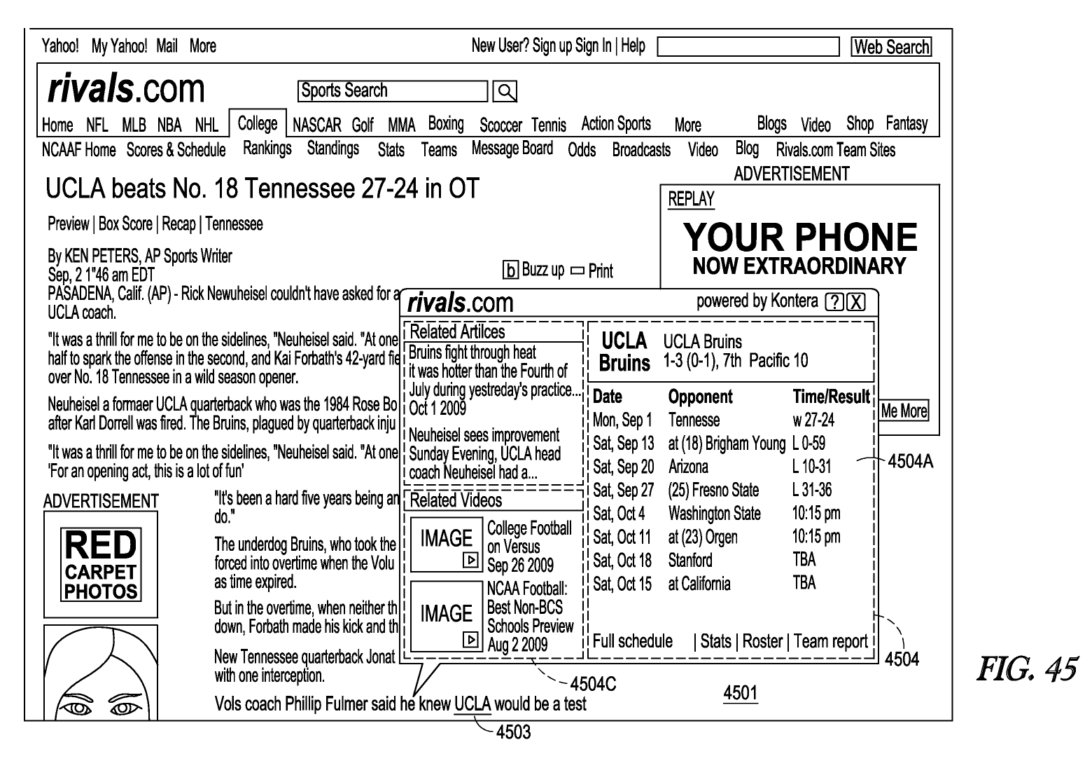

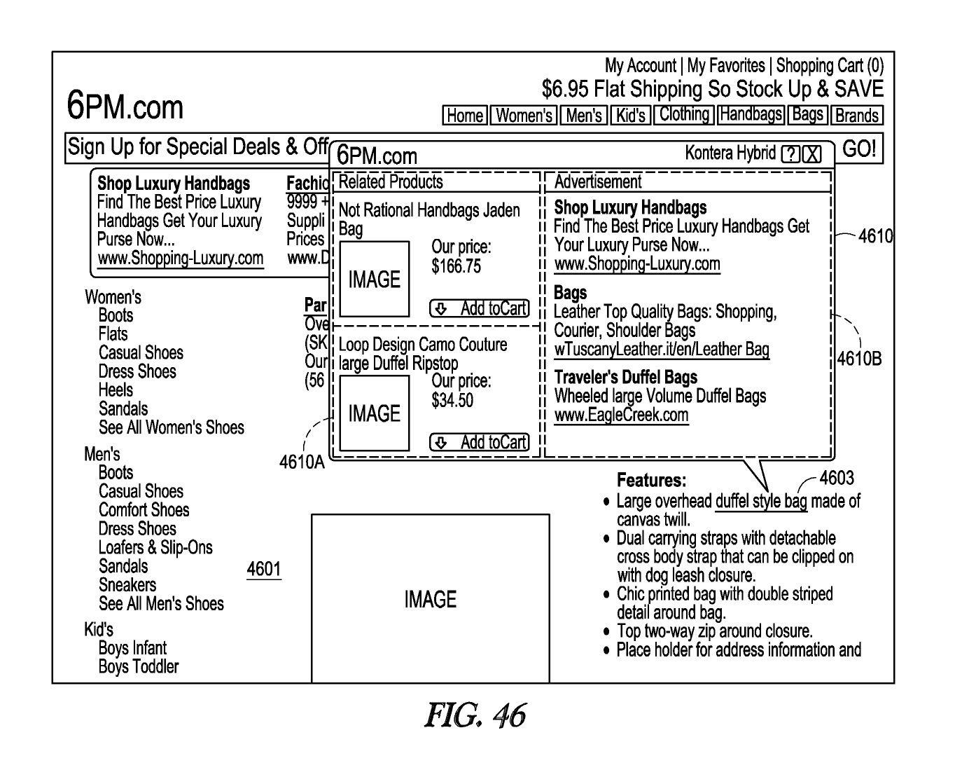

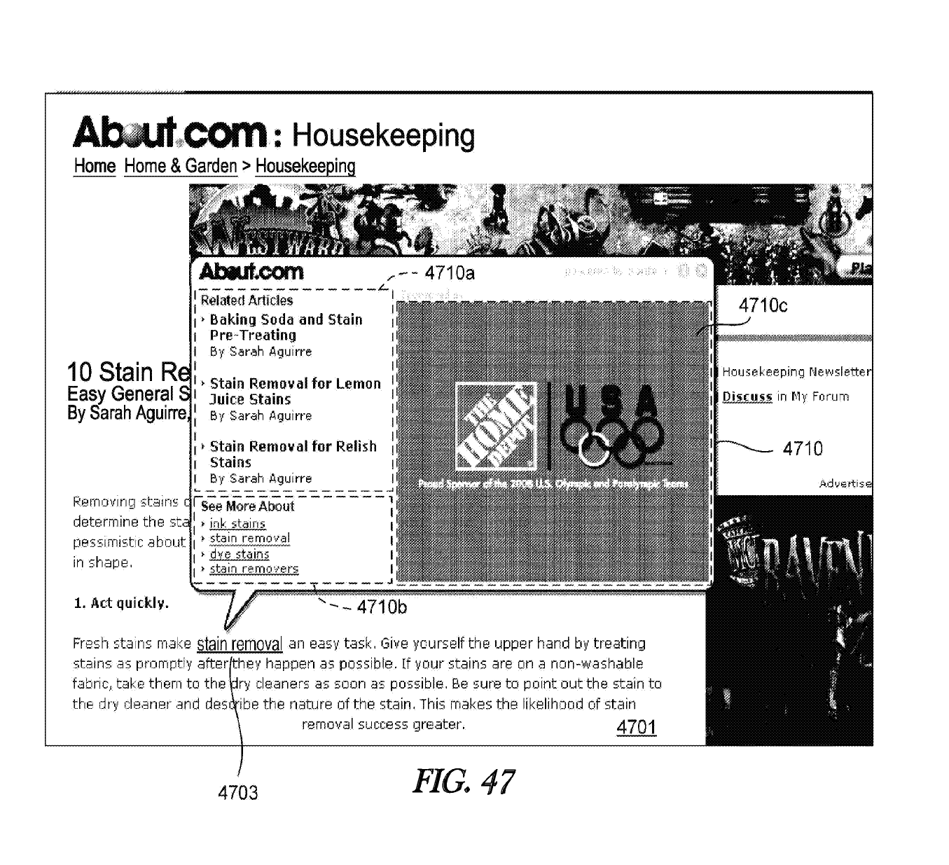

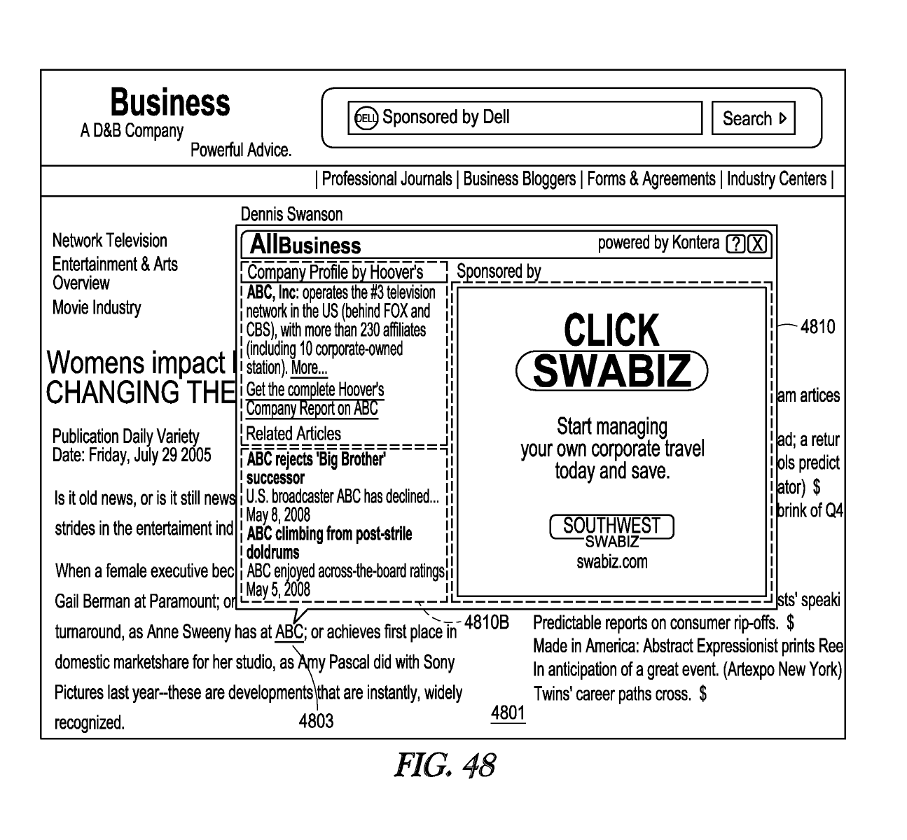

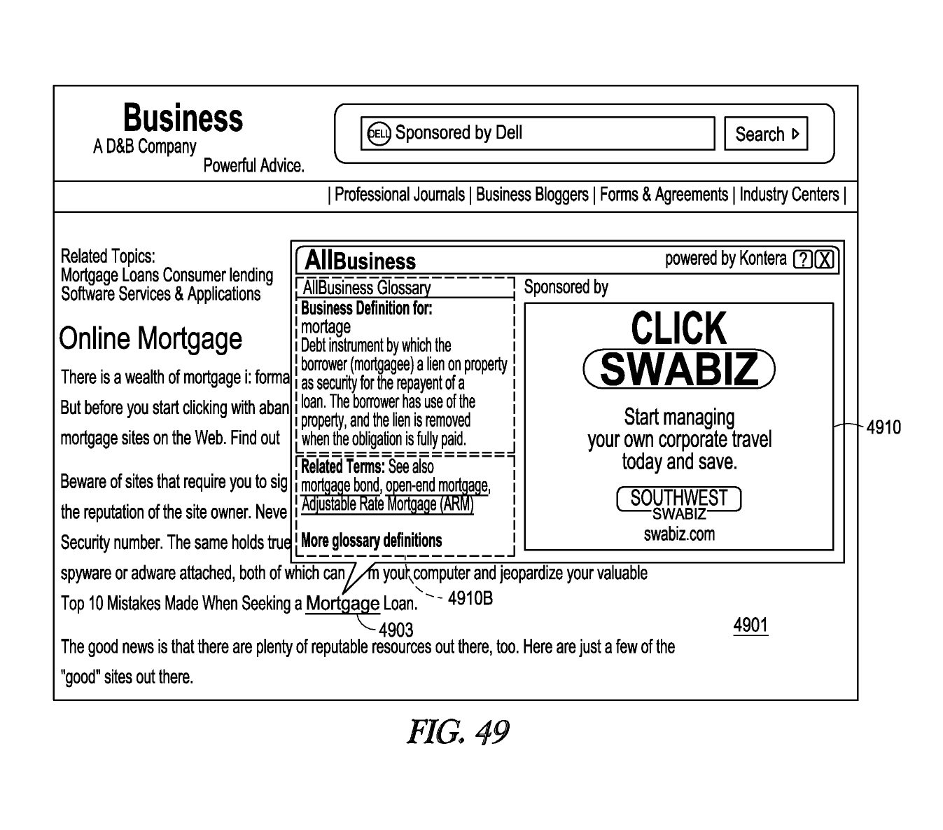

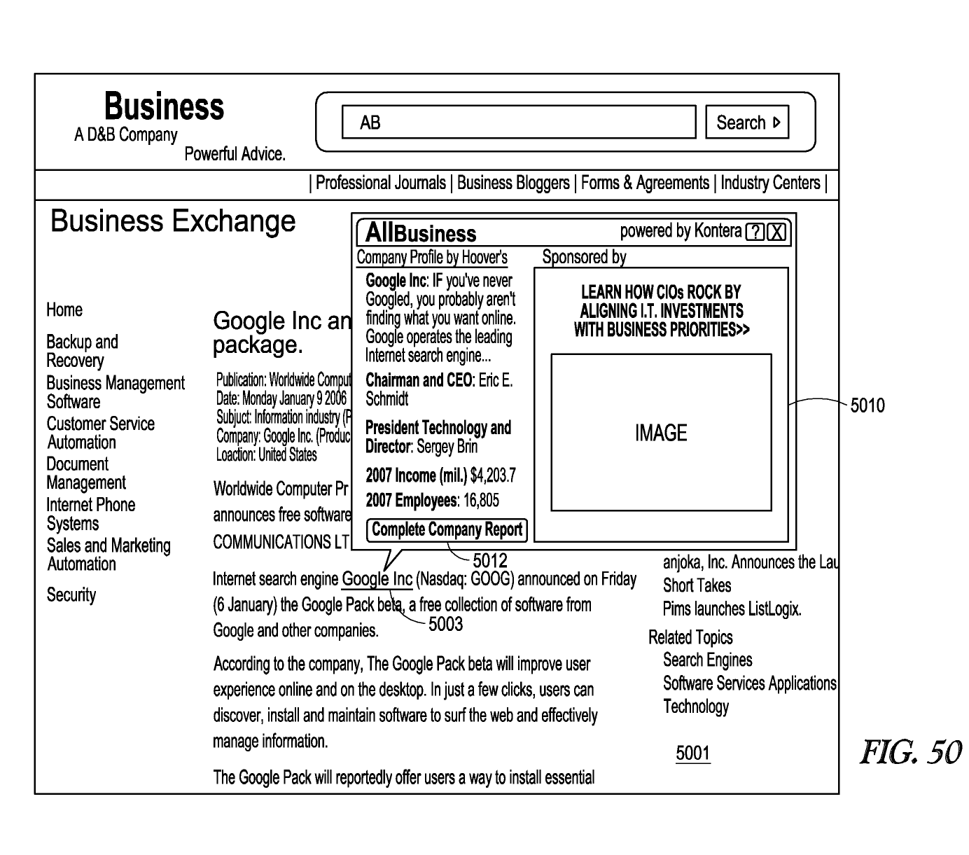

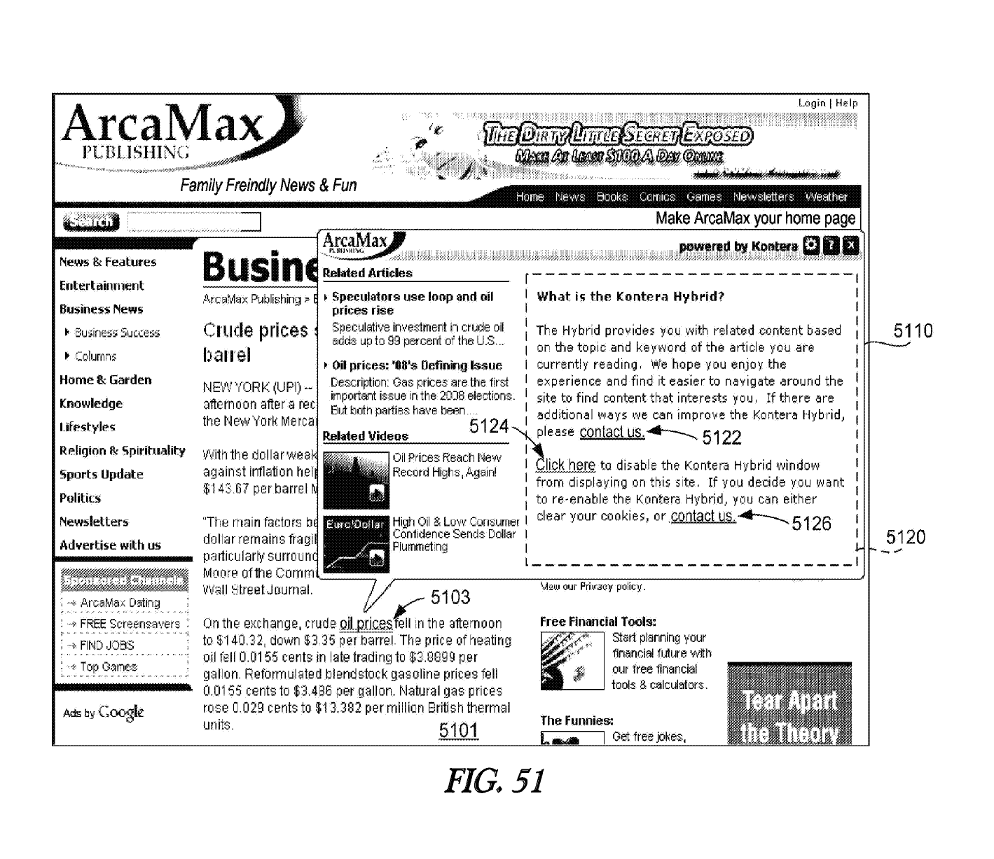

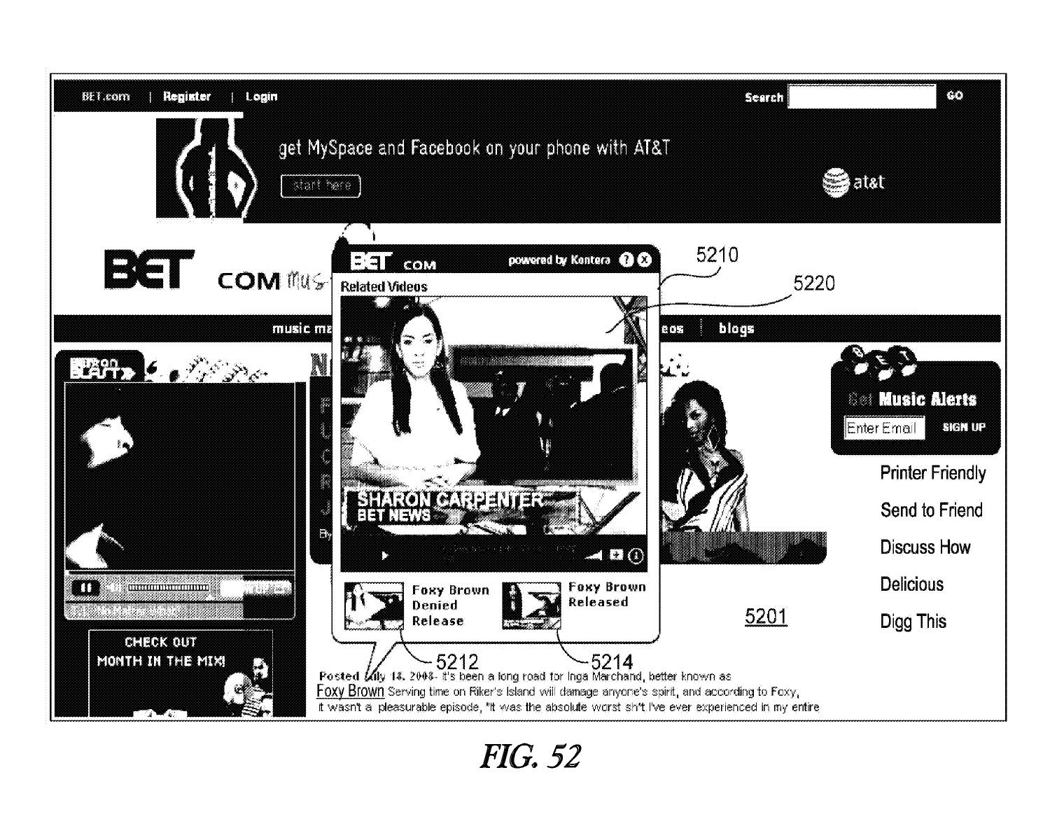

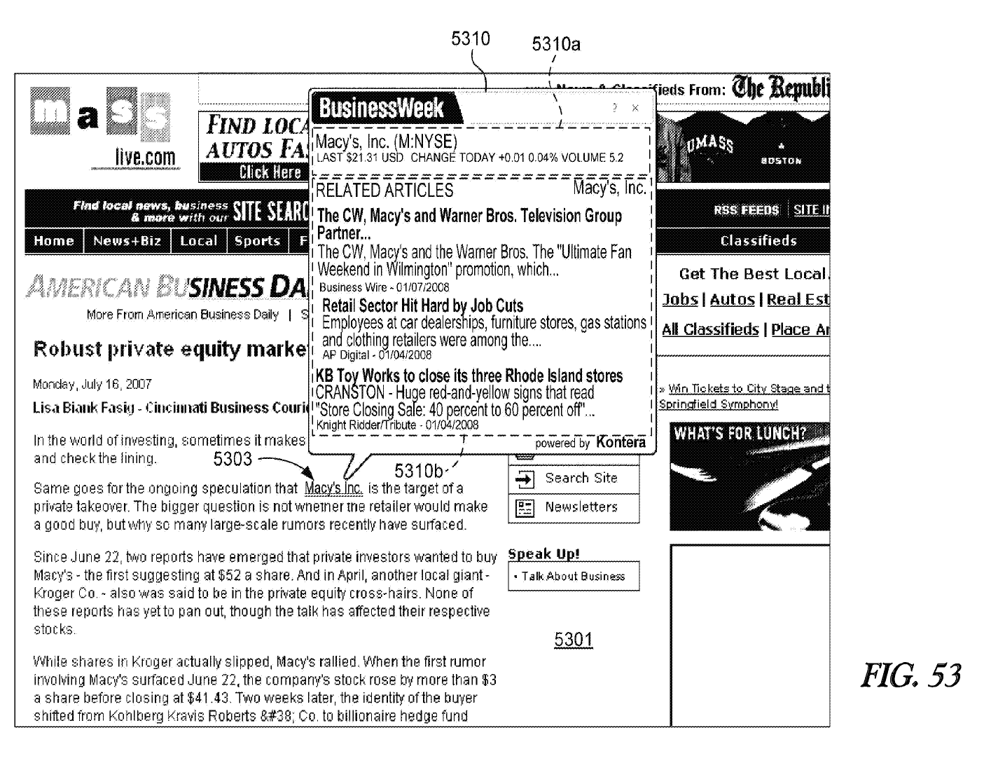

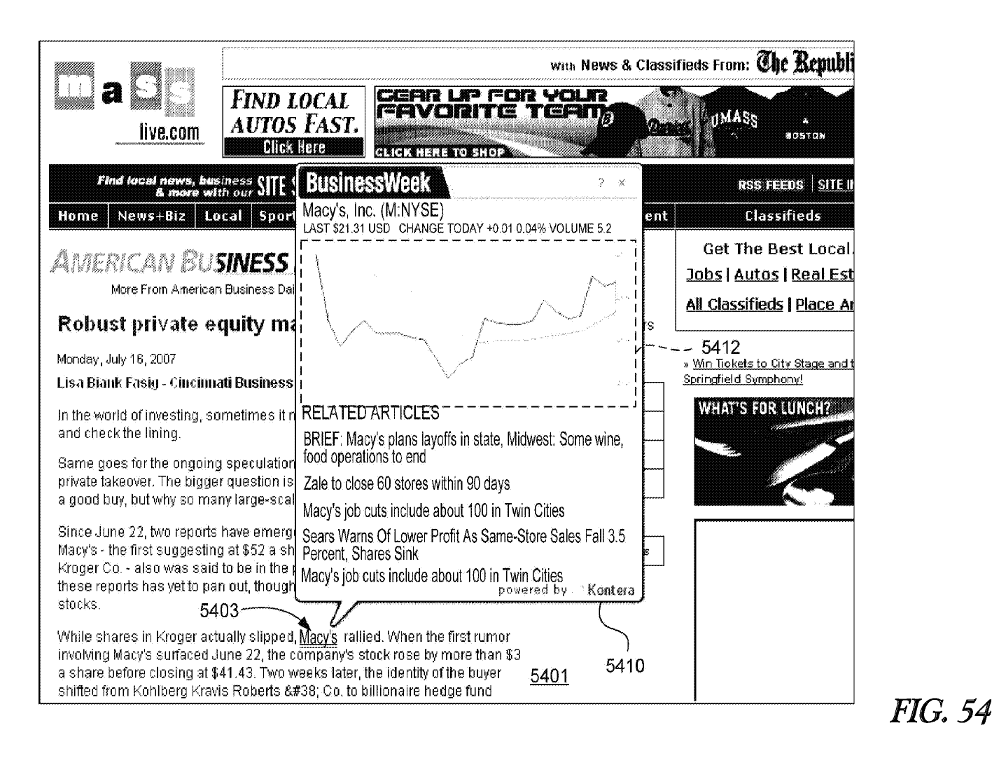

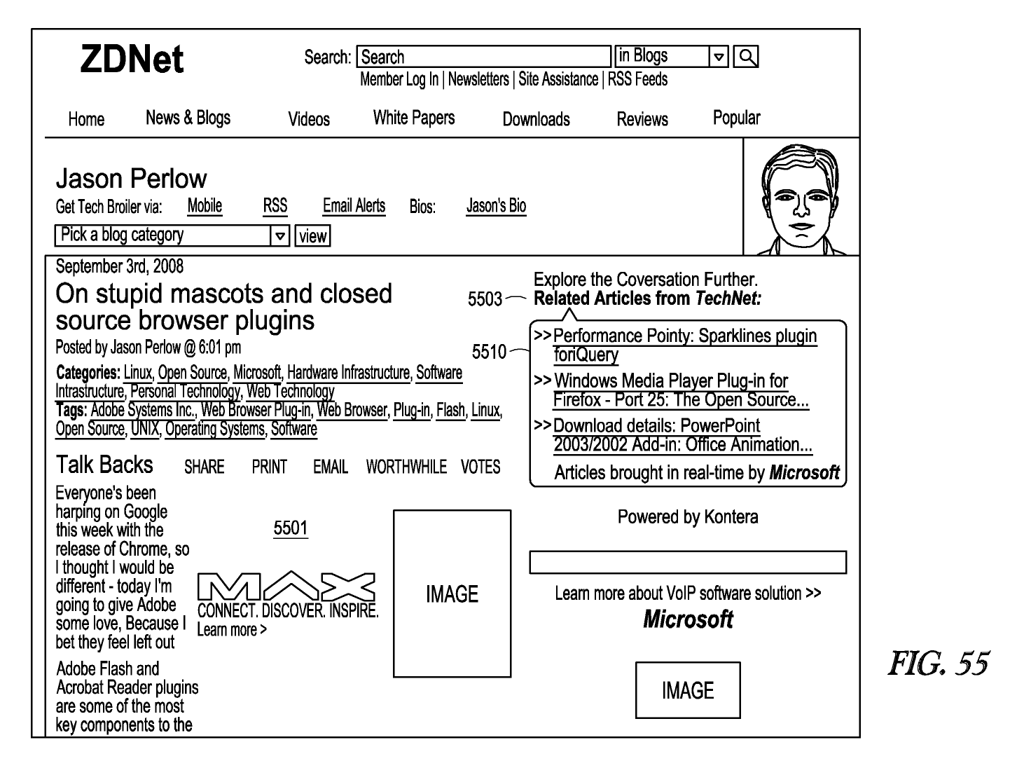

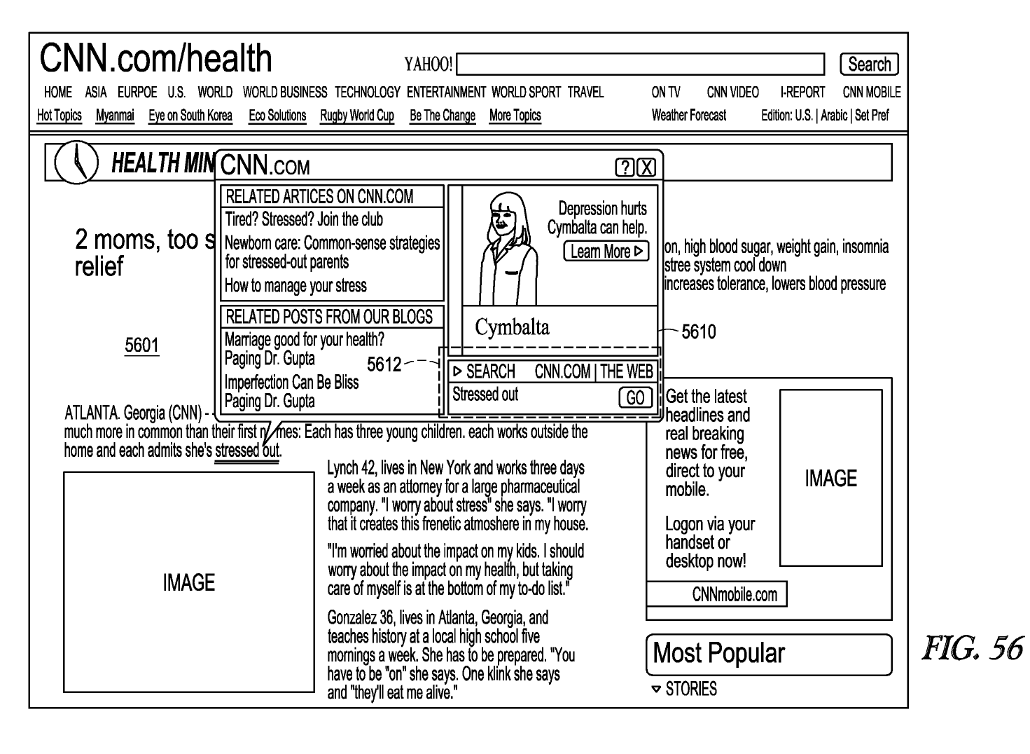

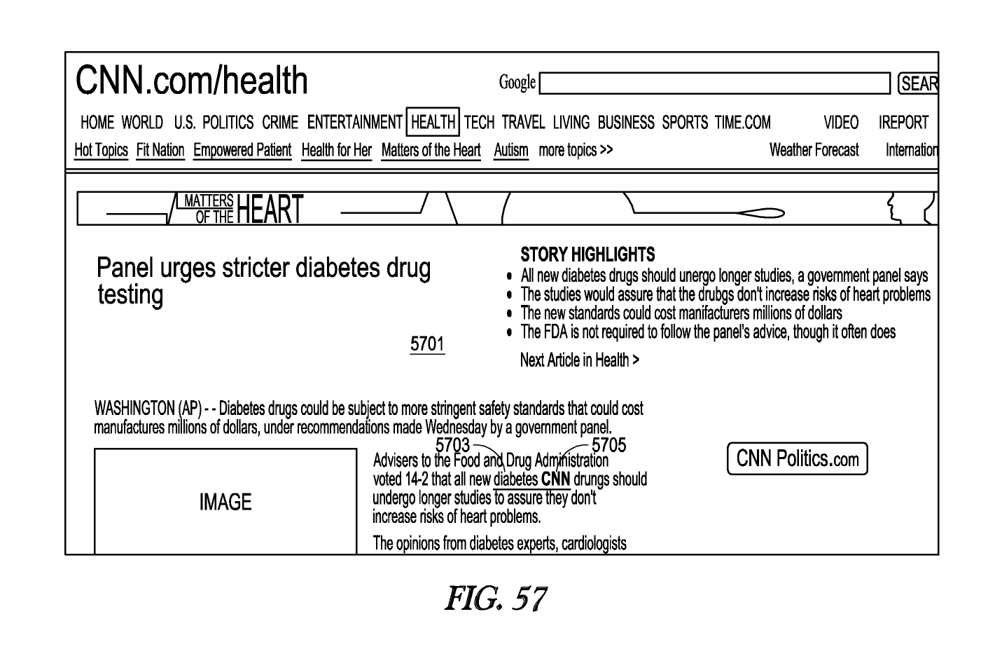

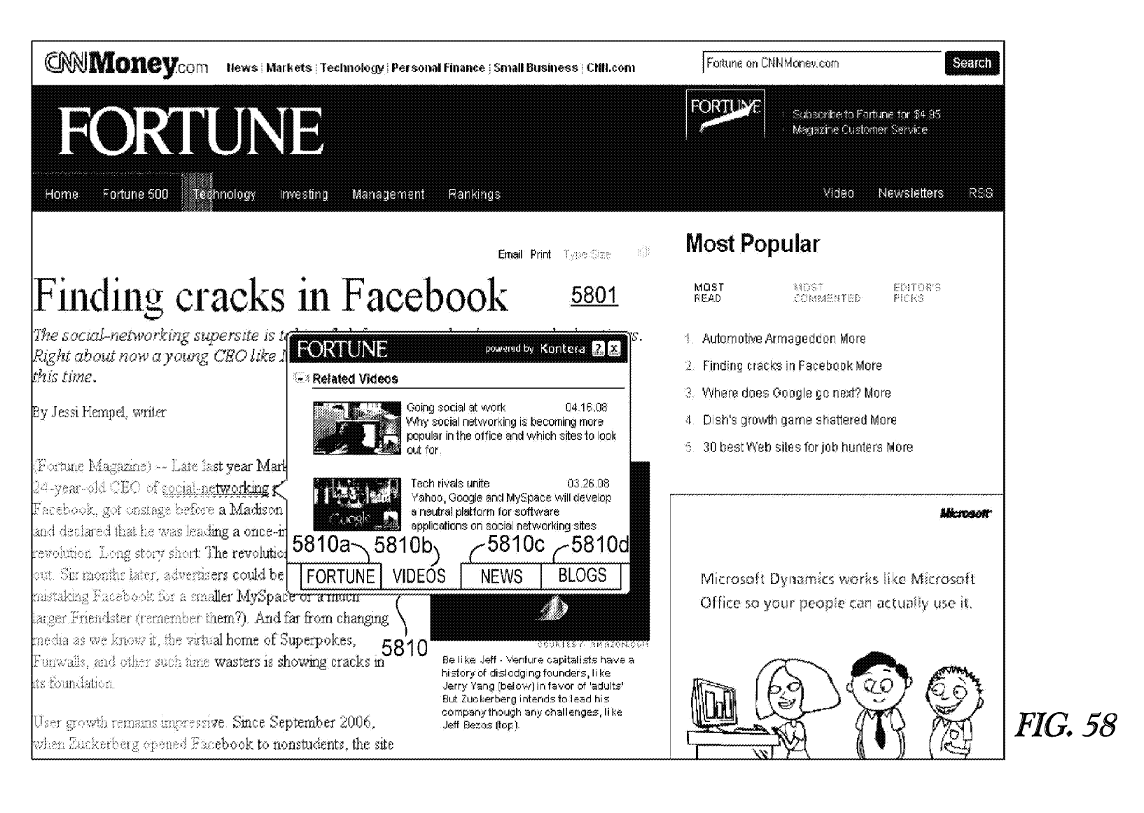

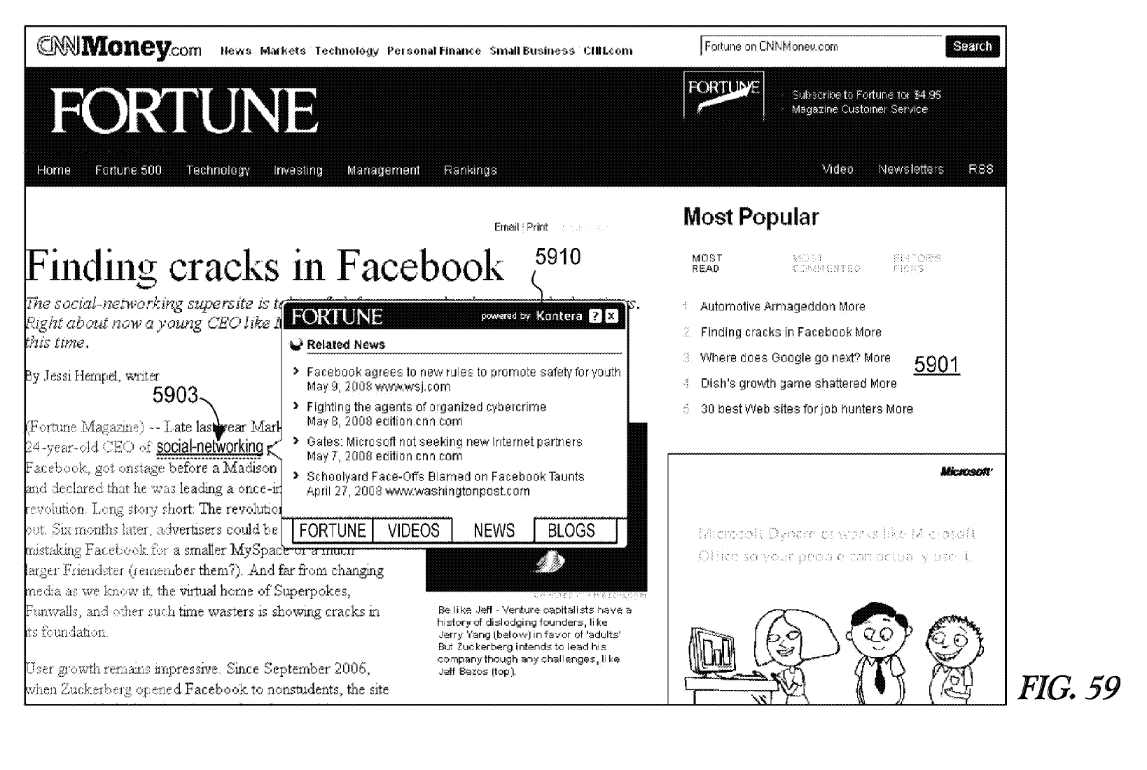

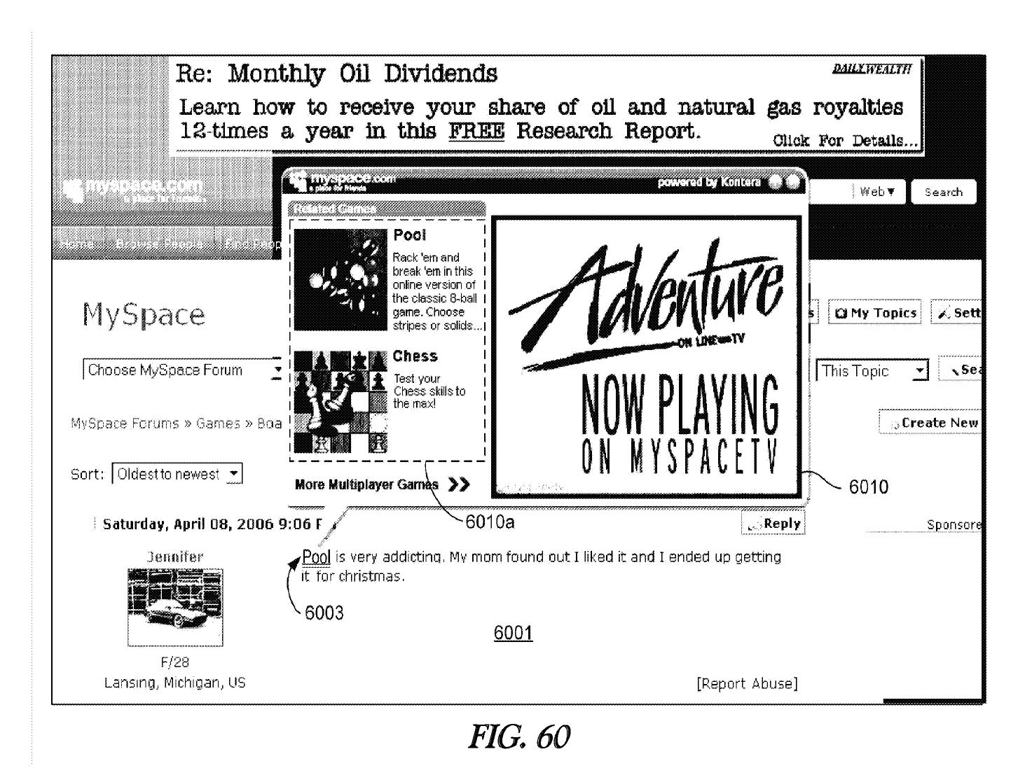

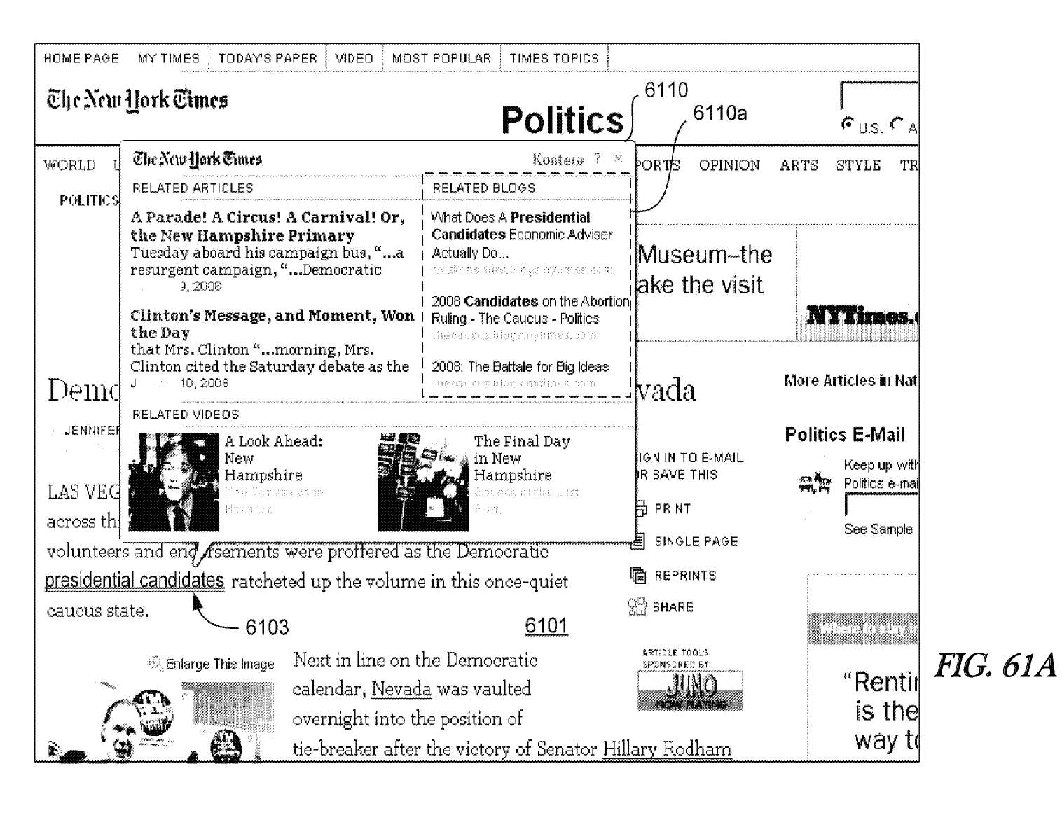

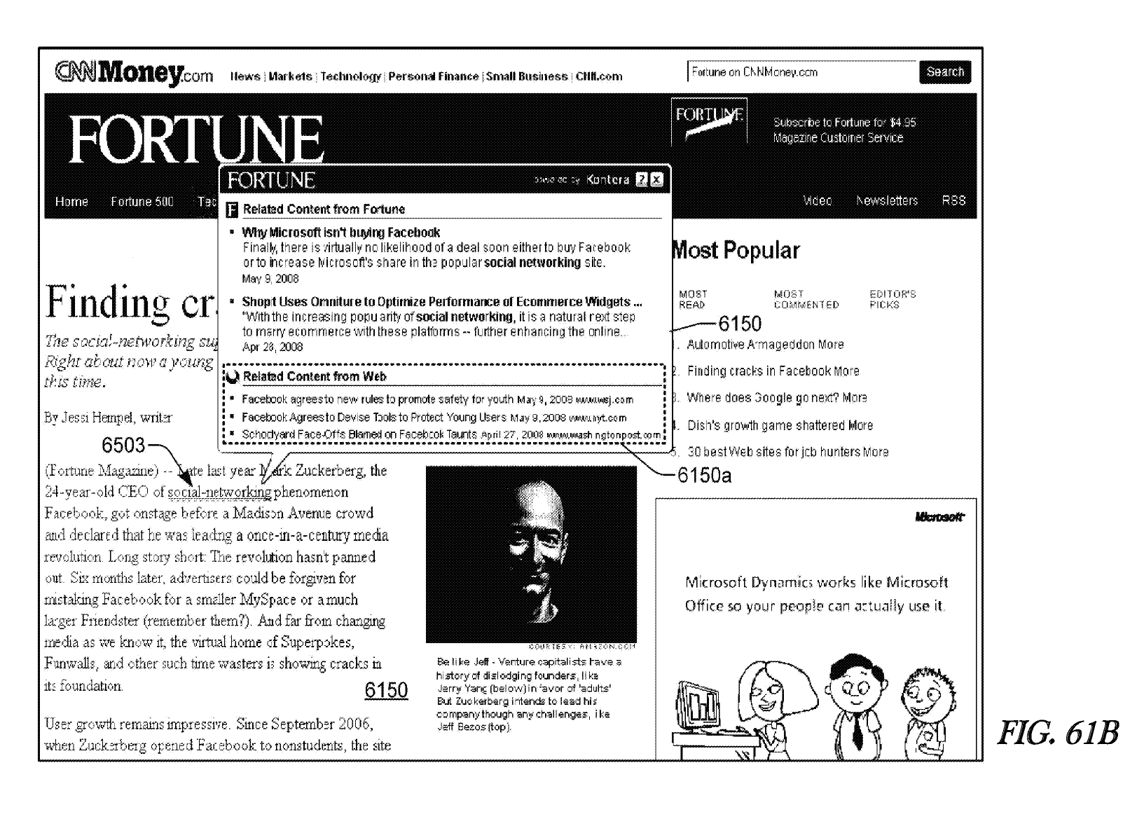

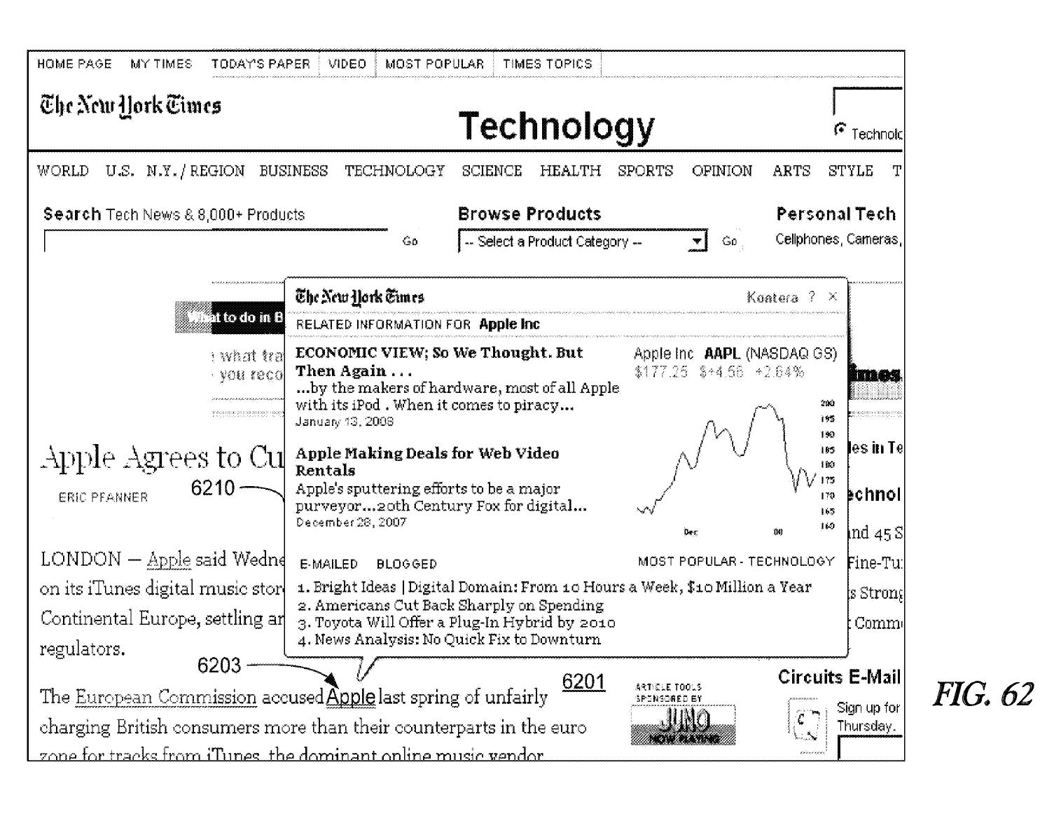

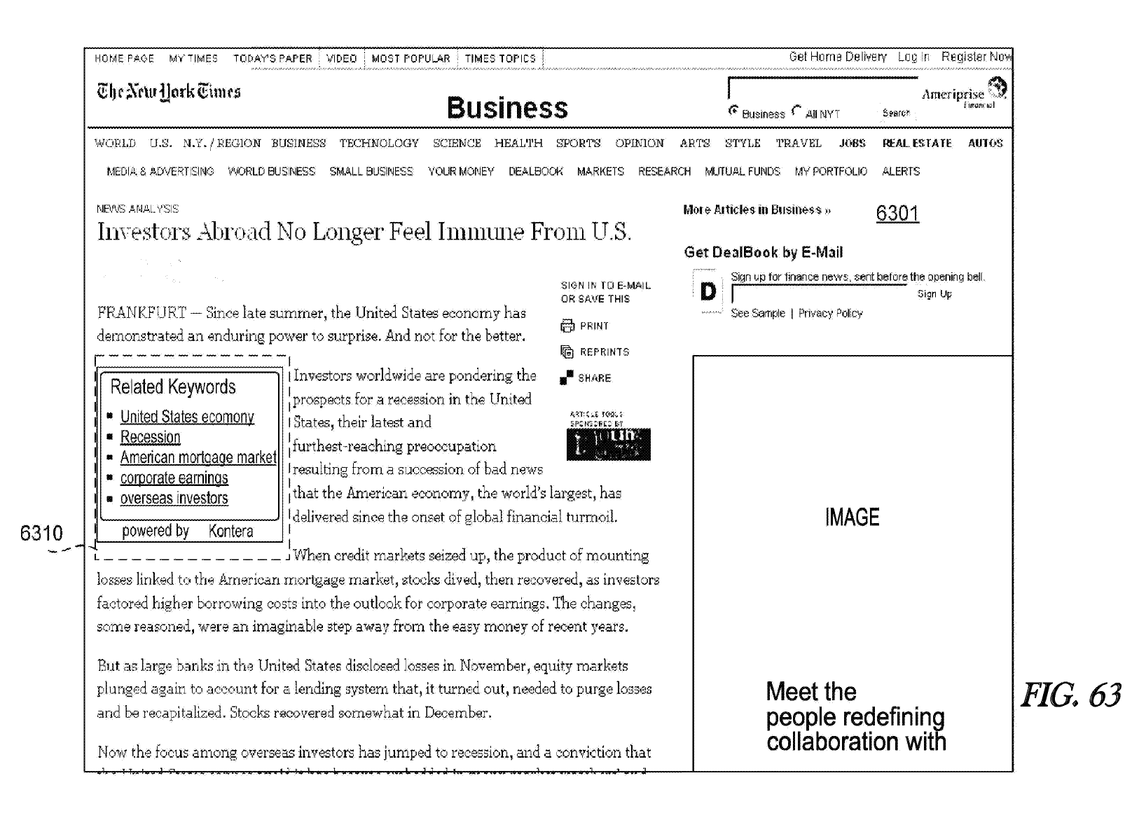

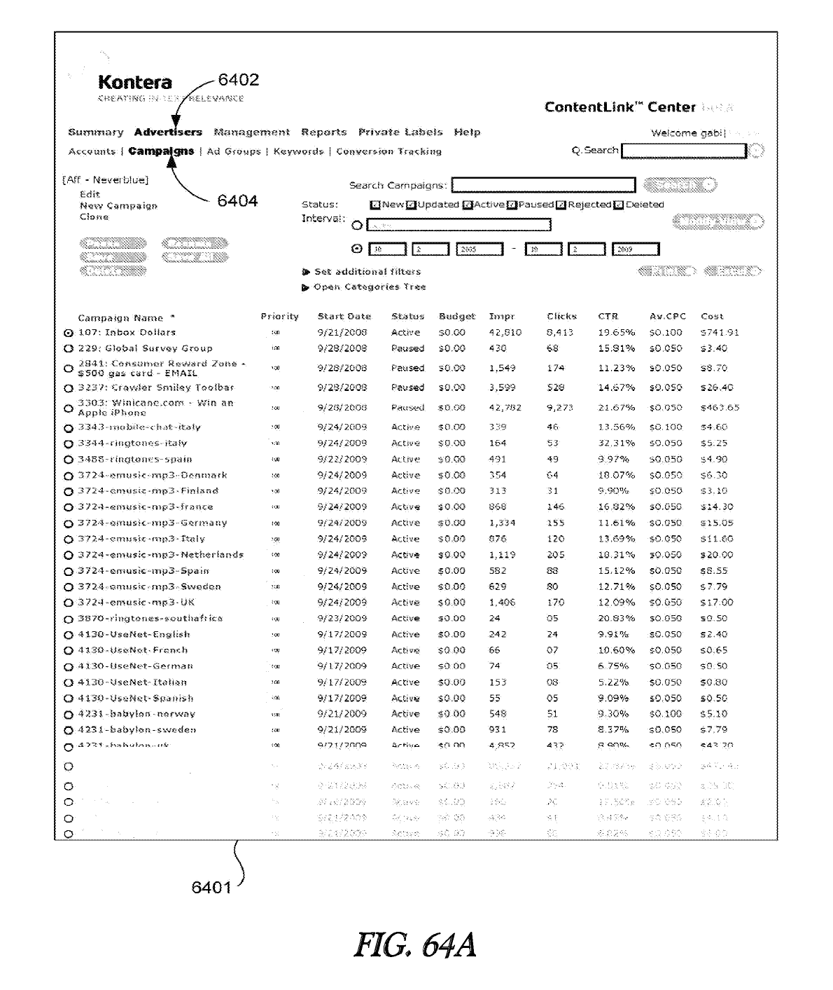

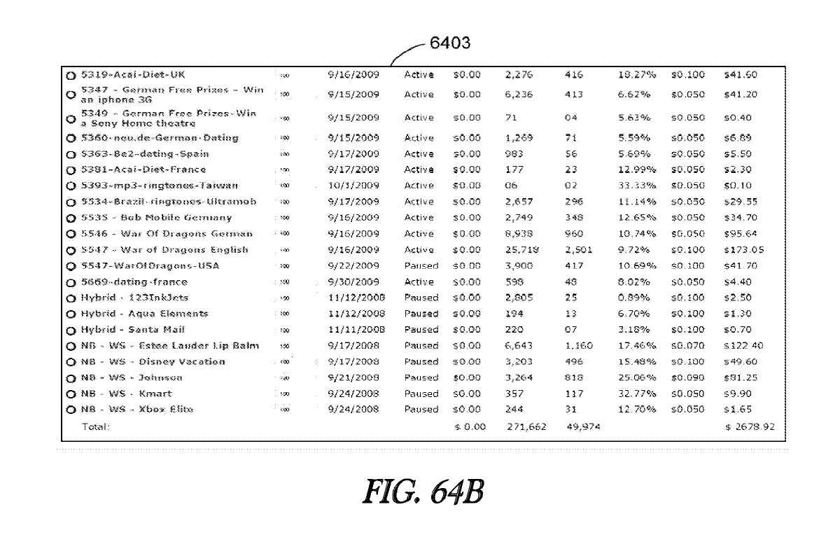

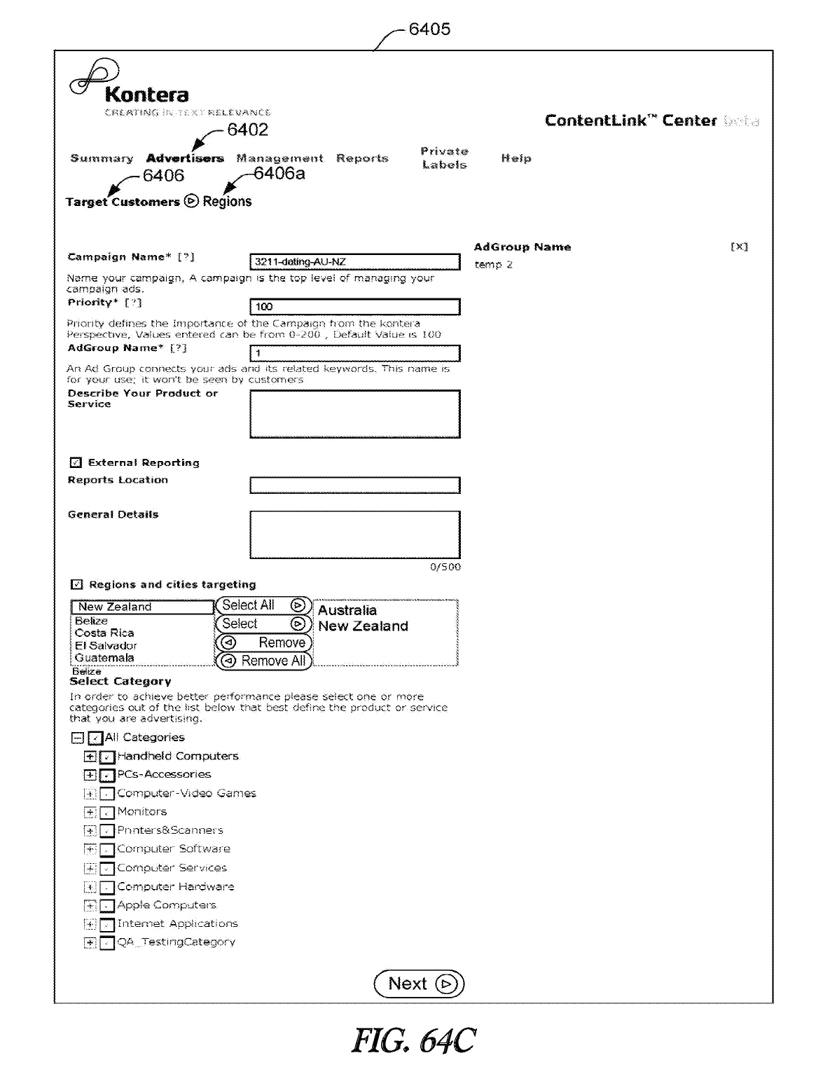

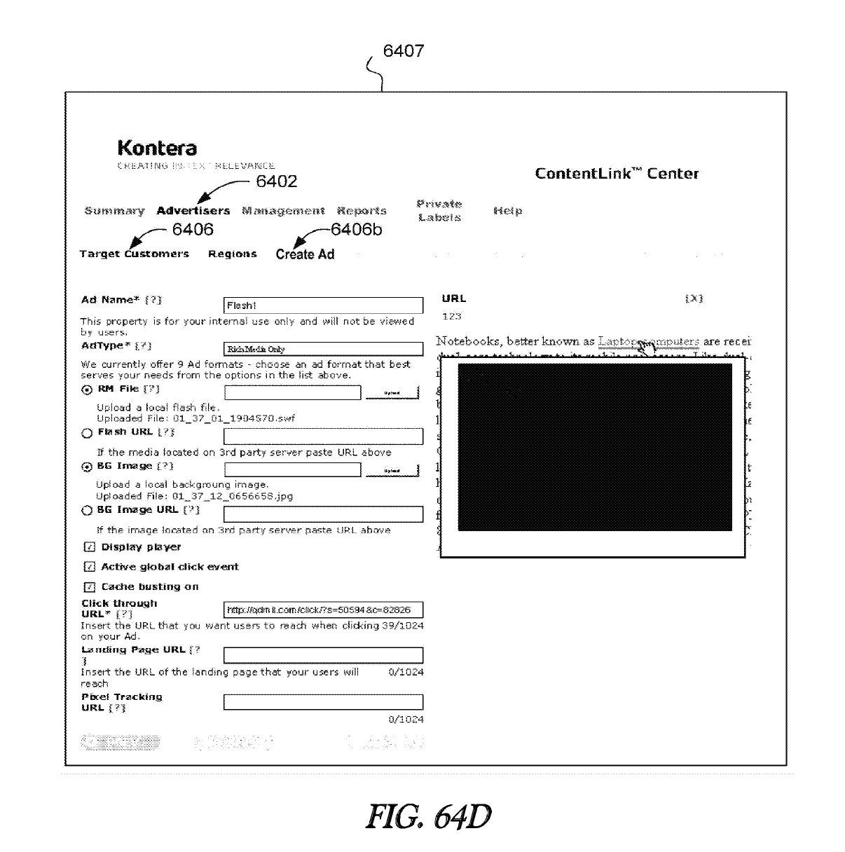

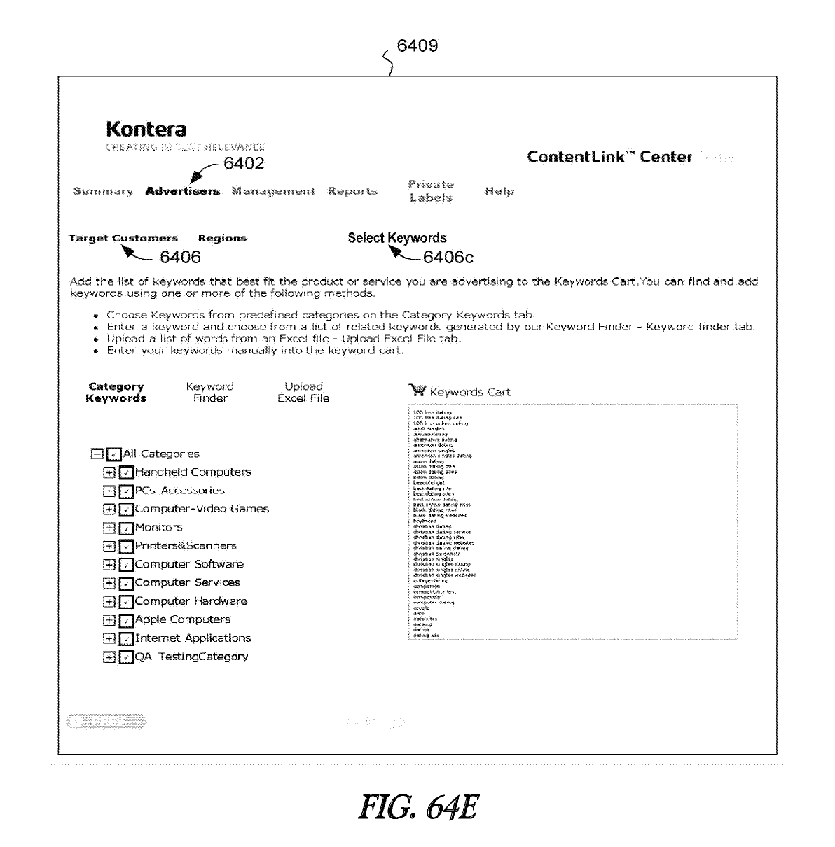

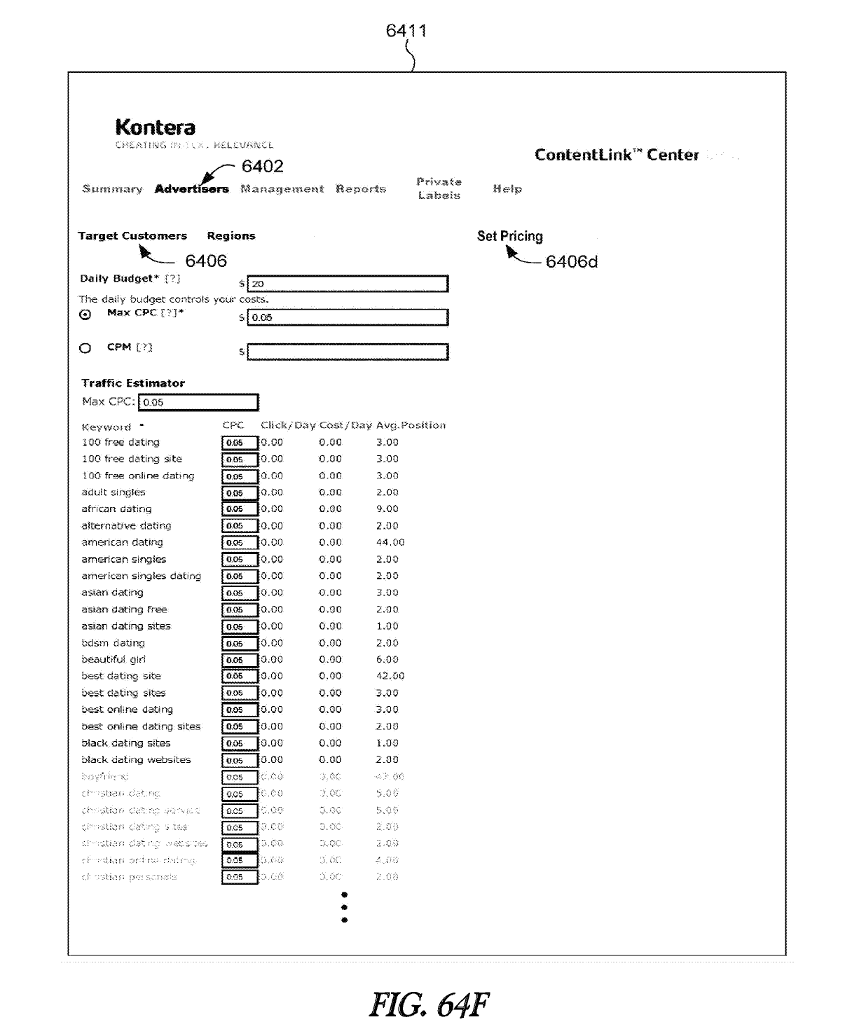

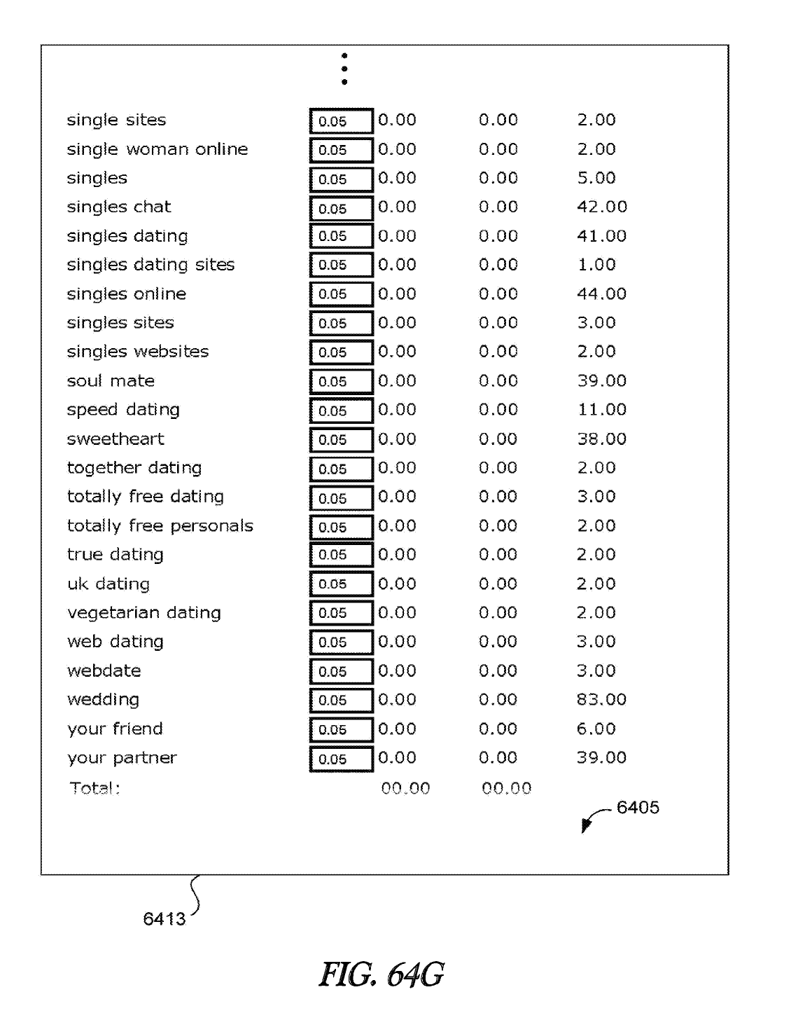

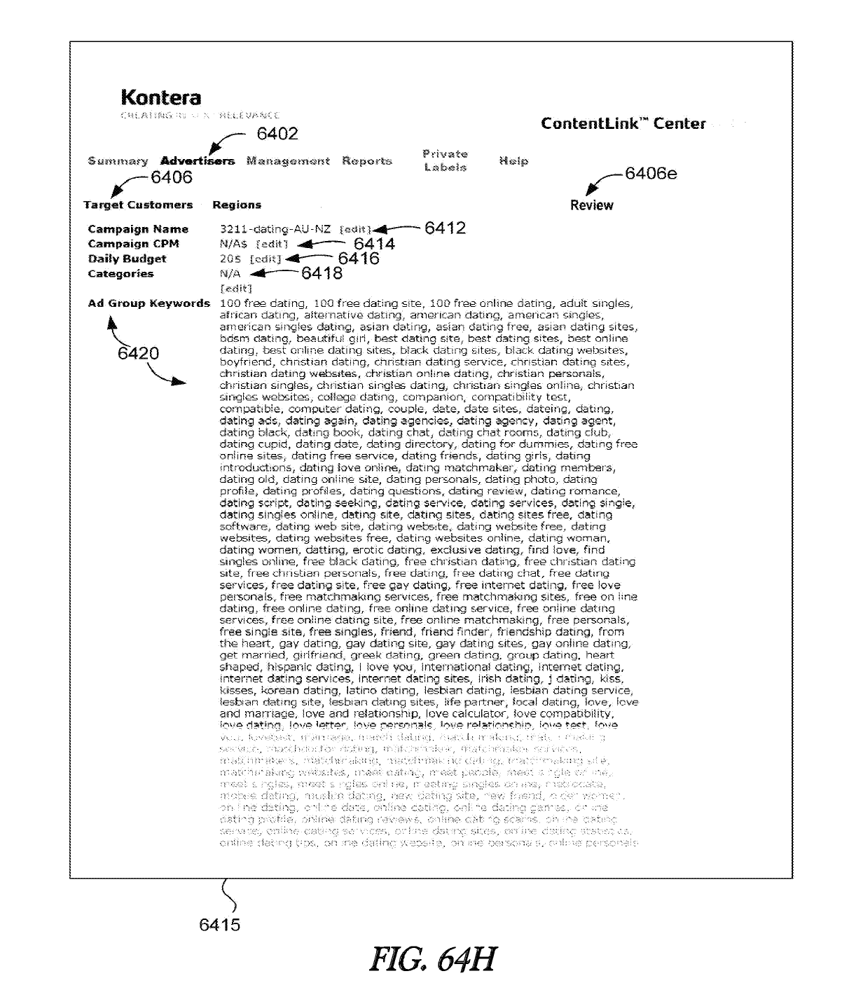

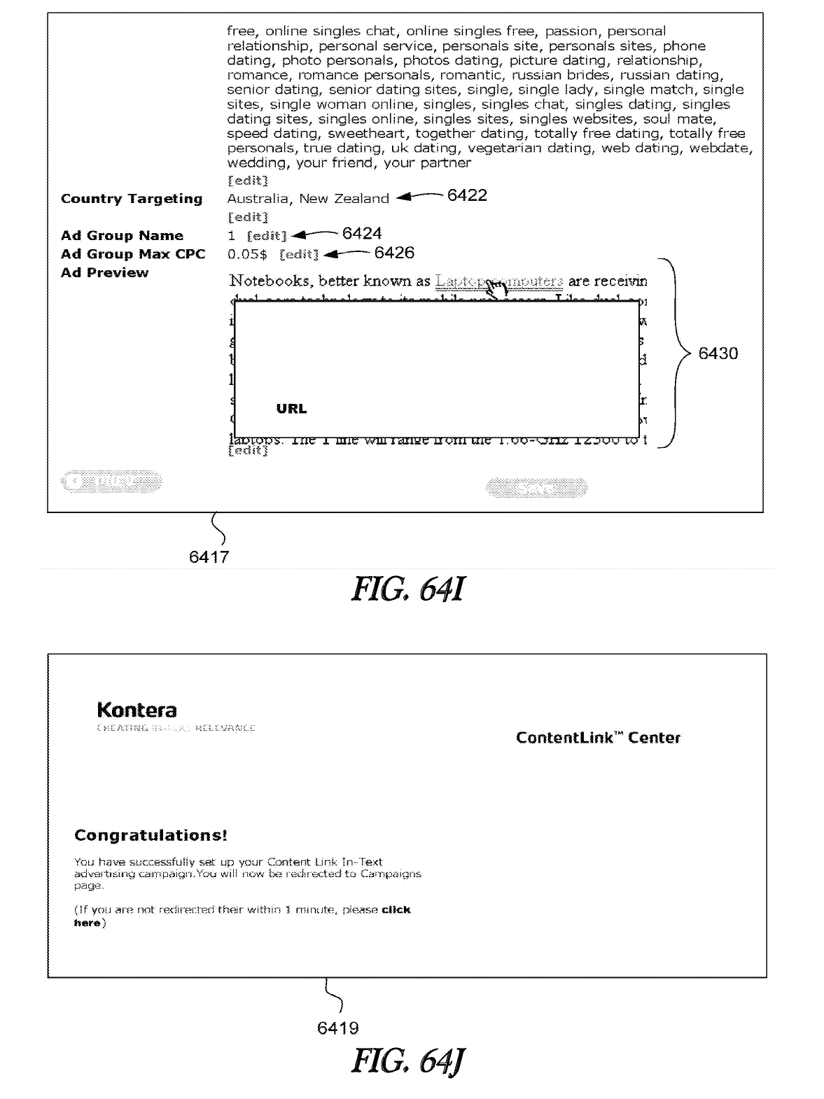

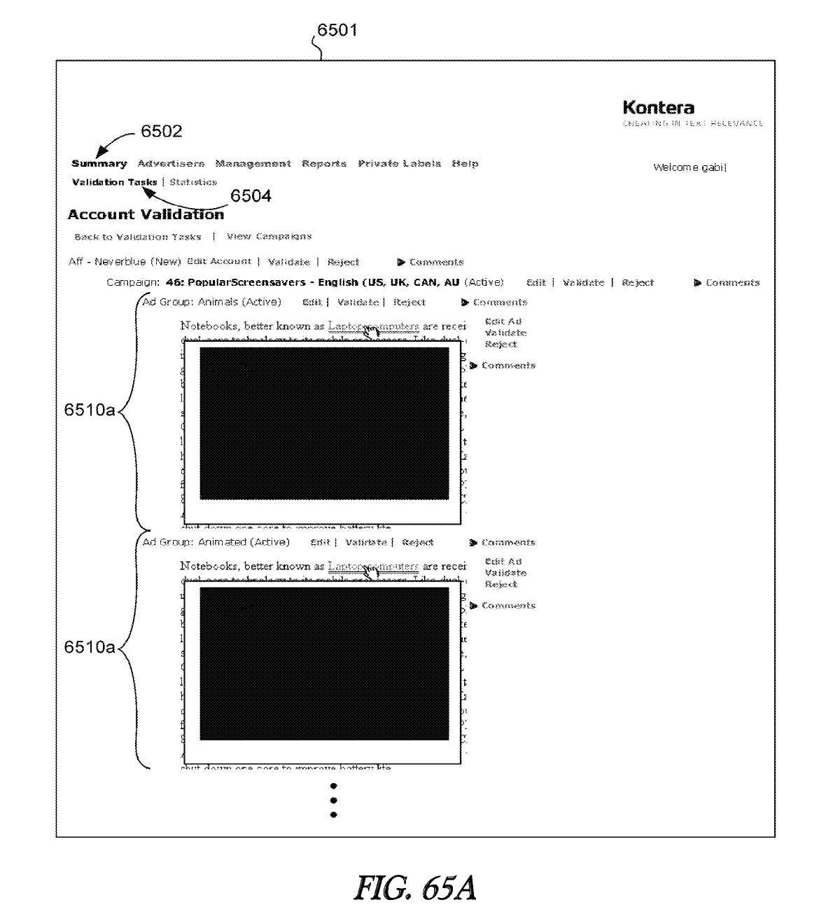

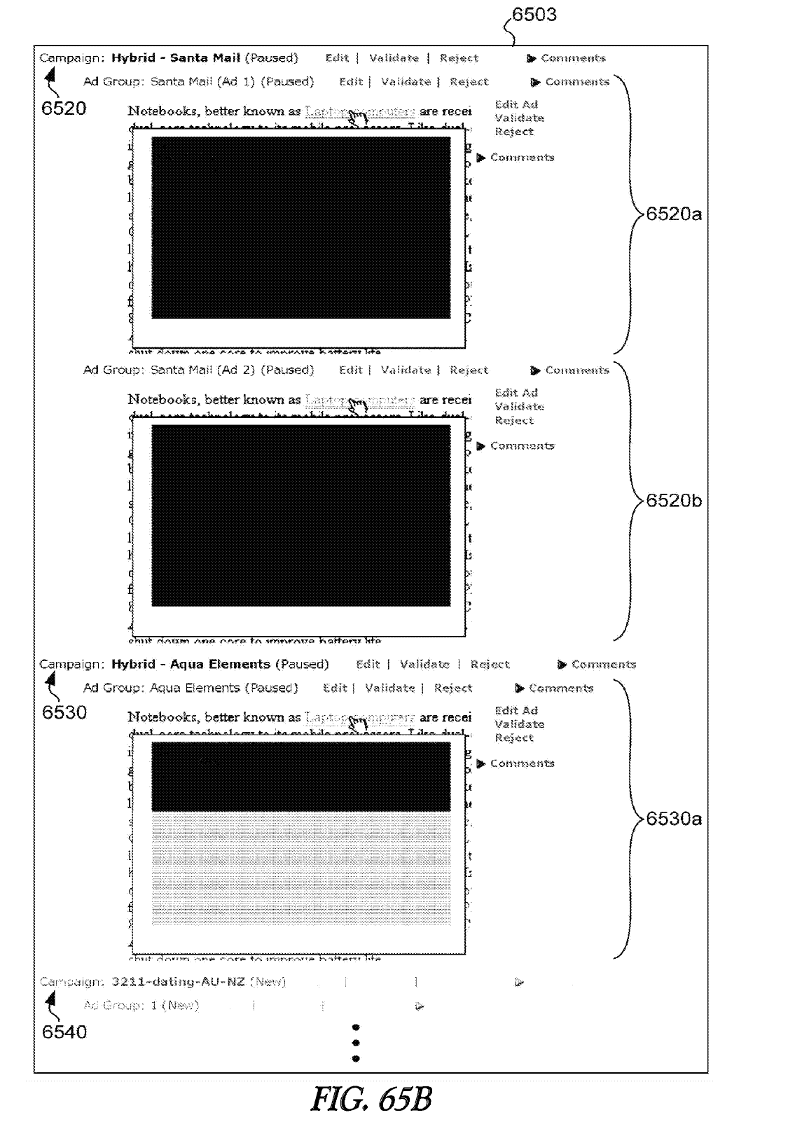

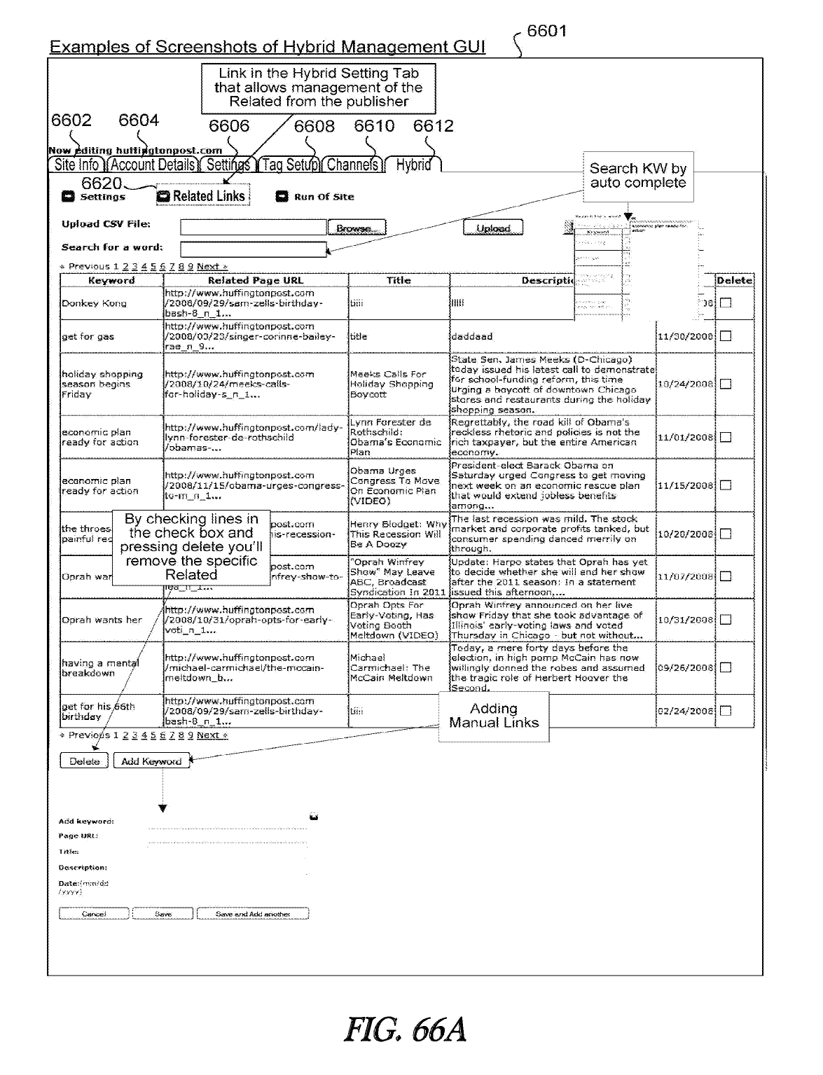

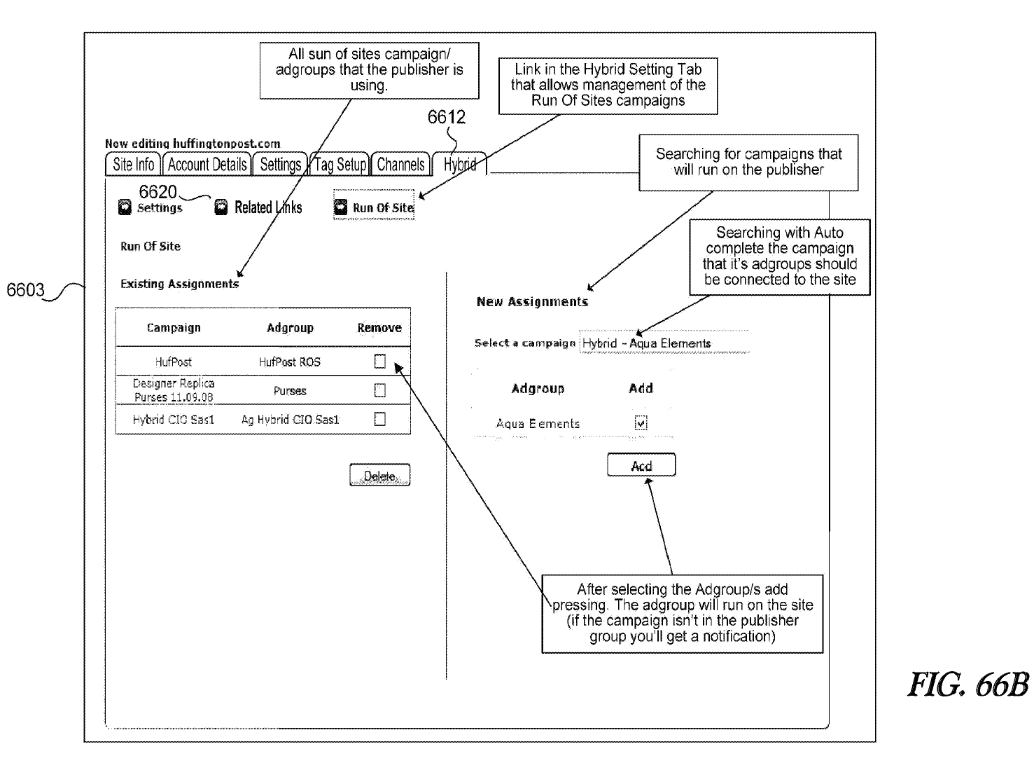

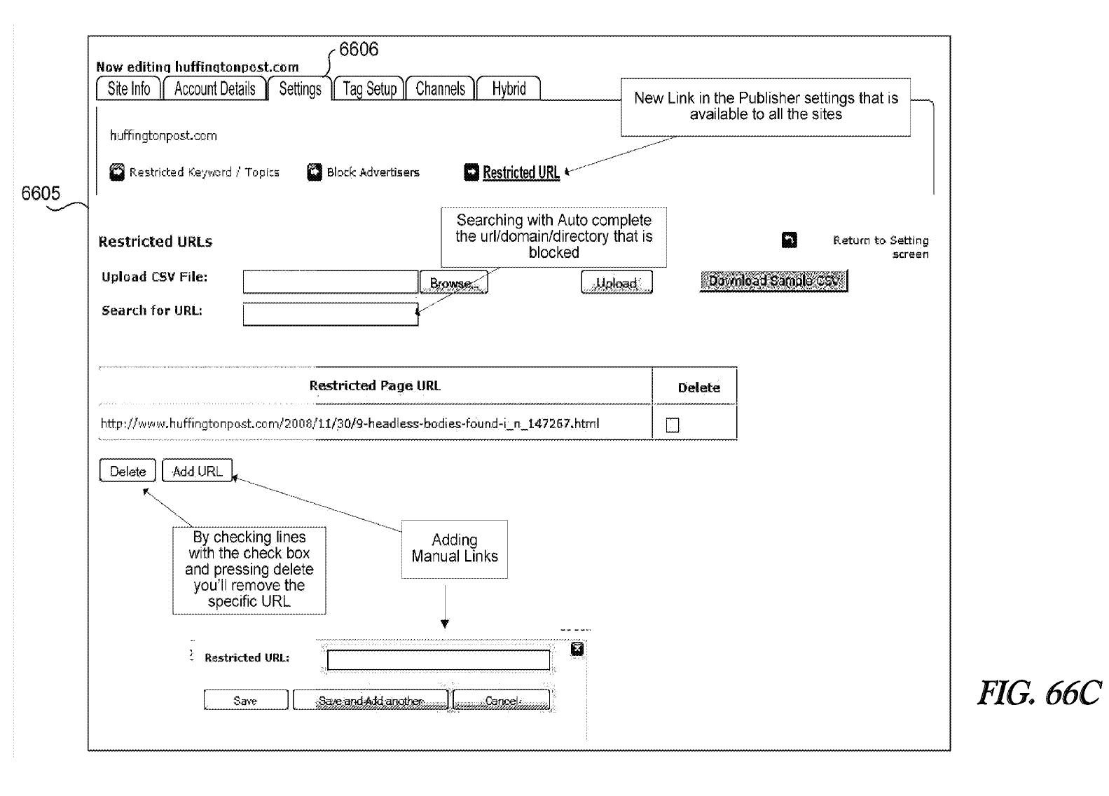

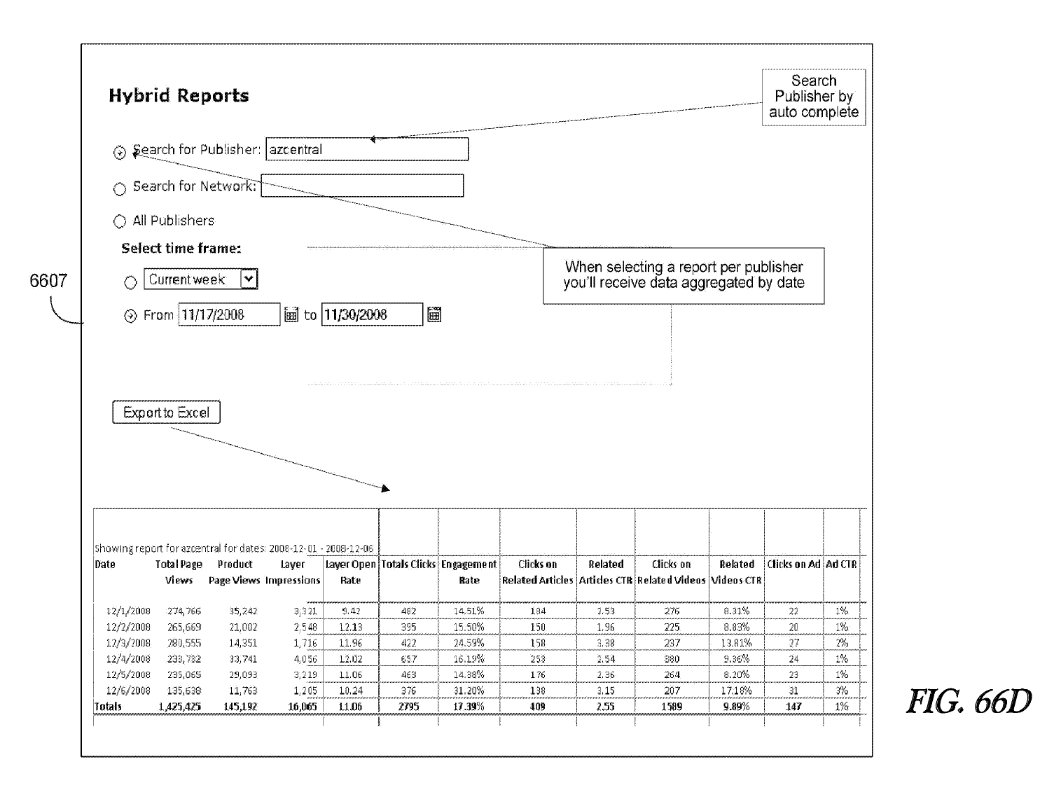

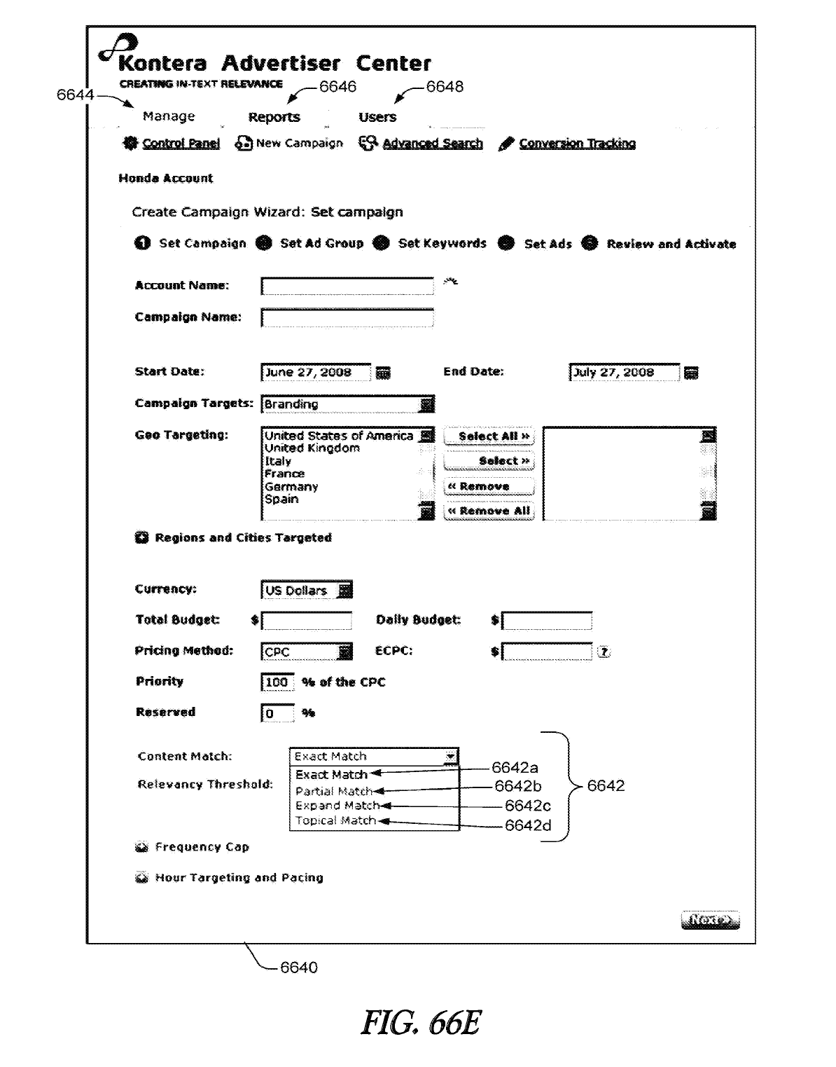

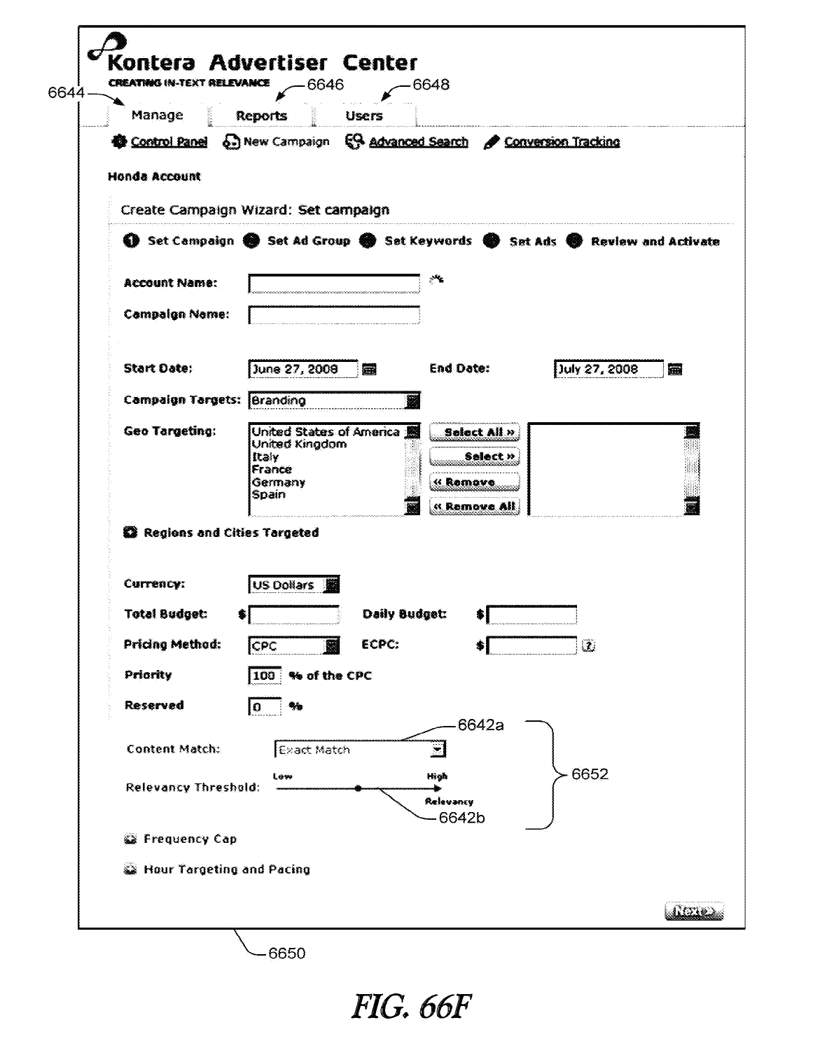

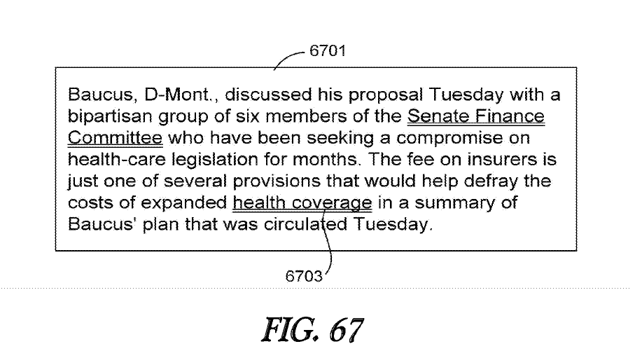

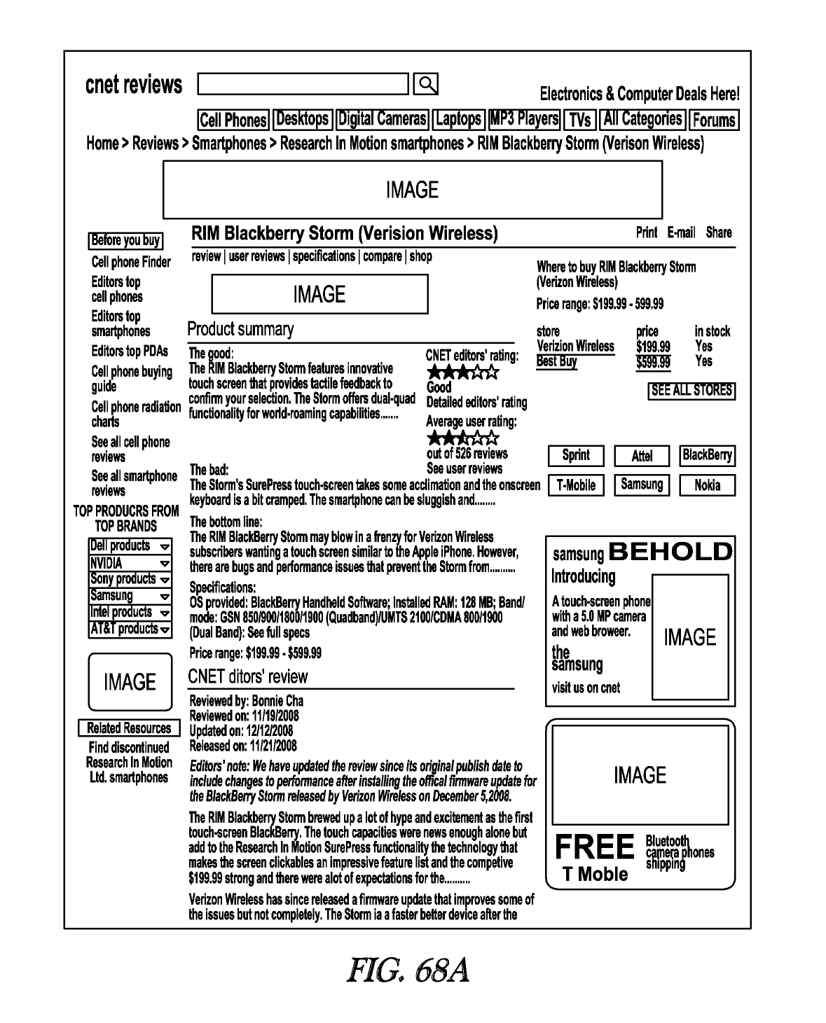

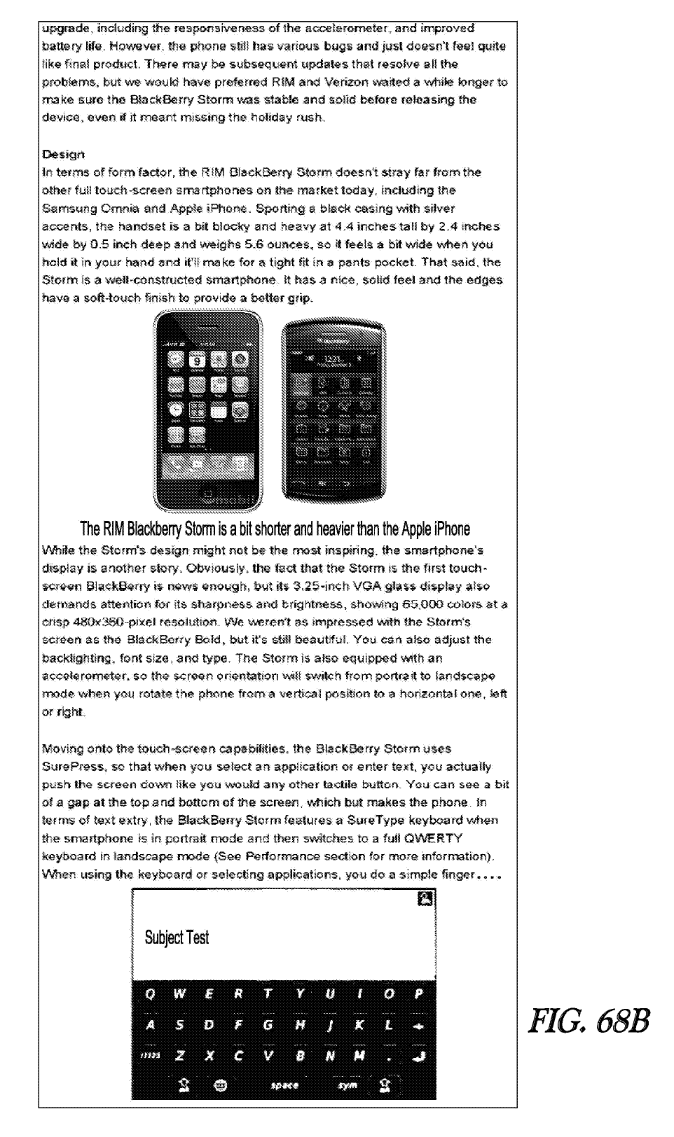

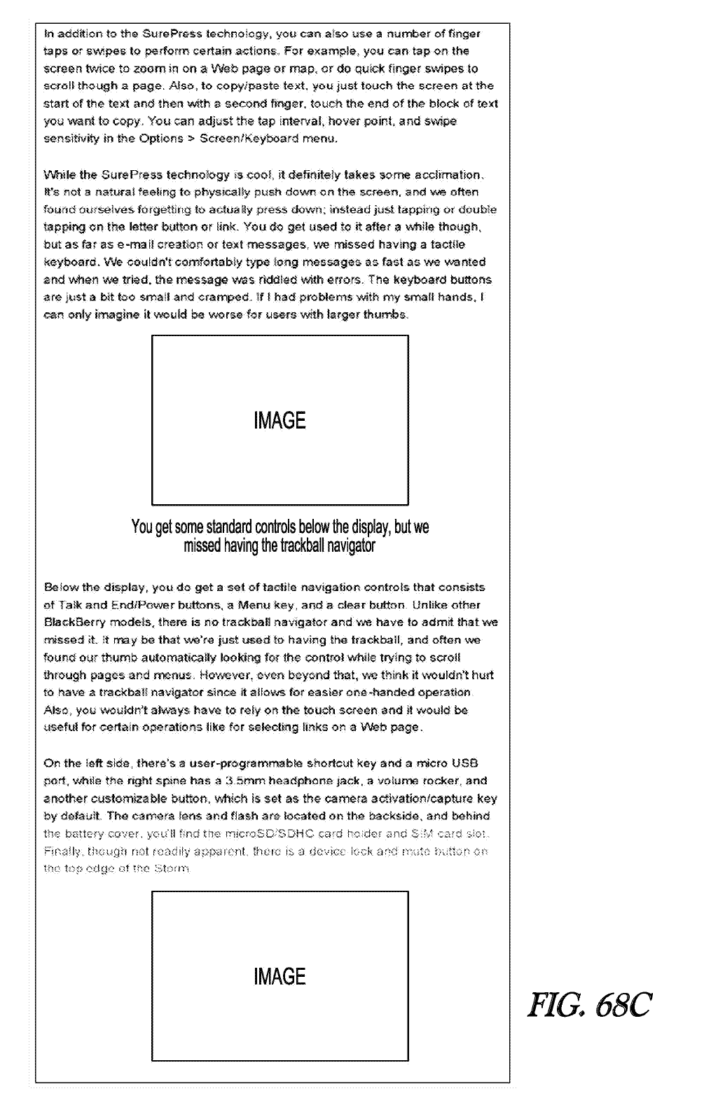

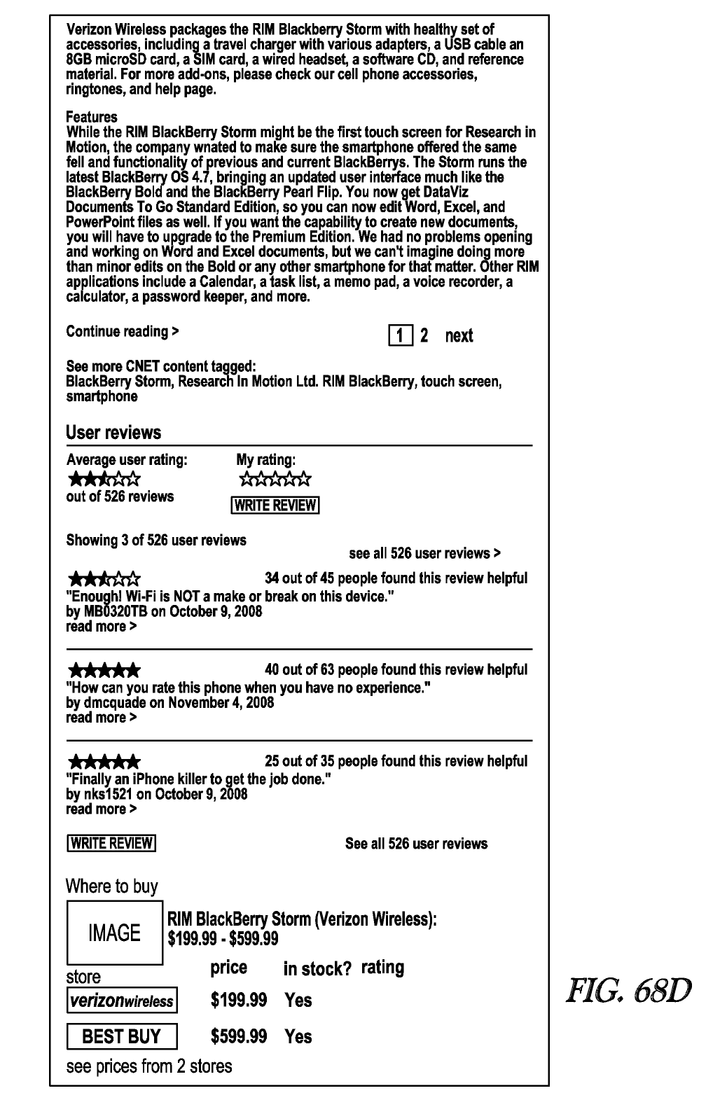

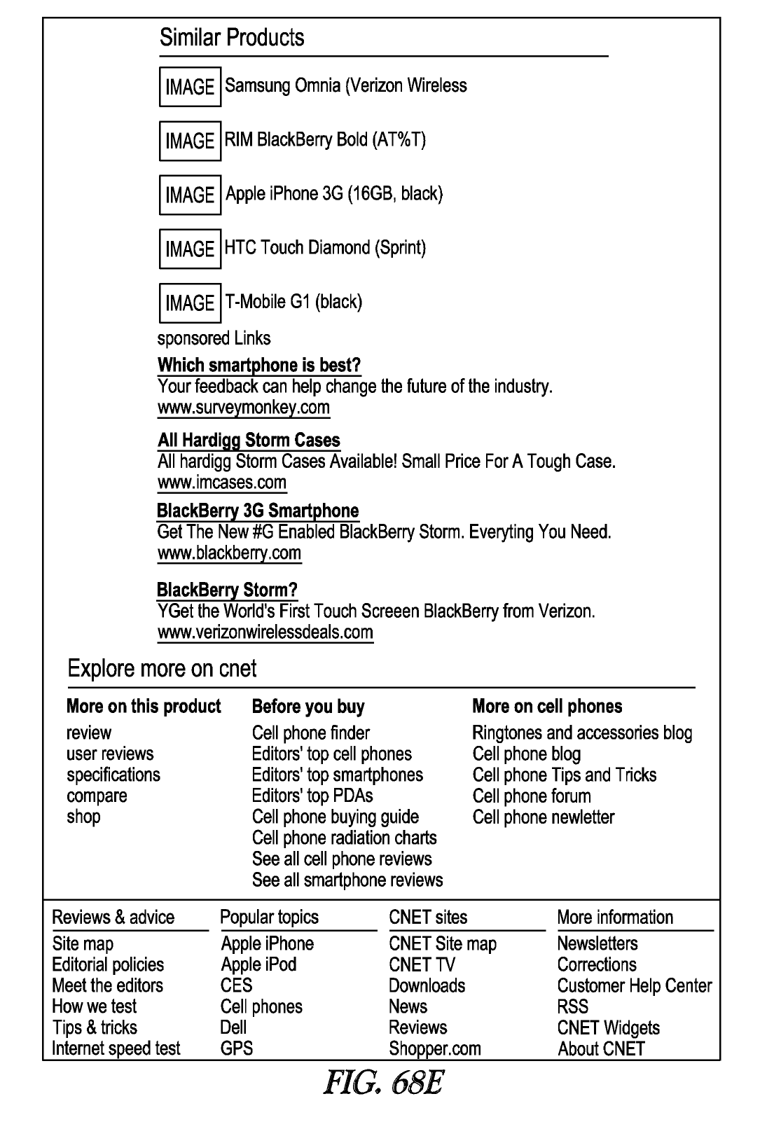

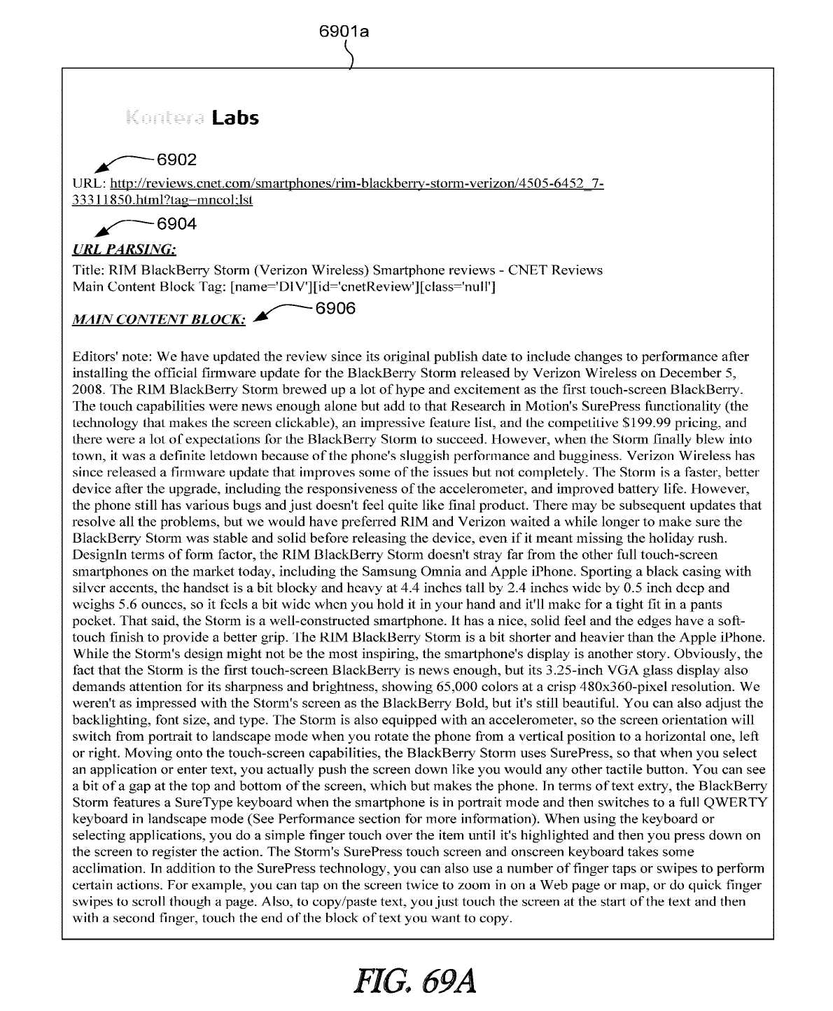

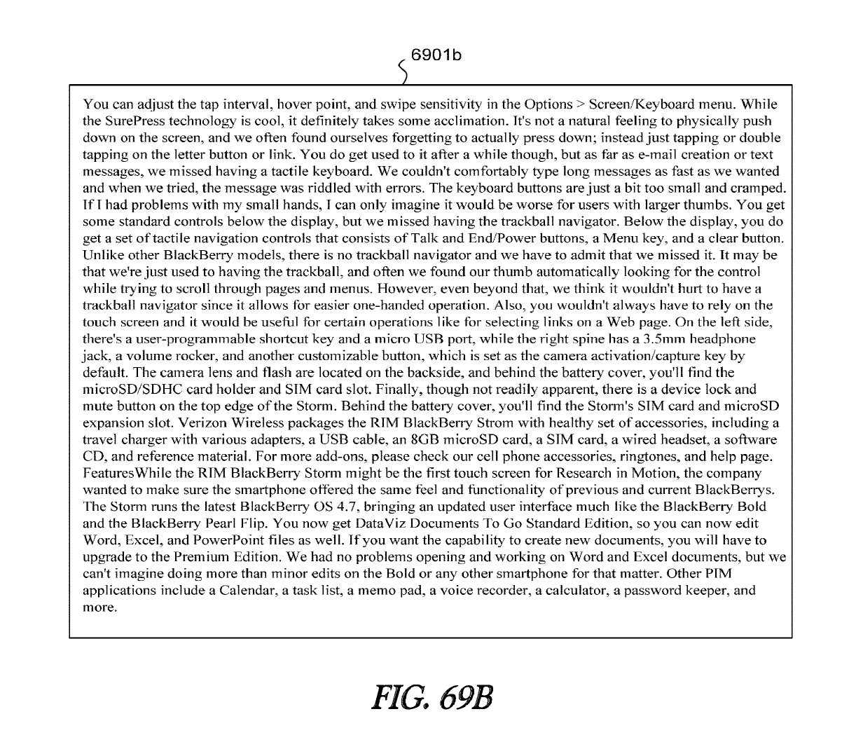

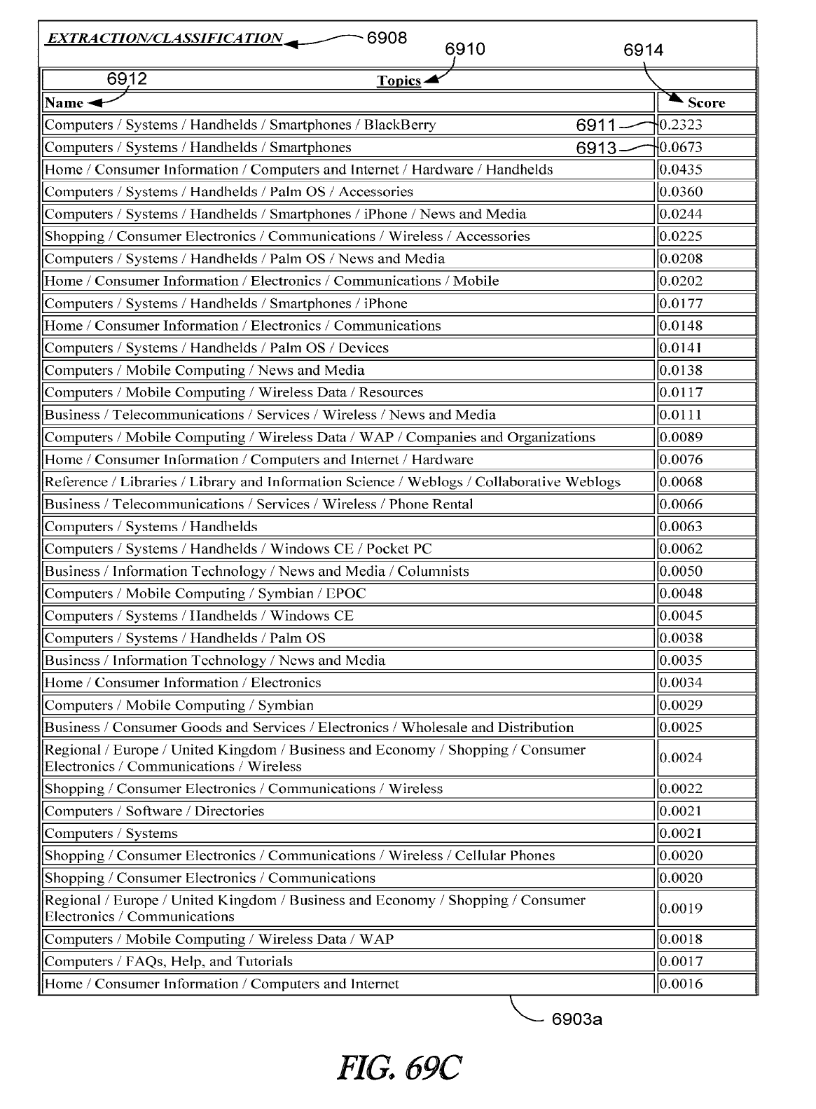

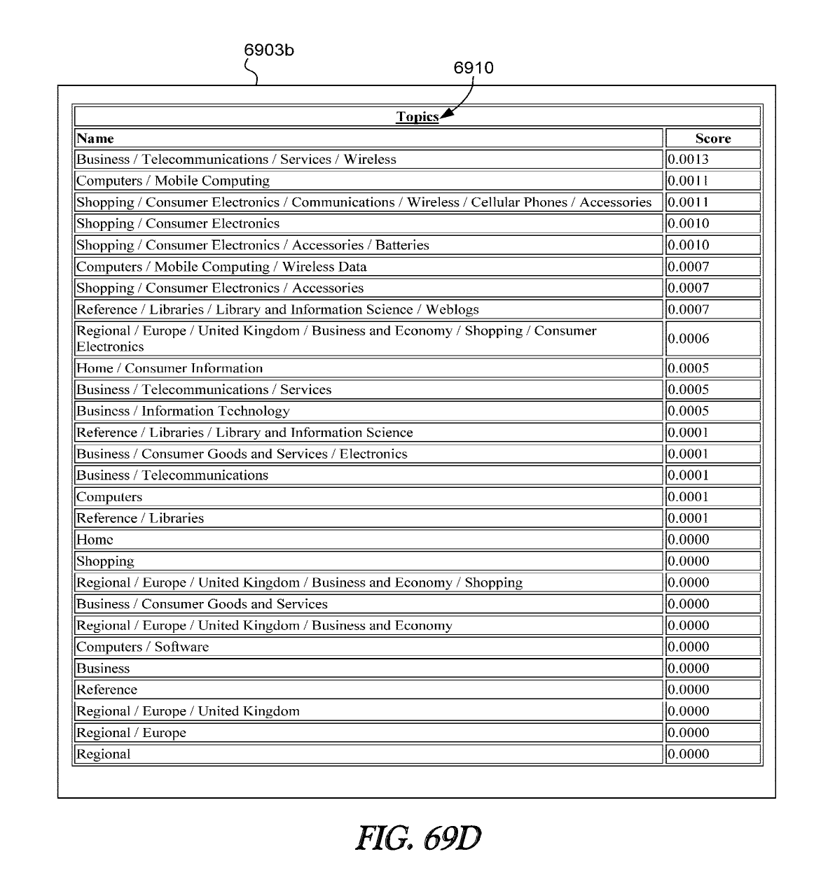

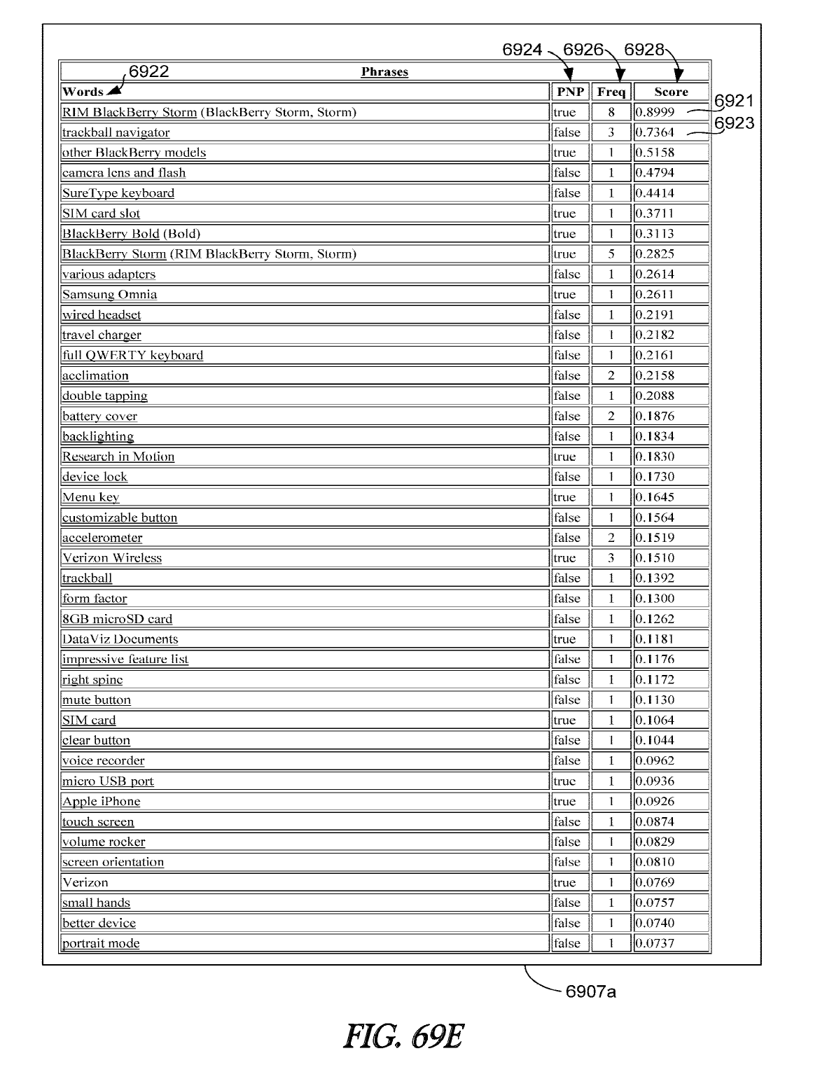

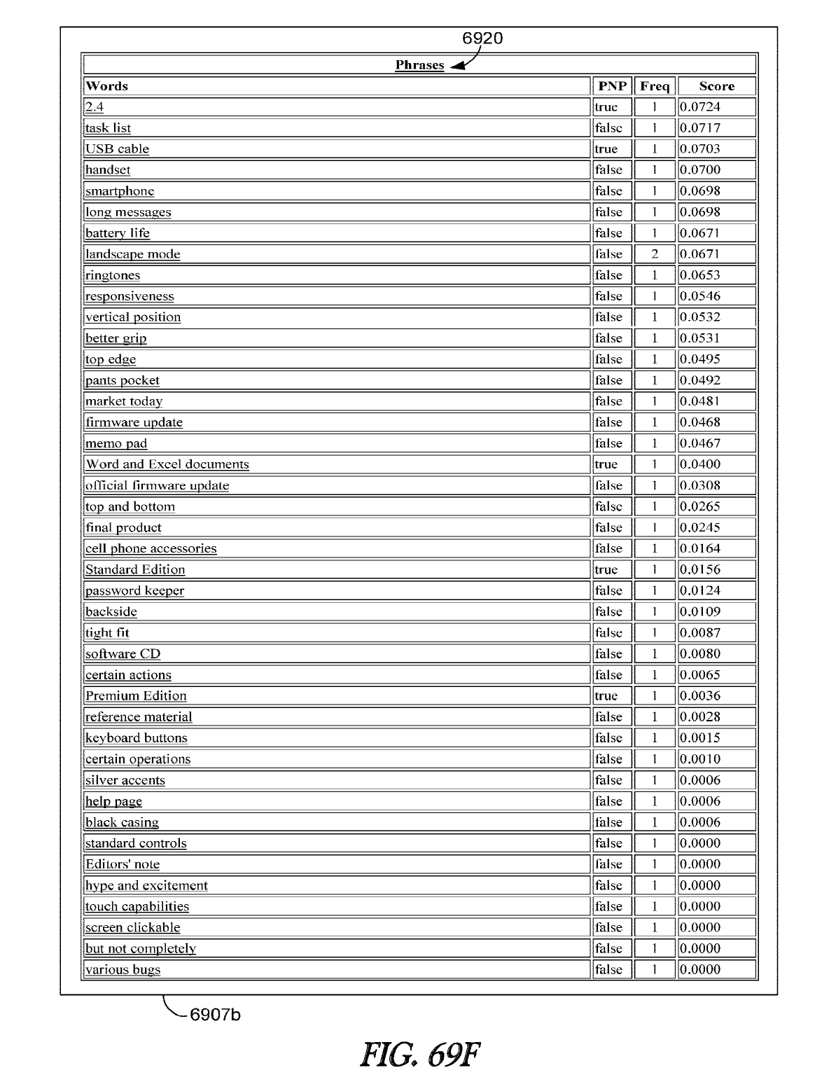

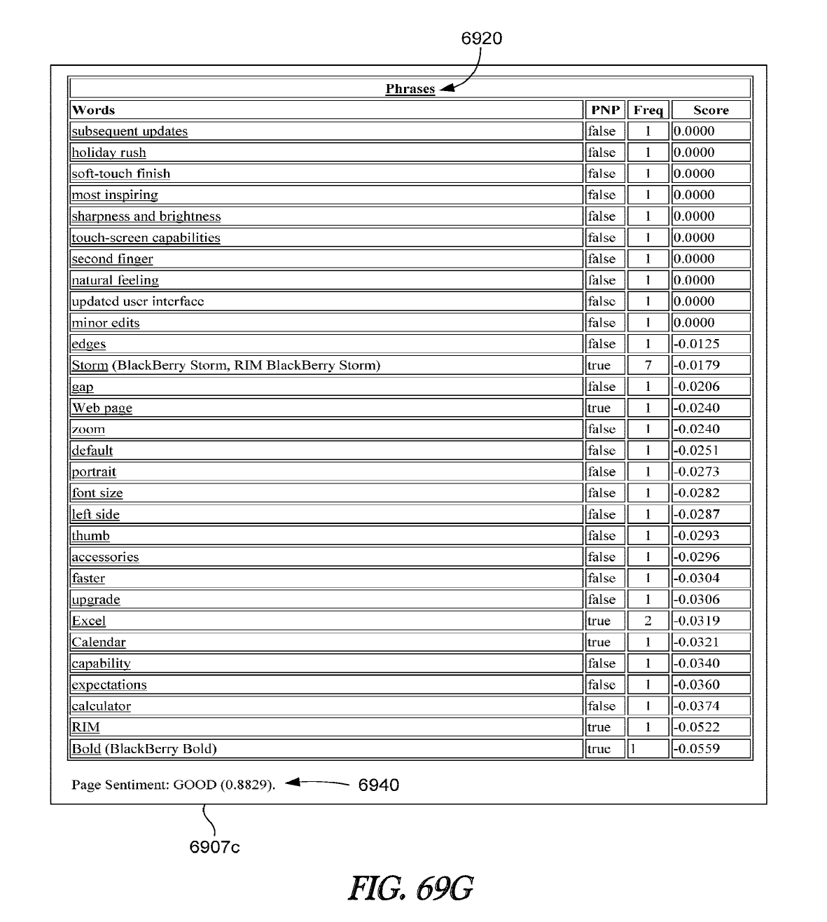

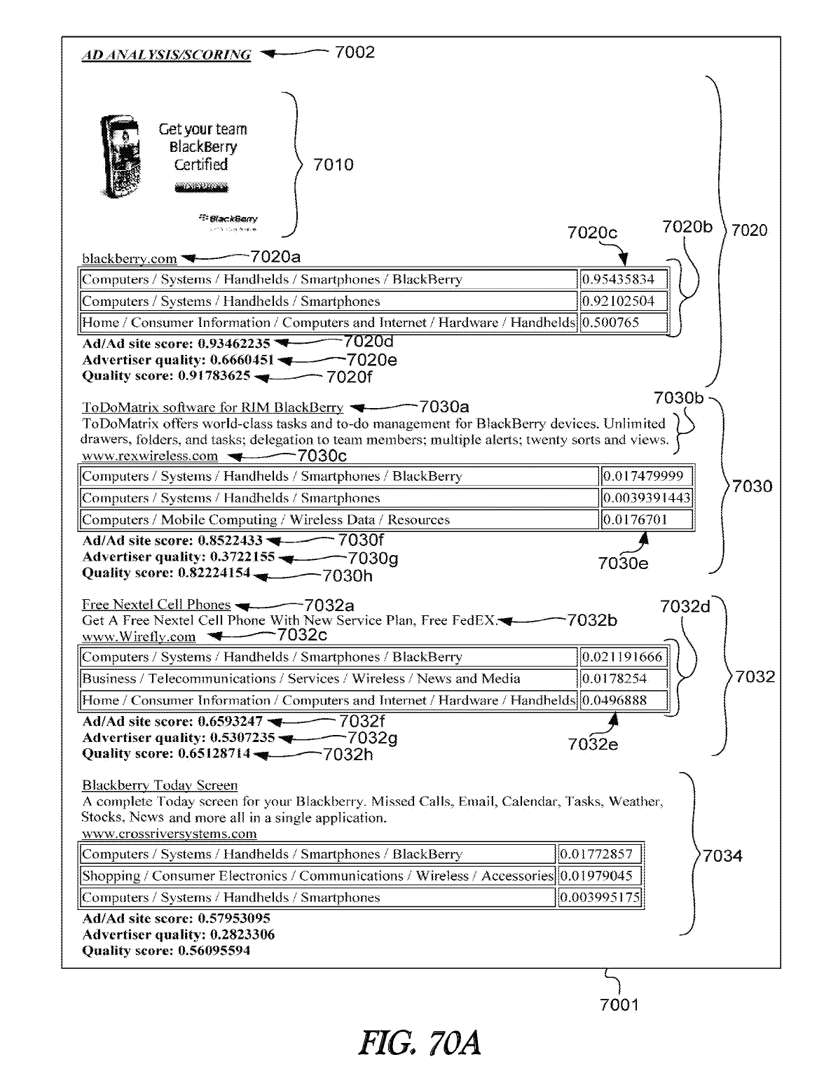

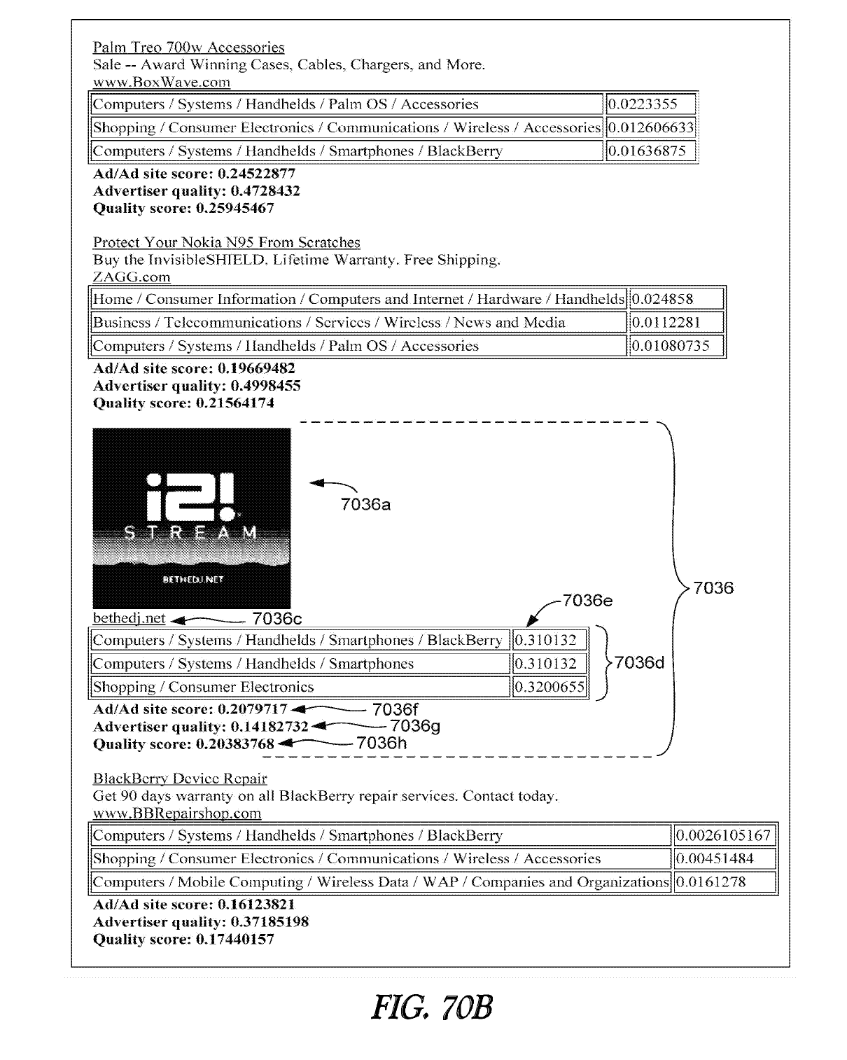

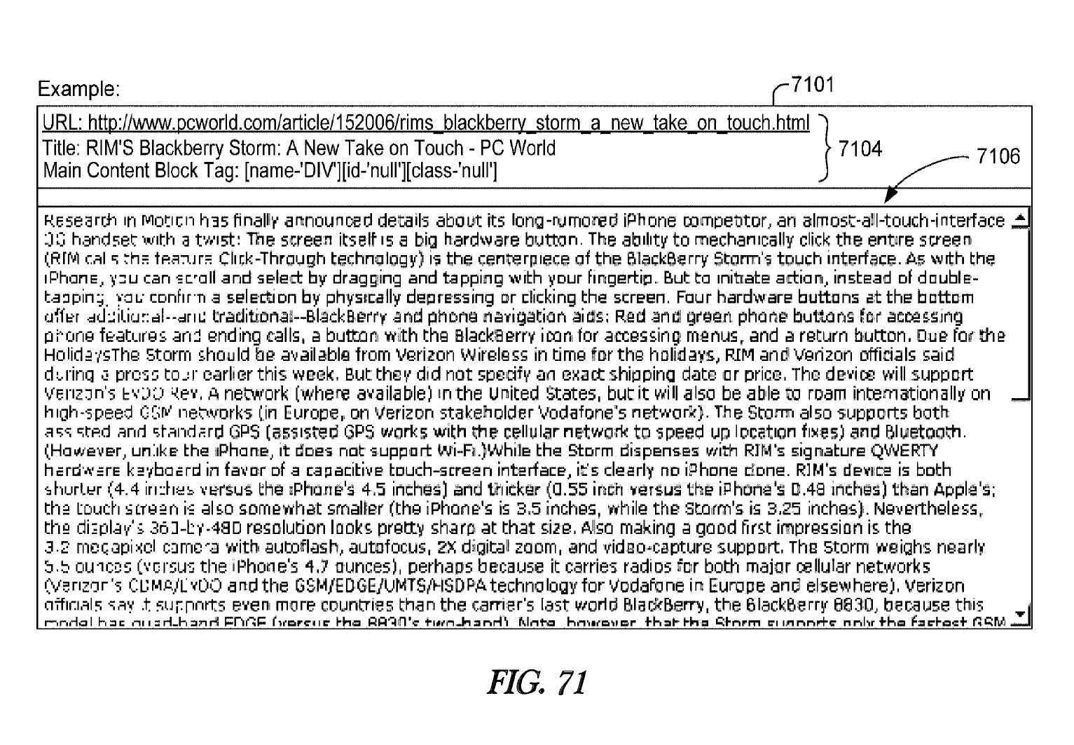

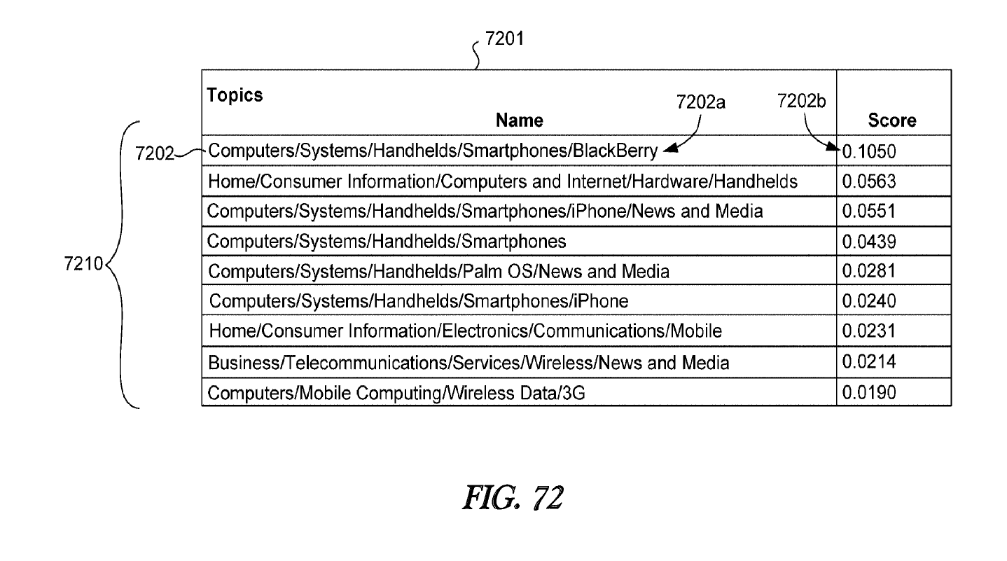

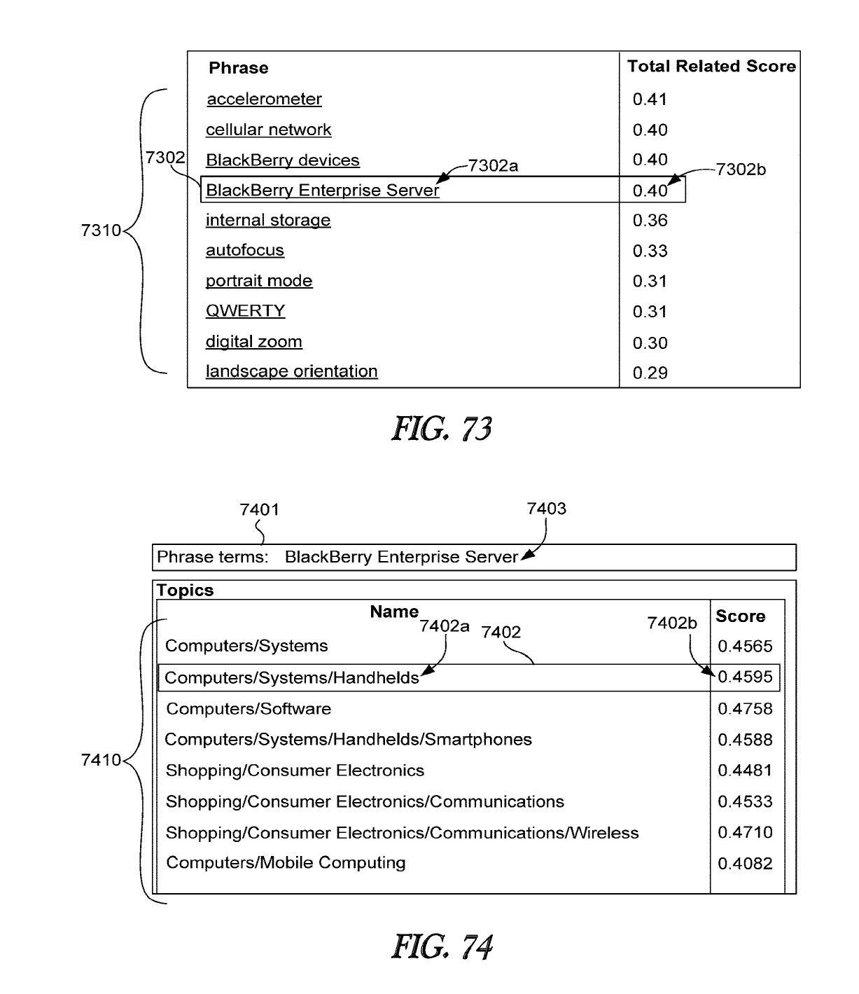

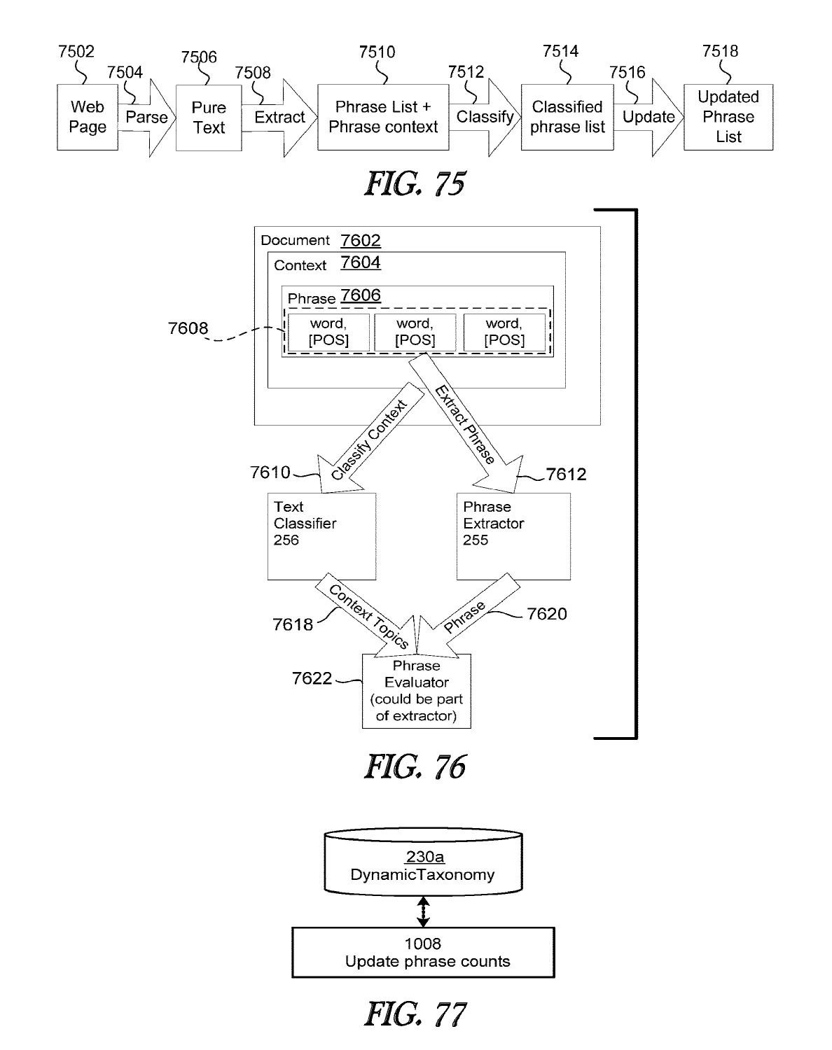

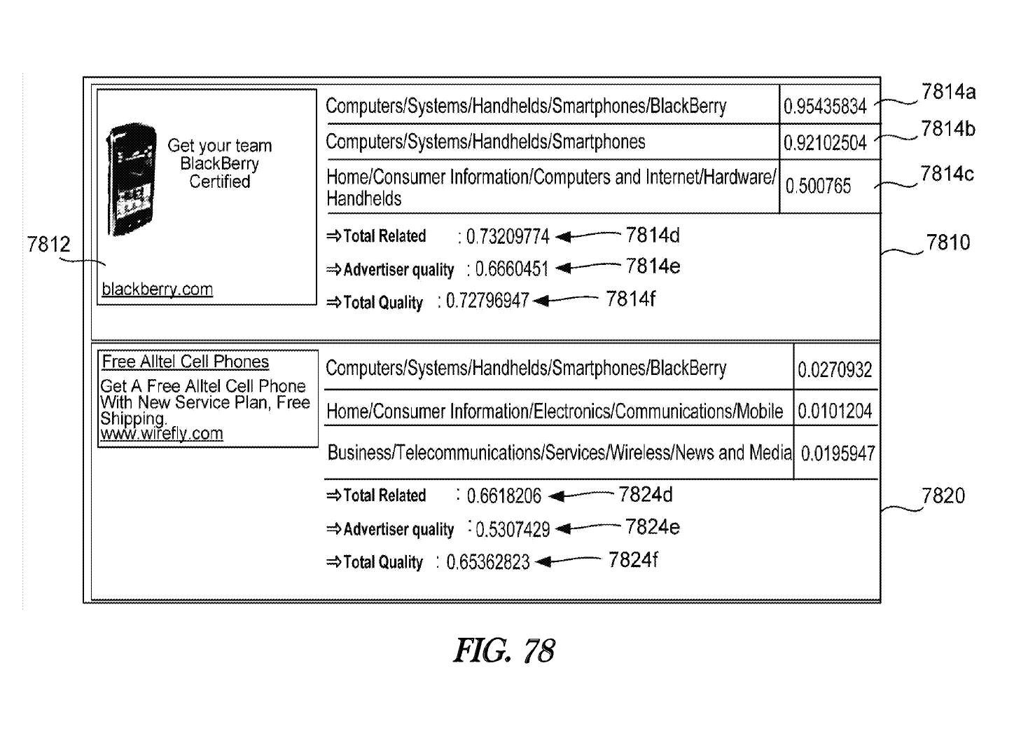

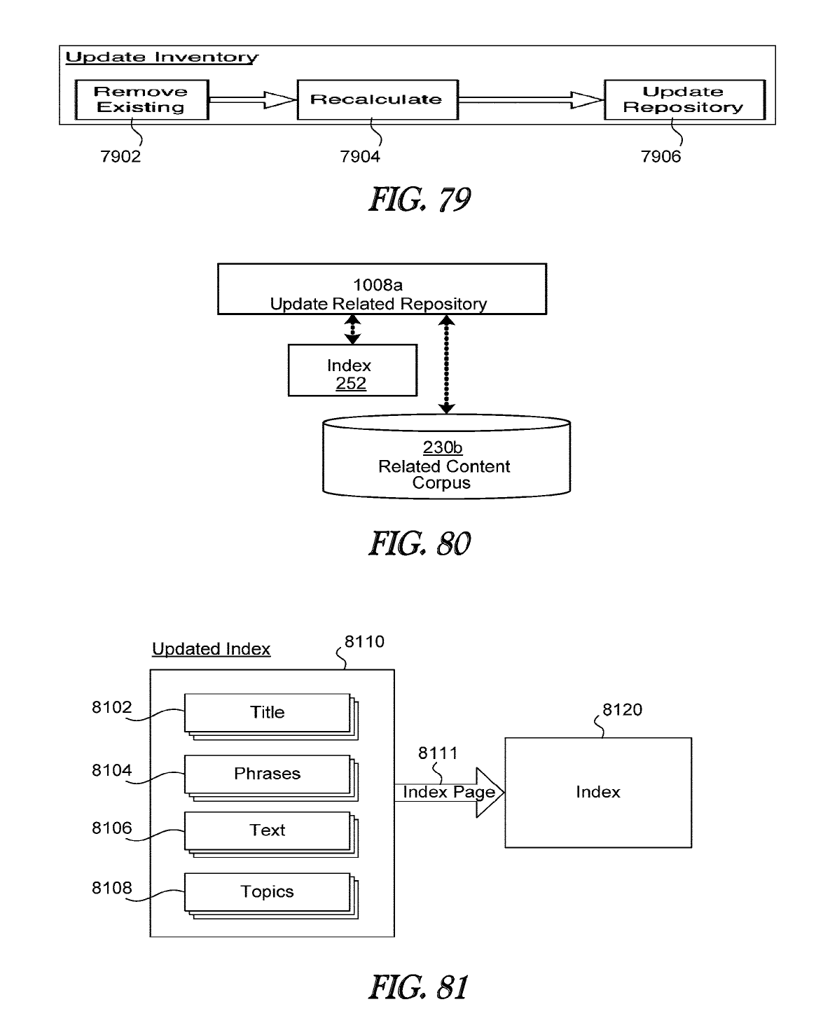

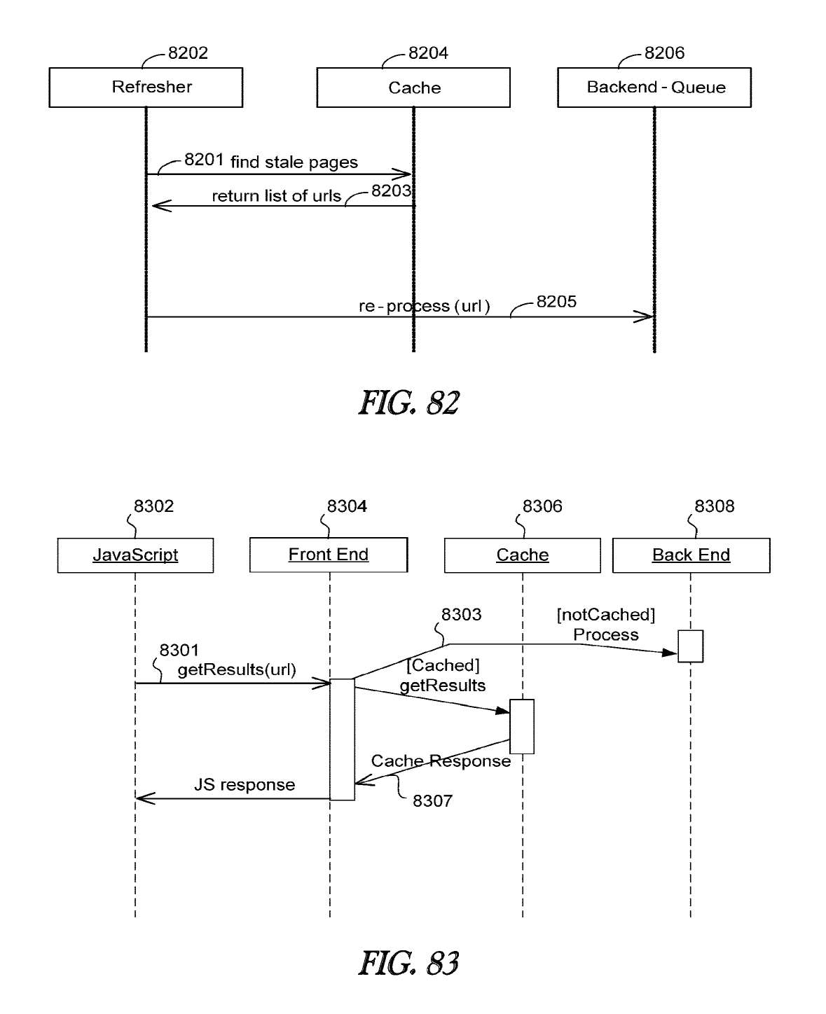

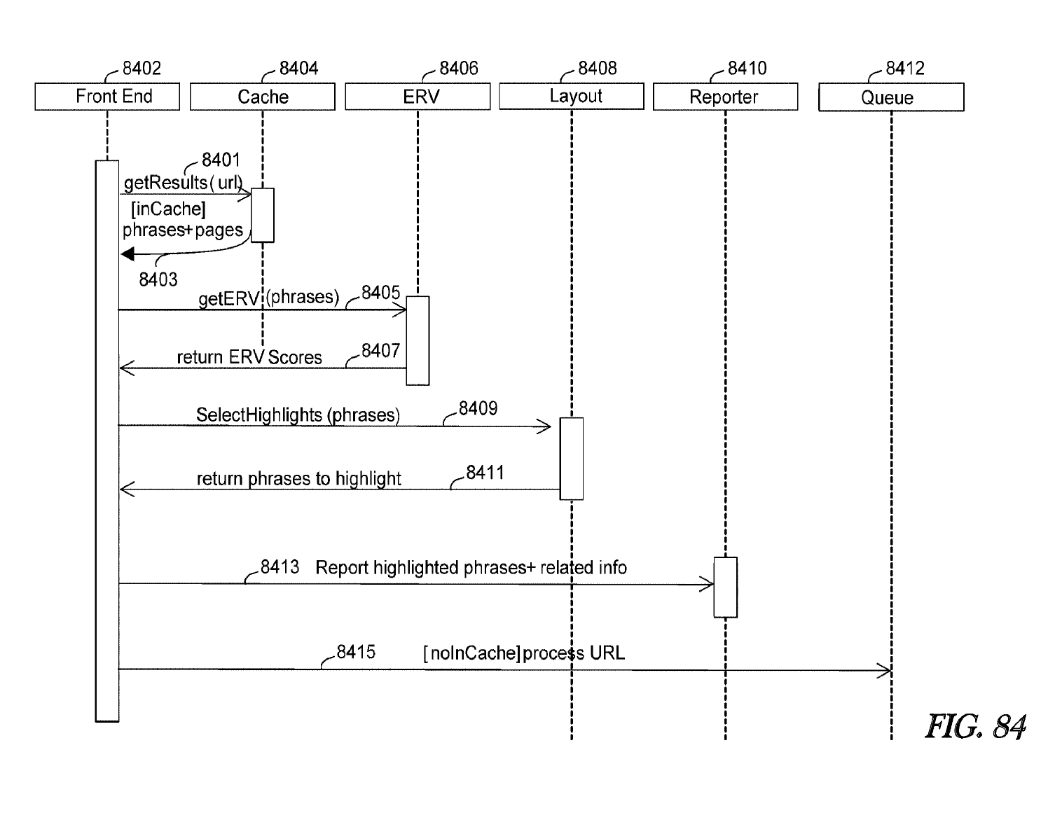

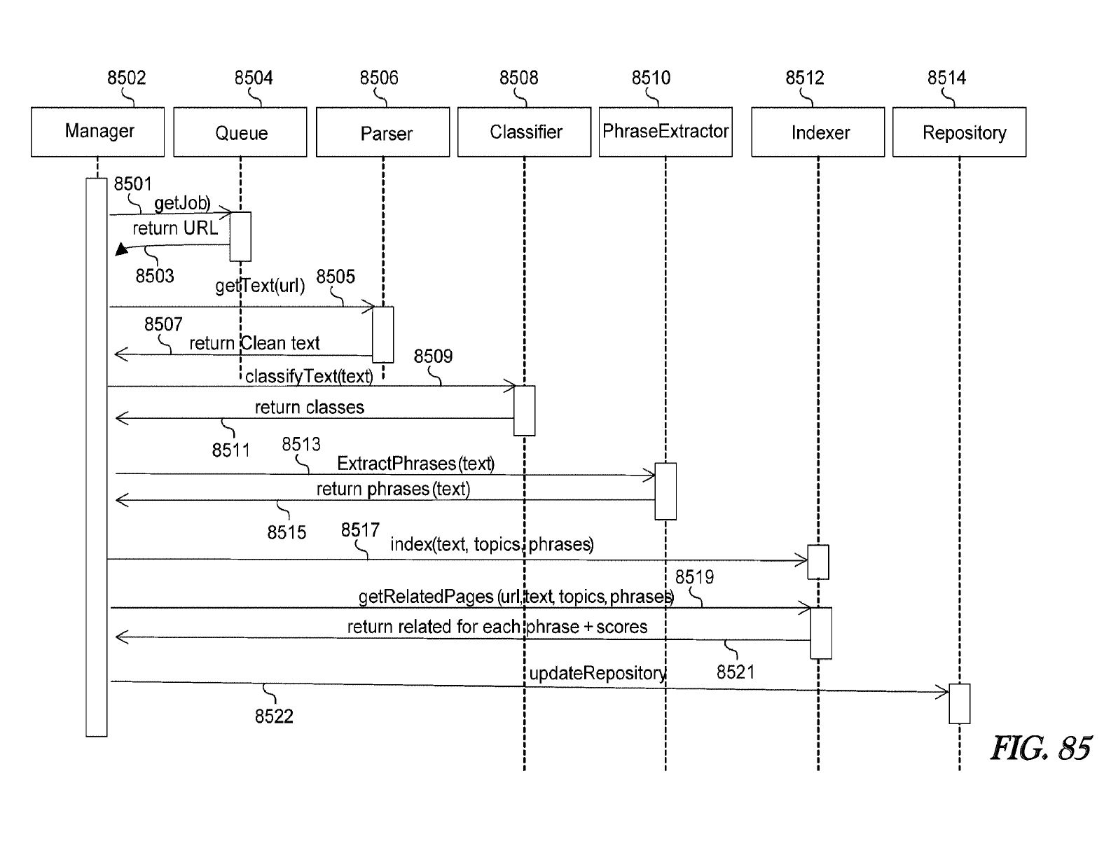

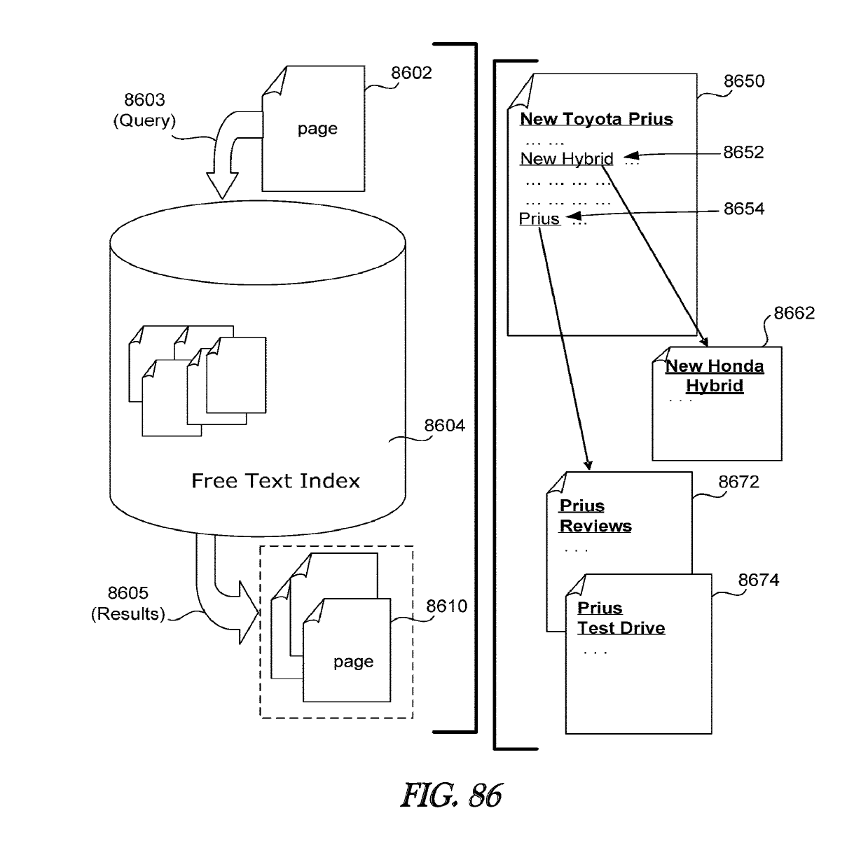

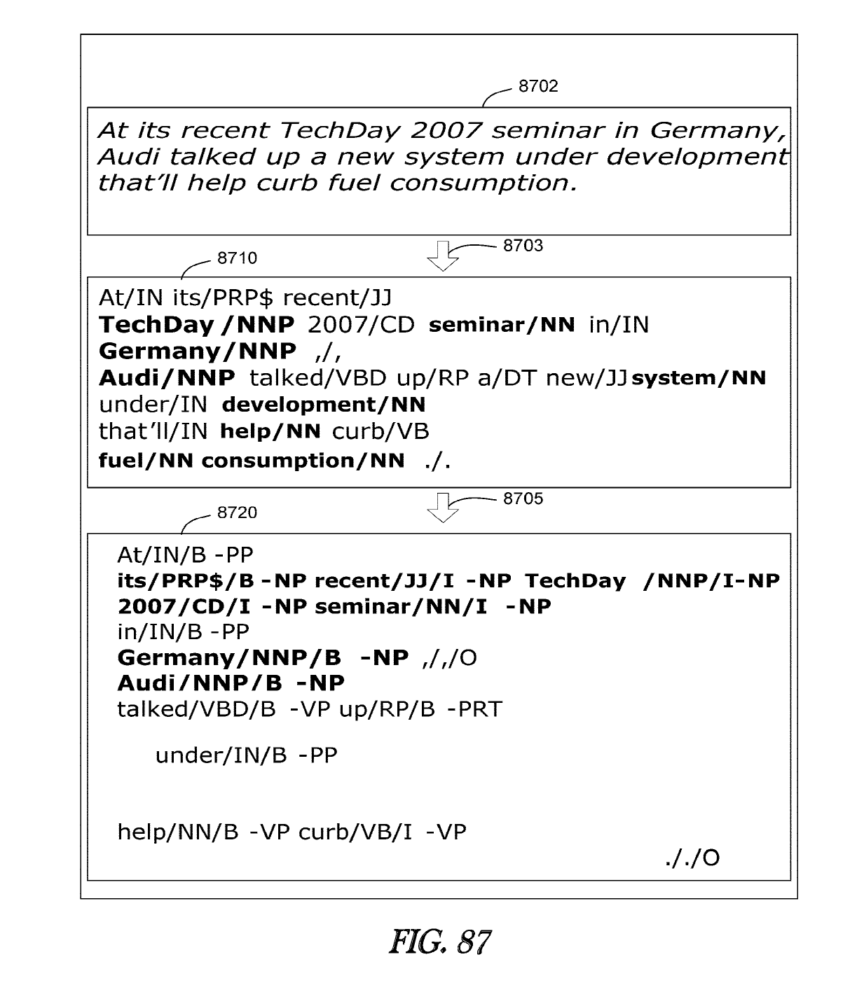

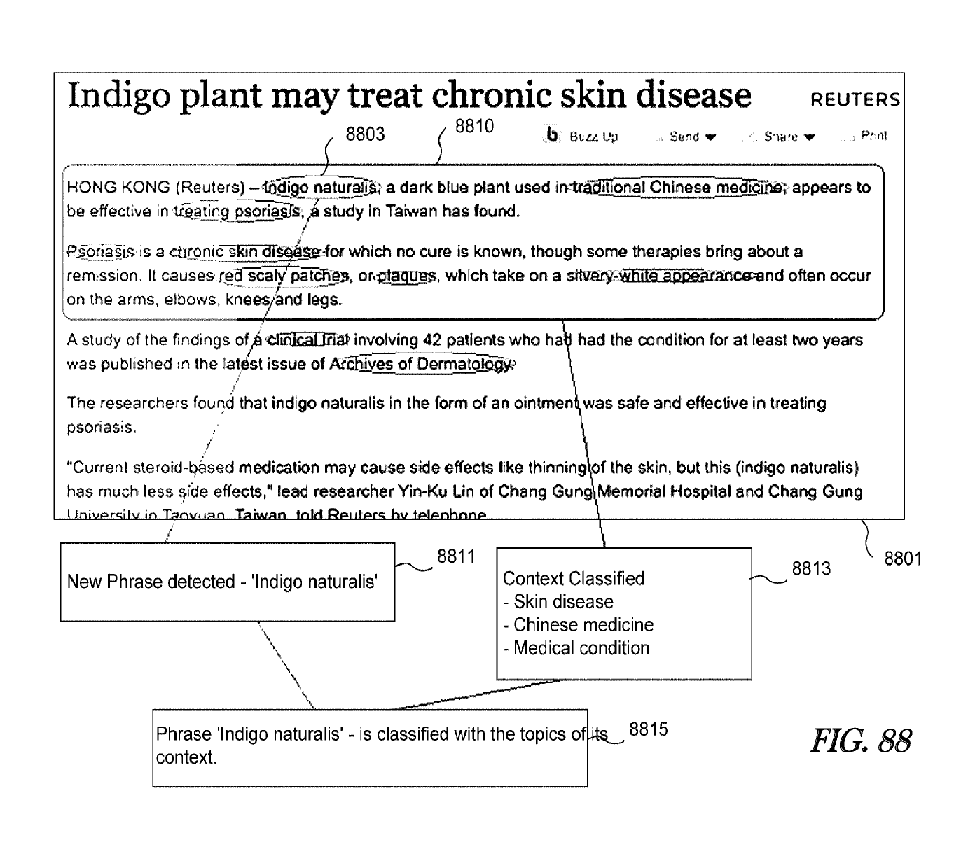

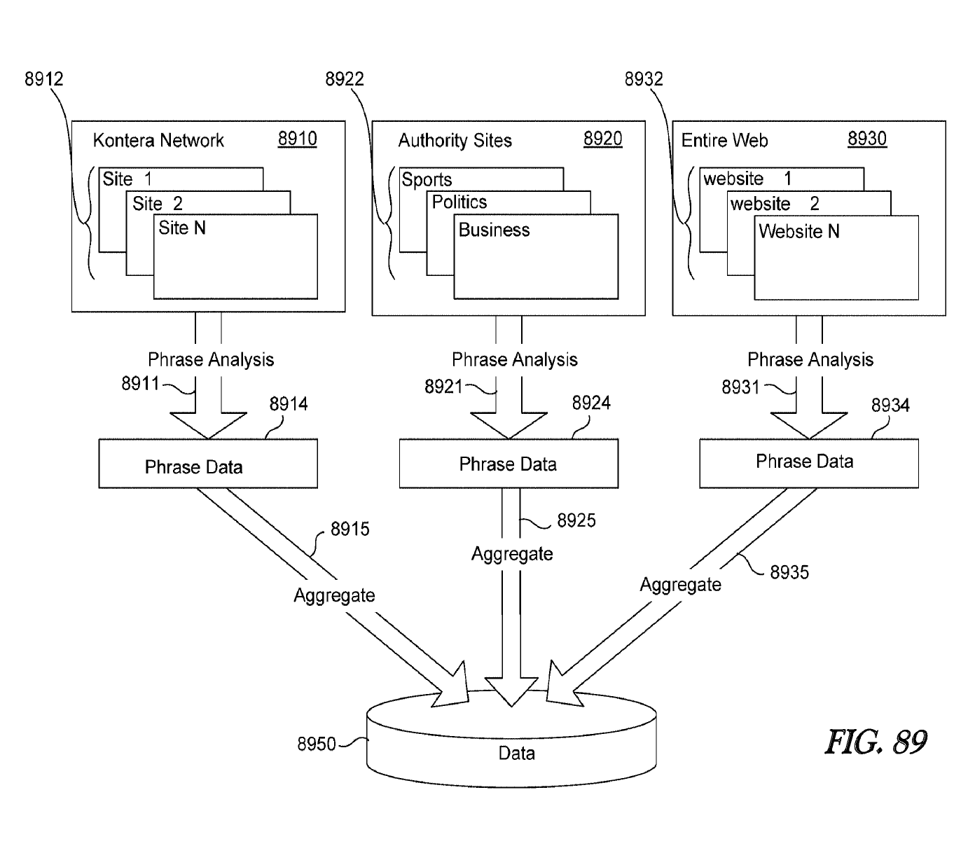

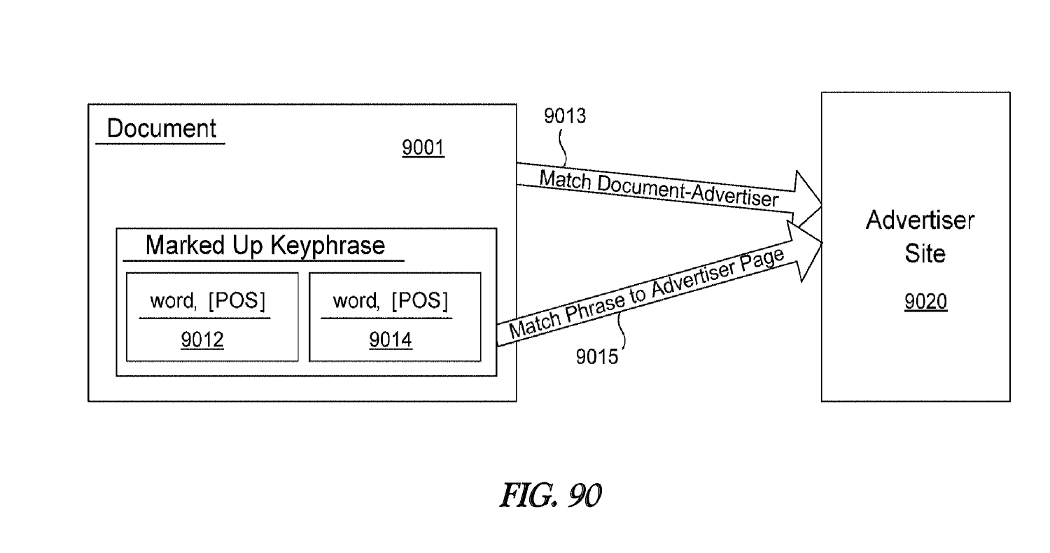

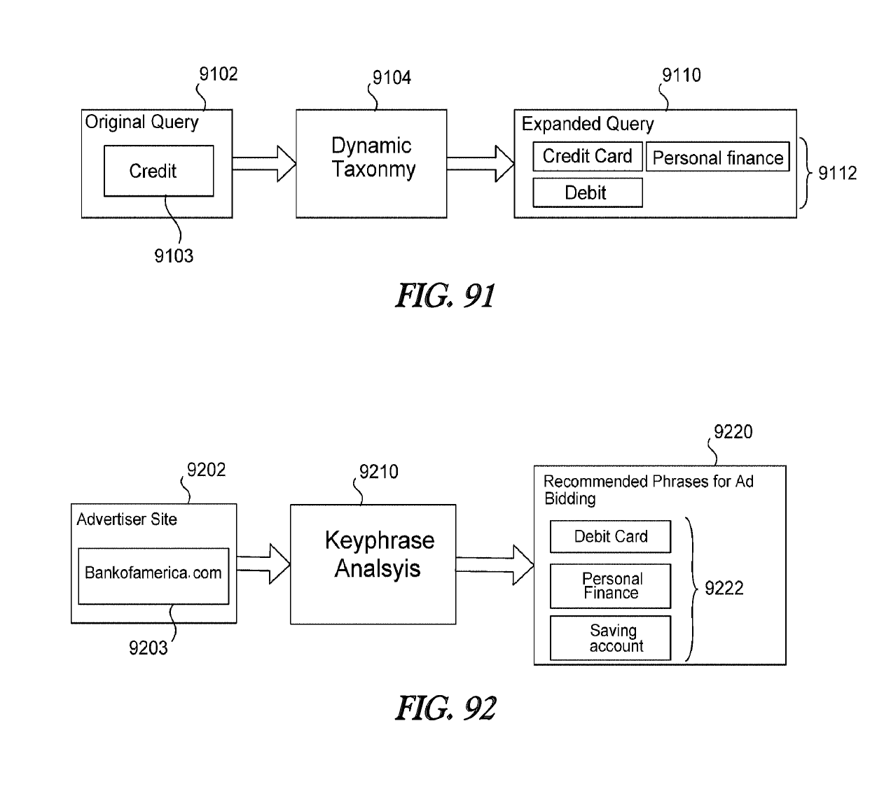

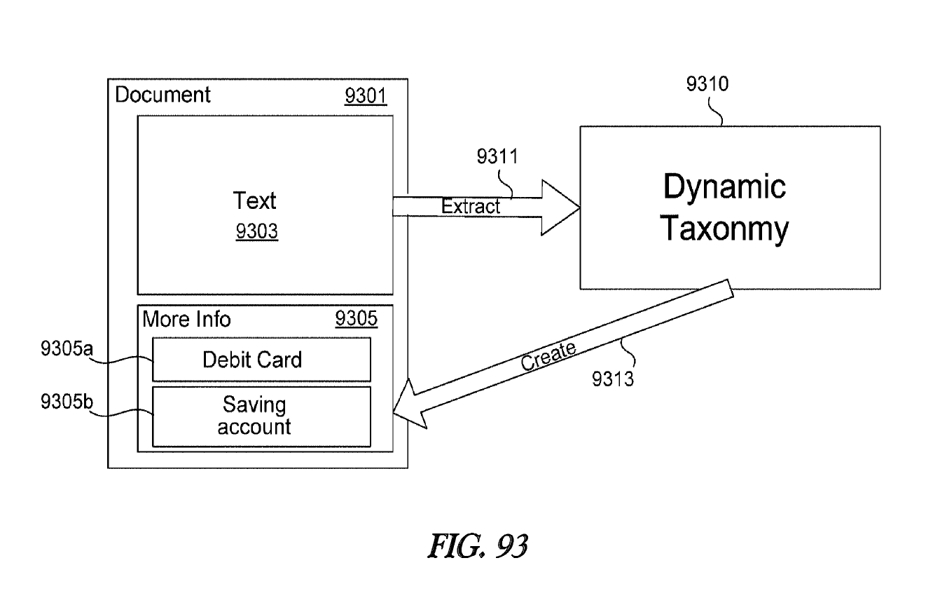

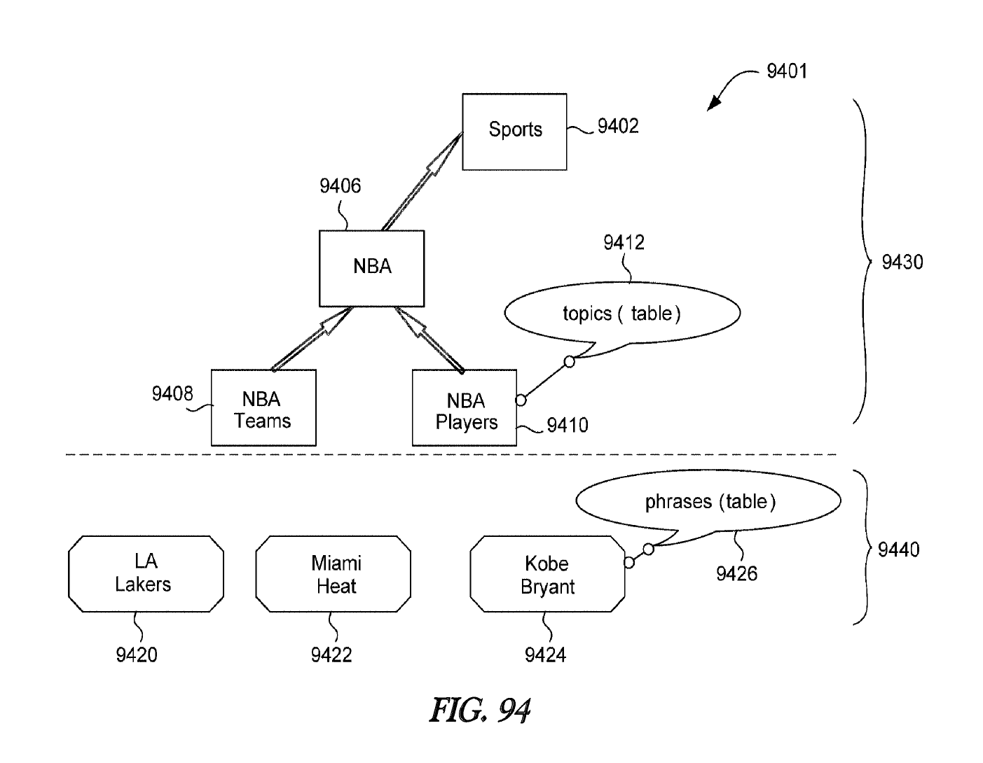

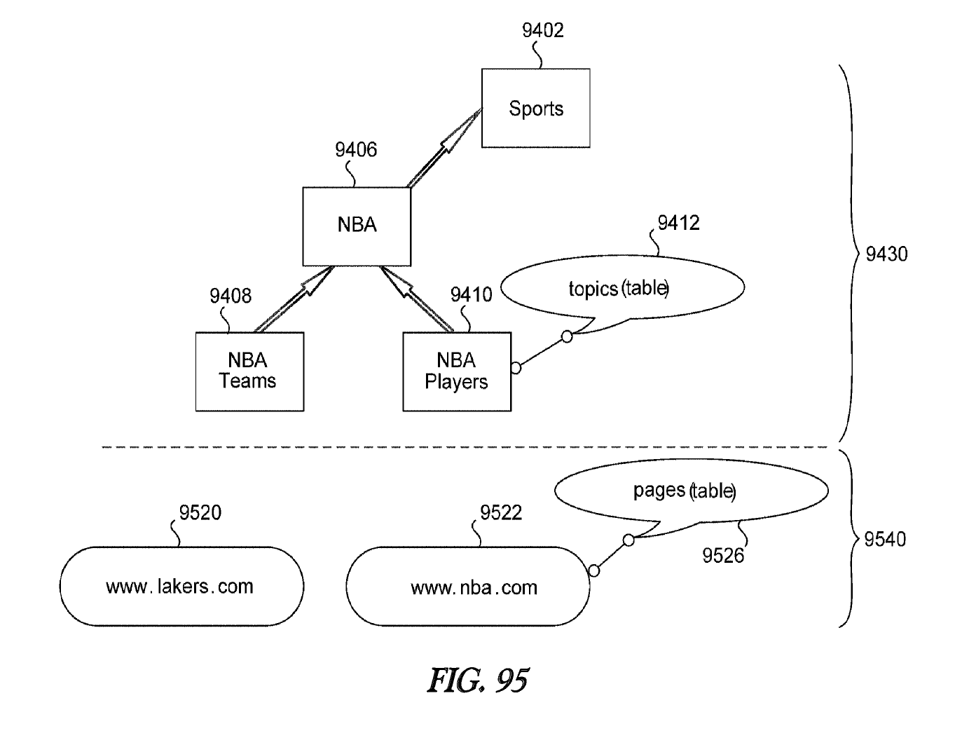

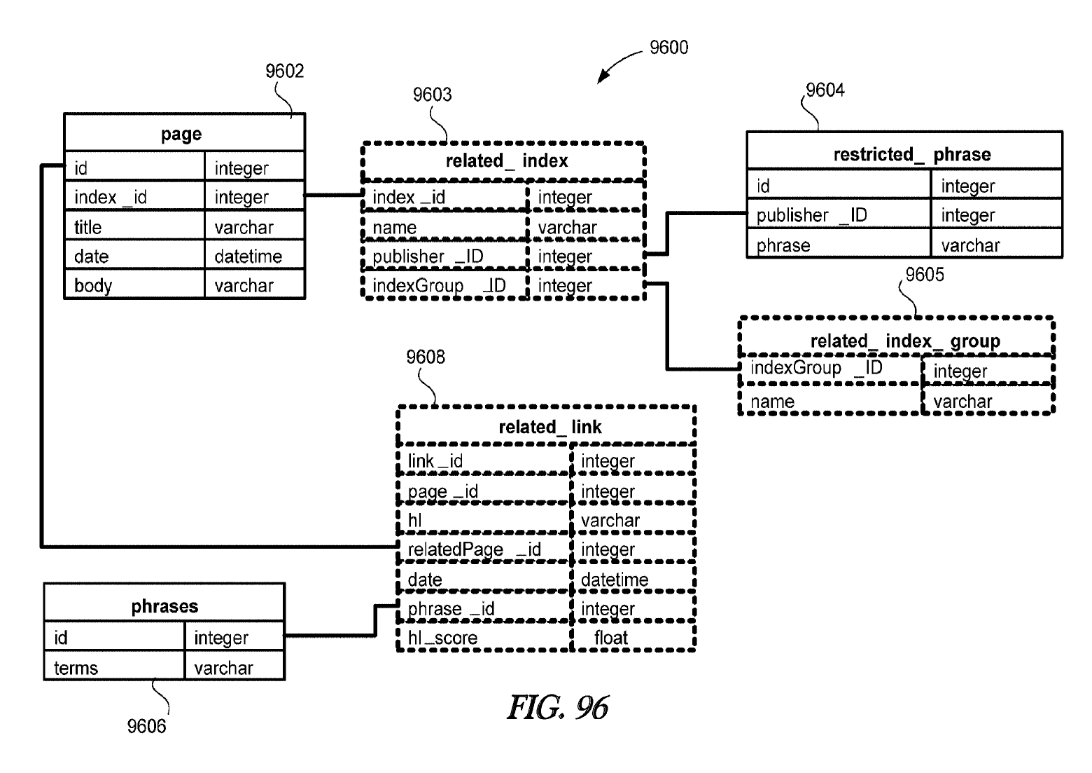

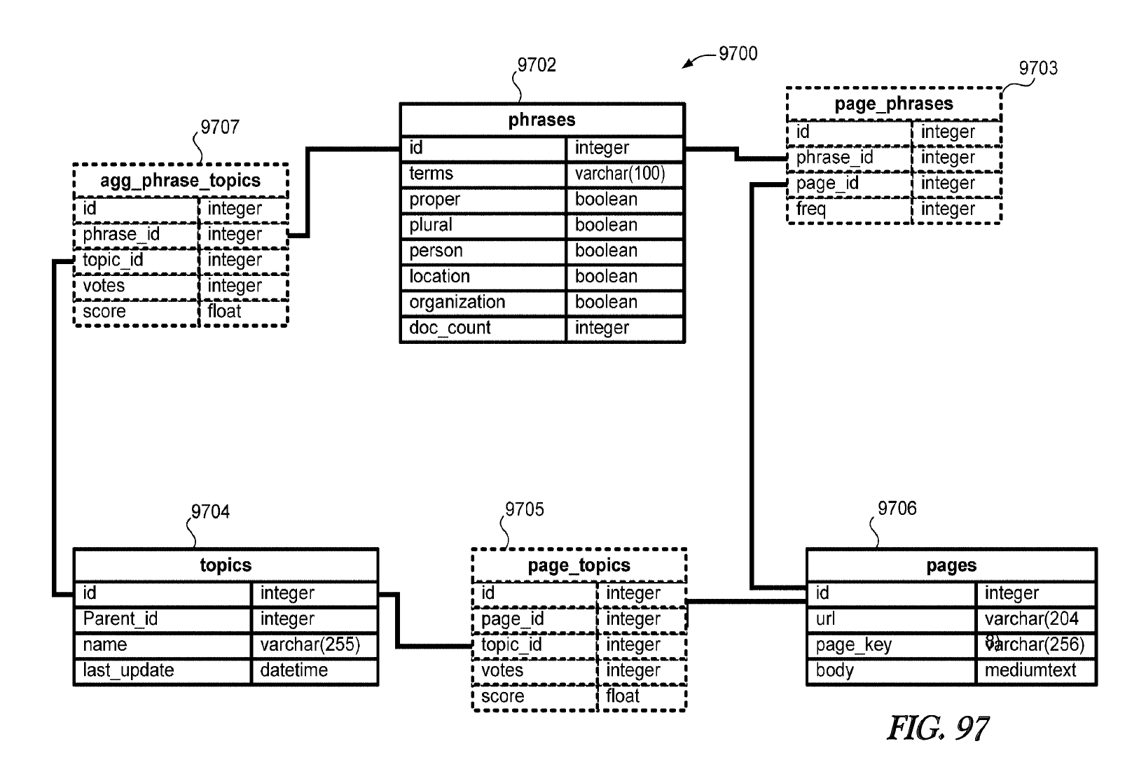

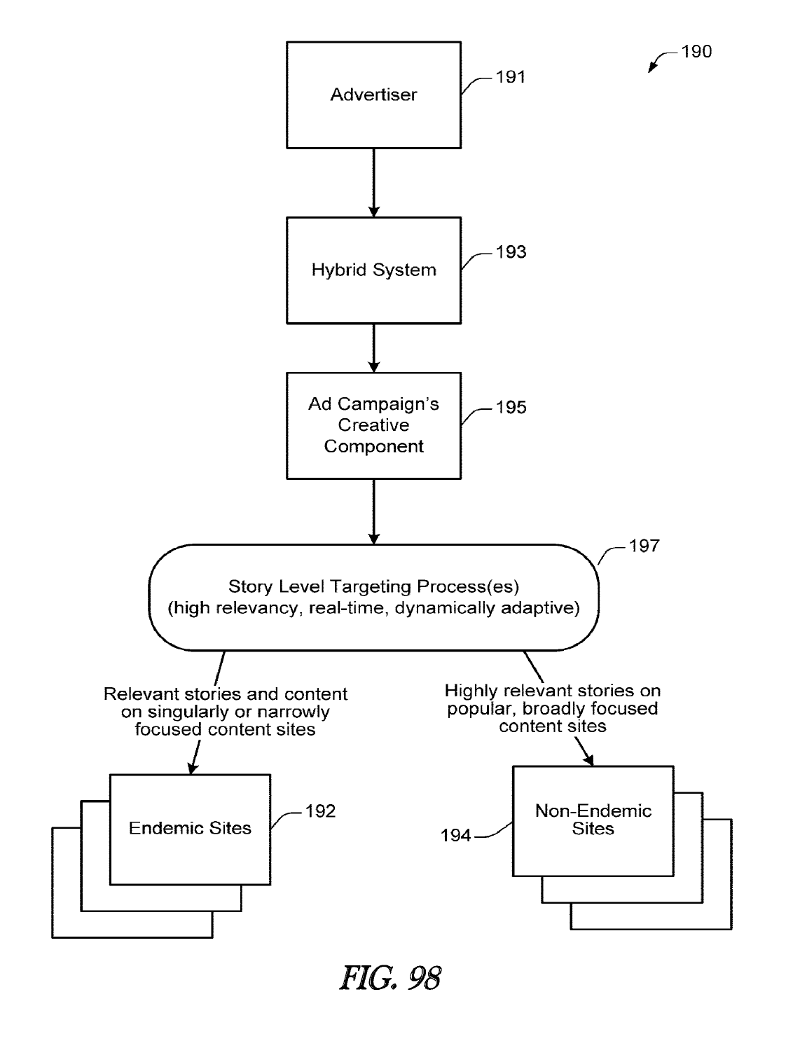

FIG. 16B shows an example of a Hybrid Related Content Selection Process 1650 in accordance with a specific embodiment.

FIGS. 17-70B generally show examples of various screenshot embodiments which, for example, may be used for illustrating various different aspects and/or features of one or more Hybrid contextual advertising, relevancy and/or markup techniques described are referenced herein.

FIG. 71 shows an illustrative example of the output of the URL parsing process in accordance with a specific example embodiment.

FIG. 72 shows an illustrative example of output which may be generated from the page classification processing, in accordance with a specific example embodiment.

FIG. 73 shows an illustrative example of output information/data which may be generated from the Phrase Extraction operation(s) in accordance with a specific example embodiment.

FIG. 74 shows an illustrative example embodiment of output which may be generated, for example, at the Hybrid System during contextual/relevancy analysis/processing of one or more source pages, target pages, ads, etc.

FIG. 75 shows an example high level representation of a procedural flow of various Hybrid System processing operations in accordance with a specific embodiment.

FIG. 76 shows a example block diagram visually illustrating an example technique of how words of a selected document may be processed for phrase extraction and classification.

FIG. 77 shows a example block representation of an Update Phrase Count process in accordance with a specific embodiment.

FIG. 78 shows an example of several advertisements and their associated scores and/or other criteria which may be used during the ad selection or ad matching process.

FIG. 79 shows a example block representation of an Update Inventory process in accordance with a specific embodiment.

FIG. 80 shows a example block representation of an Update Related Repository process in accordance with a specific embodiment.

FIG. 81 shows a example block representation of an Update Index process in accordance with a specific embodiment.

FIG. 82 shows a example block representation of a Refresher Process in accordance with a specific embodiment.

FIGS. 83-85 illustrated example block diagrams illustrating additional features, alternative embodiments, and/or other aspects of various different embodiments of the Hybrid contextual advertising and related content analysis and display techniques described herein. FIGS. 86A-B show illustrative example embodiments of features relating to the Query Index functionality.

FIG. 87 shows an illustrative example of phrase extraction and processing in accordance with a specific example embodiment.

FIG. 88 shows an illustrative example how the various parsing, extraction, and/or classification techniques described herein may be applied to the process of extracting and classifying phrases from an example webpage 8801.

FIG. 89 shows a example block diagram visually illustrating various aspects relating to the Hybrid Crawling Operations.

FIGS. 91-93 show different examples of hybrid phrase matching features in accordance with a specific embodiment.

FIGS. 94 and 95 illustrate a pictorial representation of various nodes of the Keyphrase taxonomy (FIG. 94) and Page Taxonomy (FIG. 95), in accordance with a specific embodiment.

FIG. 96 shows a specific example embodiment of various types of data structures which may be used to represent various entity types and their respective relationships to other entity types in the Related Content Corpus.

FIG. 97 shows a specific example embodiment of various types of data structures which may be used to represent various entity types and their respective relationships to other entity types in the DTD.

FIG. 98 shows an example block diagram relating to one or more story level targeting processes which may be implemented using one or more techniques described herein.

### DETAILED DESCRIPTION OF EXAMPLE EMBODIMENTS

Overview

Various other aspects are directed to different methods, systems, and computer program products for facilitating on-line contextual advertising operations implemented in a computer network. According to some embodiments, various aspects may be used for enabling advertisers to provide contextual advertising promotions to end-users based upon real-time analysis of web page content which may be served to an end-user's computer system. In at least one embodiment, the information obtained from the real-time analysis may be used to select, in real-time, contextually relevant information, advertisements, and/or other content which may then be displayed to the end-user, for example, via real-time insertion of textual markup objects and/or dynamic content.

An example embodiment provides a system and method for statistically analyzing web pages and other content to determine to what degree two or more items of content are related to one another. In an example embodiment, the degree of relevancy or relatedness of two web pages or other content may be used to decide whether to link those items. For example, a web page may be downloaded from a server on the Internet by a client computer system. The statistical distribution of words and phrases on the web page may be determined and scored against a taxonomy of topics stored in a database on a server. A score indicating how related the web page is to each topic in the taxonomy is determined. This is compared to the scores for other web pages that are candidates for being matched or linked. The similarity in scores between two web pages may be used to determine whether those two items should be matched or linked. For example, the server system may determine that a web page downloaded to a client system is related to the same or similar sets of topics as another web page. As a result, the server system may cause a link to the related web page to be inserted into the text of the downloaded web page on the client system. The server system can select a keyphrase or phrase in the downloaded web page that relates to the topics of both the downloaded web page and the other related web page that has been identified. The server system can then cause the keyphrase or phrase on the downloaded page to be converted into a hyperlink that links the two related pages.

In an example embodiment, the web pages are scored against each of the topics in the taxonomy database on the server system. In one example, the score for each topic may be normalized and represented by a number between 0 and 1. The resulting list of scores is a vector representing the relatedness of the web page to the topics in the taxonomy. For example, if there were only three topics in the taxonomy (such as health, politics and sports), the scores would be a vector of three numbers <x, y, z> based on the occurrence of keywords/keyphrases on the page that relate to each topic. The vector for one web page <x1, y1, z1> may be compared to the vector for another web page <x2, y2, z2> to determine how related the two web pages are. In this simplified example, the relatedness can be determined by the distance between the two vectors in three dimensional space (the distance between the point <x1, y1, z1> and the point <x2, y2, z2>). In an actual example, the taxonomy may have 10, 100, 1000 or more topics. The number of topics, n, would result in an n-dimensional vector for each web page being scored that indicates the relatedness of the web page to the topics in the taxonomy. These vectors may be compared to determine to what degree two web pages or other items of content are related. A cosine similarity or other technique may be used to compare the vectors in example embodiments to determine how related one web page is to another web page based on the taxonomy. This “related score” can then be used as a factor in selecting web pages or other items of content to be matched or linked for various purposes.

For example, in one embodiment, the system may be used to insert hyperlinks in a web page that are linked to advertisements. The web page and the candidate advertisements may be scored against the taxonomy and the resulting vectors may be compared to determine a “related score” between the web page and the advertisement. An advertisement may be scored against the taxonomy by analyzing and scoring the text (words and phrases) in the ad copy itself and/or in meta data associated with the ad and/or based on the text of a landing page associated with the ad and/or based on web pages for the vendor who sells the product or service being advertised. One or more of these sources of information about the ad may be analyzed and the words and phrases in those sources may be scored against the taxonomy to generate a vector of topic scores for the ad. An advertisement to be displayed or linked on a web page may be selected based, at least in part, on how related the web page is to the ad. Other factors may also be taken into account, such as the expected value for the ad (based on historical click through rates and cost per click for the ad).

Other content such as videos or graphics may also be matched or linked. The words and phrases in meta data associated with the video (such as a title, description or transcript) or graphics may be analyzed and scored against the taxonomy. The resulting topic vector can then be compared against the topic vector for web pages, advertisements or other content.

Individual keywords and keyphrases can also be scored against the taxonomy. The scores may be based on the number of times that the keyphrase or phrase has appeared on a web page (or in other content) associated with the topic. This is a statistical distribution of the occurrences of the keyphrase or phrase across the topics in the taxonomy. As web pages are analyzed the count (the occurrences of the keyphrase or phrase in each topic) may be dynamically updated. The topic vector for a particular keyphrase or phrase may then be compared against the topic vector for the source web page or a target web page being considered for matching or linking (based on cosine similarity or other technique).

The related score for particular keywords and keyphrases on a web page (or other content) may then be used to determine whether to use a particular keyphrase or phrase to link two pages (or other content). For example, the system may determine that a web page is related to candidate advertisements. The system may consider keywords and keyphrases on the web page for linking the web page to a candidate advertisements. The related score between the source web page and the advertisement, the related score between the keyword/keyphrase and the source web page, and the related score between the keyword/keyphrase and the source web page may all be considered in determining which ad to select and how to link the ad to the source web page. Other factors may also be considered in determining which ad and keyword/keyphrase to select. For example, the expected value for the advertisement may also be considered (for example, the historical click through rate for the keyword/keyphrase or ad and/or the cost per click that will be paid when the keyword/keyphrase or ad is selected).

Similarly, two web pages may be linked or a web page may be linked to other related content such as a text box or video or graphic display. The related score between the source content and the target content, the related score between the keyword/keyphrase and the source content, and the related score between the keyword/keyphrase and the target content may all be considered in determining which target content to select and how to link the target content to the source content. Other factors may also be considered in determining which ad and keyword/keyphrase to select. For non-advertising content, there may be no expected value based on payments for selecting the content. However, the quality of the keyword/keyphrase and the target content may be considered based on the historical likelihood of that item being selected when it is linked through the particular keyword/keyphrase.

In one example embodiment, the candidate targets to be selected for linking and the keyword/keyphrase to be used for linking are selected based on an overall related score that is based on a weighted sum of the related score of source/target, the related score of the keyphrase/source, and the related score of the keyphrase/target. The weightings for these three factors may be selected based on the relative emphasis to place on each of these factors in making the selection. In an example embodiment, the three weights are normalized and add up to one. The overall related score may be added to an expected value and/or quality score (based on expected value, expected click through rate or other factors indicating the desirability of the particular selection). The resulting total score can be used to select the target and keyphrase for linking. In an example embodiment, linking phrases and target candidates may be selected that have the highest total score. This is an example only and other embodiments may use other methods for selecting the target and linking phrase based on one or more of the above factors.

In one example, items are linked to a source web page (or other content item) through a keyphrase or phrase on the page. The keyphrase or phrase may be ordinary text and may be selected and converted into a link that is highlighted on the page. When the link is selected, the user may be directed to the target web page or other content. In some embodiments, when the link is selected or when a mouse is positioned over the highlighted keyword/keyphrase, a dynamic overlay layer (such as a pop up layer or window) may be displayed. The target content may be displayed in the dynamic overlay layer. The target content may be an advertisement with text, graphics and/or video as well as a link to a landing page for the ad (such as the vendor's web site). There may also be more than one item of target content displayed in the dynamic overlay layer. For example, in some embodiments, the dynamic overlay layer may display one or more ads, one or more links to related web pages or other related content, one or more related graphics and/or one or more related videos (which may be played in a box in the dynamic overlay layer). The number and types of target content to display may be determined based on preferences or settings indicated by a particular publisher who provides the source web page or by the system administrator or by an advertiser or by some other setting. The system may select the individual target content items to be displayed in the dynamic overlay layer based on a total score for each item as described above (based on related score of source/target, related score of keyphrase/source and related score of target/keyphrase and other factors such as expected value or quality). The highest scoring items of each type (ads, links to related sites, related videos, etc.) may be selected for the dynamic overlay layer.

In an example embodiment, the source web page is downloaded from a publisher web page to a client computer system. The source web page includes a javascript tag that causes javascript to execute on the browser. The javascript code may be automatically downloaded from a javascript server by the browser in response to the tag. The javascript causes the client to parse the web page and extract the main text. An identifier is generated for the page based on a hash or fingerprint for the text on the web page. The identifier is sent to a server system. The server system checks a cache to see if the particular content has already been analyzed. If not, the server system obtains the text for the web page from the client (or, in some embodiments, the server system may crawl the original web page from the publisher's server). The server system scores the overall text content and individual keyphrases on the page against the taxonomy stored on the server system and also identifies candidate items of related content or ads. Candidate ads may be obtained from ad servers who bid on the ad placement opportunity. The candidate items of target content are also scored against the taxonomy. The related scores of the source, keyphrases and targets are determined as well as other factors such as expected value and/or quality. The server system determines which keyphrases on the source page should be used for linking and sends instructions back to the browser on the client system to highlight and link these keyphrases on the source page when it is displayed by the browser. When the user selects or positions the mouse over the keyphrase, a message is sent back to the server system. In response, the server system makes the final selection among the candidate items of target content (for example, based on which ads remain available at that time) and sends those items to the client system for display in a dynamic overlay layer. When an items is selected in a dynamic overlay layer, a corresponding action may be taken (such as playing a video, or being redirected to the landing page for an ad). These actions are logged by the server system and can be used for reporting/payment to advertisers as well as for statistics to be used in future matching/linking.

In example embodiments, the taxonomy that is used for the above processing may be dynamic. The server system may continuously analyze web pages and other content and update the taxonomy database. A relative count of how many times a keyphrase or phrase occurs on a page associated with a particular topic can be maintained. This can be normalized to provide a statistical distribution of how often each keyphrase or phrase is associated with a particular topic. When a page is related to many topics, the count for the keyphrase or phrase may be proportionally updated for each of the topics based on how much the web page relates to that particular topic (which may be determined, for example, based on the topic vectors described above). As a result, the score for each keyphrase or phrase against a topic may be dynamically updated.

In addition, selected web pages or sets of web pages may be manually designated as being related to particular topics. For example, a CNN or Fox news page on breaking news may be associated with the topic of breaking news. The server system analyzes the statistical distribution of keywords and keyphrases on those pages and associates them with the topic of breaking news. These designated pages may be weighted to affect the correlation of keywords/keyphrases to the topic of breaking news more strongly than other pages being analyzed. This allows topics to be dynamic, where the keywords and keyphrases associated with the topic may change over time. The server system can periodically or continuously update the score for keywords/keyphrases relative to each topic to reflect the most recent information. As a result the server system can recognize a web page as relating to a topic (such as breaking news) even though the keywords/keyphrases change over time and there may be completely new keywords/keyphrases that had not previously been associated with that topic. For example, the term “swine flu” or “H1N1” may appear on various web sites that have been associated with topics such as health or breaking news. These terms may not have occurred much in the past, but may become common terms once a swine flu outbreak occurs. Since the server system analyzes designated sets of pages for a topic (as well as analyzing all the source web pages that are being processed for linking), the server system can quickly and dynamically adjust to recognize and link pages based on this new terminology. Another example would be the topic of sports. Various sports sites and sports news pages may be designated as relating to the topic of sports. When a new sports star emerges, the server system will start counting the relative number of times that name appears on pages associated with sports. A new keyword/keyphrase is added that becomes correlated to the sports topic (even if that name had not appeared much in the past). Pages can then be scored against the sports topic based on the occurrence of that keyphrase and the relative correlation of that keyphrase to the topic of sports. Pages related to sports can then be selected and linked to one another based on this keyphrase (and other words/phrases appearing on the pages). The dynamic taxonomy can be updated based both on pages crawled from the web (including pages designated as relating to particular topics) as well as based on source web pages obtained from client computer systems being analyzed for linking and ad placement. Thus, the scores for a particular keyphrase or phrase against a topic (indicating the relative correlation of that keyword/keyphrase to the topic) is continually updated. For example, the name of a movie actor may be associated with the topic of entertainment. However, if the actor retires and runs for political office, the name may become more strongly correlated with the topic of politics. The correlation may be based on the occurrence of keyphrases over a selected period of time or they may be weighted based upon how recent the occurrences are (with more recent occurrences being weighted more heavily, particularly for time sensitive topics such as breaking news). Keyphrases that occur more narrowly in particular topics may be weighted more heavily than common keyphrases that occur across a large number of topics.

When processing a source page for ad placement or linking to related content, the occurrence of keywords/keyphrases on the source page and the historical correlation of those keywords/keyphrases to each topic can be used to generate the score of the source page against each topic in the taxonomy. This results in the vector of topic scores that can be used to compare the source content to other content as described above.

Other aspects are directed to different methods, systems, and computer program products for facilitating on-line contextual analysis and/or advertising operations implemented in a computer network. In at least one embodiment, an estimation engine may be utilized which is operable to generate expected monetary value (EMV) information relating to estimates of Expected Monitory Values (EMVs) based on specified criteria. In one embodiment, the specified criteria may include click through rate (CTR) estimation information. In at least one embodiment, a relevance engine may be utilized which is operable to generate relevance information relating to relevance criteria between a specified page or document and at least one specified ad. In at least one embodiment, a layout engine may be utilized which is operable to generate ad ranking information for one or more of the at least one specified ads using the relevance information and EMV information. In at least one embodiment, a data analysis engine may be utilized which is operable to analyze historical information including user behavior information and advertising-related information. In at least one embodiment, an exploration engine may be utilized which is operable to explore the use of selected KeyPhrases and ads in order for the purpose of improving EMV estimation.

Other aspects are directed to different methods, systems, and computer program products for facilitating on-line contextual analysis and/or advertising operations implemented in a computer network. According to at least one embodiment, a first page may be identified for contextual ad analysis. Page classifier data may be generated, for example, using content associated with the first page. In at least one embodiment, a first group of KeyPhrases on the page may be identified as being candidates for ad markup/highlighting. In at least one embodiment, one or more potential ads may be identified for selected KeyPhrases of the first group of KeyPhrases. In at least one embodiment, ad classifier data may be generated for each of the identified ads using at least one of: ad content, meta data, and/or content of the ad's landing URL. In at least one embodiment, a relevance score may be generated for each of the selected ads. In one embodiment, the relevance score may indicate the degree of relevance between a given ad and the content of the identified page. In at least one embodiment, a ranking value may be generated for each selected ad based on the ad's associated relevance score and associated EVM estimate. In at least one embodiment, specific KeyPhrases may be selected for markup/highlighting using at least the ad ranking values.

Other aspects described or referenced herein relate to systems and methods for real-time web page context analysis and real-time insertion of textual markup objects and dynamic content. According to various embodiments described or referenced herein, real-time web page context analysis and/or real-time insertion of textual markup objects and dynamic content may occur in real-time (or near real-time), for example, as part of the process of serving, retrieving and/or rendering a requested web page for display to a user. In other embodiments described or referenced herein, web page context analysis and/or insertion of textual markup objects and dynamic content may occur in non real-time such as, for example, in at least a portion of situations where selected web pages are periodically analyzed off-line, modified in accordance with one or more aspects described or referenced herein, and served to a number of users over a period of time with the same highlighted KeyPhrases, ads, etc.

According to an example embodiment, aspects described or referenced herein may be used for enabling advertisers to provide contextual advertising promotions to end-users based upon real-time analysis of web page content that is being served to the end-user's computer system. In at least one embodiment, the information obtained from the real-time analysis may be used to select, in real-time, contextually relevant information, advertisements, and/or other content which may then be displayed to the end-user, for example, via real-time insertion of textual markup objects and/or dynamic content.

According to different embodiments described or referenced herein, a variety of different techniques may be used for displaying the textual markup information and/or dynamic content information to the end-user. Such techniques may include, for example, placing additional links to information (e.g., content, marketing opportunities, promotions, graphics, commerce opportunities, etc.) within the existing text of the web page content by transforming existing text into hyperlinks; placing additional relevant search listings or search ads next to the relevant web page content; placing relevant marketing opportunities, promotions, graphics, commerce opportunities, etc. next to the web page content; placing relevant content, marketing opportunities, promotions, graphics, commerce opportunities, etc. on top or under the current page; finding pages that relate to each other (e.g., by relevant topic or theme), then finding relevant KeyPhrases on those pages, and then transforming those relevant KeyPhrases into hyperlinks that link between the related pages; etc.

Additional objects, features and advantages of the various aspects of the present invention will become apparent from the following description of its preferred embodiments, which description should be taken in conjunction with the accompanying drawings.

### SPECIFIC EXAMPLE EMBODIMENTS

Various techniques will now be described in detail with reference to a few example embodiments thereof as illustrated in the accompanying drawings. In the following description, numerous specific details are set forth in order to provide a thorough understanding of one or more aspects and/or features described or reference herein. It will be apparent, however, to one skilled in the art, that one or more aspects and/or features described or reference herein may be practiced without some or all of these specific details. In other instances, well known process steps and/or structures have not been described in detail in order to not obscure some of the aspects and/or features described or reference herein.

One or more different inventions may be described in the present application. Further, for one or more of the invention(s) described herein, numerous embodiments may be described in this patent application, and are presented for illustrative purposes only. The described embodiments are not intended to be limiting in any sense. One or more of the invention(s) may be widely applicable to numerous embodiments, as is readily apparent from the disclosure. These embodiments are described in sufficient detail to enable those skilled in the art to practice one or more of the invention(s), and it is to be understood that other embodiments may be utilized and that structural, logical, software, electrical and other changes may be made without departing from the scope of the one or more of the invention(s). Accordingly, those skilled in the art will recognize that the one or more of the invention(s) may be practiced with various modifications and alterations. Particular features of one or more of the invention(s) may be described with reference to one or more particular embodiments or figures that form a part of the present disclosure, and in which are shown, by way of illustration, specific embodiments of one or more of the invention(s). It should be understood, however, that such features are not limited to usage in the one or more particular embodiments or figures with reference to which they are described. The present disclosure is neither a literal description of all embodiments of one or more of the invention(s) nor a listing of features of one or more of the invention(s) that must be present in all embodiments.

Headings of sections provided in this patent application and the title of this patent application are for convenience only, and are not to be taken as limiting the disclosure in any way.

Devices that are in communication with each other need not be in continuous communication with each other, unless expressly specified otherwise. In addition, devices that are in communication with each other may communicate directly or indirectly through one or more intermediaries.

A description of an embodiment with several components in communication with each other does not imply that all such components are required. To the contrary, a variety of optional components are described to illustrate the wide variety of possible embodiments of one or more of the invention(s).

Further, although process steps, method steps, algorithms or the like may be described in a sequential order, such processes, methods and algorithms may be configured to work in alternate orders. In other words, any sequence or order of steps that may be described in this patent application does not, in and of itself, indicate a requirement that the steps be performed in that order. The steps of described processes may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications thereto, does not imply that the illustrated process or any of its steps are necessary to one or more of the invention(s), and does not imply that the illustrated process is preferred.

When a single device or article is described, it will be readily apparent that more than one device/article (whether or not they cooperate) may be used in place of a single device/article. Similarly, where more than one device or article is described (whether or not they cooperate), it will be readily apparent that a single device/article may be used in place of the more than one device or article.

The functionality and/or the features of a device may be alternatively embodied by one or more other devices that are not explicitly described as having such functionality/features. Thus, other embodiments of one or more of the invention(s) need not include the device itself.

Techniques and mechanisms described or reference herein will sometimes be described in singular form for clarity. However, it should be noted that particular embodiments include multiple iterations of a technique or multiple instantiations of a mechanism unless noted otherwise.

This application incorporates by reference in its entirety and for all purposes U.S. patent application Ser. No. 10/977,352 (Attorney Docket No. KABAP004), by Henkin et al., titled “SYSTEM AND METHOD FOR REAL-TIME WEB PAGE CONTEXT ANALYSIS FOR THE REAL-TIME INSERTION OF TEXTUAL MARKUP OBJECTS AND DYNAMIC CONTENT”, filed Oct. 28, 2004.

This application incorporates by reference in its entirety and for all purposes U.S. patent application Ser. No. 11/891,436 (Attorney Docket No. KABAP002X1), by Henkin et al., titled “SYSTEM AND METHOD FOR REAL-TIME WEB PAGE CONTEXT ANALYSIS FOR THE REAL-TIME INSERTION OF TEXTUAL MARKUP OBJECTS AND DYNAMIC CONTENT”, filed Aug. 10, 2007.

This application incorporates by reference in its entirety and for all purposes U.S. patent application Ser. No. 11/732,694 (Attorney Docket No. KABAP011B)), by Henkin et al., titled “TECHNIQUES FOR FACILITATING ON-LINE CONTEXTUAL ANALYSIS AND ADVERTISING”, filed Apr. 3, 2007.

This application incorporates by reference in its entirety and for all purposes PCT Application Serial No. PCT/US2007/008042 (Attorney Docket No. KABAP010W0), by Henkin et al., titled “CONTEXTUAL ADVERTISING TECHNIQUES IMPLEMENTED AT MOBILE DEVICES”, filed Apr. 2, 2007.

This application incorporates by reference in its entirety and for all purposes U.S. patent application Ser. No. 12/340,464 (Attorney Docket No. KABAP012), by Henkin et al., titled “HYBRID CONTEXTUAL ADVERTISING TECHNIQUE”, filed Dec. 19, 2008.

### Hybrid Product High Level Overview

The world of online content today includes many sources that continue to expand exponentially. These sources may be dynamic (i.e. they continue to generate additional content and update existing content continuously). In order to take advantage of online content in an optimal way publishers and advertisers require a system that will help them match between content, of different types, with additional content and ads. This matching is required in order to perform a few basic actions such as classifying and locating content in the most suitable place in a web site and also for more advanced actions such as recommending additional related pages, video clips, images, etc. One additional important action is the ability to match ads, of different formats that originate from different sources, to this dynamic content in an accurate and effective way.

There may be several levels of classification and matching that related to both quality and coverage. In at least one embodiment, “quality” may means the level of relevancy one would assign a specific content page to another page or to a potential advertisement. Quality takes into account preventing errors that might occur due to ambiguities, and also tries to answer the question “how relevant/related is it?”. In at least one embodiment, “coverage” may mean the ability to detect and match a high ratio of content ads. For example, given 100 unique content pages, the ability to accurately classify 90 of these pages and match related content and ads to these pages yields a coverage rate of 90%.

The ability to improve both quality and coverage and doing so effectively and in a scalable way may be directly translated into additional revenue. There is also an indirect advantage when it comes to identifying and classifying new phrases, pages, ads, videos, etc. This ability allows online marketers to use the new phrases in order to expand online advertising campaigns and to target and profit from new content pages, video, etc. in a way that was not possible previously.

For example using the technology, if an advertiser is bidding on KeyPhrases such as ‘Blackberry’, one or more Hybrid System embodiments disclosed herein may be operable to recommend additional phrases such as ‘SureType keyboard’, and ‘voice dialing’. Each new expanded phrase may have a respective score which, for example, may be based, at least in part, on its relatedness or similarness to the original phrase, and/or to the advertiser's business. Such automated suggestions may be particularly useful in ad campaigns which, for example, may include paid search, banners, and video ads, etc.

Additionally, as described in greater detail below, at least some Hybrid System embodiments disclosed herein may be operable to automatically, dynamically, and continuously update its databases of dynamic taxonomies and/or related content with updated information such as, for example: newly identified pages, recently updated pages, newly identified phrases, new or recently identified phrases relating to competitor products, brands, similar offerings, etc., and may be further operable to provide customized keyword or key phrase suggestions to the advertiser (and/or campaign provider) in order, for example, to optimize the relative success and financial return of the advertiser's/campaign provider's advertising campaigns, website optimizations, and/or other marketing efforts.

The present disclosure describes various embodiments for increasing revenue potential which may be generated via on-line contextual advertising techniques such as those employing contextual in-text Keyword or KeyPhrase advertising techniques for displaying advertisements to end users of computer systems.

Most online content is supported by ad revenue and most ad revenue is delivered by one of the following commonly known formats: banners, pop-up/under ads, rich media expandable ads (takeovers), sponsored text ads (content ads), and a variety of other affiliate links that might appear on the page. In recent years search has become one of the common methods for online users to find information. This behavior carries over to the web sites that users browse, read, view vide on, etc. For example, a user reading the online version of the New York Times might look for an article about the new iPod device by typing “new ipod device” in the site's search field and then filter through the search results in an attempt to find the desired material. Web sites take advantage of this behavior and place paid search ads next to the search results as a method to generate additional ad revenue.

However, finding desired information is an activity that requires active knowledge and participation from the user. Furthermore, due to search's limitations the average user will not find additional information that might be interesting, relevant, and useful due to the way search algorithms work. In addition, in an effort to increase revenue, web sites try to increase the amount of pages users read on their sites since each additional page translates to additional revenue. In order to increase the amount of pages consumed by users, the web site needs to proactively “surface” relevant content for the user in a hope that by doing so the user will spend more time on the site, read more pages, watch more video and by doing that generate more ad revenue for the site.

Differently than search, that requires the user's active initiation, at least some of the various Hybrid contextual/relevancy analysis and markup techniques described herein may be utilized to surface related content proactively, for example, by selecting relevant phrases within the text that the user is reading, turning those phrases into links, and when the user performs a mouse rollover on the link, a custom window opens showing the user a combination of related content, that could come from the site or from external sources, links to related content, related video, images, and more. This related content is accompanied by a relevant ad. The web site offers the user related content without requiring the user to search for this content and if the user clicks to view the related page or related video, the site will generate additional revenue by virtue of the ads that are placed on that content. In addition to this revenue there is the direct revenue from the Hybrid ad. In addition to the ad revenue there is the long term brand value that the site establishes with the user by providing additional relevant information in a convenient way.

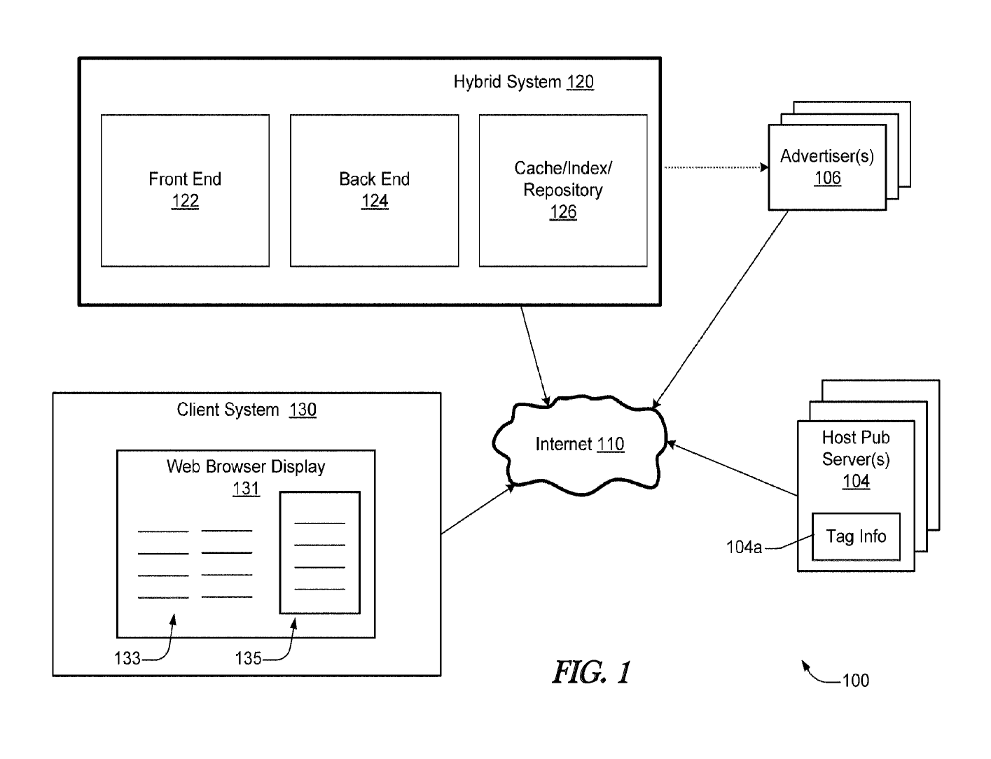

In at least one embodiment, in order to utilize the Hybrid product, the web publisher places a JavaScript code snippet or tag (e.g., 104a, FIG. 1) on one or more of his pages. This snippet communicates with the Hybrid Systems and enable the link placement on the page. The Hybrid System analyzes the publisher's pages in real time as they are served and clusters the page based on the semantic attributes of the page and how it is distributed on the dynamic taxonomy The cluster will contain several similar pages, in terms of topic/theme, and these pages will be candidates when it comes to related content pages. The cluster can contain content from one or many sites, depending on the configuration and the publisher's desire. The Hybrid System uses various different algorithms and mechanisms in order to extract the content from the page (deep crawling, parsing), identify phrases (natural language processing—NLP), classify these phrases into topical groups, and then based on the phrases that were discovered on the page, classify the page into a topical categorization. This process may be performed for various types of related content and/or other related information such as, for example, one or more of the following related element types (or combinations thereof):
Related site pages: e.g., web pages from the site that relates to the page/phrase
Related web pages: e.g., web pages from the web that relates to the origin page/phrase
Related Video: e.g., video from the site/web that relates to the origin page/phrase
Related Images: e.g., images from the site/web that relates to the origin page/phrase
Related Audio: e.g., related audio (podcast, way, etc.) that relates to the origin page/phrase
Related Ads
Related information
Related content
Related articles
Related links
Related Animation (e.g., Flash)
Related External feeds (e.g., RSS)

FIG. 1 shows a block diagram of a computer network portion 100 which may be used for implementing various aspects described or referenced herein in accordance with a specific embodiment. As illustrated in FIG. 1, network portion 100 includes at least one client system 102, at least one host server or publisher (PUB) server 104, at least one advertiser (and/or advertiser system) 106, and at least one Hybrid Contextual Advertising System 120 (also referred to herein as “Hybrid System” and “Hybrid Server System”).

In at least one embodiment, the Hybrid System 108 may be configured or designed to implement various aspects described or referenced herein including, for example, real-time web page context analysis, real-time insertion of textual markup objects and dynamic content, identification and selection of related content and/or related elements, dynamic generation of dynamic overlay layers (DOLs), etc. In the example of FIG. 1, the Hybrid System 108 is shown to include one or more of the following components:
Front End System 122
Backend System 124
Cache/Index/Repository system 126

It will be appreciated that other embodiments may include fewer, different and/or additional components than those illustrated in FIG. 1. A number of these components are described in greater detail below. In example embodiments, the client system 102 may include a Web browser display 131 adapted to display content 133 (e.g., text, graphics, links, frames 135, etc.) relating desired web pages, file systems, documents, advertisements, etc. It will be appreciated that other embodiments may include fewer, different and/or additional components than those illustrated in FIG. 1.

In one embodiment, such analysis and/or calculations may be implemented in real-time (or near real-time) in order allow one technique(s) described herein to automatically and dynamically adapt, in real-time, its algorithms and/or other mechanisms for selecting and/or estimating potential revenue relating to on-line contextual advertising techniques such as those employing contextual in-text KeyPhrase advertising.

Additionally, in some example embodiments, aspects described or referenced herein may be applied to real-time advertising in situations where selected KeyPhrases (KPs) are not located in the content of the page or document. For example, referring to FIG. 1, various techniques according to embodiments described or referenced herein may be applied to content (e.g., 133) in the main body of a web page and/or to content in frames such as, for example, Ad Frame portion 135, which, for example, may be used for displaying advertisements (or other information) that is not included as part of the original content of the web page. Moreover, these techniques may also be used to analyze dynamically generated content such as, for example, content of a web page which dynamically changes with each refresh of the URL. In at least one embodiment, it is also possible to display ads directly based on KeyPhrases and/or topics identified in the Ad Frame portion 135. In one example embodiment, performance of a KeyPhrase may be based, at least in part, on how many clicks are generated for the associated ad.

As used herein, the terms “keyword”, “keyphrase”, and “KeyPhrase” may be used interchangeably, and may be used to represent one or more of the following (or combinations thereof): a single word, a plurality of words, a phrase comprising a single word, a phrase comprising multiple words, a string of text, and/or other interpretations commonly known or used in the relevant field of art. Additionally, as used herein, the terms “relatedness” and “relevancy” are generally interchangeable, and that the term “relatedness” may typically used when referring to related articles, related pages, and/or other types of related content described herein; whereas the term “relevancy” may typically be used when referring to advertisements.

For purposes of illustration, an exemplary embodiment of FIG. 1 will be described for the purpose of providing an overview of how various components of the computer network portion 100 may interact with each other. In this example, it is assumed at that a user at the client system 102 has initiated a URL request to view a particular web page such as, for example, www.yahoo.com. Such a request may be initiated, for example, via the Internet using an Internet browser application at the client system. According to a specific embodiment, when the URL request is received at the PUB server 104, server 104 responds by transmitting the URL request info and/or web page content (corresponding to the requested URL) to the Hybrid System 108. In a specific embodiment where the Hybrid System receives only the URL request information from the PUB server, the Hybrid System may request the web page content (corresponding to the requested URL) from the PUB server 104. The server 104 may then respond by providing the requested web page content to the Hybrid System.

According to specific embodiments, as the Hybrid System 108 receives the web page content from the PUB server 104, it analyzes, in real-time, the received web page content (and/or other information) in order to generate page information (e.g., page classifier data) and KeyPhrase information (e.g., list identified KeyPhrases on page which may be suitable for highlight/mark-up). The Hybrid System may also dynamically identify and/or select, in real time, one or more ad candidates from advertisers (e.g., Advertiser System 106), which, for example, may be displayed via the use of one or more dynamic overlay layers (DOLs).

In one embodiment, each ad candidate may include one or more of the following:
title information relating to the ad;
a description or other content relating to the ad;
a click URL that may be accessed when the user clicks on the ad;
a landing URL which the user will eventually be redirected to after the click URL action has been processed;
cost-per-click (CPC) information relating to one or more monetary values which the advertiser will pay for each user click on the ad;
etc.

According to a specific embodiment, it is possible for the Hybrid System 108 to receive different contextual ad information from a plurality of different advertiser systems. In one embodiment, the received ad information (and/or other information associated therewith) may be analyzed and processed to generate relevance information, estimated value information, etc. The identified ad candidates may be ranked, and specific ads selected based on predetermined criteria. Once a desired ad has been selected, the Hybrid System may then generate web page modification instructions for use in generating contextual in-text KeyPhrase advertising for one or more selected KeyPhrases of the web page, and/or for use in generating one or more DOL layers (and various content associated therewith) which may be associated with one or more KeyPhrases of the source pages, and which may be displayed at the client system display.

According to a specific embodiment, the web page modification operations may be implemented automatically, in real-time, and without significant delay. As a result, such modifications may be performed transparently to the user. Thus, for example, from the user's perspective, when the user requests a particular web page to be retrieved and displayed on the client system, the client system will respond by displaying a modified web page which not only includes the original web page content, but also includes additional contextual ad information. If the user subsequently clicks on one of the contextual ads, the user's click actions may be logged along with other information relating to the ad (such as, for example, the identity of the sponsoring advertiser, the KeyPhrases(s) associated with the ad, the ad type, etc.), and the user may then be redirected to the appropriate landing URL. According to specific embodiments, the logged user behavior information and associated ad information may be subsequently analyzed in order to improve various aspects described or referenced herein such as, for example, click through rate (CTR) estimations, estimated monetary value (EMV) estimations, etc.

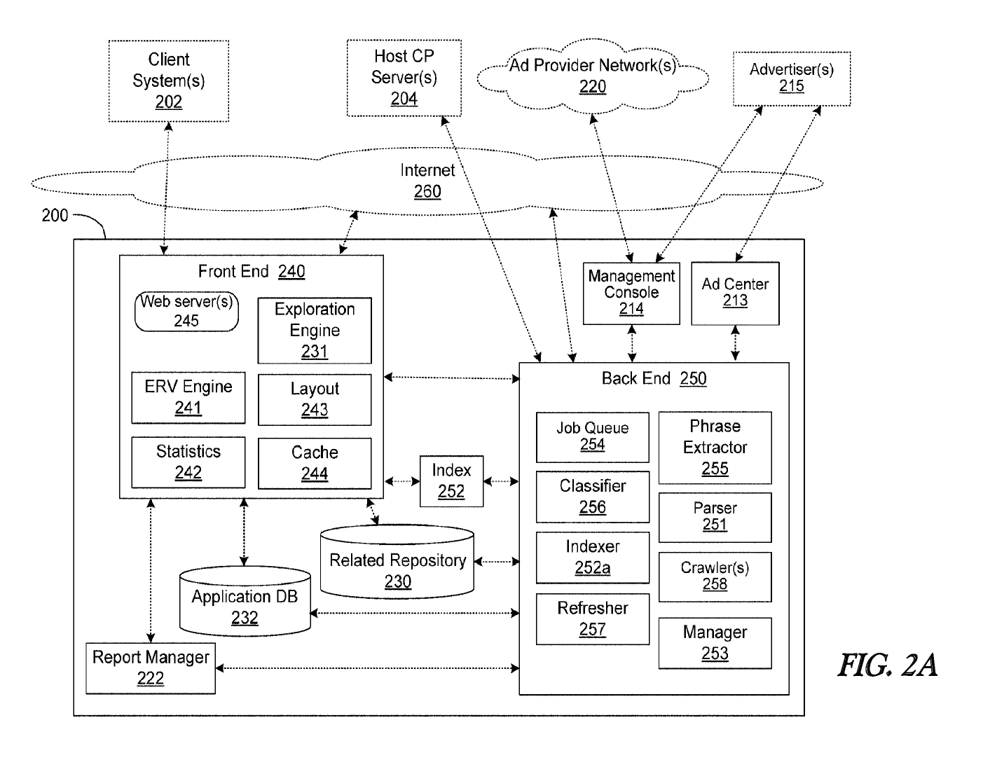

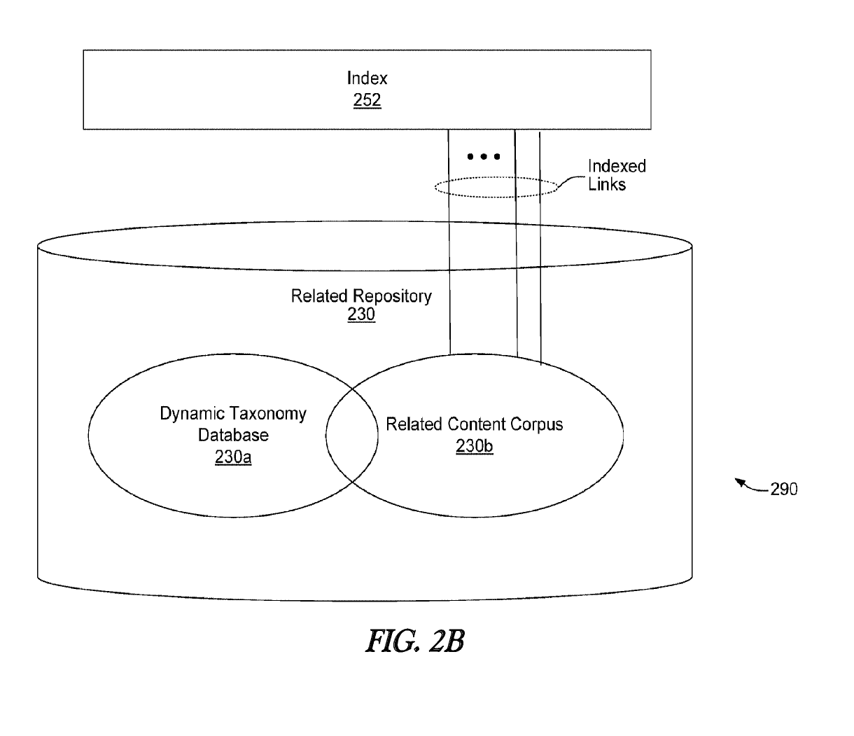

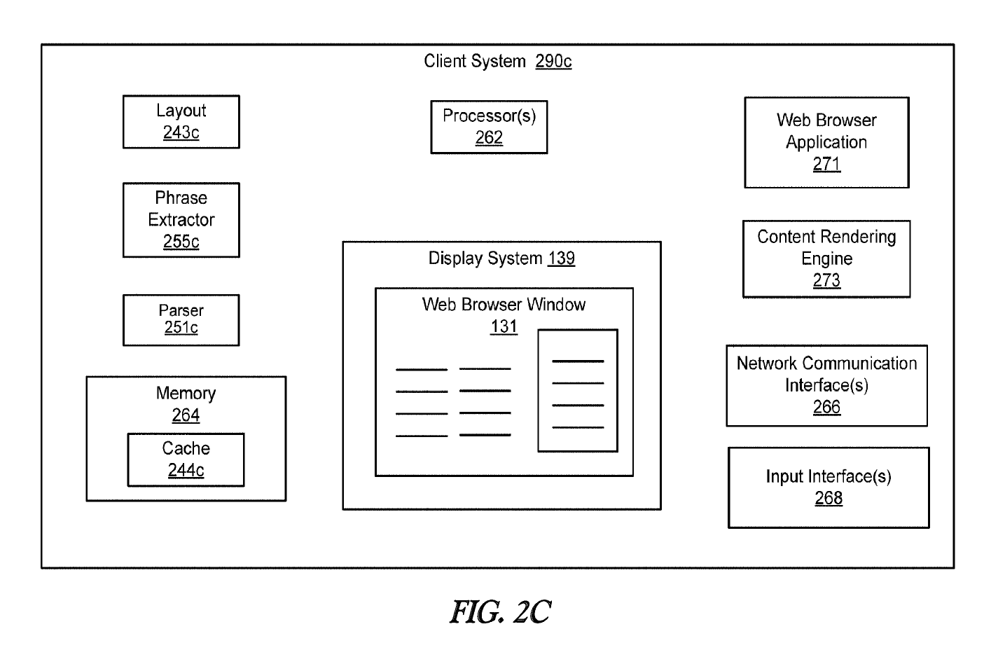

FIG. 2A shows a block diagram of various components and systems of a Hybrid System 200 which may be used for implementing various aspects described or referenced herein in accordance with a specific embodiment. At least a portion of the functionalities of various components shown in FIG. 2A are described below. It will be noted, however, other embodiments of the Hybrid System may include different functionality than that shown and/or described with respect to FIG. 2A.

One aspect of at least some embodiments described herein is directed to systems and/or methods for augmenting existing web page content with new hypertext links on selected KeyPhrases of the text to thereby provide a contextually relevant link to an advertiser's sites.

Other aspects are directed to one or more techniques for determining and displaying related links based upon KeyPhrases of a selected document such as, for example, a web page. For example, one embodiment may be adapted to link KeyPhrases from content on a web site (e.g., articles, new feeds, resumes, bulletin boards, etc.) to relevant pages within their site. In embodiments where the selected website includes multiple web pages (which, for example, may include static and/or dynamic web pages), the technique(s) described herein may be adapted to automatically and dynamically determine how to link from specific KeyPhrases to the most appropriate and/or relevant and/or desired pages on the website. In at least one embodiment, the most appropriate and/or relevant pages may include those which are determined to be contextually relevant to the specific KeyPhrases. For example, using the technique(s) described herein the KeyPhrase “DVD player” may be linked to a recently published article reviewing the latest DVD players on the market. In at least one embodiment, it may be preferable to link one or more KeyPhrases to pages, articles, URLs or other references which are determined to have the relatively greatest revenue potential as compared to a group of possible candidates which might be appropriate.

For purposes of illustration, the contextual advertising and related content processing and display techniques disclosed herein are described with respect to the use of ContentLinks. However, other embodiments described or referenced herein may utilize other types of techniques which, for example, may be used for modifying displayed content (and/or for generating modified content) in order to present desired contextual advertising information and/or other related information on a client device display.

As illustrated in the example embodiment of FIG. 2A, Hybrid System 200 may include a variety of different components which, for example, may be implemented via hardware and/or a combination of hardware and software. Examples of such components may include, but are not limited to, one or more of the following (or combinations thereof):
Front End 240 which, for example, may be operable for handling user request(s)/response(s). In at least one embodiment, the input to the front end may include URL(s) provided from the client system. In at least one embodiment, such input may cause the Front End to initiate one or more hybrid contextual analysis processes for generating and providing appropriate responses to the client system. In at least one embodiment, at least a portion of such responses may include javascript instructions that may be sent back to the client in order to present the various DOL layers described herein.
Layout 243 which, for example, may be operable for selecting the actual highlights, related content, related video and related ads. In at least one embodiment, the layout uses input from the ERV Engine 241 as well as relevancy score(s) for each (or selected) origin-target pairs in order, for example, to select the optimal highlights and information based on spatial arrangement and scores. An example of the layout process is described, for example, in U.S. patent application Ser. No. 11/732,694 (Attorney Docket No. KABAP011B), which is incorporated herein by reference for all purposes.
ERV Engine 241 which, for example, may be operable to assign ERV value(s) for each (or selected) phrase-target combination. In at least one embodiment, this is based on a Click-Through-Rate (CTR) prediction algorithm such as that described, for example, in U.S. patent application Ser. No. 11/732,694 (Attorney Docket No. KABAP011B), which is incorporated herein by reference for all purposes. In at least one embodiment, the CTR estimates may be multiplied by a value parameter such as, for example, the CPC/CPM of the ad component, the CPM of the target page, or any other value the publisher selects to give pages on his site. For example if a publisher wants to move traffic from one area of his site to another, he may assign a relatively higher value to the preferred channel.
Statistics Engine 242 which, for example, may be operable to collect all (or selected ones of) the user behavior (e.g., clicks, mouseovers) for each URL, highlights, target choices and feed them to the ERV engine. See, e.g., U.S. patent application Ser. No. 11/732,694 (Attorney Docket No. KABAP011B) for the collection of statistics, which is incorporated herein by reference for all purposes.
Exploration Engine 231 which, for example, may be operable to perform selection of sub-optimal phrases or related content in order to explore sub optimal decisions and avoid local maximums. In at least one embodiment, the exploration may be implemented, at least partially, based upon information gain theory as described, for example, in U.S. patent application Ser. No. 11/732,694 (Attorney Docket No. KABAP011B), which is incorporated herein by reference for all purposes.
Cache 244 which, for example, may be operable for caching or storing selected KeyPhrases and/or related pages from the Back End. In at least one embodiment, when the Front End receives a page or URL request from a client system, the Front End may check to see whether any of the page details are already in the cache. If the cache doesn't have desired information, the Front End may sends a request to the Back End queue for page analysis. In at least one embodiment, the cache 244 may be configured or designed as a multi-level (e.g., 3 level, 2-5 level, etc.) cache which holds information in memory, in memory outside the process and/or on disk. This enables the cache to be scalable, distributed and redundant.
Back End 250 which, for example, may be operable for analyzing selected web pages or other documents which have been identified for contextual analysis. In at least one embodiment, Back End 250 may include a queue of URLs corresponding to webpages (or other documents) to be analyzed. In at least one embodiment, the Manager process (e.g., 253) may be operable to identify and/or select URLs from the queue and/or to initiate contextual analysis for one or more of the selected URLs.
Manager 253 which, for example, may be operable for initiating and/or managing the Back End tasks. For example, in one embodiment Manager may be implemented as a process and configured or designed to retrieve jobs from the Back End queue, and send them to the appropriate Back End component for further processing/action. When the analysis is complete the Manager may automatically update the disk repository, which enables the front end to get information regarding specific page(s). In at least one embodiment, the Manager may be configured or designed to use the analysis results for specific source page(s) (e.g., phrases to highlight, and related information for each phrase) to automatically, dynamically, and/or continuously update the repository (230). The Front End may read the updated information for a given page (e.g, using a unique ID for that particular page) from the repository or cache (244) (if available in cache).
Job Queue 254 which, for example, may be configured or designed to function as a queue of identified URL(s) that either need to be analyzed for the first time, or need to be refreshed. The queue enables a distribution of the Back End jobs to several physical machines.
Indexer 252a which, for example, may be operable for automatically and dynamically indexing the pages, titles, topics, phrases, etc. In at least one embodiment, indexer may be configured or designed to facilitate or enable a quick retrieval of similar pages (e.g., based on TF-IDF scoring such as that described, for example, at http://en.wikipedia.org/wiki/Tf-idf) based on the different query field. In at least one embodiment, the Indexer may be operable to retrieve or access all (or selected ones of) related content from the Back End for specific page-phrase combinations.
Parser 251 which, for example, may be operable to automatically and dynamically parse the content of web pages and/or other documents and/or to generate one or more chunks of plain text based upon the parsed content. In at least one embodiment, the parsing of web page or document content may include, but is not limited to, one or more of the following (or combinations thereof):
   Identifying main content block of target document
   Extracting semi structured information and clean plain text
   Converting HTML to clean plain text
   Removing all (or selected) menus, advertisements, and link boxes etc.
   Generating pure text output of content only, without external noise, while retaining semi structured information such as, for example, titles, bold elements, meta information, etc.

According to different embodiments, at least some of such parsing operations may be performed at the Hybrid System, the client system(s), or both the Hybrid System and client system(s).
Phrase Extractor 255 which, for example, may be operable to automatically and dynamically extract KeyPhrases from plain text such as, for example, the main content block of a target document. In at least one embodiment, phrase extraction functionality may be implemented using one or more different types of phrase extraction mechanisms or algorithms such as, for example: part-of-speech (POS) tagging, chunking, NGram analysis, etc.
Classifier 256 which, for example, may be operable to classify a document or a paragraph to a taxonomy of topics and/or other type(s) of descriptors. In at least one embodiment, the input data may include text and the output data may include a vector of topics and associated weights which, collectively, represent the analyzed document (or selected portions thereof). Additional details and features of different Classifier embodiments are disclosed in U.S. patent application Ser. No. 11/732,694 (Attorney Docket No. KABAP011B), which is incorporated herein by reference for all purposes.
Refresher 257 which, for example, may be implemented as a process which is operable to monitor or scan the Related Repository (237) and to identify/determine whether specific URLs need to be refreshed based on specified criteria such as, for example, age of URL, the last time the URL was refreshed, the type of content being analyzed (e.g., news need to be more up-to-date while more static content doesn't need to be refreshed often), etc.
Related Repository 230 which, for example, may include one or more different databases (or portions thereof) such as, for example:
   Dynamic Taxonomy Database (DTD) (e.g., organized by topic)
   Related Content Corpus (RCC) (e.g., organized by channels)

In at least one embodiment, aspects of these two databases may overlap.
Application Database 232 which, for example, may be implemented as a separate DB which may be configured or designed to handle other types of information such as that relating to publishers, advertisers, etc. In at least one embodiment, the Application Database 232 may include business rules and/or preferences (e.g, provided by advertiser or publisher) which, for example, may be utilized when determining customized displays of DOL(s) including, for example, one or more of the following (or combinations thereof):
   look and feel
   type of DOL elements to be presented in DOL (e.g., video, text, images, audio, ads, related links)
   quantity of each DOL element to be presented in DOL
   size, shape, position (of display) of DOL;
   DOL behavior (e.g., display on mouseover, display on click, and/or other behaviors show in Hybrid demo screenshots);
   etc.

According to different embodiments, the Front End and/or Back End may be responsible for serving of different type of requests. In at least one embodiment, the Front End is responsible for handling pages that were processed, and to select in real time the different components the user will see based on its geo location, the ERV values, the ad inventory, etc. One such embodiment of this technique is described, for example, in U.S. patent application Ser. No. 11/732,694 (Attorney Docket No. KABAP011B)), which is incorporated herein by reference for all purposes. In at least one embodiment, when a new page arrives (which is not in the cache), it is sent for further processing in the Back End, which, in at least one embodiment, may be configured or designed to perform parsing, classification, phrase extraction, indexing, and/or matching of related phrases and content.

### Representations of Dynamic Taxonomy Database, Related Content Corpus, Index

FIG. 2B shows an example block diagram illustrating various portions 290 which may form part of the Related Repository 230 and/or Index 252 of Hybrid System 200, and which may be used for implementing various aspects described or referenced herein.

Various different embodiments of the Related Repositories may include a plurality of different types of components, devices, modules, processes, systems, etc., which, for example, may be implemented and/or instantiated via the use of hardware and/or combinations of hardware and software. For example, as illustrated in the example embodiment of FIG. 2B, the Related Repository 230 may include one or more different databases (or portions thereof), such as, for example, one or more of the following (or combinations thereof):
Dynamic Taxonomy Database (DTD) 230a
Related Content Corpus (RCC) 230b

According to different embodiments, the various components of the Related Repository may be configured, designed, and/or operable to provide various different types of operations, functionalities, and/or features, such as those described herein, for example.

In one embodiment, the Index (252) may be implemented as a data structure (such as, for example, an inverted index) which is configured or designed to index selected portions of the Related Repository (e.g., Related Content Corpus 230b), and facilitates/enables fast retrieval of desired and/or relevant related information, related videos, related ads, etc. (e.g., based on one or more different criteria such as, for example, tags, titles, topics, text (MCB), phrases, descriptions, metadata, etc.). In at least one embodiment, the index may be queried with the source page, and different element may be assigned different weights. For example if the phrase in the origin page appears in the title of the destination page, the relevancy score may be boosted. The final relevancy score may represent the distance between the source page and the target page. In at least one embodiment, different boosts may be given to the matches in the title, topics and/or phrases. The closer the match, the higher the score, which, for example, may be normalized to include a range of values between 0-1.

FIG. 2C shows an alternate example embodiment of a client system 290c which may be operable to implement various aspects, techniques, and/or features disclosed herein.

As illustrated in the example embodiment of FIG. 2C, client system 290c may include one or more of the following (or combinations thereof):
one or more processors 262,
one or more interfaces such as, for example:
   at least one network communication interface 266 which, for example, may be operable to facilitate communication between client system 290c and other network devices (e.g., Hybrid System(s), Advertiser System(s), Publisher System(s), etc. According to different embodiments, different types of network communication interfaces may include, for example, one or more of the following (or combinations thereof): wired interfaces (e.g., Ethernet interfaces, frame relay interfaces, cable interfaces, DSL interfaces, token ring interfaces, fast Ethernet interfaces, Gigabit Ethernet interfaces, ATM interfaces, HSSI interfaces, POS interfaces, FDDI interfaces and the like), wireless interfaces, etc.
   at least one input interface 268 which, for example, one or more of the following (or combinations thereof): keyboard, touchscreen, mouse, motion sensor(s), visual sensors, audio sensors, and/or other types of input interfaces or devices which, for example, may be utilized by a user for providing input to client system 290c.
   In at least one embodiment, at least a portion of the client system interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the processor(s) 262 to efficiently perform routing computations, network diagnostics, security functions, etc.
memory 264, which, for example, may include, but are not limited to, one or more of the following (or combinations thereof): volatile memory (e.g., RAM), non-volatile memory (e.g., flash memory, magnetic memory, optical memory, flash memory, non-volatile RAM, etc. It will be appreciated that there are many different ways in which memory could be coupled to the client system. In at least one embodiment, different portions of memory 264 may be configured or designed for different uses such as, for example, caching and/or storing data, programming instructions, and/or other types of information. For example, in at least one embodiment, memory 264 may be configured or designed to include cache 244c.
at least one display system 139
Cache 244c which, for example, may be operable for caching or storing selected information relating to one or more aspects or features of the hybrid contextual analysis techniques described herein such as, for example, one or more of the following (or combinations thereof):
   KeyPhrase information
   SourcePage ID information
   DOL element information
   markup information
   DOL layout information
   URL information
   advertising information
   relevancy score information
   related content information
   etc.
In at least one embodiment, cache 244c may be configured or designed to include at least a portion of functionality and/or data which is similar to the functionality and/or data associated with cache 244 of FIG. 2A.
Layout 243c which, for example, may be configured or designed for selecting desired highlights (e.g., to be displayed on client display system 139), related content, related video, related ads, etc. In at least one embodiment, the layout 243c may utilize ERV information and/or relevancy score information (e.g., for each or selected origin-target pair(s)) in order, for example, to select the desired/optimal highlights and information based, for example, at least partially on spatial arrangement and relevancy scores. An example of the layout process is described, for example, in U.S. patent application Ser. No. 11/732,694 (Attorney Docket No. KABAP011B), which is incorporated herein by reference for all purposes. In at least one embodiment, Layout 243c may be configured or designed to include at least a portion of functionality and/or data which is similar to the functionality and/or data associated with Layout 243 of FIG. 2A.
Parser 251c which, for example, may be operable to automatically and dynamically parse the content of web pages and/or other documents and/or to generate one or more chunks of plain text based upon the parsed content. In at least one embodiment, the parsing of web page or document content may include, but is not limited to, one or more of the following (or combinations thereof):
   Identifying main content block of a target document
   Extracting semi structured information and clean plain text
   Converting HTML to clean plain text
   Removing all (or selected) menus, advertisements, and link boxes etc.
   Generating clean text output of content only, without external noise, while retaining semi structured information such as, for example, titles, bold elements, meta information, etc.
   Performing chunking operations for generating chunks of clean text output which may then be provided to the Hybrid System for further contextual search analysis and processing.
In at least one embodiment, Parser 251c may be configured or designed to include at least a portion of functionality and/or data which is similar to the functionality and/or data associated with Parser 251 of FIG. 2A.
Phrase Extractor 255c which, for example, may be operable to automatically and dynamically extract KeyPhrases from plain text such as, for example, the main content block of a target document. In at least one embodiment, Phrase Extractor 255c may be configured or designed to include at least a portion of functionality and/or data which is similar to the functionality and/or data associated with Phrase Extractor 255 of FIG. 2A.
Web browser application 271 (such as, for example, Mozilla Firefox™, Microsoft Internet Explorer™, Safari™, Netscape Navigator™, etc.) which, for example, may be operable to implement or facilitate display of web browser window 131 and content contained therein.
Content rendering engine 273 which, for example, may be operable to render received web page content, markup instructions, URLs, DOL elements, etc. for display on client display system 139.

Although the system shown in FIG. 2C illustrates one specific example embodiment of a client computer system 290c, it is by no means the only client system device architecture which may be utilized. Accordingly, it will be appreciated that other client system embodiments (not shown) having different combinations of features or components described herein may be utilized or implementing one or more aspects of the hybrid contextual analysis and display techniques disclosed herein. Further, it will be appreciated that other client system embodiments may include fewer, different and/or additional components than those illustrated in FIG. 2C.

In one embodiment, such analysis and/or calculations may be implemented in real-time (or near real-time) in order allow one technique(s) described herein to automatically and dynamically adapt, in real-time, its algorithms and/or other mechanisms for identifying and/or selecting various types of information (e.g., KeyPhrases, advertisements, related content, DOL elements, etc.) and/or display features relating to at least a portion of the on-line contextual advertising techniques disclosed herein such as those employing contextual in-text KeyPhrase advertising.

According to different embodiments, different client system embodiments may be operable to automatically and/or dynamically initiate and/or perform various aspects, features and/or operations relating to one or more of the hybrid contextual analysis and display techniques disclosed herein, such as, for example, one or more of the following (or combinations thereof):
Parse web page content retrieved from online publishers or content providers
Generate chunks of clean or pure text output
Transmit or provide chunks of clean or pure text output to the Hybrid System for further contextual search and markup analysis
Generate an identifier (e.g., SourcePage ID) which represents the content associated with a given web page. In at least one embodiment, a unique SourcePage ID may be created or generated for a given web page or document, wherein the SourcePage ID is representative of the main content (which, for example, may include static and/or dynamically generated content) associated with that particular web page (e.g., which is to be displayed at that particular client system). Accordingly, in at least one embodiment, the SourcePage ID may correspond to a fingerprint or hash value which is representative of the main or primary content associated with that particular version or instance of the web page or document. For example, in at least one embodiment, the client system may be operable to:
   parse a given web page,
   identify and extract the main content block of that web page,
   generate clean text output version of the main content block
   use clean text output version of the main content block to generate a SourcePage ID for that particular web page
According to different embodiments, the SourcePage ID may be generated using different types of hashing function such as, for example, one or more of the well known hashing functions: elf64; HAVAL; MD2; MD4; MD5; Radio Gatlin; RIPEMD-64; RIPEMD-160; RIPEMD-320; SHA1; SHA256; SHA384; SHA512; Skein; Tiger; Whirlpool; Pearson hashing; Fowler-Noll-Vo; Zobrist hashing; JenkinsHash; Java hashCode; Bernstein hash; etc.
Provide SourcePage ID information to the Hybrid System. In at least one embodiment, the Hybrid System may cache selected SourcePage ID information received from various different client systems so that such information may be utilized (e.g., by the Hybrid System and/or client system(s)) during subsequent contextual analysis operations.
Cache (e.g., in local memory) various types of information provided by the Hybrid System such as, for example, one or more of the following (or combinations thereof):
   relevancy scoring information (e.g., Ad Final_Score values, RC Final_Score values, Ad Related Score values, RC Related Score values, TotalQuality Score values, DOL related score values, KP-DOL score values, etc.)
   EMV values
   ERV values
   CTR estimates
   SourcePage ID values
   etc.

In at least one embodiment, the Hybrid System and/or client system(s) may use the cached SourcePage IDs to determine whether an identified web page (e.g., web page to be displayed at the client system, related content page, advertiser page, etc.) has previously been processed for contextual KeyPhrase and markup analysis. In at least one embodiment, if the SourcePage ID of the identified web page matches a SourcePage ID in the cache, it may be determined that the identified web page has been previously processed for contextual KeyPhrase, relevancy scoring, and markup analysis. Accordingly, in at least one embodiment, further processing of the identified webpage (e.g., for contextual KeyPhrase, relevancy scoring, and/or markup analysis) need not be performed, and at least a portion of the results (e.g., relevancy scores, KeyPhrase data, markup information) from the previous processing of identified web page may be utilized.

In at least one embodiment, at least a portion of the above-describe client system functionality, features and/or operations may be implemented on readily available, general-purpose, end-user type computer systems (e.g., desktop PC, laptop PC, netbook, smart PDA, etc.), and without the need to install additional hardware and/or software components at the client system. For example, in at least one embodiment, at least a portion of the disclosed client system functionality, features and/or operations may be implemented at an end user's personal computer system via the use of scripts (e.g., Javascript, Active-X, etc.), non-executable code and/or other types of instructions which, for example, may be processed and initiated by the client system's web browser application. In at least one embodiment, such scripts or instructions may be embedded (e.g., as tags) into a publisher's web page(s). When the client system accesses a webpage which includes such scripts/instructions, the client system's web browser application (and/or one or more plug-ins or add-ons to the web browser application) may process the scripts/instructions, which may then cause the client system to initiate or perform one or more aspects, features and/or operations relating to one or more of the hybrid contextual analysis and display techniques disclosed herein.

### Overview of Processing of Source Pages, Target Pages, Related Ads

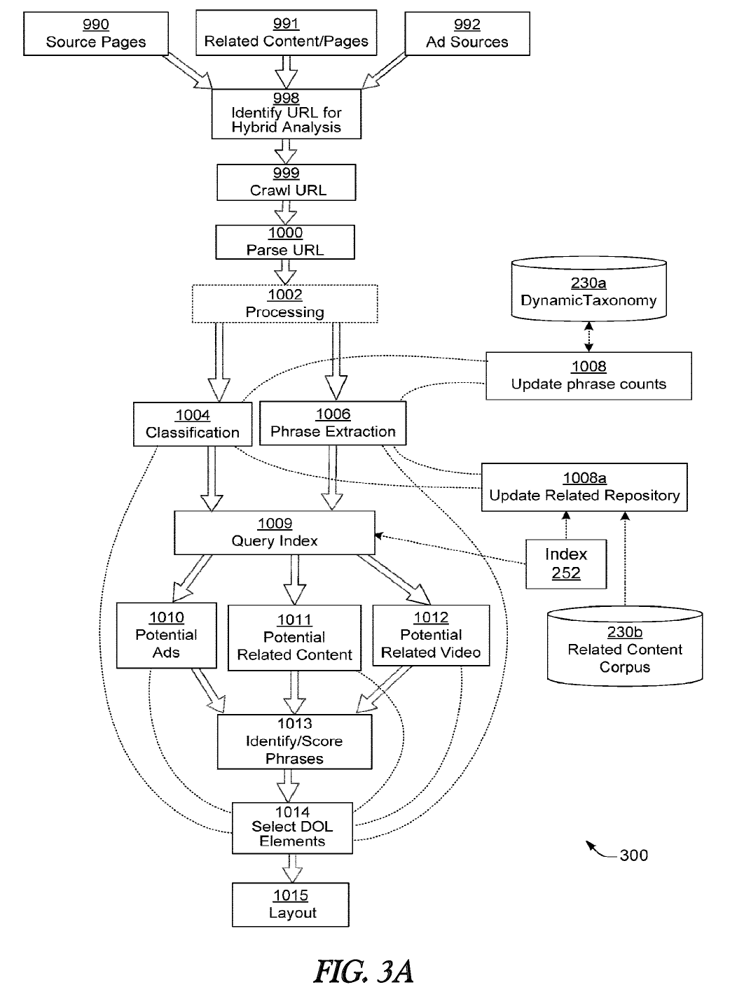

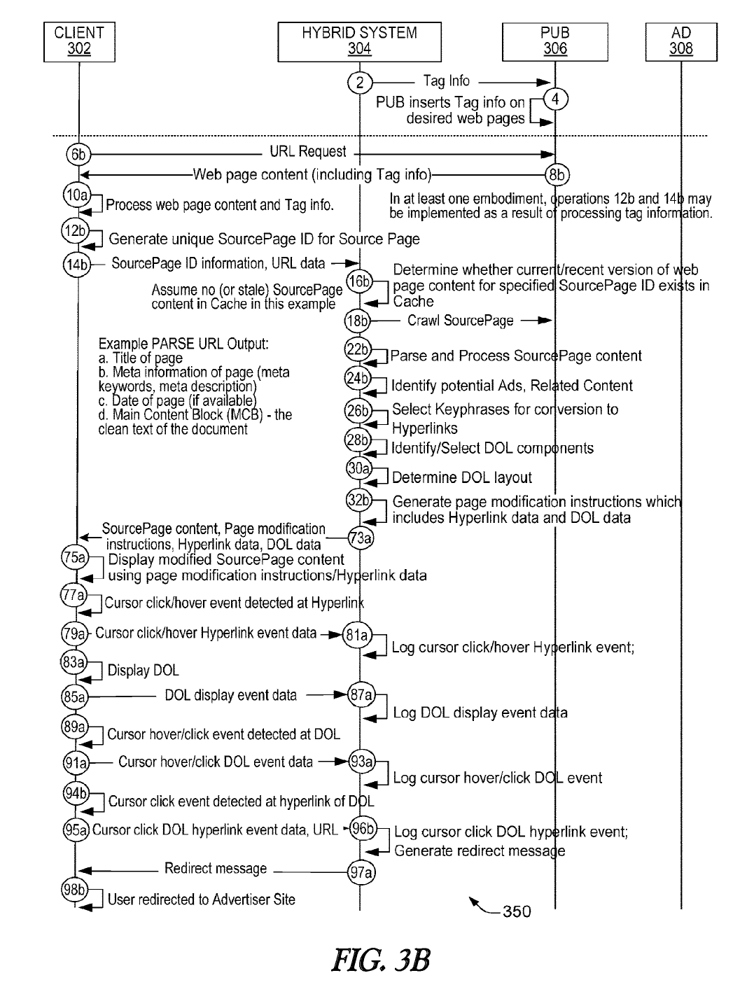

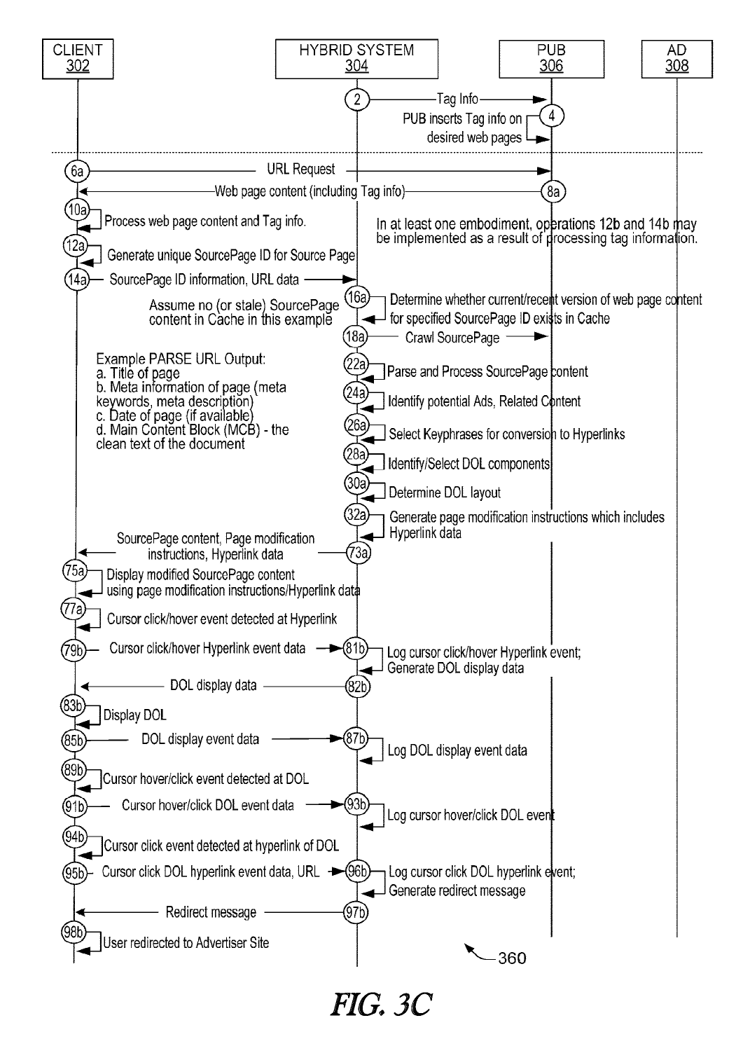

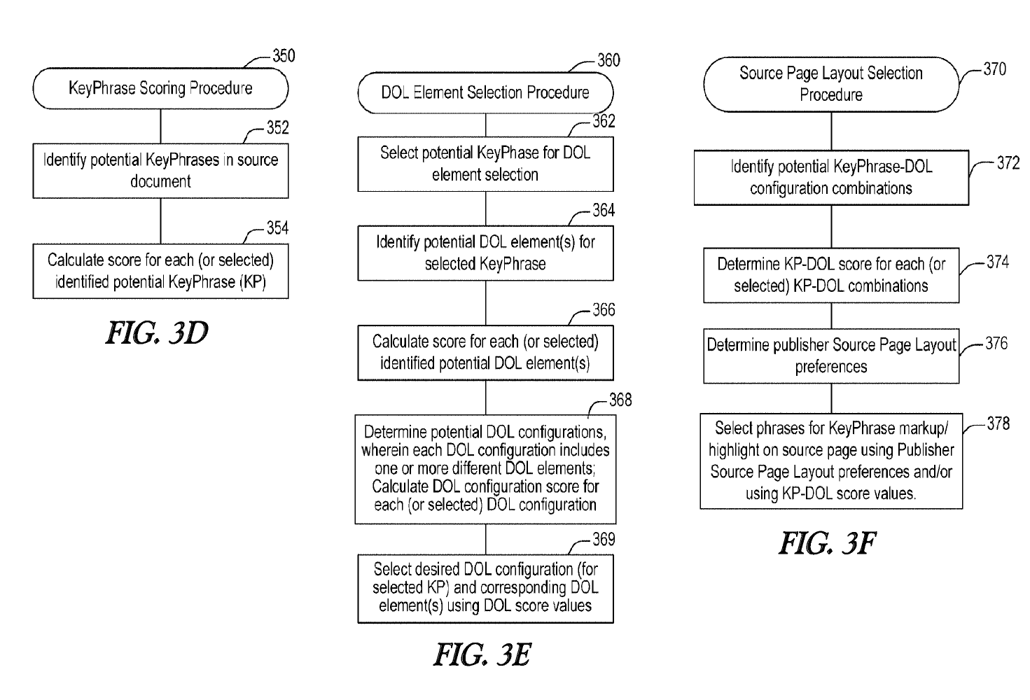

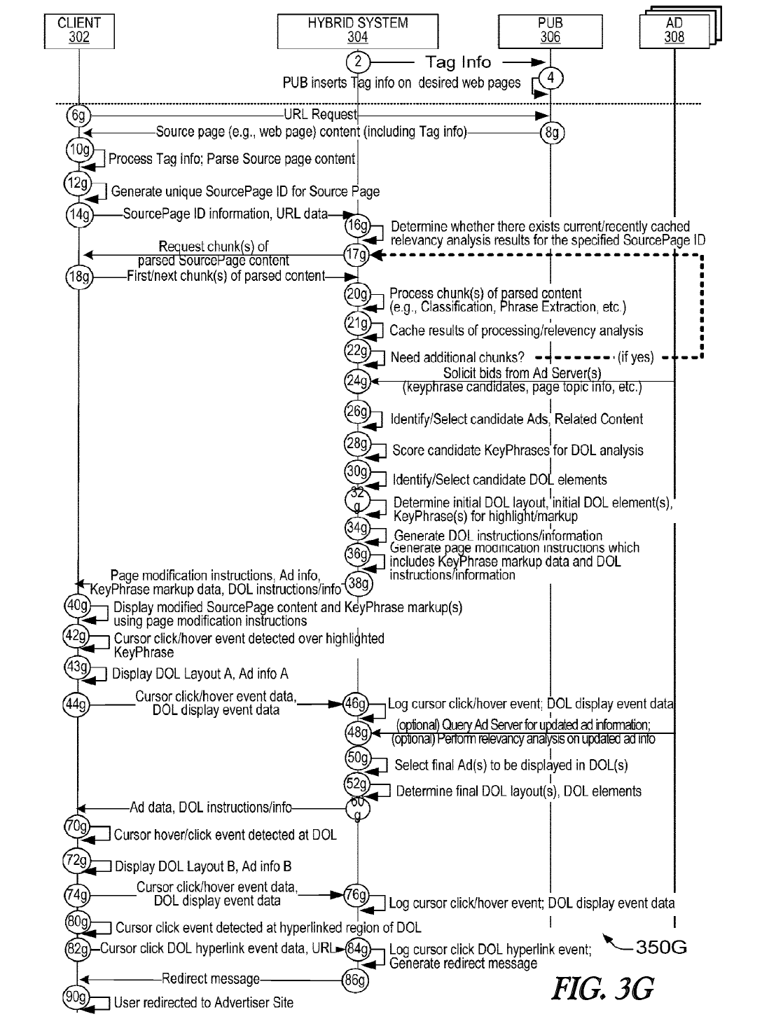

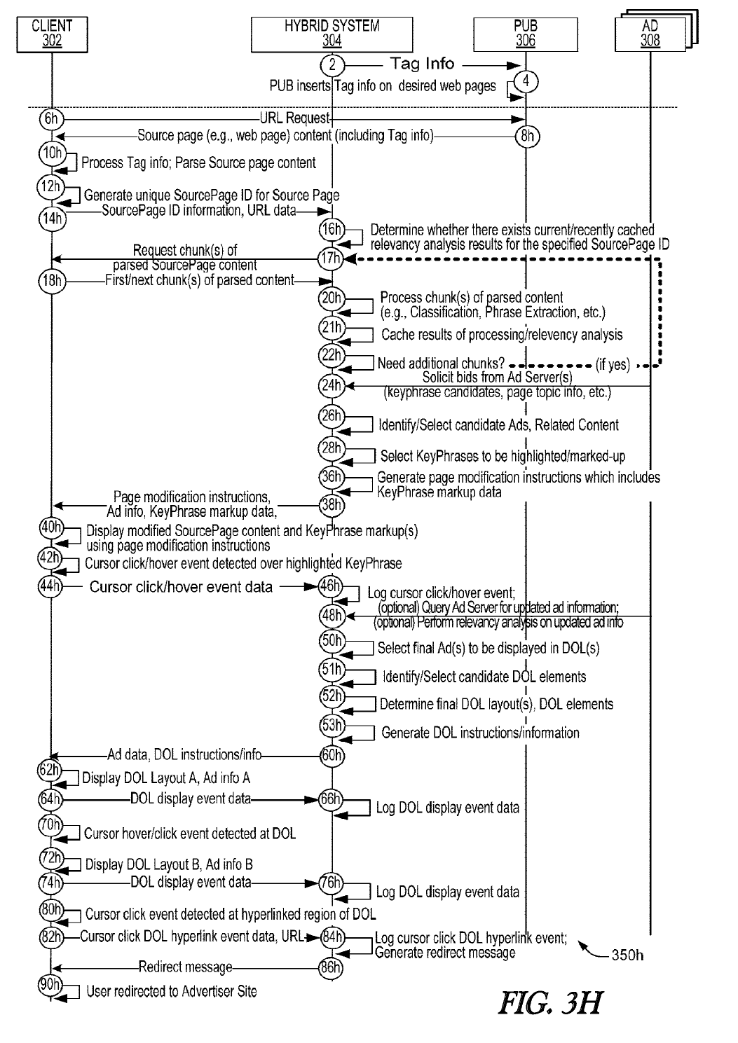

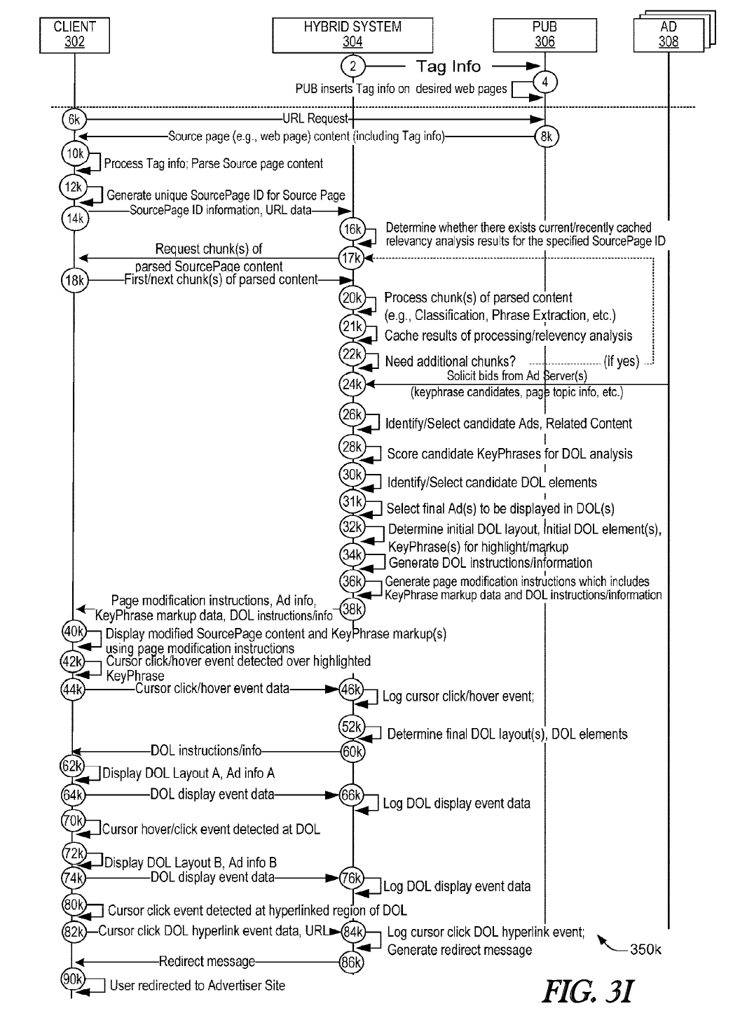

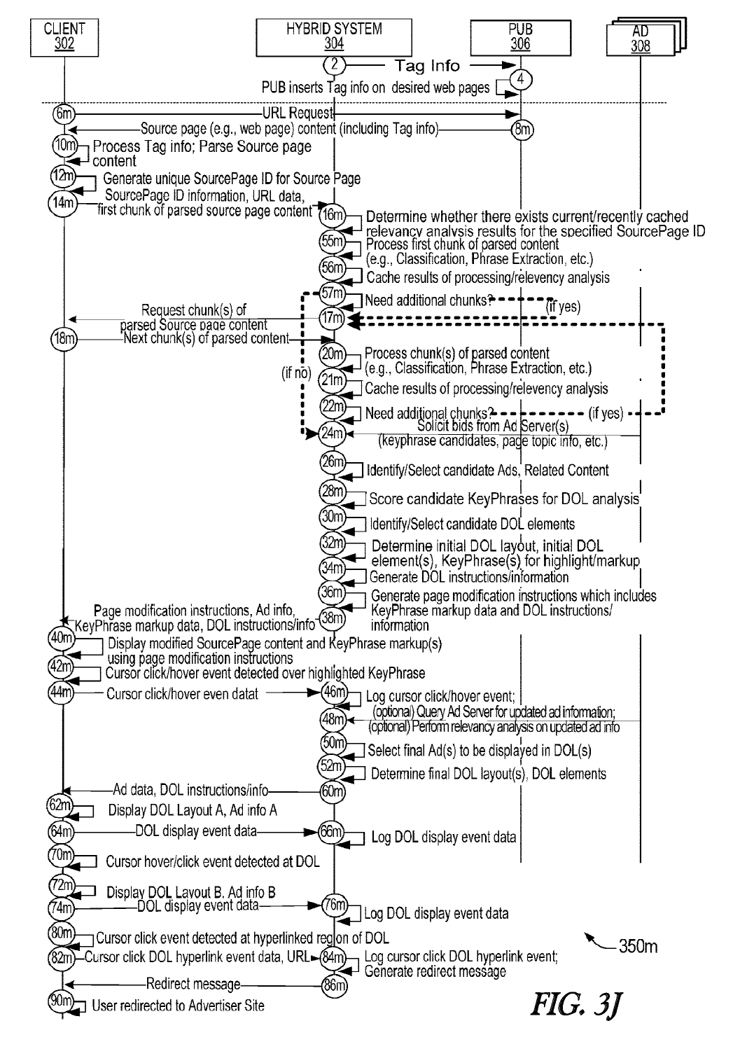

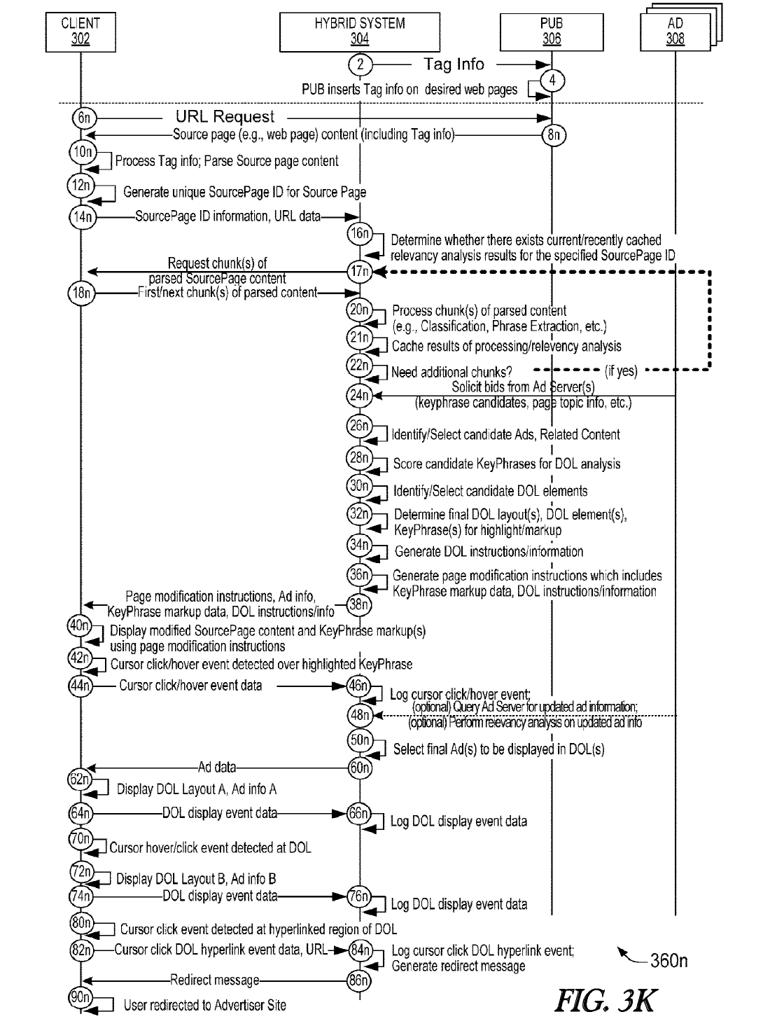

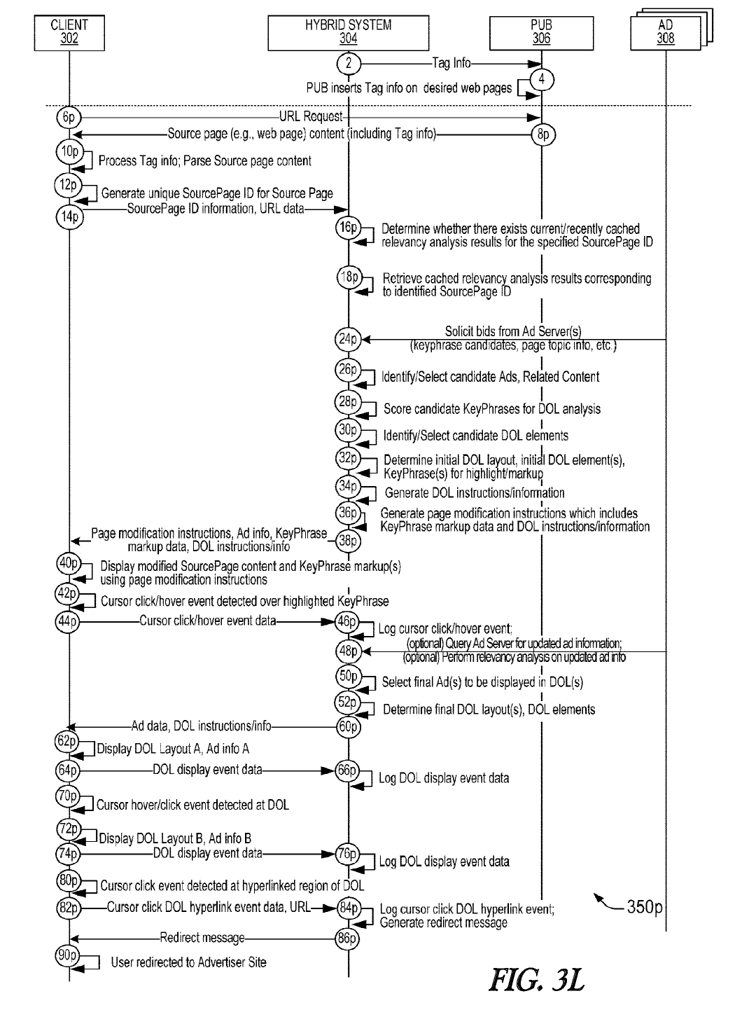

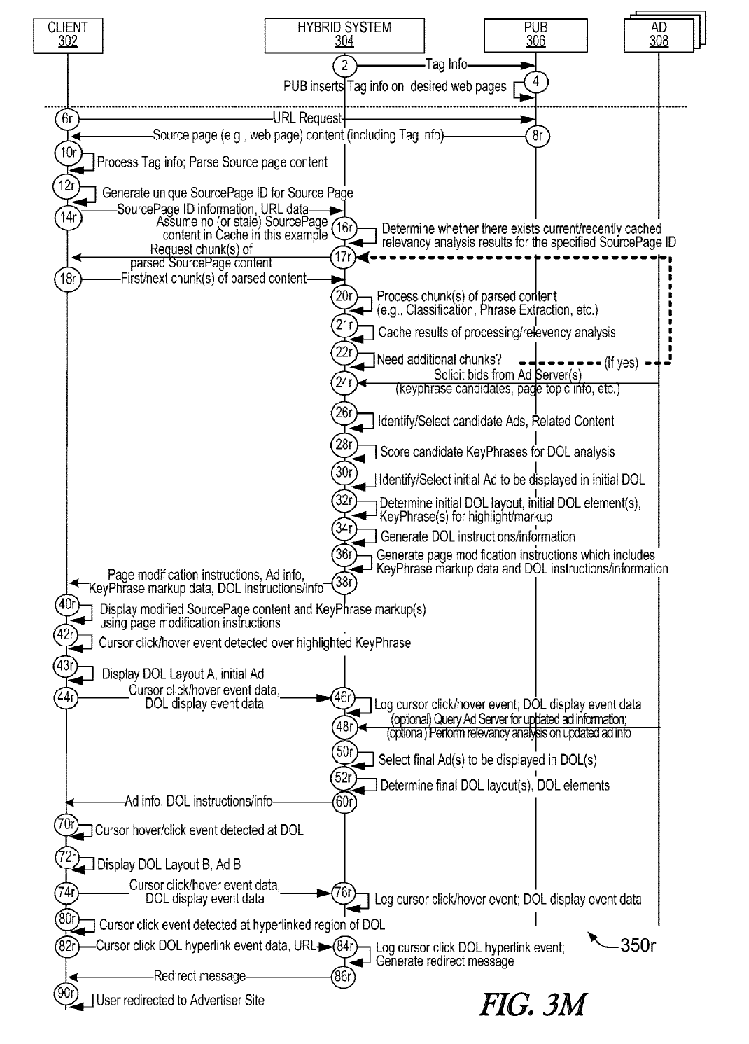

FIG. 3A shows a flow diagram of a Hybrid Contextual Advertising Processing and Markup Procedure in accordance with a specific embodiment. As illustrated in the example embodiment of FIG. 3A, the processing of various Source page types (e.g., 990), Target page types (e.g., 991), and Ad types (992) are described. In at least one embodiment, the processing of Target page types may stop after execution of operational blocks 1008/1008a, whereas the processing of Source pages may include additional processing operations (e.g., 1009-1014), resulting in selection of KeyPhrases (e.g., for highlight/markup) and layer elements to present in one or more dynamic overlay layers (DOLs).

In at least one embodiment, the Hybrid Contextual Advertising Processing and Markup Procedure may be operable to perform and/or implement various types of functions, operations, actions, and/or other features such as, for example, one or more of the following (or combinations thereof):
identifying documents/content (e.g., source pages, source page content, target pages, related content, advertisements, advertisement landing pages, and etc.) for contextual search and market analysis;
crawling and/or accessing content from one or more identified URLs, source pages, target pages, advertisements, etc.;
parsing content relating to one or more identified URLs, source pages, target pages, advertisements, etc.;
classifying parsed content into vector of one more topic;
performing keyphrase or keyphrase analysis/extraction of parsed content;
performing automated population and/or updating of information/data stored at the Dynamic Taxonomy Database and/or Related Content Repository using, for example, extracted keyphrase/keyphrase information, topic classification information, etc.;
providing/enabling real-time, automated queries to be implemented at the Dynamic Taxonomy Database and/or Related Content Repository for identifying and/or retrieving (e.g., in real time or substantially real-time) desired content such as, for example, potential ad candidates, potential related content candidates, potential related content element candidates, potential related video candidates, etc.;
performing comparative relevancy/relatedness scoring analysis on selected portions of content;
automatically and dynamically generating, in real-time or substantially real-time, relevancy/relatedness scores which, for example, may be used to identify or determine degrees of relatedness between different combinations of source pages, target pages, related content elements, keyphrases, advertisements, etc.;
automatically and dynamically identifying (e.g., using a least a portion of the relevancy/relatedness scores), in real-time or substantially real-time, different types of potential candidates which may be suitable for display in one or more dynamic overlay advertisement layers;
automatically and dynamically computing or determining various types of scoring values for each of the identified ad candidates and/or related content element candidates such as, for example, one or more of the following (or combinations thereof):
   EMV values (expected monitory value),
   ERV values (expected return value),
   Ad Quality score values,
   Related Content Relevancy score values,
   quality of the related information website (e.g., for related content),
   Final Score values for ads
   Final Score values for related content elements
   estimated click through rate (CTR),
   cost-per-click (CPC) values,
   cost-per-thousand-impressions (CPM)/effective CPM values,
   etc.
automatically and dynamically selecting desired add candidates, related content element candidates, etc., for potential display in one or more dynamic overlay advertisement layers;
automatically and dynamically generating, in real-time or substantially real-time, keyphrase/keyphrase markup information and/or source page modification instructions;
automatically and dynamically performing, in real-time or substantially real-time, dynamic overlay layer (DOL) layout information, which, for example, may include information relating to: the types of content (e.g., ads, related content, related videos, etc.) to be displayed in one or more dynamic overlay layers at one or more client systems; the types of display layouts and/or formatting to be used for displaying one or more dynamic overlay layers at one or more client systems; etc.
etc.

According to specific embodiments, multiple instances or threads of the Hybrid Contextual Advertising Processing and Markup Procedure or portions thereof may be concurrently implemented and/or initiated via the use of one or more processors and/or other combinations of hardware and/or hardware and software. In at least one embodiment, all or selected portions of the Hybrid Contextual Advertising Processing and Markup Procedure may be implemented at one or more Client(s), at one or more Server(s), and/or combinations thereof. For example, in at least some embodiments, various aspects, features, and/or functionalities of the Hybrid Contextual Advertising Processing and Markup Procedure mechanism(s) may be performed, implemented and/or initiated by one or more of the various types of systems, components, systems, devices, procedures, processes, etc. (or combinations thereof), as described herein.

According to different embodiments, one or more different threads or instances of the Hybrid Contextual Advertising Processing and Markup Procedure may be initiated and/or implemented manually, automatically, statically, dynamically, concurrently, and/or combinations thereof. Additionally, different instances and/or embodiments of the Hybrid Contextual Advertising Processing and Markup Procedure may be initiated at one or more different time intervals (e.g., during a specific time interval, at regular periodic intervals, at irregular periodic intervals, upon demand, etc.).

In at least one embodiment, a given instance of the Hybrid Contextual Advertising Processing and Markup Procedure may utilize and/or generate various different types of data and/or other types of information when performing specific tasks and/or operations. This may include, for example, input data/information and/or output data/information. For example, in at least one embodiment, at least one instance of the Hybrid Contextual Advertising Processing and Markup Procedure may access, process, and/or otherwise utilize information from one or more different types of sources, such as, for example, one or more databases. In at least one embodiment, at least a portion of the database information may be accessed via communication with one or more local and/or remote memory devices. Additionally, at least one instance of the Hybrid Contextual Advertising Processing and Markup Procedure may generate one or more different types of output data/information, which, for example, may be stored in local memory and/or remote memory devices. Examples of different types of input data/information and/or output data/information which may be accessed and/or utilized by and/or generated by the Hybrid Contextual Advertising Processing and Markup Procedure are described in greater detail below.

For purposes of illustration, an example of the Hybrid Contextual Advertising Processing and Markup Procedure will now be described by way of example with reference to the flow diagram of FIG. 3A. However, it will be appreciated that different embodiments of the Hybrid Contextual Advertising Processing and Markup Procedure (not shown) may include additional features and/or operations than those illustrated in the specific embodiment of FIG. 3A, and/or may omit at least a portion of the features and/or operations of Hybrid Contextual Advertising Processing and Markup Procedure illustrated in the specific embodiment of FIG. 3A.

As illustrated in the example embodiment of FIG. 3A, block 990 may represent one or more source pages which may be analyzed such as, for example, a webpage which is to be displayed at one or more client systems. As described in greater detail below, in at least one embodiment, each (or selected ones) of the source page(s) may include one or more tags (e.g., JavaScript tag) for facilitating hybrid contextual/relevancy and markup analysis of that page. In at least one embodiment, at least some of the identified source pages may correspond to user initiated URL requests, which the user may initiate via use of a web browser application at a client system.

For example, in at least one embodiment, a user initiates a request to view a webpage which includes Hybrid tag. The Hybrid tag is processed at the user's client system. The processing of the Hybrid tag may cause the client system to initiate a request to the Hybrid System for performing hybrid contextual/relevancy and markup analysis on the source webpage. In one embodiment, the request comes from the client via a javascript call to the server. Alternatively the request can come from a background job that crawls a specific website. As illustrated in the example embodiment of FIG. 3A, hybrid contextual/relevancy and markup analysis of the content of selected source pages may include various different automated operations, such as, for example, operations 999-1015 of FIG. 3A.

As illustrated in the example embodiment of FIG. 3A, block 991 may represent one or more target pages which may be analyzed for hybrid contextual/relevancy and markup analysis. Various different examples of target pages may include, but are not limited to, one or more of the following (or combinations thereof):
related webpages
related content such as for example:
   related text
   related links
   related video
   related images
   related audio
   animation (flash)
   related information
   related feeds
   related articles
   etc.
landing advertisement webpages
pages that may be not part of the Hybrid network, and do not have the Hybrid tags on them;
etc.

In at least one embodiment, related pages may include all (or selected ones of) webpages and/or other documents associated with a list of one or more websites. The identified related pages may subsequently be processed for hybrid contextual/relevancy and markup analysis (e.g., by the Hybrid System), and considered as potential target page candidates for subsequent hybrid contextual/relevancy and/or markup operations. As illustrated in the example embodiment of FIG. 3A, hybrid contextual/relevancy and markup analysis of the content of selected target pages may include various different automated operations, such as, for example, operations 999-1008 of FIG. 3A. As illustrated in the example embodiment of FIG. 3A, block 992 may represent one or more ad sources such as, for example, online advertisement(s), landing URLs associated with one or more on-line ads, etc. In at least one embodiment, when an ad is identified at the Hybrid System (e.g., via direct channel, via feed, etc.) its ad landing (e.g., landing URL of ad) may be automatically and dynamically identified, extracted, and sent to crawling and/or parsing components. In one embodiment, the Hybrid System may elect to deep crawl the advertiser's site. In one embodiment, when performing a deep crawl, for example, more than 1000 pages of advertiser pages may be analyzed for hybrid contextual/relevancy analysis. As illustrated in the example embodiment of FIG. 3A, hybrid contextual/relevancy and markup analysis of the content of selected ad sources may include various different automated operations, such as, for example, operations 999-1008 of FIG. 3A.

According to different embodiments, one or more different threads or instances of the Hybrid Contextual Advertising Processing and Markup Procedure may be initiated in response to detection of one or more conditions or events satisfying one or more different types of criteria (such as, for example, minimum threshold criteria) for triggering initiation of at least one instance of the Hybrid Contextual Advertising Processing and Markup Procedure. Examples of various types of conditions or events which may trigger initiation and/or implementation of one or more different threads or instances of the Hybrid Contextual Advertising Processing and Markup Procedure may include, but are not limited to, one or more of the following (or combinations thereof):
Example Source Page trigger: page view request from client system of URL(page) with Tag Information
Example Ad trigger—bid on Ad detected/identified.
Example Target Page trigger(s): page identified by crawler, related page ID'd with included Tag Information

In at least one embodiment, each (or selected ones of) source page(s) may be considered as target page(s) for other (different) source pages.

In at least one embodiment, target pages may be identified by:
Landing URL of ad (if available)
crawlers (related content)
etc.

For example, in at least one embodiment, when a page view (source page) is requested by a user, the Hybrid Back End may send crawlers (e.g., asynchronously—via Job Queue) to crawl associated source page website (or portions thereof) and/or related websites and perform related content analysis processing.

As shown at 998, a selected page or URL may be identified for Hybrid contextual/relevancy and markup analysis. By way of example, it is assumed, in this particular example embodiment, that the Hybrid System has identified specific page/element (e.g., user initiated source page; related target (e.g., related page, related content element, etc.); advertisement (e.g., Ad+landing URL); etc.) for Hybrid contextual/relevancy and/or markup analysis.

As shown at 999, one or more page crawling operation(s) may be initiated. For example, in at least one embodiment, if the identified URL is determined to be new or stale (see, e.g., caching existing pages), the Hybrid System may respond by sending a crawl job to a queue via TCP or UDP message. An automated worker thread may then pick the URL from the queue, and perform an HTTP-GET request to download the page to the server. Alternatively, in at least some embodiments where the identified page corresponds to a source page initiated by a user of the client system, the Hybrid System may instruct the client system to retrieve additional content from the source webpage, and/or to provide chunks of parsed source page content to the Hybrid System for analysis.

As represented at blocks 1000, 1002, 1004, 1006, 1008, 1008a, various different processing operations may be performed at the Hybrid System. For example, according to different embodiments, examples of the various different content processing operations which may be performed may include, but are not limited to, one or more of the following (or combinations thereof):
page/content/ad identification
page/content/ad content parsing operations
phrase extraction operations
page/content/ad classification/scoring operations
topic classification/scoring operations
phrase classification/scoring operations
database update operations
etc.

By way of illustration, and for purposes of explanation, FIG. 75 shows an example high level representation of a procedural flow of various Hybrid System processing operations in accordance with a specific embodiment. Referring to the example embodiment of FIG. 75, a high level description of an example procedural flow of the various processing operations which may be performed at the Hybrid System may be described as follows:
7502—page/document identified for analysis (e.g., source page, target page, ad, etc.)
7504—Parsing operations—In at least one embodiment, at least a portion of the parsing operations may be performed by Hybrid Parser input may include HTML output may include pure text without HTML markup information, and without parts that may be not the main text area of the page such as menus, links, advertisement etc.
7508—Extracting operations—In at least one embodiment, at least a portion of the extracting operations may be performed by Hybrid Extractor, extract the phrases based on algorithms described above. Input clear and semi structured text, output—list of phrases, phrases location within the text, and relationships between phrases.
7512—Classifying operations—In at least one embodiment, at least a portion of the classifying operations may be performed by Hybrid Classifier, classifies documents or part of documents into a directory of documents such as http://dir.yahoo.com/. Input—clear text broken into parts (e.g., sentences, paragraphs, etc) output—list of topics that best fit the specific part
7516—Updating operations—In at least one embodiment, at least a portion of the updating operations may be performed by Hybrid Phrase Evaluator—which assigns the topic of the context classified (e.g., during classifying operations) to each phrase, and then aggregates the counts across the corpus (described later). Input—list of phrases and their context classification, output may include to update HybridPhraseRepository.

Returning to the specific example embodiment of FIG. 3A, as shown at 1000, content associated with the identified URL may be parsed. In at least one embodiment, the input to the parser may include the raw HTML from the page being analyzed. In at least one embodiment, the parsing may extract the all (or selected ones of) the following types of information from the page:
a. Title of page
b. Meta information of page (meta KeyPhrases, meta description)
c. Date of page (if available)
d. Main Content Block (MCB)—the clean, unformatted text of the document/page

FIG. 71 shows an illustrative example of the output of the URL parsing process in accordance with a specific example embodiment. In the example embodiment of FIG. 71, it is assumed that the Hybrid System has parsed content associated with the following URL: www.pcworld.com/article/152006/rims blackberry storm a new take on touch.html

As illustrated in the example embodiment of FIG. 71, output (7101) of the URL parsing process may include, but are is limited to, one or more of the following (or combinations thereof):
Main Content Block (MCB) portion 7106
URL of page
Title of page
date (optional)
etc.

In at least one embodiment, at least a portion of the parsing operations may be performed by Hybrid System Parser and/or client system Parser. Input may include HTML output may include clear text without HTML markup information, and without parts that may be not the main text area of the page such as menus, links, advertisement etc. In at least one embodiment, the output of a parsed document may include semi structured information and clean plain text. According to one or more embodiments:
the Hybrid Parser converts HTML to clean plain text (other parsers may be used such as (http://htmlparser.sourceforge.net/)
the Parser may be configured or designed to remove all (or selected ones of) menus, advertisements, and link boxes etc.
the parsing output may include only pure text of content only, without external noise
in at least one embodiment, at least a portion of the page's semi structured information (such as titles, bold elements, meta information, etc.) may be retained and included as part of the parsed output.

In at least one embodiment, the Hybrid System may process chunk(s) of parsed webpage content, which, for example, may have been parsed by a client system and provided to the Hybrid System. In at least one embodiment, such processing may include, but are not limited to, initiating and/or implementing one or more of the following types of operations (or combinations thereof):
Performing Page Classification (e.g., using at least a portion of the received chunks of parsed content associated with the identified Source web page).
Performing Phrase Extraction (e.g., using at least a portion of the received chunks of parsed content associated with the identified Source web page).
Identifying candidate KeyPhrases for the identified Source web page.
Identifying page topic(s) for the identified Source web page.
Performing relevancy (or relatedness) analysis on identified candidate KeyPhrases
Performing relevancy (or relatedness) analysis on identified candidate Page Topics
Generating relevancy/relatedness analysis output data (e.g., relevancy analysis results), which, for example, may include, but is not limited to, one or more of the following types of data (or combinations thereof):
   KeyPhrase-Page Topic relatedness (or relevancy) score values
   KeyPhrase-Corpus Topic relatedness (or relevancy) score values
   Page Topic-Corpus Topic relatedness (or relevancy) score values
   List of KeyPhrase candidates
   Page topic data
   Timestamp data
   Source page URL
   SourcePage ID
   Chunk(s) of parsed web page content
   etc.

As shown at 1002, various different content processing operations may be performed. According to different embodiments, this processing operations may include, but are not limited to, one or more of the following (or combinations thereof):
content parsing operations
phrase extraction operations
page classification/scoring operations
topic classification/scoring operations
phrase classification/scoring operations
database update operations
etc.

In at least one embodiment, processing component 1002 takes the output of 1000, and initiates at least 2 parallel processes:
Page Classification (1004)
Phrase Extraction (1006)

As shown at 1006, Phrase Extraction operations may be performed. In at least one embodiment, at least a portion of the phrase extraction operations may be performed by a Hybrid System phrase extractor (e.g., 255). In at least one embodiment, the phrase extractor may be operable to extract and/or classify meaningful phrases from the main content block using one or more different phrase extraction algorithms such as those described and/or referenced herein. This may include, for example, tagging part-of-speech for every word (or selected words) in the content, grouping words into different types of phrases, at least a portion of which, for example, may be based on ‘Noun Phrases’, ‘Verb Phrases’, NGrams, Search Queries, meta KeyPhrases etc. In one embodiment, the output of this process may include a list of all (or selected ones of) potential keywords or keyphrases. In at least one embodiment, at 1006 phrases may be extracted from the text extracted from the page/document (e.g., source webpage) identified for analysis.

In at least one embodiment, Phrase Extraction operations may include phrase extraction and/or phrase classification operations. In one embodiment, input data is clear and semi structured text, output data is list of phrases, each phrase's location within the text, and relationships between phrases.

According to different embodiments, at least a portion of the various types of phrase extraction functions, operations, actions, and/or other features may be implemented using a variety of different types of phrase extraction techniques such as, for example, one or more of the following (or combinations thereof):
1. N-Gram analysis (combination of 1−N sequences of words)
2. SearchLog analysis (extracting ‘search queries’ from our logs and searching them with-in document
3. Lists of words to be extracted
4. Entities such as Locations, Organizations, People and Product names
5. Entities such as Noun Phrases and Verb Phrases (‘the new black Jaguar’, ‘Running a new platform’)
   (a) N-Gram analysis
      i. From clean text select all (or selected ones of) sequences of words up to N words
      ii. Based on the popularity of the sequence with-in the document or within the corpus keep interesting NGrams
   (b) Entities Extraction
      i. Using ontology of entities (such as dictionaries, dedicated websites, encyclopedias) regognize entities in the text
      ii. Using Machine Learning algorithms to automatically detect and classify entities
   (c) Noun and Verb phrase extraction
      i. Use a part-of-speech tagger (Such as Brill tagger—en.wikipedia.org/wiki/Brill_tagger) to tag each word in the document with its part of speech (Noun, Verb, Adverb etc.)
      ii. Use Heuristics and a Chunk parser (such as described here: http://www.ai.uga.edu/mc/ProNTo/Brooks.pdf) to create meaningful phrases such as Noun and Verb phrases
   (d) Phrase Semantic analysis
      i. Stemming—extract the morphological root of phrases (running—run)
      ii. Recognize similar phrases on a page (‘Obama’, ‘Barack Obama’, ‘President elect Barack Obama’
      iii. Acronym Resolution—(CIA, Central Intelligence Agency)

In at least one embodiment, the Phrase Extraction process extracts and classifies meaningful phrases from the main content block of the parsed Source page content. This may include, for example, tagging part-of-speech for all (or selected) words in the content block, grouping words into phrases based on ‘Noun Phrases’, ‘Verb Phrases’, NGrams, Search Queries, meta KeyPhrases etc. In one embodiment, the output of this process is the list of all (or selected ones of) potential keyphrases.

FIG. 87 shows an illustrative example of phrase extraction/phrase classification processing in accordance with a specific example embodiment. In this particular example, the input content 8702 may be processed for phrase extraction, wherein different words/phrases of the input content may be extracted and parsed into different parts of speech (e.g., as shown at 8710). As shown at 8720, the parsed phrases may be classified into different types of phrases such as, for example, nouns, noun phrases, proper nouns, proper noun phrases, etc. In at least one embodiment, the Hybrid System may automatically and dynamically calculate, in real time, a respective relatedness score for each (or selected ones) of the extracted words/phrases, which, for example, may represent a degree of contextual relatedness of that particular phase to the main content block of the analyzed webpage.

As shown at 1004, various page classification operations may be performed. In at least one embodiment, at least a portion of page classification operations 1004 may be performed by a Hybrid System classifier 256. In at least one embodiment, page classification input may include the parsed page info (including, for example, title, main content block, and meta information). The output may include a list of different topic classes/nodes and their respective relatedness weights/scores (which may be automatically and dynamically computed in real time) to the analyzed page content. (See, e.g., module 209, U.S. patent application Ser. No. 11/732,694 (Attorney Docket No. KABAP011B).

For example, in at least one embodiment, during the page classification processing, the parsed source page information (including, for example, title, main content block, and/or meta information) is analyzed (e.g., at the Hybrid System) and evaluated for its relatedness to each (or selected) of the topics identified in the dynamic taxonomy database (DTD). In at least one embodiment, the output of the page classification processing includes a distribution of topics and associated relatedness scores representing each topic's respective relatedness to the main content block of the source page (as well as other types of parsed source page information (e.g., source page title, meta data, etc.) which may have also been considered during the page classification processing).

For example, in at least one embodiment, page classification processing may include, but is not limited to, one or more of the following types of operations and/or procedures (or combinations thereof):

(a) Using text classification, classify the context of each phrase
i. Break document into paragraphs or sentences
ii. Classify each sentence, paragraph and document to a directory (such as dir.yahoo.com)
   a. Classification based on Hybrid classification technology
   b. Each phrase get votes based on the classification of the context it appeared in
   c. Output—a list of topics based on the document, that may be assigned to the specific phrase.

(b) Update phrase counts with context topics and weights
i. Accumulate all (or selected ones of) the counts from different documents where the phrase appeared, and constantly upgrade the counts for the phrase. For example if the KeyPhrase ‘Jaguar’ appear in an article that was classified as related to ‘Zoo’ the phrase Jaguar gets a count to the ‘Zoo’ category.
ii. Create relationship between long and short phrases, and propagate counts between similar phrases (e.g., Blackberry can contribute some of its counts the longer phrase ‘Blackberry Storm’)

(c) Aggregate counts for each topic across entire corpus
i. Phrases and topics may be saved in a database or file-system
ii. The aggregation process is constantly updating the repository with updated counts.
iii. New phrases that may be detected may be immediately populated or updated in the repository.

According to different embodiments, examples of different types of page classification operations which may be performed may include, but are not limited to, one or more of the following (or combinations thereof):
page-topic classification/scoring
page-phrase classification/scoring
phrase-topic classification/scoring
etc.

For example, in at least one embodiment, classification processing of a selected page (e.g., source page) may include page-topic classification/scoring, wherein the source page is analyzed and classified into a vector of topics. The output may include various topical classes/classifications, each having a respective relatedness score which, for example, may represent the contextual relatedness of that particular topic class to the main content block of the source page (e.g., the webpage which is currently undergoing page classification/phrase extraction analysis). According to different embodiments, at least a portion of the page classification operations described herein may be performed during Phrase Extraction 1006.

Additionally, in at least one embodiment, classification processing of the selected source page may include page-phrase classification/scoring, which, for example, may generate as output, a distribution of each of the words/phrases identified in the analyzed source page, along with a respective score value for each identified word/phrase which, for example, may represent the contextual significance of that word/phrase to do the entirety of the source page.

For example, in at least one embodiment, a respective score value may be calculated for each word/phrase identified in the source document according to: Score(phrase-page)=a*Frequencey+b*Title+c*MCB+d*Bold+e*Link, where:
Frequency=the number of occurrences of that word/phrase in the source page
Title=a value (e.g., 1 or 0) representing whether or not the word/phrase appeared in the page title
MCB=a value (e.g., 1 or 0) representing whether or not the word/phrase appeared in the MCB of the page
Bold=a value (e.g., 1 or 0) representing whether or not the word/phrase appeared in bold formatting
Link=a value (e.g., 1 or 0) representing whether or not the word/phrase appeared as part of a link on the page, and
where the weighted variables a+b+c+d+e=1.

In order to help illustrate the various operations which may be performed during page classification processing, reference is hereby made to FIGS. 96 and 97 of the drawings, which illustrate specific example embodiments of various types of data structures which may be used to represent relationships in and between the dynamic taxonomy database (DTD) and Related Content Corpus.

For example, FIG. 96 shows a specific example embodiment of various types of data structures which may be used to represent various entity types and their respective relationships to other entity types in the Related Content Corpus. For example, as illustrated in the example embodiment of FIG. 96, each of the data structures illustrated in solid lines (e.g., 9602, 9604, 9606) represent entity type nodes which, for example, may be used to represent data such as, for example, pages 9602, phrases 9606, restricted phrases 9604, etc. Each of the data structures illustrated in dashed lines (e.g., 9603, 9605, 9607) may represent relationship-type nodes, which, for example, may represent different respective relationships between each of the entity type nodes. In at least one embodiment, at least a portion of the relationship-type nodes may be implemented using one or more reference tables. A more detailed explanation of the various data structures illustrated in FIG. 96 is provided below, and therefore will not be repeated in the section.

For example, FIG. 97 shows a specific example embodiment of various types of data structures which may be used to represent various entity types and their respective relationships to other entity types in the DTD. For example, as illustrated in the example embodiment of FIG. 97, each of the data structures illustrated in solid lines (e.g., 9702, 9704, 9706) represent entity type nodes which, for example, may be used to represent data such as, for example, phrases 9702, pages 9706, topics 9704, etc. Each of the data structures illustrated in dashed lines (e.g., 9703, 9705, 9707) may represent relationship-type nodes, which, for example, may represent different respective relationships between each of the entity type nodes. In at least one embodiment, at least a portion of the relationship-type nodes may be implemented using one or more reference tables.

For example, referring to the specific embodiment of FIG. 97, each phrase in the DTD may be represented by a unique phrase node 9702 having a unique phrase ID value. Similarly, each topic in the DTD may be represented by a unique topic node 9704 having a unique topic ID value, and each page in the DTD may be represented by a unique page node 9706 having a unique page ID value. The various relationships which exist between each of the phrases, pages, and topics of the DTD may be represented by respectively unique relationship-type nodes (e.g., reference tables), each having a unique ID. Additional details relating to the various data structures illustrated in FIG. 97 are provided below, and therefore will not be repeated in the section.

To help illustrate the various operations which may be performed during at least one embodiment of the page classification processing, the following simplistic example is provided for purposes of explanation with reference to FIG. 97.

In this particular example, it is assumed that the DTD is populated with at least the following information:

| Phrase | |
|---|---|
| ID | Phrase |
| 1 | jaguar |
| 2 | fast car |

| Topics | |
|---|---|
| ID | Name |
| 100 | automotives |
| 200 | animal |
| 300 | computer |

Additionally, in this particular example, it is assumed that the following relationships exist in the various topics and phrases of the DTD:

| agg_phrase_topics | | | |
|---|---|---|---|
| Phrase_ID | Topic_ID | Votes (phrase count) | Score |
| 1 | 100 | 7 | 5 |
| 1 | 200 | 6 | 6 |
| 2 | 100 | 13 | 20 |

Thus, for example, in this particular example, it is assumed that:
the phrase “jaguar” has been found to occur 7 times on pages which have been classified as relating to the “automotive” topic
the phrase “jaguar” has been found to occur 6 times on pages which have been classified as relating to the “animal” topic
the phrase “fast car” has been found to occur 13 times on pages which have been classified as relating to the “automotive” topic.

Additionally, although not illustrated in the tables above, each page which is analyzed by the Hybrid System has associated therewith a respective list of topics which have been identified as being associated with that particular page (e.g., based, at least in part, on the words/phrases which have been identified on that particular page).

In at least one embodiment, each time of the occurrence of a particular phrase is identified, a process at the Hybrid System may automatically update the appropriate reference tables in the DTD corresponding to the page it was seen in, and the topics in which the phrase was seen.

Additionally, for example, during page classification processing each time a new occurrence of the phrase “jaguar” is encountered on a page which has been determined to be associated with the topic “automotive,” the respective count value of the appropriate phrase-topic relationship knows may be updated (e.g., in the example above from count=7 to count=8). In at least one embodiment, every time the phrase ‘jaguar’ is encountered, based on the context it appeared the counts of the correlated topics will be updated. So, for example, if it appeared in an article about cars—the weights for the automotive topic will be updated. Additionally, the score value for that particular phrase-topic relationship may be updated accordingly (e.g., as described previously).

In at least one embodiment, the Hybrid System may be operable to compute a distribution of the relatedness of one or more selected KeyPhrases to each (or selected) topic(s) of the Dynamic Taxonomy Database (DTD). In some embodiments, each KeyPhrase in the corpus has an associated relatedness score based on all (or selected ones of) its occurrences in the past (inside and outside the Hybrid affilited sites). This score may represent the distance between each of the pages the phrase appeared in, and the (human and/or automated) classified pages that represent the specific node. In at least one embodiment, the distance may be computed based on cosine similarity between the specific context, and each of the documents for each of the nodes, and the score may represent an average distance to all (or selected ones of) the document(s) being analyzed by the Hybrid System.

By way of illustration, vectors for a given source page and phrase may be represented, for example, as shown in the example below.

| | Page | Phrase (jaguar) |
|---|---|---|
| Topic | Vector_1 | Vector_2 |
| 100 | 6 | 5 |
| 200 | 2 | 6 |
| 300 | 1 | 0 |

In at least one embodiment, the Related_Score(source,phrase) value for these 2 vectors may be computed according to:

Related_Score(source,phrase)=V1 dot V2/∥V1∥*∥V2|

FIG. 72 shows an illustrative example of output which may be generated from the page classification processing, in accordance with a specific example embodiment. For example, in the specific example embodiment of FIG. 72, an example screenshot is shown which includes page classification output information (7201) which, for example, may represent a distribution of topics (e.g., 7210) and each topic's calculated relatedness score relevant to the MCB of the source page (e.g., the webpage which is currently undergoing page classification/phrase extraction analysis). In at least one embodiment, the distribution of topics may include, for example, all (or selected ones) of the different topics/topic nodes stored at the Related Repository. In at least one embodiment, the Hybrid System may automatically and dynamically calculate, in real time, a respective relatedness score (e.g., 7202b) for each topic node/entry. In at least one embodiment, relatedness scores may be normalized (e.g., to value between 0-1), and may represent the relatedness of the topic-page based, for example, on vector similarity.

In at least one embodiment, the Hybrid System parser component(s) may be operable to perform and/or implement various types of functions, operations, actions, and/or other features such as, for example, one or more of the following (or combinations thereof):
parse document and extract semi structured information and clean plain text
convert HTML to clean plain text (other parsers may be used such as (http://htmlparser.sourceforge.net/)
remove all (or selected ones of) menus, advertisements, and link boxes etc.
generate output which is a pure text of content only, without external noise.
identify and retain semi structured information such as titles, bold elements, meta information.
etc.

FIG. 73 shows an illustrative example of output information/data which may be generated from the Phrase Extraction operation(s) in accordance with a specific example embodiment. As illustrated in the example screenshot 7301 of FIG. 73, the phrase extraction/classification output data may include a list of phrases, which, for example, may include one or more of the webpage keyphrases extracted identified during the phrase extraction processing. In at least one embodiment, the list of phrases 7301 may represent potential KeyPhrase candidates, e.g., for In-Text contextual markup/highlight advertising purposes. Additionally, as illustrated in the example embodiment of FIG. 73, in at least one embodiment, the Hybrid System may automatically and dynamically calculate (e.g., in real time) a respective score value (e.g., 7302b) for each (or selected ones) of the potential KeyPhrase candidates, which, for example, may represent a degree of contextual relatedness of that particular phase to the main content block of the analyzed webpage. In at least one embodiment, the relatedness scores may be used by the Hybrid System to identify and/or select a subset of KeyPhrases for use in subsequent Hybrid contextual/relevancy and markup analysis operations. In at least one embodiment, a respective KeyPhrase relatedness score may be determined for each of the identified KeyPhrases, and subset of KeyPhrases may be selected as KeyPhrase candidates based on relative values of their respective relatedness scores.

For example, as illustrated in the example embodiment of FIG. 73, the phrase ‘BlackBerry Enterprise Server’ (7302) may be identified from the parsed page content as a potential keyphrase candidate, and maybe automatically and dynamically assigned a score value of 0.4 (7203b) which, for example, may represent the degree of contextual relatedness of that particular phase to the main content block of the analyzed webpage.

By way of illustration, vectors and score values for a given source page and phrase may be represented, for example, as shown in the example below.

| | Page 1 | page 2 |
|---|---|---|
| Title | title of a page | title of an ad |
| MCB | this is an example of a page | this is an example of an ad |
| Topics | sports, cars | sports, vacation |

| | Vector 1 | Vector2 |
|---|---|---|
| | Score Page 1 | Score Page 2 |
| Title | 1.5 | 1.5 |
| this | 1 | 1 |
| is | 1 | 1 |
| an | 1 | 3.5 |
| example | 1 | 1 |
| of | 2.5 | 2.5 |
| a | 2.5 | 0 |
| ad | 0 | 2.5 |
| page | 2.5 | 0 |
| sports | 2 | 2 |
| cars | 2 | 0 |
| vacation | 0 | 2 |

As described previously, in at least one embodiment, respective score values may be automatically and dynamically calculated for each of the words or phrases which are identified on each of the respective pages according to:

Score(word-page)=a*Frequencey+b*Title+c*MCB+d*Bold+e*Link

FIG. 74 shows an illustrative example embodiment of output which may be generated, for example, at the Hybrid System during contextual/relevancy analysis/processing of one or more source pages, target pages, ads, etc. In the specific example embodiment of FIG. 74, an example screenshot is shown which includes phrase-topic output information (7401) which, for example, may represent a distribution of the relatedness of a selected phrase (e.g., 7403) to each (or selected) topic/topic nodes (e.g., 7402), as well as each topic's calculated relatedness score (e.g., 7402b) relevant to the currently selected phrase (7403). In at least one embodiment, the distribution of topics/topic nodes may include, for example, all (or selected ones) of the different topics/topic nodes stored at the Related Repository. In at least one embodiment, the Hybrid System may automatically and dynamically calculate, in real time, a respective relatedness score (e.g., 7402b) for each topic node/entry shown in the table of FIG. 74. In at least one embodiment, relatedness scores may be normalized (e.g., to value between 0-1). Additionally, in at least one embodiment, scoring techniques such as those described herein may be may be adaptively applied for computing the respective score values illustrated, for example, in FIG. 74.

In at least one embodiment, multiple different threads of the classification/scoring processes may run concurrently or in parallel, thereby allowing the scores in FIG. 74 to be accumulated over all the processed pages, while a separate process updating the information illustrated in FIG. 73 may concurrently use at least a portion of this data to match a single phrase to a single page.

Returning to the specific example embodiment of FIG. 3A, as shown 1008, one or more Update Phrase Count operation(s) may be initiated or performed. In at least one embodiment, this may be executed as a parallel, asynchronous process which, for example, may be configured or designed to periodically and automatically update the Hybrid Dynamic Taxonomy Database (DTD). In at least one embodiment, the process takes the phrases extracted in 1006, and the classification output of 1004 and updates the counts of the phrase and its topic distribution in the Dynamic Taxonomy Database (e.g., 230a). A separate representation of this process is illustrated, for example, in FIG. 77.

In at least one embodiment, the Update Phrase Count may be operable to automatically, dynamically and/or periodically perform various types of update operations at the DTD, for example, in order to maintain an up-to-date live inventory. For example, in at least one embodiment, the Update Phrase Count may be operable to update counts (and/or other related information) of previously identified and/or newly identified phrases in order to maintain an up-to-date live inventory of all or selected phrases which have been identified and/or discovered from one or more sources such as, for example, all or selected portions of the Internet, selected websites, selected documents, selected ads, etc.

According to different embodiments, one or more different threads or instances of the Update Phrase Count process(s) may be initiated and/or implemented manually, automatically, statically, dynamically, concurrently, and/or combinations thereof. Additionally, different instances and/or embodiments of the Update Phrase Count process(s) may be initiated at one or more different time intervals (e.g., during a specific time interval, at regular periodic intervals, at irregular periodic intervals, upon demand, etc.).

According to specific embodiments:
Each phrase may have a distribution of appearances of taxonomy topics. In at least one embodiment, the aggregation of this distribution (e.g., for a given phrase) may be represented as a data structure that aggregates all (or selected ones of) the topics, and their counts that were selected for each phrase. For example the phrase ‘Jaguar’ may have different numbers of counts in topics such as ‘Zoo’, ‘Safari’, ‘Luxury cars’, ‘Automotive’, etc.
Phrase counts and/or other information relating to each (or selected ones) of the phrases of the DTD may be continuously and/or periodically updated
Phrases that have distribution over many different taxonomy nodes (e.g., general phrases) may be penalized. For example, phrases such as ‘system’ appear in a lot of different topics and may be being penalized because of their uniform distribution
Phrases with distribution over narrow branch(es) (e.g., specific phrases) may be boosted. For example, specific phrases which appear in a narrow section of the taxonomy ‘Apple iPod touch’ may be represented in a narrow section of the DTD taxonomy and as a skewed distribution.
In at least one embodiment, a Hybrid Classifier (e.g., 256) may be operable to classify documents or parts of documents into a directory of documents (such as, for example, http://dir.yahoo.com/). In at least one embodiment, input to the Hybrid Classifier may include, for example, clean (e.g., unformatted, plain) text broken into parts (e.g., sentences, paragraphs, etc). In at least one embodiment, output from the Hybrid Classifier may include, for example, a list of topics that best fit the specific part of the document being analyzed.
In at least one embodiment, at least a portion of the DTD update operations may be performed by a Hybrid Phrase Evaluator, which, may be configured or designed to assign, to a given or selected phrase, one or more different topic(s) (e.g., based on the contextual occurrences of that phrase in different documents/pages), and/or may further aggregate the different phrase counts associated with the selected phrase across the entire Related Repository or portions thereof (such as, for example, Related Content Corpus 230b). In at least one embodiment, input to the Hybrid Phrase Evaluator may include one or more list(s) of phrases and their contextual classification(s). In at least one embodiment, output and/or response(s) from the Hybrid Phrase Evaluator may include the automatic updating of the Hybrid Phrase Repository (e.g., which, for example, may be stored at the Dynamic Taxonomy Database (DTD)), as described herein.

Returning to the specific example embodiment of FIG. 3A, as shown at 1008a, one or more Update Related Repository operation(s) may be performed. Examples of different types of Update Related Repository operation(s) may include, but are not limited to, one or more of the following (or combinations thereof):
Update Index
Update Related Content Corpus
Etc.

In at least one embodiment, this may be executed as a parallel, asynchronous process which, for example, may be configured or designed to periodically and automatically update one or more portions of the Hybrid Related Repository (such as, for example, Related Content Corpus 230b). A separate representation of this process is illustrated, for example, in FIG. 80.

FIG. 80 shows a example block representation of an Update Related Repository process in accordance with a specific embodiment.

In at least one embodiment, the Update Related Repository process (1008a) may be operable to cause various types of information, such as, for example, parsed text (e.g., generated at 1000), topic/classification information (e.g., generated at 1004), phrases (e.g., generated at 1006) to be indexed into the Related Repository (e.g., Related Content Corpus). In at least one embodiment, at least a portion of the information/data stored at the Related Content Corpus may serve as (and/or may be used to identify) potential targets for other source pages which may subsequently be analyzed at the Hybrid System.

In one embodiment, in case the page is only a target page, the processing ends in this phase.

According to different embodiments, one or more different threads or instances of the Update Related Repository process(s) may be initiated and/or implemented manually, automatically, statically, dynamically, concurrently, and/or combinations thereof. Additionally, different instances and/or embodiments of the Update Related Repository process(s) may be initiated at one or more different time intervals (e.g., during a specific time interval, at regular periodic intervals, at irregular periodic intervals, upon demand, etc.).

Returning to the specific example embodiment of FIG. 3A, as shown 1008, one or more Update Phrase Count operation(s) may be initiated or performed. In at least one embodiment, this may be executed as a parallel, asynchronous process which, for example, may be configured or designed to periodically and automatically update the Hybrid Dynamic Taxonomy Database (DTD). In at least one embodiment, the process takes the phrases extracted in 1006, and the classification output of 1004 and updates the counts of the phrase and its topic distribution in the Dynamic Taxonomy Database (e.g., 230a). A separate representation of this process is illustrated, for example, in FIG. 77.

Updated Index

FIG. 81 shows a example block representation of an Update Index process in accordance with a specific embodiment.

When a page is index, the attributes may be indexed separately and may be searched either combined or separately (for example the index can retrieve all (or selected ones of) documents with a title containing the word ‘BlackBerry’ or all (or selected ones of) documents that have ‘BlackBerry’ in the title or text or topics or phrases.

Update Inventory

FIG. 79 shows a example block representation of an Update Inventory process in accordance with a specific embodiment.

In at least one embodiment, the Update Inventory process may be implemented as a batch or maintenance job that runs in the background every few hours. It goes through the inventory and removes entries that may be stale, recalculating the relations between entities and updating the repository.

As illustrated in the example embodiment of FIG. 79, the Update Inventory process may be operable to:
Remove Existing—A page may be removed because of various reasons such as, for example, one or more of the following (or combinations thereof):
   1. the page is stale,
   2. other pages that pointed from or to it have changed.
In at least one embodiment, the process works in the background and remove from the inventory pages that need to be refreshed. After they may be removed, they may be inserted to the job queue in order to be recalculated like new pages.
Recalculate—In this phrase the page goes through the process described in 950.
Update Repository—In at least one embodiment, processing of Target page types relating to 991 (Related content) and 992 (Ads) stops after execution of operational block 1008/1008a.

FIG. 76 shows a example block diagram visually illustrating an example technique of how words of a selected document may be processed for phrase extraction and classification. A brief description of at least some of the various objects represented in the specific example embodiment of FIG. 76 is provided below.
Word, POS 7608—Word and its part-of-speech (noun, verb, adjective etc).
Phrase 7606—a sequence of words with in a document.
Context 7604—a chunk of text (usually sentence, paragraph or the entire document) surrounding a specific phrase
Document 7602—the clean text and semi-structured information extracted from the HTML.
Text Classifier 256—classifies textual information into a directory or taxonomy. In at least one embodiment, the classification may be based on Machine learning classification techniques such as, for example, Naïve Bayes (http://en.wikipedia.org/wiki/Naive Bayesian classification), SVM (http://en.wikipedia.org/wiki/Support vector machine), and/or or based on information retrieval techniques (such as TF-IDF http://en.wikipedia.org/wiki/Tf-idf)
Phrase Extractor 255—extract phrases from a text document as described above.
Phrase Evaluator 7622—may receive as input the list of phrases and their locations within the document, and the topics for each piece of context, and updates the HybridPhrase Repository with the counts and weights of topics that were assigned for each phrase.

FIG. 88 shows an illustrative example how the various parsing, extraction, and/or classification techniques described herein may be applied to the process of extracting and classifying phrases from an example webpage 8801.

For example, as illustrated in the example embodiment of FIG. 88, it is assumed for purposes of this example that the phrase ‘Indigo naturalis’ is a novel term that has not been previously identified by Hybrid System.

Using the phrase extraction techniques described herein, the Hybrid System may extract the various phrases of the webpage 8801, and may classify the context of each occurrence of the ‘Indigo naturalis’ phrase to being related to the topics of ‘Skin Disease”, “Chinese Medicine” and “Medical Condition”. The Dynamic Taxonomy Database (and/or Related Content Corpus) may then be updated/populated with this new information, and the appropriate phrase-topic, page-topic, phase-page relationships created/updated.

In this particular example, it is assumed that the phrases ‘chronic skin disease’ and ‘traditional Chinese Medicine’ are known terms (e.g., to the Hybrid System). Accordingly, the Hybrid System may extract these phrases, and update their respective counts in the repository with the new topics extracted from the specific context.

In at least one embodiment, when advertiser subsequently bids on a KeyPhrase such as ‘Chinese Medicine’, the Hybrid System is able to automatically and dynamically identify and suggest related terms like ‘Traditional Chinese Medicine’ and ‘Indigo naturalis’, depending on an analysis of the advertiser's needs (which, for example, may be based, at least in part, on crawling and classifying at least a portion of the advertiser's website).

### Hybrid-Based Ad Bidding Process

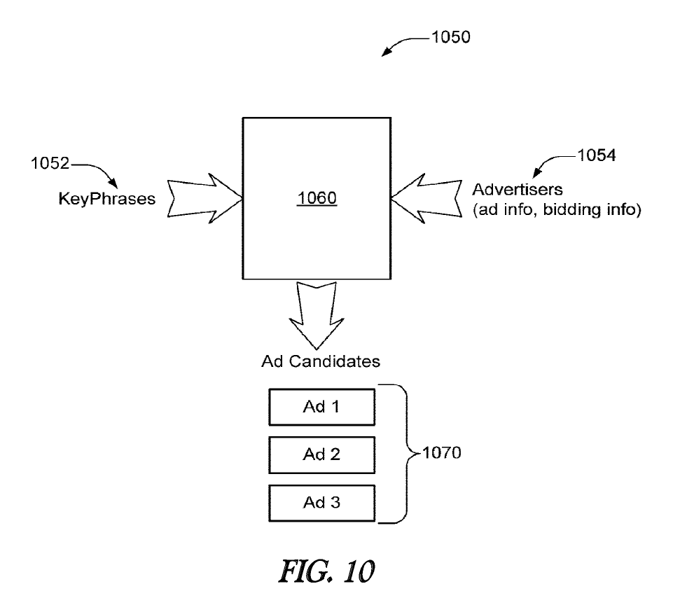

FIG. 10 shows an example procedural flow of a Hybrid-Based Ad Bidding Process 1050 in accordance with a specific embodiment.

As illustrated in the example embodiment of FIG. 10, at least a portion of the Hybrid ad selection (or ad matching) process may be performed by Ad Matching component 1060 using various types of input data such as, for example: source page keyphrase and page topic information (1052) and ad campaign information (1054). In at least one embodiment, at least a portion of the functionality performed by the ad matching component 1060 may be implemented, for example, using the Hybrid Inverted Index functionality, as described herein. As illustrated in the example embodiment of FIG. 10, the output 1070 of the Ad Matching component may include a plurality of potential ad candidates, each of which may be subsequently evaluated and scored for relevancy and markup/layout analysis. In at least one embodiment, each ad candidate may have associated there with their respective set of ad data such as, for example, one or more of the following (or combinations thereof): Landing URL, Title of Ad, Description of Ad, Graphics/Rich Media, CPC data (e.g., price bidder willing to pay), etc.

### Hybrid Inverted Index and Query Index Functionality

In information technology, an inverted index (also referred to as postings file or inverted file) is an index data structure storing a mapping from content, such as words or numbers, to its locations in a database file, or in a document or a set of documents, in this case allowing full text search. The inverted file may be the database file itself, rather than its index. The Hybrid inverted Index indexes the Related Repository of Hybrid, and enables a quick retrieval of related information, related videos and related ads based, for example, on their titles, topics, text (MCB) and phrases.

FIGS. 86A-B show illustrative example embodiments of features relating to the Query Index functionality.

For example, as illustrated in the example embodiment of FIG. 86A, the index may be queried with the source page. Each element has different weights. For example if the phrase in the origin page, appears in the title of the destination page, the relevancy score is boosted. The final relevancy score is the distance between the source page and the target page. Different boosts may be given to the matches in the title, topics or phrases. The closer the match, the higher the score, which ranges between 0-1.

In at least one embodiment, the index component(s) include a process that maps documents to inverted index. The index includes different attribute that were extracted from the original document, including title, text, meta information, categories, phrases etc. each or all (or selected ones of) of these attributes may be searched efficiently. The novel approach is by indexing all (or selected ones of) the additional information (phrases, topics) in order to be able to retrieve information that is not part of the original text.

Additional features and descriptions of the Query Index functionality and its applications are further described below by way of example with reference to FIG. 3A and FIG. 78.

For example, returning to the specific example embodiment of FIG. 3A, as shown at 1009, one or more Query Index operation(s) may be initiated or performed.

In at least one embodiment, the Query Index may be configured or designed to identify and retrieve potential relevant ads candidates (1010), potential related content candidates (1011), potential related video candidates (1012), other types of DOL element(s), etc. For example, in one embodiment, using the Query Index functionality, the extracted text, phrases and topics (which, for example, were extracted in operations 1000-1006 of FIG. 3A) may be queried against the related repository which is indexed using an inverted index (see appendix).

In at least one embodiment, potential content may be identified and selected as appropriate candidates based, at least in part, on publisher preferences (e.g. ad-only, related-only, related-video, channel preferences, or any combination of the above). In at least one embodiment, the query to the index may be based on one or more of the following (or combinations thereof):

a. Title of source page

b. Content of source page

c. Topics of source page

d. Phrases of source page

The output may include a list of potential targets (e.g., Related Ad Elements, Related Content Elements, etc.) based on their respective indexing and/or scoring properties. In at least one embodiment, each of the target entities may have associated therewith a respective relevancy score (e.g., VEC_SCORE(entity,page)) that reflects its relatedness to the source page.

In at least one embodiment, the VEC_SCORE(entity,page) value for each related entity may be calculated using a vector scoring technique such as, for example cosine similarity, Jaccard index, etc. For example, in one embodiment, the VEC_SCORE(entity,page) value may be calculated according to:

VEC_Score(entity,page)=V1 dot V2/∥V1∥*∥V2|

In at least one embodiment, VEC_SCORE(entity,page) value may be represented as number ranging between 0 to 1, which may be used to represent a similarity between the vectors, e.g., where 1 is identical vectors.

In a similar manner, other types of VEC_Scores may be calculated, as needed, depending upon the different types of entities/information being evaluated and compared. Examples of other such types of VEC_Scores may include, but are not limited to, one or more of the following (or combinations thereof):
Related_source_ad_score—the relevancy of the source to an Ad=vec_score(source, ad) (source represents title, content, topics, phrases)
Related_source_info_score—the relevancy of the source to related information=vec_score(source, related_info)
Related_source_video_score—the relevancy of the source to a related video=vec_score(source, related_video)

In at least one embodiment, the Publisher may define different thresholds for each Ad/related element type such as, for example, one or more of the following (or combinations thereof):
Ads
Video
Audio
Related information
Related content
Related articles
Related links
Images
Animation
External feeds
etc.

The retrieval from the index bring all (or selected ones of) the results that pass different threshold values for ads, videos and information. The thresh values may be between 0-1. The default threshold example is 0.25.

As shown at 1013, one or more Identify/Score Phrases operations may be performed. (See FIG. 3D)—Selecting the actual phrases to be highlighted, by taking the phrases that maximize relevancy and yield to the source and target pages. The score for each triplet of: source, target and phrase is calculated using the following:

Final_Score(phrase, source, target)=α*Total_Quality+βTotal_ERV (1)

[Where: α+β=1]

TotalQuality(source,target,phrase)=α*Total_Related(source,target,phrase)+β*Quality(target)

### [Where: α+β=1]

$$Total\_Related ( source , target , phrase ) = {α}^{*} Related\_Score ( source , target ) + {β}^{*} Related\_Score ( source , phrase ) + {χ}^{*} Related\_Score ( phrase , target ) \\ [ Where \text{:} α + β + χ = 1 ]$$

Quality(target)=Quality(target) (e.g., either the quality of the Advertiser, or the Quality of the related information website.)

Total_ERV(source, target, phrase)=CTR(source,phrase,target)*(Value(target))^{φ}
CTR(source,phrase,target)=Estimated Click Through Rate based on historical data as described in the EMV techniques (see, e.g., U.S. patent application Ser. No. 11/732,694 (Attorney Docket No. KABAP011B))
Value(target)=Value assigned to the target which may be the CPC (in case of Ad), ECPM(effective CPM—how much adveritzer is willing to pay for 1000 impressions, e.g., in case of related video, related page, or other graphical content), or a manual value assigned by the publisher or by Hybrid System, to reflect the preference of publisher to the specific content type
φ represents relative strength (weighting factor) (range 0-5, default: φ=1)

In at least one embodiment, for any given URL, source remains the same.

### Example of TotalQuality Scoring for Ads:

For purposes of illustration and explanation, the brief description of the ad matching process will now be provided by way of example with reference to the example embodiment of FIG. 78.

FIG. 78 shows an example of several advertisements and their associated scores and/or other criteria which may be used during the ad selection or ad matching process. In the example screenshot of FIG. 78, the Total Quality of two candidate target advertisements (e.g., for a specifically identified source page) is displayed. Each Ad has associated therewith a respective vector of topics representing it (e.g., output of the 1004 for the Ad+Ad Landing URL).

The TotalQuality score is calculated (as discussed above) according to:

TotalQuality(source,target,phrase)=α*Total_Related+β*Quality [Where: α+β=1]

In at least one embodiment, the calculation of the Total_Related Score (7203b) may be determined according to:

$$Total\_Related = {α}^{*} Related\_Score ( source , target ) + {β}^{*} Related\_Score ( source , phrase ) + {χ}^{*} Related\_Score ( phrase , target )$$

[Where: α+β+χ=1]

Output of 1013 is Final Score for each source-phrase-target combination (according to Final_Score(phrase, source, target), as discussed above)

E.g.: Separate Final Scores calculated for:
source-phrase1-target1
source-phrase1-target2
source-phrase2-target1
source-phrase2-target2

### Final Score Calculation Example:

Assume a source page has 2 potential key-phrases, 3 related text and 3 potential ads (as follows):
phrase1, phrase2
related1, related2, related3
ad1, ad2, ad3
   FinalScores may be calculated as follows:
final_score(src1,phrase1,related1)=f(s1,p1,r1)=0.6
final_score(src1,phrase1,related2)=f(s1,p1,r2)=0.4
final_score(src1,phrase1,related3)=f(s1,p1,r3)=0.5
final_score(src1,phrase1,ad1)=f(s1,p1,a1)=0.45
final_score(src1,phrase1,ad2)=f(s1,p1,a2)=0.2
final_score(src1,phrase1,ad3)=f(s1,p1,a3)=0.4
final_score(src1,phrase2, related1)=f(s1,p2,r1)=0.4
final_score(src1,phrase2, related2)=f(s1,p2,r2)=0.6
final_score(src1,phrase2, related3)=f(s1,p2,r3)=0.4
final_score(src1,phrase2, ad1)=f(s1,p2,a1)=0.3
final_score(src1,phrase2, ad2)=f(s1,p2,a2)=0.5
final_score(src1,phrase2, ad3)=f(s1,p2,a3)=0.5

### Keyphrase Scoring, DOL Element Selection, Layout Selection

Returning to the specific example embodiment of FIG. 3A, as shown at operational blocks 1013-1015, various operation(s) may be initiated or performed which relate to keyphrase selection/scoring (e.g., for highlighting/markup purposes), DOL element selection, and Layout selection. FIGS. 3D-3F illustrate example procedural details relating to keyphrase scoring, DOL element selection, layout selection, in accordance with a specific embodiment.

For example, as shown at 1013 of FIG. 3A, one or more keyphrase scoring operations may be performed. In at least one embodiment, at least a portion of the keyphrase scoring operations may include execution of one or more Keyphrase Scoring Procedures such as that illustrated in FIG. 3D.

### KeyPhrase Scoring (FIG. 3D)

352—iterate over all (or selected ones of) the potential KeyPhrases on page
354—for each potential KeyPhrase, calculate Final Score for each phrase-source-target combination based on Final Score formula described at 1013 (above)

Note: Value(target) may be determined based on one or more of the following (or combinations thereof):
Publisher Layer Preferences (pre-defined):
Source channel preferences
Target (e.g., landing URL) Channel preferences
Types of elements to be displayed in DOL
Quantity of elements to be displayed in DOL
Day/Date preferences
Click behaviours (e.g., see Demo) for opening/displaying/closing/expanding DOL
size/location of DOL on screen
Amount of time DOL is displayed

Color/Look and Feel/Visual appearance of DOL and DOL elements

In at least some embodiments, when computing final score for Ads, EMV may be used instead of ERV. In one embodiment, both EMV and ERV may be calculated according to: CTR*Value.

As shown at 1014 one or more DOL Element Selection operations may be performed. (See FIG. 3E)—Based on the scores of phrases and targets (from 1013), potential sources, and publisher preferences, the response for each DOL is generated by maximizing the Final_Score of the items in the layer (treating each item as independent, and aggregating Final_Score, to achieve the maximum score for each layer).

By selecting source-phrase-target combinations with relatively highest score values, multiple different possible DOL Presentation candidates may be generated at output of 1014 which represent the preferred/recommended DOL Presentation candidates for each phrase/target combination, along with Final DOL Presentation Scores (e.g., calculated by summing/aggegrating final score values according to:

Max(g)=αΣf(related_info)+βΣf(related_video)+χΣf(related_ad) (2)
Where α, β, χ may be configured by publisher preference.

E.g.: Separate DOL Presentation Scores for:
source-phrase1-target1 DOL Presentation
source-phrase1-target2 DOL Presentation
source-phrase2-target1 DOL Presentation
source-phrase2-target2 DOL Presentation

In at least one embodiment, at least a portion of the DOL Element Selection operations may include execution of one or more DOL Element Selection Procedures such as that illustrated in FIG. 3E.

### DOL Element Selection (FIG. 3E)

For each scored KeyPhrase from 354 iterate over all (or selected ones of) potential target DOL elements (e.g., related content, pages, videos etc).
362—Select potential KeyPhase for DOL element selection
364—Identify potential DOL element(s) for selected KeyPhrase. In at least one embodiment, possible Target DOL elements may include, but are not limited to, one or more of the following (or combinations thereof):
   Ads
   Video
   Audio
   Related information
   Related content
   Related articles
   Related links
   Images
   Animation
   External feeds
   etc.
366—For each selected target DOL element, calculate Final Score for each phrase-source-target combination based on Final Score formula described at 1013 (FIG. 3A)
368—Determine potential DOL configurations where each DOL configurations includes different combination(s) of DOL elements; Calculate score for each/selected DOL configuration based on combination of DOL Element(s) of each particular DOL configuration. In one embodiment, the score for each DOL configuration is equal to the sum of the final scores of the DOL elements of that DOL configuration.
369—Select desired DOL configuration (for selected KP) and corresponding DOL element(s) using DOL score values.

### DOL Layout Selection Example

For purposes of illustration in this specific example, assume Publisher preference was to show 1 phrase on page, with two related and two ads in each layer. Publisher puts higher emphasis on revenue, so the ad part has weight of 2 while related part as weight of 1 (β=2, α=1_).

In at least one embodiment, a desired goal would be to maximize:

g=1*Σf(s1,p,r_{—}i)+2*Σf(s1,p,a_{—}j) (i=1,2 j=1,2)

Accordingly, in this example, the Hybrid System may perform the following calculations:

max g(p1,2related,2ads)=g(s,p1,r1,r3,a1,a3)=1(0.6+0.5)+2(0.45+0.4)=2.8

max g(p2,2related,2ads)=g(s,p2,r1,r2,a2,a3)=1(0.4+0.6)+2(0.5+0.5)=3.0

In at least one embodiment, the actual highlight will mark phrase2, with related1, related2, ad2, ad3 in the layer in order to maximize score, and publisher preferences.

As shown at 1015 one or more Source Page Layout operations may be performed. (See FIG. 3F)—Based on the final score of each phrase, layer select which phrases will be updated. For example if there are 3 potential phrases, each has a layer with different score, and publisher preference is to highlight 2 phrases, then layout output will be the best 2 phrases (and their layers from 1014), which, for example may be implemented using the Layout/Layer techniques described in U.S. patent application Ser. No. 11/732,694 (Attorney Docket No. KABAP011B).

In at least one embodiment, at least a portion of the Source Page Layout operations may include execution of one or more Source Page Layout Selection Procedures such as that illustrated in FIG. 3F.

### Source Page Layout (KeyPhrase Markup) Selection (FIG. 3F)

(Iterate over each of the KeyPhrase-DOL configuration combinations mentioned in 1013-1014)
372—Identify potential KeyPhrase-DOL configuration combinations
374—Determine KP-DOL score for each (or selected ones of) KP-DOL combinations
376—Determine publisher Source Page Layout preferences
378—Select phrases for KeyPhrase markup/highlight on source page using (1) Publisher Source Page Layout preferences and (2) KP-DOL score values.

For example, assume that publisher's source page preferences allows two KP highlights (on source page), and that 3 potential phrases KP1, KP2, KP3 have been identified on source page, with corresponding/respective KP-DOL scores of KP1-DOL1=1.6; KP2-DOL2=1.7; and KP3-DOL3=2.4.

In addition, assume publisher's source page preferences also specify that there should be at least 20 words spacing between the highlighted phrases (e.g., min distance (btwn highlighted KPs>=20 words), and assume that distance(KP2, KP3)=15 words.

In at least one embodiment, Layout should preferably be selected between highlighting KP1,KP2 or KP1,KP3. In order to maximize overall page score, the layout algorithm will select KP1,KP3 (1.6_{—}+2.4) instead of KP1,KP2 (1.6+1.7). In this example, the other option of KP2,KP3 (1.7+2.4) is assumed not valid because of publisher's business rules/preferences of minimum distance of 20 words.

In at least one embodiment, Publisher LAYOUT Preferences may include various types of preferences and/or criteria which a publisher may specify relating to highlight/markup of KPs on source page associated with that publisher. Examples of different Publisher LAYOUT Preferences may include, but are not limited to, one or more of the following (or combinations thereof):
number of KPs to be highlighted
minimum distance between highlight (e.g., characters, words, distance)
page highlight density (e.g., up to 1% of page highlighted)
paragraph highlight density
KeyPhrase restrictions
sensitivity restrictions; (e.g., words not suitable for children)
minimum CPC restrictions
etc.

In one embodiment, Publisher may provide template for DOL layout (e.g., relating relative placement of DOL elements in DOL). In another embodiment, Hybrid System can dynamically evaluate and determine the best DOL layout for maximizing Final Score for DOL layout. In at least one embodiment, selection of DOL layout may be based, at least in part, upon criteria such as, for example, Publisher ID, Channel ID, Publisher preferences, Ad type, Advertiser preferences, etc.

### EXAMPLE PROCEDURAL DETAILS RELATING TO KEYPHRASE SCORING, DOL ELEMENT SELECTION, LAYOUT SELECTION

In at least one embodiment, during the process of Layout selection, the Hybrid System may analyze the scores of each Source, Phrase, Target and generate the Final Score which is described, for example, at 1009 of FIG. 3A. Once the final scored is calculated for each triplet, the final DOL layout may be selected based, at least in part, on the publisher's specified Layout Preferences.

FIG. 29 shows an embodiment of a portion of an example screenshot which may be used for illustrating at least a portion of procedural details relating to keyphrase scoring, DOL element selection, and/or DOL layout selection.

For purposes of illustration, it is assumed in this particular example that the publisher's DOL preferences specify preference for selection of: related information+related video+Ad.

Accordingly, in the example embodiment of FIG. 29, it is assumed that the phrase ‘Beauty Routine’ was selected for markup based, at least in part, upon the Final_Score results generated, for example, at 1013 (e.g., FIG. 3A).

Additionally, it is assumed in the example embodiment of FIG. 29 that the other DOL elements which were finally selected for display at DOL layer 2902 were selected based, at least in part, using the output/results of processes 1010, 1011, 1012 in a way that maximizes the E Final_Score of all (or selected ones of) the targets within the DOL layer 2902. In at least one embodiment, one way of expressing this may be:

$$\sum Final\_Score ( DOL 2902 target elements = Final\_score \_related \_ 1 + Final\_score \_related \_ 2 + Final\_score \_related \_video \_ 1 + Final\_score \_related \_video \_ 2 + Final\_score \_related \_ad$$

### EXAMPLE EMBODIMENTS RELATING TO AD SELECTION/RELATED CONTENT SELECTION

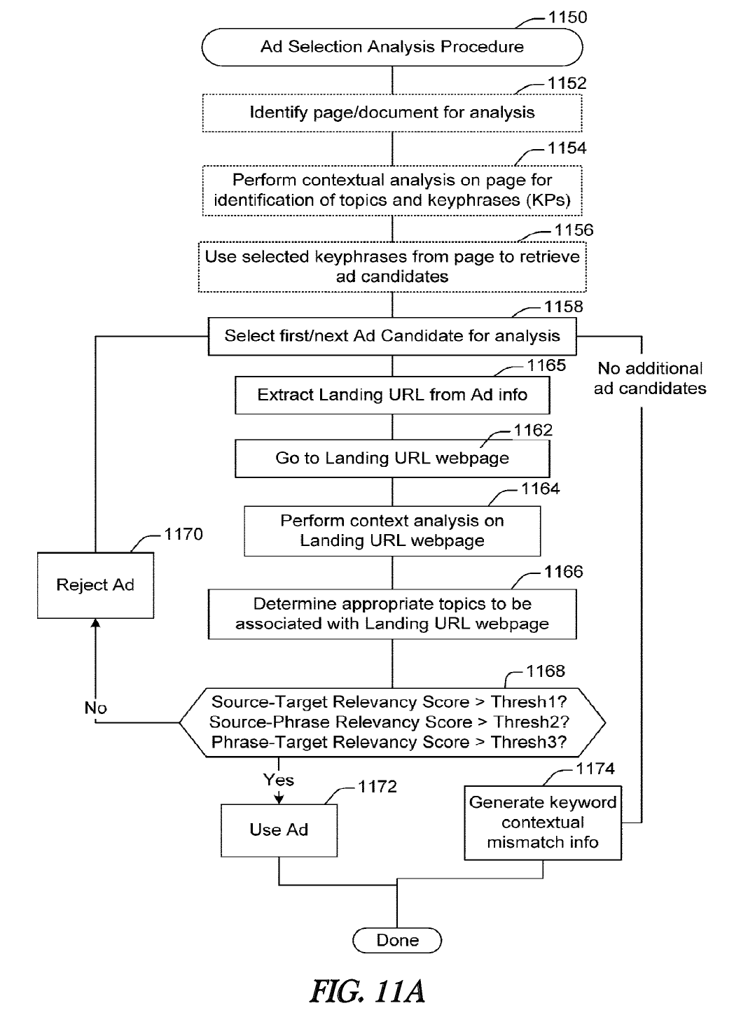

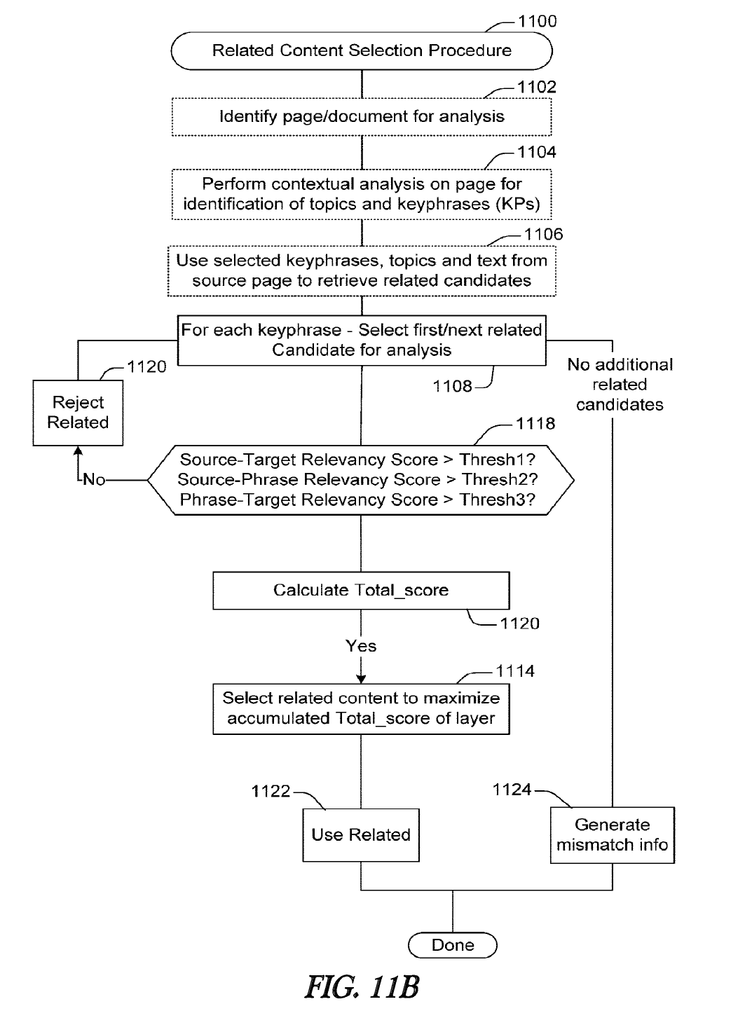

FIG. 11A illustrates an example flow diagram of an Ad Selection Analysis Procedure 1150 in accordance with a specific embodiment.

FIG. 16A shows an example of a Hybrid Ad Selection Process 1600 in accordance with a specific embodiment (described in greater detail below).

FIG. 11B illustrates an example flow diagram of a Related Content Selection Analysis Procedure 1100 in accordance with a specific embodiment.

FIG. 16B shows an example of a Hybrid Related Content Selection Process 1650 in accordance with a specific embodiment (described in greater detail below).

A brief description of at least some of the various operations represented in the specific example embodiment of the Ad Selection Analysis Procedure 1150 of FIG. 11A is provided below.
1152—Identify page/document for analysis
1154—Perform contextual analysis on page for identification of topics and keyphrases (KPs)
1156—Use selected keyphrases from page to retrieve ad candidates
1158—Select first/next Ad Candidate for analysis
1165—Extract Landing URL from Ad info
1162—Go to Landing URL webpage
1164—Perform context analysis on Landing URL webpage
1166—Determine appropriate topics to be associated with Landing URL webpage
1168—Determine whether:
   Source-Target Relevancy Score>Thresh1?
   Source-Phrase Relevancy Score>Thresh2?
   Phrase-Target Relevancy Score>Thresh3?
1170—Reject Ad
1172—Use Ad
1174—Generate keyword contextual mismatch info

A brief description of at least some of the various operations represented in the specific example embodiment of the Related Content Selection Analysis Procedure 1100 of FIG. 11B is provided below.
1100—Java script tag initiates the process of highlighting key-phrases and finding layers with related content.
1102—URL for analysis is fetched in the server and analysis process begins
1104—analysis extracts key-phrases from document, and classifies it.
1106—the information from 1104 is used to query index of related information and retrieve similar documents based on the cosine_similarity to the topics, phrases, title and text of the source document
1108—iterate over all (or selected ones of) the results and find the best phrase and targets combination to maximize final score.
1118—for each source, phrase, target combination assert that relevancy threshold is above a pre-defined thresh (configurable by publisher, default is 0.2 for entire system).
1112—if above all (or selected ones of) thresholds calculate the best match given a source page, a key-phrase, and the available related pages.
1114—select the combination that maximizes final score
1122—select the top X maximizing key-phrases based on layout and publisher preferences.
1124—if not enough related target pages, do not highlight phrase.

### Example Embodiments of EMV, ERV, and Layout Analysis Processes

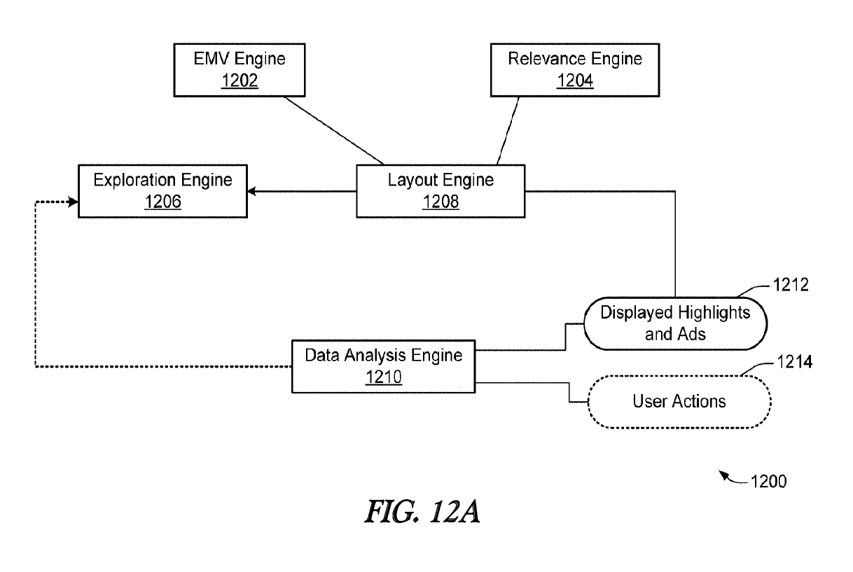

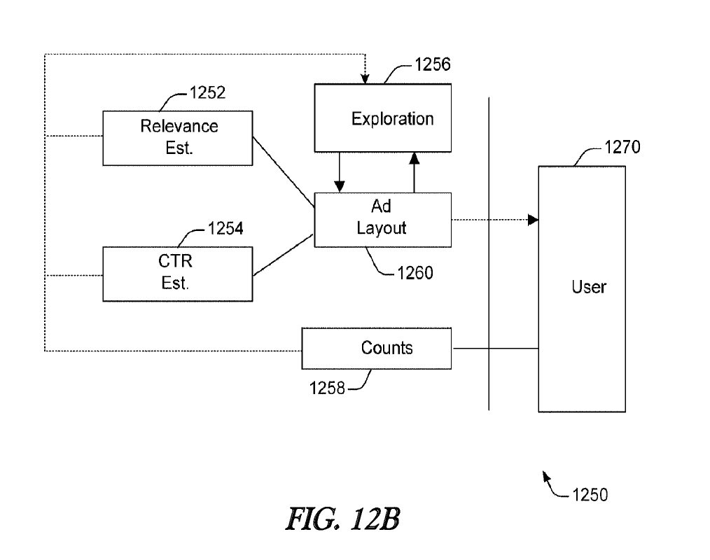

FIGS. 12A-14 generally relate to various aspects of EMV, ERV, and Layout analysis processes.

FIG. 12A shows a block diagram of a portion of a Hybrid Server System 1200 in accordance with a specific embodiment. At least a portion of the functionality of each of the displayed components of the Hybrid Server System portion 1200 is described below. It will be noted, however, other embodiments of the Hybrid Server System may include different functionality than that described with respect to FIG. 12A.

According to specific embodiments, the EMV Engine (e.g., 1202) may include various types of functionality which, for example, may include, but are not limited to, one or more of the following features (or combination thereof):
generating estimates of various parameters, such as, for example, the Expected Monitory Value for specified Page, Highlight, and/or ad combinations;
providing analysis and/or tracking operations;
learning user behaviours for facilitating increased accuracy of estimates such as, for example, EMV estimates;
generating back-off estimates;
providing Logistic Regression operations;
etc.

According to specific embodiments, the Relevance Engine (e.g., 1204) may include various types of functionality which, for example, may include, but are not limited to, one or more of the following features (or combination thereof):
identifying and/or selecting ads that are relevant to the content of a selected page;
providing analysis operations;
generating ad and/or page classifier data;
generating ad relevancy scores;
etc.

According to specific embodiments, the Layout Engine (e.g., 1208) may include various types of functionality which, for example, may include, but are not limited to, one or more of the following features (or combination thereof):
identifying and/or selecting highlights (e.g., keyphrase highlights) to be displayed;
generating ad rankings;
providing reaction operations;
etc.

According to specific embodiments, the Exploration Engine (e.g., 1206) may include various types of functionality which, for example, may include, but are not limited to, one or more of the following features (or combination thereof):
exploring ads that may yield better values (e.g., better revenues) than current ads;
interacting with layout engine, for example, to understand and/or to identify highlight candidates for further exploration;
providing tracking and/or reaction functionality;
etc.

According to specific embodiments, the Data Analysis Engine (e.g., 1210) may include various types of functionality which, for example, may include, but are not limited to, one or more of the following features (or combination thereof):
collecting and/or analyzing user behaviour information;
tracking ad impression information;
etc.

FIG. 12B shows a high level architecture of a specific embodiment of an on-line contextual advertising system in accordance with a specific embodiment. At illustrated, one component of the Hybrid System includes an ad Layout Module (1260), which selects a set of highlight/ad pairs to display on each page. To make this decision, the ad Layout Module may utilize estimates of the relevance of the ad to the page, as well as its expected monetary value. In one embodiment, these estimates may come from the ad Relevance Estimation (1252) and/or CTR Estimation (1254) modules.

According to a specific embodiment, Click-through rate (CTR) estimation refers to the statistical estimation of the probability that a user will click on a certain ad in a certain context. Once the page has been displayed, and the user action recorded, this information may be added to the current counts of impressions, clicks (and/or possibly mouseover events) maintained by the Counts Module (1258), and used by the CTR Estimation Module and/or other desired modules to make estimates.

Additionally, an Exploration Module (1256) makes decisions about which ads are worth exploring, and sends these recommendations to the Ad Layout Module 1260, so that the exploration ads can be included in the layout. Additionally, to make this decision, the Exploration Module may need to obtain information about which ads are already being displayed, and what kind of change in the estimates of an ad would be required in order to make the ad worth including in the layout. In one embodiment, at least a portion of this information may be provided by the Ad Layout Module.

According to a specific embodiment, the CTR estimation system may be operable to generate real-time CTR estimates or predictions based on historical data relating to the live or on-line system, which may be continually and dynamically changing.

However, because system development experiments based upon live system data would not be repeatable, in at least one embodiment, it is proposed to “freeze” some data sets as a snapshot of the Hybrid System at a particular point in time for the development systems to run on and/or be tested. This technique may also be useful for the training procedures that may be required by some parts of the Hybrid System.

According to specific embodiments, each data set may include counts of the number of impressions and number of clicks of particular page/highlight/ad combinations over a specified period of time. For example, in one embodiment, three such data sets are used, which, for example, may include: a training set, a held-out set, and a test set. In one embodiment, it may be preferable that these sets be drawn from temporally contiguous time periods. For example, if the training set is created from counts over the period January to March, then the held-out set should preferably include the month of April, and the test set should preferably include the month of May. In another embodiment may be preferable that the data sets do not overlap temporally. This is explained, for example, in greater detail below with respect to the EM training feature(s). In at least one embodiment, the time period of the training set should preferably be long enough to include significant numbers of impressions for each combination (e.g., more than a day). However, the held-out and test sets may be significantly smaller. In one embodiment, the data sets may include statistics about as many page/highlight/ad combinations as possible. For example, if feasible given computing and storage constraints, it may be desirable to use all impressions detected in the Hybrid System over a specified time period.

Using the training, held-out, and test sets, one is then able to perform rigorous, quantitative evaluations of the complete CTR estimation system. For example, in one embodiment, one or more of the models may be trained, for example, using the training and held-out sets, and subsequently used to predict the click stream that is observed in the test set. This mirrors the process that may occur when the CTR estimation model is integrated into the production system, and so will serve as a good measure of its performance.

Estimation Overview and Examples

Consider an ad a served at a highlight h of a keyphrase k on a page p. We would like estimate the probability P(c=1|a, h, p) that this ad will be clicked (c=1) by the user during the next page display. There are several sources of information for this task. The basic source is the local counts of the number of impressions (e.g., how many times this ad was displayed on this exact highlight of a keyphrase on this exact page) and of those ad impressions, how many times it was clicked. Given enough counts of the particular page/highlight/ad combination, we will eventually have a good idea of its empirical CTR, which, for example, may be computed according to:

$$\hat{P} ( c = 1 \vert p , h , a ) = \frac{\# ( c = 1 , p , h , a )}{\# ( p , h , a )}$$

However, if the total number of impressions of this particular page/highlight/ad combination is too small, this is likely to be an inaccurate, or noisy estimate of the true CTR. For example, if the CTR is less than 0.1%, we are not likely to see any clicks in the first 100 impressions, which would make the CTR estimate zero. For this reason, it may be preferable to use evidence from similar events to provide estimates. We will call such estimates back-off estimates, since they are constructed from “backing off” from the most specific counts to counts in more general classes.

In any particular case, it may be desirable to combine the local counts with one or more back-off estimates in such a way that a system according to example embodiments may use the back-off estimate(s) when the local counts are low, and uses the local counts increasingly as they become larger. A natural way to do this is to use the back-off estimate(s) as a prior distribution which may be updated by the empirical counts. This may result in desired behavior such that, as the empirical counts grow larger, they eventually overwhelm the prior. In particular, we can use the back-off model to form a Dirichlet prior so that the maximum a posteriori (MAP) estimate of the distribution takes the following form:

$${\hat{P}}_{CTR} ( c = 1 \vert p , h , a ) = \frac{\# ( c = 1 , p , h , a ) + β {P}_{BO} ( c = 1 \vert p , h , a )}{\# ( p , h , a ) + β}$$

In one embodiment, the above expression may be used to calculate an estimate of CTR. The parameter corresponds to a free parameter which may be determined and/or tuned either manually or automatically. If is too large then the CTR model will not be impacted by the presence of the empirical counts, even if those counts are large enough to provide reliable estimates of the CTR. If is too small, then even small (noisy) amounts of counts will lead to changes in the estimated CTR. Since most actual CTRs in the Hybrid System are less than 0.001, one might suggest that a good value for would be at least 1000.

According to a specific embodiment, it is preferable that the back-off estimate(s) be computed based on a mixture of different empirical estimates, each made from the counts of a particular abstracted comparison classes. For example, possible back-off estimates include but are not limited to the following:
\hat{P}(c=1|t(p),h,a), which represents the probability of a click occurring given the specific topical class of the specific web page, specific highlight, and specific ad;
\hat{P}(c=1|s(p),h,a), which represents the probability of a click occurring given the specific website, specific highlight, and specific ad;
\hat{P}(c=1|p,k(h)), which represents the probability of a click occurring given the specific web page, and specific keyphrase;
\hat{P}(c=1|p,a), which represents the probability of a click occurring given the specific web page, and specific ad;
\hat{P}(c=1|k,a), which represents the probability of a click occurring given the specific keyphrase, and specific ad;
\hat{P}(c=1|a), which represents the probability of a click occurring given the specific ad;
\hat{P}(c=1|k(h)), which represents the probability of a click occurring given the specific keyphrase;
\hat{P}(c=1|t(p)=t(a)), which represents the probability of a click occurring given that the topical class of the specific web page matches the topical class of the specific ad;
\hat{P}(c=1), which represents the probability of a click occurring for all topical classes, web pages, highlights, keyphrases, etc;

where:

t(p) is the topical class of the page p;

s(p) is the website that p is a part of;

k(h) is the keyphrase occurring at highlight h.

In one embodiment, the last estimate may represent the Hybrid System-wide ad CTR, which may include no specific information about the page, keyphrase, or ad.

According to a specific embodiment, the mixture weights may be learned on temporally contiguous held-out data using an Expectation-Maximization (EM) algorithm. An example of the form of the linear interpolated back-off estimate is:

$${P}_{BO} ( c \vert p , h , a ) = {\sum }_{i}^{ } {α}_{i} {P}_{i} ( c \vert {Evidence}_{i} ) \qquad ( 1 )$$

where ᵢare respective positive weights summing to one, and each Pᵢ(c|Evidenceᵢ) is a particular back-off class or back-off estimate such as, for example, one of those described above. According to a specific embodiment, each ᵢmay be statically or dynamically calculated for a given Evidenceᵢ.

According to a specific embodiment, the Expectation-Maximization (EM) algorithm can be used to learn the weights ᵢabove. One first initializes these weights to 1/B where B is the number of comparison classes being mixed together. Using these preliminary weights, one iterates through each held-out record (p, k, a, c) and calculates the posterior distribution over which mixture generated each record, according to:

$$P ( i \vert p , k , a , c ) = \frac{{P}_{i} ( c \vert p , k , a )}{{\sum }_{j}^{ } {P}_{j} ( c \vert p , k , a )}$$

The new mixing weights are the normalized sum of these posteriors:

$${α}_{i} ∝ {\sum }_{( p , k , a , c )}^{ } P ( i \vert p , k , a , c )$$

According to a specific embodiment, the indicates that the ᵢmay be renormalized to sum to one. This process of calculating posteriors and updating weights is iterated until convergence.

According to at least one embodiment, it is preferable that the held-out set be temporally distinct from the training set, since, for example, if we tried to learn these parameters from the training set, the most specific comparison classes would receive all the weight, and little generalization would occur.

Another valuable source of information in CTR estimation is whether or not the user put his mouse over a particular highlight on the page. This event is typically referred to as a mouseover. The intuition here is that the decision to mouse over a link is conditioned only on the highlighted keyphrase, and is not affected by the contents of the ad, since, according to at least some embodiments, the ad was not visible at the time of the decision or mouseover action. Also, the CTR estimates of the ad are likely to be much higher if they are conditioned on the mouseover since presumably, most highlights are never moused over.

Incorporating this information properly, it may be preferable to include a small change to one or more of the model(s) proposed above. For example, if we use (m=1) to represent the mouseover event, then we can factor the probability distribution as:

$$P ( c = 1 \vert p , h , a ) = {\sum }_{m}^{ } P ( c = 1 \vert p , h , a , m ) \cdot P ( m \vert p , h ) = P ( c = 1 \vert p , h , a , m = 1 ) \cdot P ( m = 1 \vert p , h ) \qquad ( 2 )$$

The first line stems from introducing the variable m and conditioning on it, and the second line is created by dropping the term in the sum for m=0 because the probability of a click is 0 if the mouseover doesn't happen.

Thus, for example, we see that the probability of a click on a particular highlight is the probability of a mouseover times the probability of a click given a mouseover. So we have two quantities to estimate now, instead of one. According to a specific embodiment, each can be estimated using at least one of the models described herein such as, for example, by using a combination of local counts and a back-off mixture model. In one embodiment, such models may be combined using maximum a posteriori (MAP) estimation with a parameter giving the strength of the prior that can be tuned either manually or automatically, and each of the back-off mixtures has weights that can be learned (e.g., separately) by EM, for example.

Although there are now two quantities to estimate, there is reason to believe that we have actually made our problem easier. For example, the mouseover probability conditions only on the page and the highlight, but not on the ad. To estimate this quantity we may use counts from fewer categories, and each category is likely to contain more counts. Additionally, the click probability conditions on the fact that there was a mouseover, and is likely to be a larger probability, thus requiring few counts overall to estimate properly.

According to specific embodiments, the back-off model may be used to generate accurate and/or efficient estimates, but may not allow for the exploitation of more general features of keyphrases and advertisements, such as, for example, whether the keyphrase is capitalized, whether the ad text ends in an exclamation point, whether the keyphrase occurs in the page title, and so on.

Logistic Regression

Accordingly, in at least one embodiment, a more sophisticated approach may be to utilize a feature-driven logistic regression model. In this approach, general features alone may be used to predict the CTR. Examples of such general features may include, but are not limited to, one or more of the following (or combination thereof):
whether the keyphrase is capitalized;
whether the ad text ends in an exclamation point;
whether the keyphrase occurs in the page title;
length of ad
length of keyphrase;
length of page;
position on page;
structure of page;
other ads on page;
type of ad;
html elements;
whether keyphrase is bold;
font of ad;
etc.

According to a specific embodiment, it may also be preferable for a feature of the logistic regression model to include a log-probability of one or more back-off estimate(s), which, for example, were derived using one of the back-off estimate models described above. In this way, the other features are then able to provide multiplicative correction to the base count-driven estimates. For example, one embodiment of a logistic regression model may be expressed as:

P(c=1|p,h,a)≈LR_{f(i)}[EMᵢ+λᵢFeaturesᵢ] (3)

where LR_{f(i)} represents a logistic regression function, EM, represents one or more EM-based estimates (which may include one or more back-off estimates), Featuresᵢ represents one or more general features (such as those described above) and ᵢrepresents a respective weighted value for each Featuresᵢ parameter.

According to a specific embodiment, the task as we have defined it is one of regression, not classification. In one embodiment, the model and training procedure may be substantially similar to the logistic regression model used for classification. For this reason, it may be possible to use an existing logistic regression classifier, such as one provided in classification software packages such as, for example, Rubryx (available from www.sowsoft.com/rubryx/about.htm).

It will be appreciated that another aspect of at least some of the various technique(s) described herein relates to the use, in the field of on-line contextual advertising, of EM parameters and/or back-off estimate parameters as features in logistic regression computations for improving CTR estimation.

According to specific embodiments, a variety of different architectures may be used for implementing logistic regression techniques in accordance with various embodiments. For example, according to one exemplary architecture, one can learn a logistic model for each comparison class in the back-off lattice and mix those models. In another exemplary architecture, one can wrap a single logistic model around the interpolated lattice. It is anticipated that the patterns of which ads and keyphrases are most popular will change over time. There is therefore a tension between wanting as many observations as possible, and wanting those observations to be as recent (and therefore relevant) as possible. One effective and tunable way to trade off these extremes is to discount counts with age. A simple way to do this is with an exponential decay of counts, perhaps in time steps of days, weeks, or other specified time periods. A rapid rate of decay may be used to maximize relevance, whereas a slow rate of decay may be used to maximize available evidence. An alternative solution would be to use only a fixed number w of the most recent impressions in building estimates.

Relevance Estimation

According to at least one embodiment, at least some of the various technique(s) described herein relating to relevance estimation (RE) addresses the issue of estimating the relevance of a prospective keyphrase/ad pair to a particular page. In at least one embodiment, the term relevance may refer to an informal notion of the relatedness between the text on the source page and the text in the keyphrase, ad, and/or the ad's target page. We may wish to assess relative relevance (e.g., so that we might be able to rank possible keyphrase/ad pairs for their relatedness) and/or to assess absolute relevance (e.g., so that we could filter out ads which are deemed too irrelevant).

In designing a relevance estimation system, it may be preferable to develop a general way of measuring the performance (e.g., accuracy) of a relevance system.

One way to assess textual relatedness of two documents is to convert each of the documents to a featural representation, and then to compare these representations quantitatively. Typically the featural representations are vectors of real numbers, which can be compared using various metrics.

One featural representation of a text document is the vector of word (token) counts contained in the document, where the vectors for different documents are indexed by the same list word types. There are a few tricks, however, to building featural representations which capture similarity well. For example, it is often useful to remove extremely common words, often called stopwords, from the representation completely. Lists of stopwords are usually built by hand but are very easy to come by on the Internet. A more sophisticated approach is to weight different features differently. Instead of token counts, another approach is to use the TFIDF (term frequency, inverse document frequency) measure, which discounts terms that are common to many documents:

$$tf = \frac{c ( t , d )}{c ( ; d )}$$

$$idf = \frac{\vert D \vert}{\vert \{ d \text{:} c ( t , d ) > 0 \} \vert}$$

$$tfidt = tf log idf$$

Additional features that could be added to the representation include counts of bigrams (contiguous pairs of tokens), counts of word shapes (capturing capitalization, etc.), web page formatting and layout information, and/or other global features of the document, such as length, title, etc.

One metric for comparing vectors is the dot product. This has a desirable property that when the vectors are perpendicular (unrelated) the dot product is Φ, and when they are parallel the dot product is maximized (it is the geometric mean of the lengths of the vectors). When it is properly normalized, the dot product is equal to the cosine of the angle between the vectors, which is D when the vectors are perpendicular, and Φ when they are parallel.

$$cos ( Φ ) = \frac{x \cdot y}{\vert x \vert \vert y \vert}$$

In at least some embodiments, it can be useful to work with both the cosine and the unnormalized dot product. For example, while the latter is sensitive to the length of the vectors (the number of words in the documents), the former can behave strangely with short documents.

While it is often convenient to think of documents as just vectors of feature counts, this conception often doesn't work well at capturing similarity. In particular, small differences in word counts near zero can have a large impact on similarity (whether a particular word was mentioned at all, for example), but in a dot product the differences near zero are treated identically to those that are far from zero.

One way to address this phenomenon is to view the vectors instead as probability distributions over the words generated by the documents. According to a specific embodiment, when viewed this way, a more appropriate way to measure the relatedness of two documents may be to compute the Kullback-Leibler (KL) divergence between their associated probability distributions:

$$KL ( p \vert \vert q ) = {\sum }_{x}^{ } p ( x ) log \frac{p ( x )}{q ( x )}$$

KL-divergence can be thought of as a measure of the difference between the entropy of a distribution p, and the cross entropy of p and q. Informally, it measures the relative “cost” that would be incurred if we were to try to use the distribution q to represent the distribution p, instead of using p itself.

Although the use of KL-divergence may be desirable in some circumstances, other circumstances may make its use undesirable. For example, when q assigns zero probability to an event (e.g., Event X) which p assigns positive probability to, the KL divergence goes to infinity.

Statistical Classifiers

Instead of directly computing the similarity between two text documents, an ontology of document classes (e.g., either learned or hand-coded) could be used to assign each document a class, and see whether or not the two documents belong to the same class. More generally, one could compute for each document a distribution over the classes that the document could belong to, and compare the class distributions of two documents to measure their similarity.

One advantage of the class-based approach is that it can be used to give absolute assessments of relevance. An example of one way to do this is via a rule which says that documents are relevant if they are assigned to the same class. A different approach would be to compare the class distributions computed for each document using one or more similarity metrics (such as those described previously, for example), and consider the documents to be relevant if the score is above a predetermined threshold.

Statistical classifiers are tools that have been designed specifically for the purpose of assigning class labels to a document, and/or (for some classification methods) computing distributions over possible classes for a document. Such classifiers can be learned directly from training data, and in many cases can make very accurate decisions.

According to a specific embodiment, it may be preferable to use a Naive Bayes statistical classifiers model, since it is high bias and robust to noisy real-world data. However, it would still be good to experiment also with either multiclass logistic regression (also called a maximum entropy or log-linear model), with quadratic priors for normalization, and/or with multiclass support vector machine (SVM) models.

According to a specific embodiment, one way to classify a document into a set of topic classes is to use a multiclass classifier in which each topic is a class. This method is appropriate if we expect each document to have a single topic class. If, instead, each document may be labeled with a variable number of relevant topics, then it may be more effective to instead build a separate binary classifier for each topic; this may be referred to as one vs. all classification. This approach allows zero, one, or multiple topics to be detected on a single document.

Latent Semantic Measures

One drawback of the class-based approach is that it may require the use of a supervised (e.g., manually edited) training set of examples to train a statistical classifier that can be used to assign class labels. In some cases, unsupervised techniques such as latent semantic analysis (LSA) can also work well, without the need for manually edited examples. LSA is an application of matrix factorization techniques, in which the matrix in question is indexed by documents and terms, and the elements contain a representation of the magnitude of the occurrence of a particular word in a document. Many LSA variants exist, including the LSA technique based on the Principal Components Analysis (PCA) algorithm from linear algebra, as well as Probabilistic Latent Semantic Indexing (pLSI), the Latent Dirichlet Allocation (LDA), and Non-negative Matrix Factorization techniques. They vary in both efficiency and solution quality.

In one embodiment, the LDA approach is recommended because it has a firm probabilistic foundation. Another advantage of using a system like LDA to assign topics to pages is that it is designed to allow each document to draw words from several topics.

Ad Layout

According to specific embodiments, one objective of an ad selection and layout system is to select a subset of the possible keyphrases and ads to display on a particular page and then to lay them out in a way that maximizes both readability and expected monetary value. To accomplish this, it is helpful to formalize the notion of a “good” layout as a scoring function, and then search over the space of possible layouts, to find the one with the highest score.

In designing a scoring function, it is also helpful to define and/or clarify various factors which contribute to “good” layouts and “bad” layouts. For example, in one embodiment, it is preferable that the score of a layout be based (at least partially) on a function of the average quality of the keyphrases and ads that it may include. In addition, the scoring function should preferably incorporate other features of the layout, such as the average distance between adjacent keyphrases, etc.

For page p and highlighted keyphrase h, and let k(h) be the keyphrase type of highlight h. Let a* be a vector of ads indexed by keyphrases appearing on the page, such that a*ₖ is the best ad aεA available for keyphrase k (this is easily precomputed). Then a layout l⊂Hₚ may include a subset of the keyphrase highlights possible for the page p, using this notation, we propose the following general scoring function:

$$s ( 𝓁 , p , {a}^{*} ) = {\sum }_{h ∈ 𝓁}^{ } f ( p , h , {a}_{k ( h )}^{*} ) + {\sum }_{i = 0}^{\vert 𝓁 \vert} g ( d ( {h}_{i} , {h}_{i + 1} ) )$$

Note that f(p, h, a) is the score given to a particular page/highlight/ad combination, d(hᵢ, hᵢ+1) is the distance between adjacent highlights hᵢ and hᵢ+1, and g is a function mapping integer distances (e.g., between adjacent highlights on the page) to real numbers.

According to a specific embodiment, when computing the page/highlight/ad scoring function f, it is preferable that the score incorporate both a relevance score as well as an expected monetary value (EMV) estimate. The relevance score can be taken directly from the relevance estimation module, and the EMV score can be computed from the CTR estimate and the cost per click (CPC) of the ad to be displayed:

EMV(p,h,a)=P_{CTR}(c=1|p,h,a)·CPC(a)

In many cases, the relevance and EMV scores may be aligned, but in other cases it may be necessary to sacrifice one to improve the other, and vice-versa. According to specific embodiments, a variety of different techniques may be used to combine them into a single score. Examples of at least some of such techniques are provided below:
Additively, such as, for example:

f(p,h,a)=αEMV(p,h,a)+βRel(p,k(h),a)
Multiplicatively, such as, for example:

f(p,h,a)=(EMV(p,h,a))^{α}(Rel(p,k(h),a))^{β}
Using Thresholds, such as, for example:

f(p,h,a)=1{EMV(p,h,a)>t}·Rel(p,k(h),a)

f(p,h,a)=EMV(p,h,a)·1{Rel(p,k(h),a)>t}

In the above examples, EMV represents the expected monetary value, and Rel represents the relevance score. The additive and multiplicative options are similar, differing mostly in their behavior near zero. While an additive combination will simply average the two scores, a multiplicative combination will set the score to zero if either the EMV or the relevance score is zero. In at least one embodiment, the multiplicative combination may be preferable, since, for example, it will remove highlights which have a low EMV or low relevance.

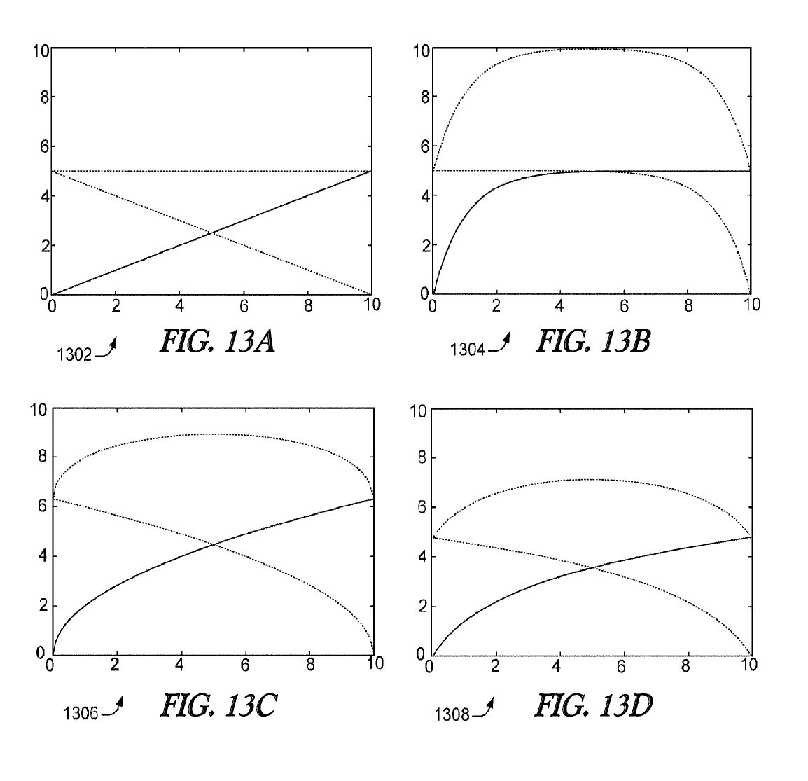

A distance scoring function g may also be used to favor adjacent pairs of highlights that are sufficiently distant from each other. A simple way to do this would be with a linear penalty function which gives a linearly higher score to pairs that are far apart. Unfortunately, a function of this form would not penalize unevenly spaced highlights, as shown, for example, in FIGS. 13A-D.

FIGS. 13A-D depict graphical representations illustrating various behaviors associated with different types of distance scoring functions. For example, FIG. 13A graphically illustrates various behaviors which may be associated with a specific embodiment of a linear scoring function. FIG. 13B graphically illustrates various behaviors which may be associated with a specific embodiment of a negative exponential decay scoring function. FIG. 13C graphically illustrates various behaviors which may be associated with a specific embodiment of a square root scoring function. FIG. 13D graphically illustrates various behaviors which may be associated with a specific embodiment of a logarithmic scoring function. The examples shown in FIGS. 13A-D are intended to illustrate the computation of distance scores for different possible locations of a new highlight (e.g., ContentLink) to be inserted between the two existing highlights located, for example, at 0 and 10, respectively.

According to a specific embodiment, if a sublinear function were used, such as the negative exponential given by:

g(x)=k(1−e^{-x})

the result may be that highlights that are adjacent have a minimum score of 0, and as they spread out (e.g., in distance from each other), their relative score approaches a maximum score of k, as shown, for example, in FIGS. 13A-D.

Yet a third alternative would be a function such as the square root function:

g(x)=k\sqrt{x}

which has a minimum score but no maximum score. That is, the further apart the highlights are, the better.

A fourth alternative would be a shifted log function which continues to grow, but does so very slowly. An example of such a shifted log function is given by:

g(x)=log(x+1)

The space of possible layouts is large: 2^{|Hp|} where Hₚ is the set of possible highlights on a page p. For this reason, the approach of enumerating all possible layouts, scoring them, and returning the highest scoring layout is undesirable. While in principle it may be desirable to search over all combinations of ads on all possible highlights of the page, we can improve efficiency somewhat by searching only over the subsets highlights. For example, various predefined filtering or selection criteria may be used to generate a subset of potential ads and/or highlights for analysis. According to a specific embodiment, for each highlight, we can independently select the best ad to show on that highlight. This removes redundant computation, and makes the search space smaller

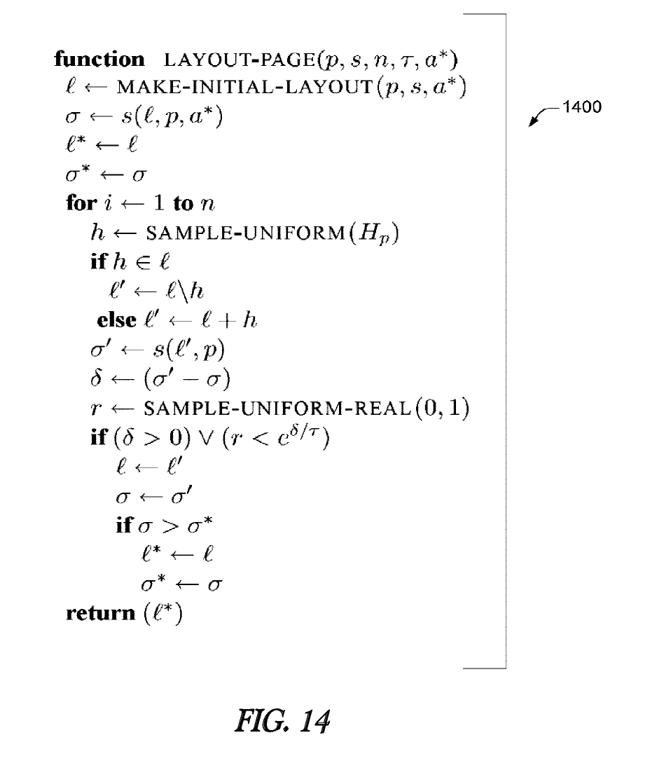

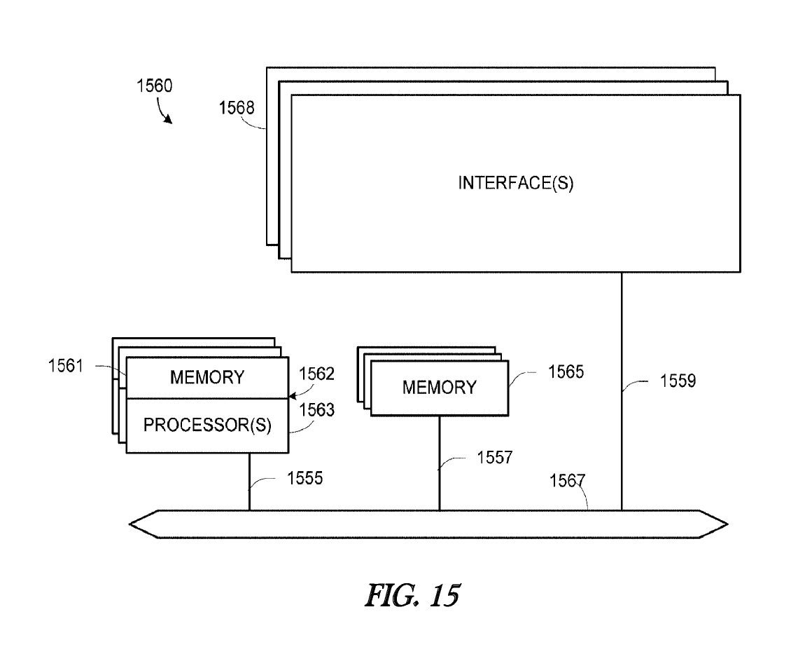

Alternatively, an approximate procedure may be used for finding “good” or “desirable” layouts. For example, according to one embodiment, a stochastic local search algorithm may be used which is based loosely on the well-known simulated annealing approach. Such an algorithm may include the steps of: sampling a new layout, scoring it, and then deciding whether to accept or reject the new layout. Additionally, in at least some embodiments, such an algorithm may be implemented in real-time using dynamic and/or automated processes. New layouts which are determined to be better than the current layout are always accepted. However, at least some new layouts that are determined to be worse than the current layout may be accepted with a small probability which depends on how “bad” they are. The algorithm may also keep track of the best layout seen overall, and returns that, if desired. An example of pseudocode for such a proposed algorithm is illustrated in FIG. 14.

FIG. 14 shows an example of a portion of pseudocode 1400 representing a page layout algorithm which, for example, may be used a for implementing a specific embodiment of a stochastic local search algorithm that may be utilized at the Layout Engine. As shown in example of FIG. 14, variable and/or other parameters relating to the page layout algorithm may include, for example: a page p, a scoring function s giving a real-valued score for each layout lε2^{Hp} and page pεP, the number of iterations n, a temperature 0<τ, and for each highlight h, the best ad a*ₖ₍ₕ₎ available on the keyphrase of that highlight. When the temperature τ is large, the Hybrid System will be very willing to try low scoring layouts, and as τ approaches zero, the Hybrid System will be unwilling to try layouts that score less than its current layout. A popular variant of this algorithm is to start it with a high value of τ, and slowly decrease τ so that it is close to zero when the algorithm finishes.

According to specific embodiments, relative to the exploration phase (as described, for example, in greater detail below), one may view the Layout Module as implementing at least a portion of the exploitation phase, whereby the ad selection system exploits the current estimates of ad “goodness”, showing the ads it knows are most likely to be successful. In one embodiment, it is preferable for the layout system to interact with the exploitation system in various ways.

For example, one interaction with the exploration system stems from the fact that the Layout Module may need to incorporate some of the lower scoring exploration highlights in the layouts that it selects. Accordingly, in one embodiment, it is preferable that the Layout Module have a parameter x for the maximum number of exploration highlight/ad pairs to include in each layout. The Layout Module may then ask the exploration system for the x highlight/ad pairs that are most valuable to explore.

Once the Layout Module has this set of exploration highlights, there are several ways that the layout system could incorporate them into the final layout. For example, if the number of exploration highlights is very low (e.g., 1), then the layout system could just add them to the good highlights in the existing layout, possibly removing neighboring highlights if they are too close. A more sophisticated way of including them would be to force its inclusion in the layout, and rerun the layout search.

Another interaction with the exploration system stems from the need of the exploration system to assess which ads to explore. To compute the value of information, the exploration system may need to query the exploitation system about the current status of particular highlight/ads. It may need to know whether the ad is currently being shown, and also whether some projected history of counts (e.g., typically a sequence of clicks) would lead the Layout Module to change whether it is including the highlight in the currently layout.

Exploration

In the presence of perfect knowledge of CTRs, one could calculate relevance and layout values, and select ads as described above. However, in many cases at least some of the CTR estimates may be wrong. For example, consider an ad on a new keyphrase. We will have only very general grounds on which to predict the CTR, perhaps resulting in a low estimate and the keyphrase not being selected. If, on the other hand, the CTR is actually high, we will not discover this without trying the keyphrase out. This is an instance of the general tradeoff between exploitation, when we act in the way our estimates suggest, and exploration, when we act in a way which appears suboptimal for the sake of improving our estimates. This concept has been studied in the field of reinforcement learning.

There are again several schemes for incorporating some exploration into the ad selection process. For example, in one embodiment, it is recommended for all (or selected) exploration schemes setting aside a small fixed fraction of the ads on each page (such as, for example, 5-10%) for exploration. In other embodiments, this value may be higher or lower, depending upon desired characteristics. In any event, the amount of exploration may be tuned to reflect contextual ad service provider's (or an individual publisher's) tolerance for early error in exchange for eventual improvement.

One exploration scheme might choose ads for exploration uniformly at random from the ads that are not currently being shown on the page. This strategy would work reasonably well and be simple to implement. It would also provide an opportunity to test the utility of an exploration system. It may be very useful to test empirically whether by doing exploration the Hybrid System ever discovers new keyphrase/ad pairs for a page that have high EMV but which were not being discovered using just the existing CTR and Relevance estimates in the exploitation model.

According to specific embodiments, when an exploratory highlight/ad is to be displayed, it may be desirable to choose the ad that maximizes the value of the information that it will provide when we learn whether a user chose to click on it. Intuitively, the display of an ad can provide more valuable information if little is known about it and it has high CPC value. In contrast, there is little value in exploring ads that are known to be “good”, and thus are currently being shown by the exploitation model, and similarly for ads that are known to be “bad”.

In one embodiment, the value of information may be defined as the difference between the expected value of the actions we'd take with and without seeing the exact value of some variable. As applied to the on-line contextual advertising environment, the information we're valuing is whether or not the user clicks on the particular ad the next time (or several times) that it is displayed. The action that this information could influence is whether we choose to show the highlight/ad pair on this page in the future.

For purposes of illustration, let S be the set of possible click streams we could observe over the next n displays if we should choose to explore the highlight/ad pair, and e be our current estimate of the value of the highlight/ad pair. Also let D={0, 1} represent our decision about whether to display the highlight or not in the future. Then the value of the “perfect” information we get from exploring the highlight/ad pair can be written as:

$$VPI ( S ) = [ {\sum }_{s ∈ S}^{ } P ( s ) EU ( D \vert s ) ] - EU ( D )$$

where s is the possible click stream, EU(D) is the Utility function of the decision to present certain set of highlights, EU(D|s) is the Utility of a certain set of highlights given a click on s, P(s) is the estimated probability of click (s), and EU(D) is the utility given set of highlights. Using this formula, for example, we can decide whether it is worthwhile exploring and/or exploiting selected data.

### Example Interaction Diagrams of Hybrid Process

In one embodiment, operations at 12a/12b and 14a/14b of FIGS. 3B/3C may be implemented as a result of processing tag information.

FIGS. 3B, 3C, 3G, 3H, 3I, 3J, 3K, 3L, 3M illustrate different example embodiments of flow diagrams showing various types of information flows and processes which may be implemented or initiated at one or more systems for facilitating one or more of the hybrid contextual advertising techniques described herein.

For clarification purposes, in order to avoid any confusion which may arise due to similarities between visually similar letters and digits, FIGS. 3I, 3J, 3L, 3O, and 3Q are not represented in the Figures of this application.

In the example embodiment of FIG. 3B, it is assumed that the Hybrid System provides all (or selected portions) of DOL data (73b) to client system (e.g., at time of providing hyperlink markup data to client)

In the example embodiment of FIG. 3C, it is assumed that the Hybrid System dynamically generates and provides all (or selected portions) of DOL data (82c) to client system (e.g., in response to detecting cursor click/hover event over portion of marked-up content at client system)

As illustrated in the example embodiment of FIG. 3G, the Hybrid System 304 provides (2) tag information (e.g., which may include includes the publisher ID as well as other scripted instructions) to the publisher server (PUB) 306. In at least one implementation, the publisher may utilize the tag information to generate one or more tags to be inserted or embedded (4) into one or more of the publisher's web pages, as desired by the publisher.

In at least one embodiment, each embedded tag may include information relating to the publisher ID, and/or may also include other information such as, for example, one or more of the following (or combinations thereof):
information relating to one or more preferred or desired add types to be displayed on that particular webpage;
publisher channel ID information;
publisher preferences relating to preferred or permitted DOL elements to be displayed on that particular webpage;
publisher preferences relating to preferred or permitted markup of identified keyphrases or keyphrases on that particular webpage;
other types of information relating to the publishers preferences, requirements and/or restrictions with respect to:
   the markup or highlighting of keyphrases on a particular webpage;
   the types of advertising to be displayed in connection with that particular webpage;
   the types of related content to be displayed in connection with that particular webpage;
   the types of DOL elements to be displayed in connection with that particular webpage;
   etc.
etc.

In one embodiment, dynamic content tags may be inserted or embedded as different distinct tags into each of the selected web pages. Alternatively, the tag information may be inserted into the page via a tag that is already embedded in each of the desired pages such as, for example, and ad server tag or an application server tag. In at least one embodiment, once present on the page, the tag may be served as part of the page that is served from the publisher's web server(s). In at least some embodiments, the tag on the publisher's page may include instructions for enabling the Hybrid-related tag information to be dynamically served (e.g., by 3rd party server) to client system.

As illustrated in the example embodiment of FIG. 3G, it is assumed at (6g) that a user at the client system 302 has initiated a URL request to view a particular web page such as, for example, www.yahoo.com. Such a request may be initiated, for example, via the Internet using an Internet browser application at the client system.

In at least one embodiment, when the URL request is received at the publisher server 306, the server responds by transmitting or serving (8g) web page content, including the tag information, to the client system 302.

As shown at (10g), the client system processes the tag information. In at least one embodiment, at least a portion of the received tag information may be processed by the client system's web browser application.

In at least one embodiment, the processing of the tag information at the client system may cause the client system to automatically and dynamically parse (10g) the received web page content and/or to generate one or more chunks of plain text based upon the parsed content. In at least one embodiment, the parsing of web page or document content may include, but is not limited to, one or more of the following (or combinations thereof):
Identifying main content block of a target document
Extracting semi structured information and clean plain text
Converting HTML to clean plain text
Removing all (or selected) menus, advertisements, and link boxes etc.
Generating clean text output of content only, without external noise, while retaining semi structured information such as, for example, titles, bold elements, meta information, etc.
Performing chunking operations for generating chunks of clean text output which may then be provided to the Hybrid System for further contextual search analysis and processing.

In at least one embodiment, at least a portion of the parsing operations performed at the client system may be implemented by a Parser component (such as, for example, 251c, FIG. 2c). In at least one embodiment, the tag information which is processed at the client system may include executable instructions (e.g., via a scripting language such as, for example, Javascript, ActiveX, etc.) which, when executed, causes the client system to automatically and dynamically parse (10g) the received web page content and/or to generate one or more chunks of plain text based upon the parsed content.

In at least one embodiment, the processing of the tag information at the client system may also cause the client system to automatically generate (12g) a unique SourcePage ID for the received web page content, and to transmit (14g) the SourcePage ID (along with other desired information) to the Hybrid System 304. Examples of other types of information which may be sent to the Hybrid System (e.g., at 14g) may include, but are not limited to, one or more of the following (or combinations thereof):
Publisher ID information;
Web page URL;
Channel ID information;
Chunk(s) of parsed content (e.g., first chunk of parsed content)
etc.

In at least one embodiment, a SourcePage ID represents a unique identifier for a specific web page, and may be generated based upon text, structure and/or other content of that web page. In at least one embodiment, the first chunk of parsed web page content may be used as the SourcePage ID. In at least one embodiment, the SourcePage ID may be based solely upon selected portions of the web page content for that particular page, and without regard to the identity of the user, identity of the client system, or identity of the publisher. However, in at least some embodiments, the SourcePage ID may be used to uniquely identify the content associated with specific personalized web pages, customized web pages, and/or dynamically generated web pages, which, for example, may be specifically customized by the publisher based on the user's identity and/or preferences.

Upon receiving the SourcePage ID information (as well as other related information, if desired), the Hybrid System uses the SourcePage ID information to determine (16g) whether there exists current/recently cached relevancy analysis results for the specified SourcePage ID (e.g., at Hybrid System Cache 244). In at least one embodiment, such cached information may be considered to be recent or current if it is determined that the cached information has been generated within a maximum specified time value T (e.g., where, for example, the value T may represent a time value (such as, for example, 4 hours, 12 hours, 24 hours, 48 hours, and/or other time values within the range of 4-48 hours, for example).

For example, in at least one embodiment, the cached information may be considered to be recent or current if it is determined that the cached information has been generated within the past 24 hours. Similarly, the cached information may be considered to be old or stale (or not current) if it is determined that the cached information has been generated more than 24 hours ago.

In at least one embodiment, if it is determined that there exists current/recently cached relevancy analysis results for the specified SourcePage ID, the Hybrid System may chose to forgo new/additional processing and/or analysis of the Source web page content, and instead use at least a portion of the cached information associated with the identified SourcePage ID. A specific example embodiment of this is illustrated, for example, at operations (16p), (18p) of FIG. 3L.

In at least one embodiment, the cached information may include, for example, one or more of the following (or combinations thereof) types of information (e.g., which are associated with the web page content for the identified SourcePage ID):
Chunk(s) of parsed web page content associated with the SourcePage ID
KeyPhrase-Page Topic relatedness (or relevancy) score values
KeyPhrase-Corpus Topic relatedness (or relevancy) score values
Page Topic-Corpus Topic relatedness (or relevancy) score values
KeyPhrase candidate information
Page topic information
Timestamp data
Source page URL
SourcePage ID
etc.

In at least one embodiment (as illustrated, for example, in the specific example embodiments of FIGS. 3B and 3C), if it is determined that there does not exist current/recently cached relevancy analysis results for the specified SourcePage ID, the Hybrid System may respond by identifying the URL associated with the SourcePage ID, and by retrieving and/or crawling (e.g., 18g, 18c) (or by instructing automated agents to crawl) the web page content corresponding to the identified URL.

Returning to the specific example embodiment of FIG. 3G, it is assumed, in this particular example, that there does not exist current/recently cached relevancy analysis results for the specified SourcePage ID. Accordingly, in at least one embodiment, the Hybrid System may transmit (15g) a communication to the client system, requesting or instructing the client system to send or upload a first (or next) chunk of parsed content to the Hybrid System.

For example, in the specific example embodiment of FIG. 3G, it is assumed (at 15g) that the client system has not yet provided any chunks of parsed content to the Hybrid System. Accordingly, in a particular example embodiment, the Hybrid System may instruct the client to upload the first chunk of parsed web page content, and the client system may respond by transmitting or uploading (18g) a first chunk of parsed web page content to the Hybrid System. In at least one embodiment, each chunk of parsed content may be configured or designed to include about 100-400 characters (e.g., about 200 characters). In some embodiments, the Hybrid System may instruct the client system to upload multiple chunk(s) to the Hybrid System over one or more sessions.

In a different example embodiment, as illustrated in Figure, for example, where the client system has previously uploaded (e.g., 14m) the first chunk of parsed content, the Hybrid System may initially process and analyze (e.g., 16m) the received first chunk of parsed content, and thereafter, may subsequently instruct (15m) the client system (if desired) to upload the next chunk of parsed web page content to the Hybrid System.

Returning to the specific example embodiment of FIG. 3G, the Hybrid System may perform (e.g., in real-time) contextual/relevancy search and markup analysis on the received chunk(s) of parsed web page content. Additionally, in at least some embodiments, the Hybrid System may perform (e.g., in real-time) contextual/relevancy search and markup analysis on other types content which, for example, which the Hybrid System (and/or any of its crawler agents) has retrieved from other types of content sources such as, for example, one or more of the following (or combinations thereof):
target pages,
landing URL pages,
related pages (e.g., selected pages from the publisher's web site, related pages from advertiser website, etc.),
related content,
ad descriptions and/or other ad content,
etc.

According to different embodiments, the Hybrid System may be operable to perform (e.g., using at least a portion of the received chunks of parsed content) various different types of contextual/relevancy search and markup analysis operations, which, for example, may include, but is not limited to, one or more of the various types of operations and/or procedures described herein, at least a portion of which may each be implemented automatically, dynamically and/or in real-time.

As shown at (20g), the Hybrid System may process chunk(s) of parsed content (e.g., received from client system). In at least one embodiment, such processing may include, but are not limited to, initiating and/or implementing one or more of the following types of operations (or combinations thereof):
Performing Page Classification (e.g., using at least a portion of the received chunks of parsed content associated with the identified Source web page).
Performing Phrase Extraction (e.g., using at least a portion of the received chunks of parsed content associated with the identified Source web page).
Identifying candidate KeyPhrases for the identified Source web page.
Identifying page topic(s) for the identified Source web page.
Performing relevancy (or relatedness) analysis on identified candidate KeyPhrases
Performing relevancy (or relatedness) analysis on identified candidate Page Topics
Generating relevancy/relatedness analysis output data (e.g., relevancy analysis results), which, for example, may include, but is not limited to, one or more of the following types of data (or combinations thereof):
   KeyPhrase-Page Topic relatedness (or relevancy) score values
   KeyPhrase-Corpus Topic relatedness (or relevancy) score values
   Page Topic-Corpus Topic relatedness (or relevancy) score values
   List of KeyPhrase candidates
   Page topic data
   Timestamp data
   Source page URL
   SourcePage ID
   Chunk(s) of parsed web page content
   etc.

In at least one embodiment, during the page topic classification processing, the parsed source page information (including, for example, title, main content block, and/or meta information) is analyzed (e.g., at the Hybrid System) and evaluated for its relatedness to each (or selected) of the topics identified in the dynamic taxonomy database (DTD). In at least one embodiment, the output of the page topic classification processing includes a distribution of topics and associated relatedness scores representing each topic's respective relatedness to the main content block of the source web page (as well as other types of parsed source page information (e.g., source page title, meta data, etc.) which may have also been considered during the page topic classification processing).

In at least one embodiment, page topic classification processing may include one or more of the operations discussed previously, for example, with respect to FIG. 3A

In at least one embodiment, the Phrase Extraction process extracts and classifies meaningful phrases from the main content block of the parsed Source page content. This may include, for example, tagging part-of-speech for all (or selected) words in the content block, grouping words into phrases based on ‘Noun Phrases’, ‘Verb Phrases’, NGrams, Search Queries, meta KeyPhrases etc. In one embodiment, the output of this process is the list of all (or selected ones of) potential keyphrases.

In at least one embodiment, a respective KeyPhrase relatedness score may be determined for each of the identified KeyPhrases, and subset of KeyPhrases may be selected as KeyPhrase candidates based on relative values of their respective relatedness scores.

In at least one embodiment, the Hybrid System may compute a distribution of the relatedness of selected KeyPhrases to each topic of the related content corpus/DTD. In some embodiments, each KeyPhrase in the corpus has an associated relatedness score based on all (or selected ones of) its occurrences in the past (inside and outside the Hybrid affilited sites). This score may represent the distance between each of the pages the phrase appeared in, and the (human and/or automated) classified pages that represent the specific node. In at least one embodiment, the distance may be computed based on cosine similarity between the specific context, and each of the documents for each of the nodes, and the score may represent an average distance to all (or selected ones of) the document(s) being analyzed by the Hybrid System.

As shown at (21g), the Hybrid System may cache (e.g., in Cache 244) at least a portion of the output data of the processing/relevancy analysis, as well as associated information, if desired. In at least one embodiment, the Hybrid System may also be operable to cache other types of information such as, for example, one or more of the following (or combinations thereof):
Ad Final_Score values,
RC Final_Score values,
Ad Related Score values,
RC Related Score values,
TotalQuality Score values,
DOL related score values, \
KeyPhrase-DOL score values,
EMV values,
ERV values,
CTR estimates,
etc.

As shown at (22g), the Hybrid System may determine (22g) whether or not it is desirable or necessary to processes additional chunk(s) of parsed content for the identified Source web page. For example, as illustrated in the example embodiment of FIG. 3G, if the Hybrid System determines that it is desirable or necessary to processes additional chunk(s) of parsed content for the identified Source web page, the Hybrid System may request (15g) or instruct the client system to upload a next chunk (chunks) of parsed web page content to the Hybrid System, whereupon the client system may then respond by transmitting (18g) or uploading a next chunk(s) of parsed web page content to the Hybrid System. The Hybrid System may then process and analyze (20g) the next received chunk(s), cache (21g) the results, and then determine (22g) once again whether or not it is desirable or necessary to processes additional chunk(s) of parsed content for the identified Source web page.

In at least one embodiment, the Hybrid System may continue to request and/or analyze parsed web page content associated with the source page URL until the entirety of the parsed web page content has been analyzed, and/or until the Hybrid System has determined that it has acquired/generated sufficient relevancy analysis output data to enable the Hybrid System to adequately and subsequently perform specifically desired or required operations, such as, for example, one or more of the following (or combinations thereof) types of operations:
Solicit bid(s) from one or more Ad Server(s)
Identify/Select candidate Ads, Related Content
Select KeyPhrases to be highlighted/marked-up
Identify/Select candidate DOL elements
Determine final DOL layout(s), DOL elements
Select final Ad(s) to be displayed in DOL(s)
etc.

As shown at (24g), the Hybrid System may solicit bid(s) for advertisements from one or more Ad Server(s). In at least one embodiment, the Hybrid System may provide multiple candidate KeyPhrases and/or multiple candidate page topics to each of the selected Ad Servers. For example, in at least one embodiment where it is desired to solicit bids for advertisements to be displayed (e.g., at the client system) in association with the display of the Source web page content, the Hybrid System may be operable to provide a plurality of selected candidate KeyPhrases and/or candidate Page Topics (e.g., ranging from about 5-15 KeyPhrases) to about 5-15 different Ad Servers. In at least one embodiment, the Hybrid System may be configured or designed to send out at least multiple ad solicitation requests at about the same time to multiple different Ad Servers.

As described in greater detail herein (such as, for example, with respect to FIG. 10), one or more different types of ad bidding processes may be utilized for acquiring and/or identifying a portion of the ad candidates which may be considered for selection and presentation at the client system. Examples of the various types of ad bidding processes which may be utilized may include, but are not limited to, one or more of the following (or combinations thereof):
Manual-type Ad Bidding Process—In at least one embodiment, the Advertiser (or ad campaign provider) manually inputs and/or selects Keyphrases or KeyPhrases (KP's) to be associated with each given Ad. In at least one embodiment of the Manual-type Ad Bidding Process, the advertiser may upload a list of KeyPhrases and may bid a desired CPC amount for each KeyPhrase.
Topic-type Ad Bidding Process—In at least one embodiment, the Advertiser (or ad campaign provider) inputs or selects one or more topic(s) relating to a given Ad. In at least one embodiment of the topic-type ad bidding process, the advertiser may provide topic input regarding one or more selected page topics which the advertiser has determined (and/or desires) to be related to a given Ad. In at least one embodiment, the Hybrid System may be operable to analyze a given ad, and to provide recommended, contextually relevant KeyPhrase candidates for the ad using on topic input data provided by Advertiser.
Automated-Type Ad Bidding Process—In at least one embodiment of the automated-type ad bidding process, the advertiser (or ad campaign provider) provides Ad data (e.g., corresponding to one or more ads), and the Hybrid System uses the input ad data (provided by the advertiser) to automatically perform all other operations which may be needed/desired for creating and implementing a successful ad campaign using at least a portion of the advertiser's ads. For example, in at least one embodiment, the Hybrid System may be operable to automatically and dynamically perform one or more of the following (e.g., for creating and implementing a successful ad campaign for the advertiser):
   Analyze the ad data provided by the advertiser;
   Perform ad topic classification processing on at least a portion of the input ad data, which, for example, may include analyzing or evaluating each of the ads (e.g. provided by the advertiser) for its relatedness to each (or selected ones) of the topics identified in the dynamic taxonomy database (DTD). In at least one embodiment, the ad topic classification processing may include analyzing the landing URL page content associated with each of the ads for its relatedness to each (or selected ones) of the topics identified in the dynamic taxonomy database (DTD). In at least one embodiment, the output of the ad topic classification processing includes a distribution of topics and associated relatedness scores representing each topic's respective relatedness to each of the advertiser's ads. (see, e.g., 1604, 1606, 1608, FIG. 16A);
   Analyze and classify selected pages of the advertiser's website;
   Automatically select, based at least in part upon the analysis/classification of selected pages of the advertiser's website, at least one set of contextually relevant KeyPhrases which best match or relate to the content on the advertiser's site. In at least one embodiment, the Hybrid System may automatically identify and/or select different sets of contextually relevant KeyPhrases to be associated with respectively different portions or channels of the advertiser's site.
   Determine, identify and select, using at least a portion of the ad data provided by the advertiser, a respective set of contextually relevant KeyPhrases (KPs) to be associated with each of the advertiser's ads. In at least one embodiment, a respective set of contextually relevant KeyPhrases (KPs) may be associated with a respective ad of the advertiser's ads. Additionally, in some embodiments, some of the different sets of contextually relevant KeyPhrases (KPs) may include one or more similar and/or identical KeyPhrases.
   etc.

In at least one embodiment, in response to the ad solicitation requests, the Hybrid System may receive a plurality of different ad candidates from multiple different Ad Servers. In at least one embodiment, each ad candidate may include (or have associated therewith) a respective set of ad information (also referred to as “ad data”) which, for example, may include, but is not limited to, one or more of the following (or combinations thereof):
Landing URL,
Title of Ad,
Description of Ad,
Graphics/Rich Media,
CPC (e.g., cost-per-click or amount bidder willing to pay per click),
etc.

Returning to the specific example embodiment of FIG. 3G, as shown at (26g), the Hybrid System may identify and/or select one or more potential Ad candidates, Related Content candidates, etc. According to different embodiments, one or more different types of processes may be utilized for identifying and/or determining at least a portion of the ad candidates and/or related content candidates which may be considered for selection and presentation at the client system.

For example, in at least one embodiment, the Hybrid System may be operable to automatically and dynamically perform ad topic classification processing on each (or selected ones) of the ad candidates. Examples of various different types of operations which may be initiated or performed during the ad topic classification processing may include, but are not limited to, one or more of the following (or combinations thereof):
Performing ad topic classification processing on at least a portion of the input ad data associated with each ad candidate (e.g., Landing URL, Title of Ad, Description of Ad, Graphics/Rich, Media, CPC, etc.). I;
Analyzing or evaluating each of the ad candidates for its relatedness to each (or selected ones) of the topics identified in the dynamic taxonomy database (DTD);
Analyzing the landing URL page content associated with each of the ad candidates for its relatedness to each (or selected ones) of the topics identified in the dynamic taxonomy database (DTD);
Generating, for an identified ad candidate, ad ad-topic relatedness score values representing each topic's respective relatedness to the identified ad candidate. In at least one embodiment, calculation of the ad-topic relatedness score value(s) for an identified ad may be based, at least in part, upon classification ad elements, including, for example, the ad title, ad description, and content associated with the ad landing URL.

In at least one embodiment, the output of the ad topic classification processing includes a distribution of topics and associated relatedness scores representing each topic's respective relatedness to each of the advertiser's ad candidates. (see, e.g., 1604, 1606, 1608, FIG. 16A).

As described in greater detail herein, the Hybrid System may be operable to automatically and dynamically calculate additional scoring and/or relevancy values (e.g., as part of the Ad Selection process and/or Related Content selection process) such as, for example, one or more of the following (or combinations thereof):
EMV values (e.g., 1604d, 1606d, 1608d) (e.g., for each of the identified ad candidates);
Ad Quality Score values (e.g., 1604e, 1606e, 1608e) (e.g., for each of the identified ad candidates). In at least one embodiment, the Ad Quality Score value (e.g., for a selected ad or ad candidate) may represent the amount or degree of relatedness (or similarity) between the vector of topics of the source page and the vector of topics of the selected ad.
Final Score Values (e.g., 1604f, 1606f, 1608f) (e.g., for each of the identified ad candidates)
ERV values (e.g., 1654d, 1656d, 1658d) (e.g., for each of the identified related content element candidates);
Ad Quality Score values (e.g., 1654e, 1656e, 1658e) (e.g., for each of the identified related content element candidates);
Final Score Values (e.g., 1654f, 1656f, 1658f) (e.g., for each of the identified related content element candidates)
etc.

In at least one embodiment, the relevancy and/or scoring values may be used to select and/or rank the most desirable and/or suitable ad candidates (e.g., 1620) for an identified source web page (e.g., 1602). More specifically, as illustrated in the example embodiment of FIG. 16A, the final result (1620) of the ad selection process 1600 includes ad information (and related ranking information 1622) corresponding to 3 potential ad candidates (e.g., Ad2, Ad1, Ad3).

Returning to the specific example embodiment of FIG. 3G, as shown at (28g), the Hybrid System may score candidate KeyPhrases for DOL analysis. In at least one embodiment, the selection of the final KeyPhrase candidates to be highlighted/marked up may be performed at the Hybrid System by scoring each (or selected ones) of the candidate KeyPhrases and identifying the KeyPhrases which maximize relevancy and yield to the source and target (e.g., landing URL) pages. In at least one embodiment, a respective Final_Score value may be calculated for each (or selected) possible source-KeyPhrase-target combination. Specific example embodiments KeyPhrase scoring procedures are described, for example, with respect to operational block 1013 (FIG. 3A) and FIG. 3D.

As shown at (30g), the Hybrid System may identify/select one or more candidate DOL components. Specific embodiments of at least one DOL Element Selection Procedure are illustrated and described, for example, with to operational block 1014 (FIG. 3A) and FIG. 3E. Additionally, in at least one embodiment, as illustrated in the example embodiment of FIG. 16G, for example, the Hybrid System may be operable to identify and/or select related content candidates (and/or DOL elements) using a Related Content Selection Process which is similar in many respects to the Ad Selection Process illustrated and described with to FIG. 16A, with the exception that ERV (expected return value) may be used to computer the Final_Score for each source-RC-target combination.

As shown at (32g), the Hybrid System may determine at least one DOL layout (and associated DOL elements, selected KeyPhrase(s) for highlight/markup) which is to be displayed at the client system. Specific embodiments of at least one DOL Element Selection Procedure are illustrated and described, for example, with to operational block 1015 (FIG. 3A) and FIG. 3F.

As shown at (34g), the Hybrid System may generate page modification instructions/information which, for example, may include, but is not limited to, one or more of the following (or combinations thereof):
Page content (new and/or original),
Page modification instructions,
Markup instructions,
Advertising information,
Hyperlink data,
DOL data,
Related content information,
Relevancy scoring information,
KeyPhrase information,
etc.

As shown at (38g) the Hybrid System may send the page modification instructions/information to the client system. In a specific embodiment, the web page modification instructions may include highlight/markup instructions, which, for example, may be implemented using a scripting language such as, for example, Javascript.

According to different embodiments, the page modification instructions/information may include, but is not limited to, one or more of the following (or combinations thereof):
KeyPhrase markup data (e.g., relating to one or more KeyPhrases identified in the original content of the source web page which has/have been selected for highlight/markup modification operations),
page modification instructions,
hyperlink data (e.g., relating to one or more URLs),
dynamic overlay layer (DOL) data,
ad information
etc.

As illustrated in the example embodiment of FIG. 3G, when the web page modification instructions are received at the client system, the client system processes the instructions, and in response, modifies (40g) the display of the web page content in accordance with the page modification instructions and KeyPhrase markup information.

In at least one embodiment, the client system may perform markup operations on the identified KeyPhrase to cause a keyphrase to be highlighted on the client system display. Upon detecting a cursor click/hover event over a portion of the highlighted KeyPhrase, the client system may respond by sending a notification message to the Hybrid System, informing the Hybrid System of the detected cursor click/hover event over the highlighted KeyPhrase. The Hybrid System may then take appropriate action at that time to select the final ad (e.g., from the multiple different ad candidates) to be linked to the highlighted KeyPhrase at the client system.

According to at least one embodiment, the web page modification instructions may include instructions for modifying, in real-time, the display of web page content on the client system by inserting and/or modifying textual markup information and/or dynamic content information. Because the web page modification operations are implemented automatically, in real-time, and without significant delay, such modifications may be performed transparently to the user. Thus, for example, in at least one embodiment, when the user submits a URL request at the client system to view a web page (such www.yahoo.com, for example), the client system may receive web page content from www.yahoo.com, and will also receive web page modification instructions from the Hybrid System. The client system may then render the web page content to be displayed in accordance with the received web page modification instructions.

As shown at 42g, it is assumed that the client system has detected a cursor click/hover event at (or over) a portion of a highlighted or marked up KeyPhrase. In at least one embodiment, such an event may be caused and/or initiated as a result of input from the user such as, for example, the user positioning the mouse cursor to hover over and/or select (e.g., via mouse click or other type of display content selection mechanism(s)) one of the highlighted KeyPhrases which was dynamically highlighted/marked up in accordance with the received page modification instructions/information.

In at least one embodiment, the client system may implement or initiate different types of response procedures, depending upon whether the detected event relates to a cursor hover (e.g., mouseover) event or a selection (e.g., mouse click) event.

As shown at 43g, the client system may respond to the detected cursor click/hover event by automatically and dynamically displaying a first dynamic overlay layer (DOL) (or pop-up window, etc.) which includes a first portion of ad information.

As shown at 44g, information relating to the detected cursor click/hover event and DOL display event may be automatically reported by the client system to the Hybrid System.

As shown at 46g, the Hybrid System may log information relating to the detected cursor click/hover event and/or DOL display event which occurred at the client system.

As shown at 48g, the Hybrid System may optionally query one or more Ad Server(s) for updated ad information, and/or may optionally perform additional analysis (e.g., ad selection analysis, relevancy analysis, DOL element selection analysis, related content selection analysis, etc.) using any updated ad information received from any of the queried Ad Server(s). In at least one embodiment, querying of the Ad Server(s) (e.g., at 48g) may skipped or aborted if wait time exceeds or is expected to exceed a predetermined threshold value (e.g., skip or abort if wait time>500 mS+/−200 mS)

As shown at 50g, the Hybrid System may dynamically perform analysis and selection of a final ad which is to be displayed at the client system.

As shown at 50g, the Hybrid System may dynamically perform analysis and selection of one or more final ad(s) which is/are to be displayed at the client system.

As shown at 52g, the Hybrid System may dynamically perform analysis and selection of one or more DOL Layout(s) (and associated DOL element(s)) which is/are to be displayed at the client system.

As shown at 60g, the Hybrid System may provide updated Ad data, and/or updated DOL instructions/information to the client system.

As shown at 70g, it is assumed that the client system has detected a cursor click/hover event at (or over) a portion of a highlighted or marked up KeyPhrase.

As shown at 72g, the client system may respond to the detected cursor click/hover event by automatically and dynamically displaying a second dynamic overlay layer (DOL) (or pop-up window, etc.) which includes a second portion of ad information. In some embodiments, the layouts of the first and second DOL layers may be identical or substantially similar. In other embodiments the layouts of the first and second DOL layers may differ.

As shown at 74g, information relating to the detected cursor click/hover event and DOL display event may be automatically reported by the client system to the Hybrid System.

As shown at 76g, the Hybrid System may log information relating to the detected cursor click/hover event and/or DOL display event which occurred at the client system.

As shown at 80g, Cursor click event detected at hyperlink of DOL

As shown at 82g, Cursor click DOL hyperlink event data, URL data may be reported to the Hybrid System. and logged (84g) at the Hybrid System.

According to at least one embodiment, the action of the user clicking on one of the contextual ads causes the client system to transmit a URL request to the Hybrid System. The URL request may be logged in a local database at the Hybrid System when received. The URL may include embedded information allowing the Hybrid System to identify various information about the selected ad, including, for example, the identity of the sponsoring advertiser, the KeyPhrase(s) associated with the ad, the ad type, etc. The Hybrid System may use at least a portion of this information to generate redirected instructions for redirecting the client system to the identified advertiser. Additionally, the Hybrid System may also use at least a portion of the URL information during execution of a Dynamic Feedback Procedure. In at least one embodiment, the Dynamic Feedback Procedure may be implemented to record user click information and impression information associated with various keyphrases.

As shown at 84g, 86g, the Hybrid System may respond by generating and sending a redirect message to the client system.

As shown at 90g, the user redirected to Advertiser Site (e.g., landing URL)

In at least some embodiments, the page modification instructions/information may include ad information relating to multiple different ads (and/or multiple different ad servers) which have been selected (e.g., based on computed relevancy and/or scoring values and/or other criteria) as ad candidates for presentation at the client system display in association with a given web page that is (or will be) displayed at the client system.

Further, in at least some embodiments, selection of the final list of ad candidates to be considered (e.g., for presentation at the client system display in association with a given web page that is (or will be) displayed at the client system) may occur before final selection has been determined of the actual KeyPhrase(s) which are to be marked up and converted to hyperlinks.

For example, as illustrated in the example embodiment of FIG. 3B, the Hybrid System may be operable to dynamically generate and provide all (or selected portions) of DOL layout data (e.g., as shown at 73b) to the client system before the user performs a mouseover or click operation at/over one of the displayed highlighted KeyPhrases.

In other embodiments, as illustrated in the example embodiment of FIG. 3C, the Hybrid System may be operable to dynamically generate and provide all (or selected portions) of the DOL element and/or DOL layout data (82c) in response to detecting cursor click/hover event at/over one of the displayed highlighted KeyPhrases.

In some alternate embodiments, as illustrated, for example, in the example embodiments of FIGS. 3G, 3H, 3I, 3K, the client system may be operable to automatically and/or dynamically initiate and/or perform various aspects, features and/or operations relating to one or more of the hybrid contextual analysis and display techniques disclosed herein, such as, for example, one or more of the following (or combinations thereof):
Parse web page content retrieved from online publishers or content providers;
Generate chunks of clean or pure text output;
Transmit or provide chunks of clean or pure text output to the Hybrid System for further contextual search and markup analysis;
Generate an identifier (e.g., SourcePage ID) which represents the content associated with a given web page. In at least one embodiment, a unique SourcePage ID may be created or generated for a given web page or document, wherein the SourcePage ID is representative of the main content (which, for example, may include static and/or dynamically generated content) associated with that particular web page (e.g., which is to be displayed at that particular client system). Accordingly, in at least one embodiment, the SourcePage ID may correspond to a fingerprint or hash value which is representative of the main or primary content associated with that particular version or instance of the web page or document. For example, in at least one embodiment, the client system may be operable to:
   parse a given web page,
   identify and extract the main content block of that web page,
   generate clean text output version of the main content block
   use clean text output version of the main content block to generate a SourcePage ID for that particular web page
Provide SourcePage ID information to the Hybrid System. In at least one embodiment, the Hybrid System may cache selected SourcePage ID information received from various different client systems so that such information may be utilized (e.g., by the Hybrid System and/or client system(s)) during subsequent contextual analysis operations.
Cache (e.g., in local memory) various types of information provided by the Hybrid System such as, for example, one or more of the following (or combinations thereof):
   relevancy scoring information (e.g., Ad Final_Score values, RC Final_Score values, Ad Related Score values, RC Related Score values, TotalQuality Score values, DOL related score values, KP-DOL score values, etc.)
   EMV values
   ERV values
   CTR estimates
   SourcePage ID values
   etc.

In at least one embodiment, the Hybrid System and/or client system(s) may use the cached SourcePage IDs to determine whether an identified web page (e.g., web page to be displayed at the client system, related content page, advertiser page, etc.) has previously been processed for contextual KeyPhrase and markup analysis. In at least one embodiment, if the SourcePage ID of the identified web page matches a SourcePage ID in the cache, it may be determined that the identified web page has been previously processed for contextual KeyPhrase, relevancy scoring, and markup analysis. Accordingly, in at least one embodiment, further processing of the identified webpage (e.g., for contextual KeyPhrase, relevancy scoring, and/or markup analysis) need not be performed, and at least a portion of the results (e.g., relevancy scores, KeyPhrase data, markup information) from the previous processing of identified web page may be utilized.

In some embodiments, as illustrated in the example embodiments of FIGS. 3I, 3K, for example, the Hybrid System may identify and/or determine (e.g., 31k), before detection of a cursor click/hover event at/over one of the displayed highlighted KeyPhrases (e.g., 42k), a final list of ad candidates to be considered for presentation at the client system display (e.g., in association with a given web page that is (or will be) displayed at the client system). Alternatively, as illustrated in the example embodiment of FIG. 3J, the determination/selection of the final ad (e.g., 50m) to be displayed (e.g., 62m) within the a given DOL layer (e.g., DOL Layout A, which is to be displayed in response to cursor click/hover event (42m) is not performed until after the detection of a cursor click/hover event at/over one of the displayed highlighted KeyPhrases (e.g., 42m).

In at least one embodiment, during the process of selecting the final ad, the Hybrid System and/or client system may (optionally) obtain (e.g., in real-time) updated ad inventory information, which, for example, may include querying one or more of the ad servers for real-time updates of available ad inventory. In at least one embodiment, during the process of selecting the final ad, the Hybrid System may re-compute and/or update (e.g., in real-time) at least a portion of the associated relevancy and scoring values relating to one or more ad candidates. In at least one embodiment, the Hybrid System may use the updated relevancy and scoring values to select, as the final ad, an ad candidate which was not included in the original list of multiple different ad candidates. In some embodiments, the Hybrid System may use the updated relevancy and scoring values and/or updated ad inventory information to select a final ad from the remaining ad candidates still available from the list of multiple different ad candidates.

Additionally, as illustrated in the example embodiment of FIG. 3G, at least a portion of the operations relating to DOL element identification and/or DOL layout determination may be performed (e.g., by the Hybrid System) in response to detection of a cursor click/hover event at/over one of the displayed highlighted KeyPhrases (e.g., 42g). In other embodiments, as illustrated in the example embodiment of FIG. 3K, for example, the Hybrid System may be operable to perform DOL element identification/selection and/or DOL layout determination before detection of a cursor click/hover event at/over one of the displayed highlighted KeyPhrases (e.g., 42n).

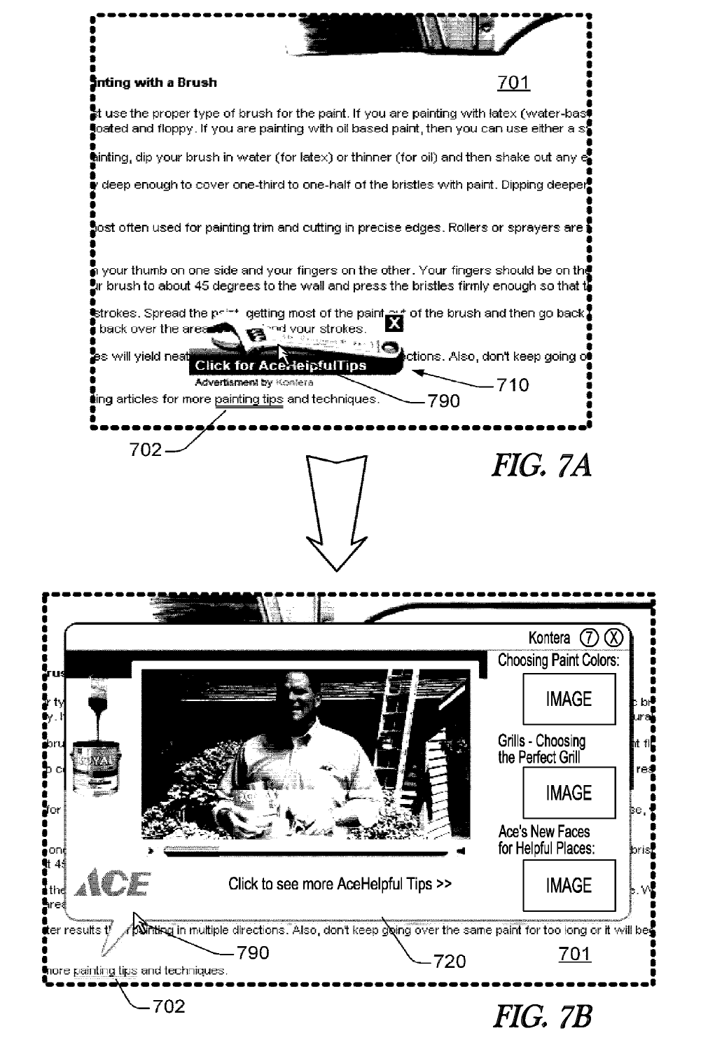

As illustrated in the example embodiment of FIG. 3M, at least some of the DOL element/layout analysis and selection operations may be based, at least in part, upon the type of ad (e.g., Ad Type) to be displayed. For example, in at least one embodiment, at least a portion of the example flow diagram of FIG. 3M may be utilized for implementing the example multi-step combinational advertising technique illustrated in FIGS. 7A-B in which a first type of DOL layout (e.g., Layout A—Floating-type DOL) is selected for use in displaying (43r) an initial floating-type ad, and a second type of DOL layout (e.g., Layout B—expanded-type DOL) is selected for use in subsequently displaying (72r) a non-floating-type ad and related content.

As described in greater detail herein, the Hybrid System may also automatically and asynchronously crawl, analyze, score and/or otherwise process identified target content which, for example, may include, but is not limited to, one or more of the following (or combinations thereof):
advertising content (e.g., associated with all (or selected) ad candidates),
web page content associated with landing URLs of identified ads,
and/or other types of potentially related content.

In at least one embodiment, a separate process or thread running on the Hybrid System may continuously and/or periodically crawl, analyze, and score identified target content. In at least one embodiment, this process may run independently and asynchronously with respect to the real-time processing and contextual/markup analysis of web page content to be displayed on the client system(s).

Further, in at least some embodiments, the Hybrid System may be operable to automatically and dynamically perform at least a portion of its various target content crawling, analyzing, and/or scoring operations on-demand, on-the-fly, and/or in real-time, as needed (or desired). For example, in at least one embodiment, the Hybrid System may be operable to automatically and dynamically perform at least a portion of the various target content crawling, analyzing, and/or scoring operations on-the-fly (e.g., and in real-time) in response to one or more conditions or events such as, for example, one or more of the following (or combinations thereof):
receiving and/or identifying new or updated ad information (e.g., from AD server 308);
detection of at least one ad bidding response (e.g., from one or more AD servers);
receiving and/or identifying new or updated landing URL information
receiving and/or identifying new or updated related content information;
receiving and/or identifying new or updated links to potentially related content;
receiving and/or identifying new or updated links to previously analyzed source pages, related pages, related content, ad sources, etc.
identifying new or updated URLs associated with one or more online publishers or content providers;
receiving and/or identifying new or updated information relating to one or more of the following target element types (or combinations thereof):
   Ads
   Video
   Audio
   Related information
   Related content
   Related articles
   Related links
   Images
   Animation
   External feeds
   etc.
etc.

As described in greater detail herein, scoring and/or relevancy values may be automatically and dynamically computed (e.g., by the Hybrid System in real-time) for each (or selected ones) of the different possible combinational pairs that may be identified between the various source pages, page topics, KeyPhrases, ads, landing URL pages, related content pages/elements, DOL elements, etc. The computation of at least a portion of the scoring and/or relevancy values may also take into account other variables such as, for example, one or more of the following (or combinations thereof):
EMV values (expected monitory value),
ERV values (expected return value),
Ad Quality score values,
Related Content Relevancy score values
quality of the related information website (e.g., for related content),
Final Score values for ads
Final Score values for related content
estimated click through rate (CTR),
cost-per-click (CPC) values,
cost-per-thousand-impressions (CPM)/effective CPM values,
etc.

In at least one embodiment, the final calculated scoring and/or relevancy values may be used to identify and/or determine the preferred or optimal selections between a given source page, identified KeyPhrases, identified ads, identified target pages, identified related content elements, identified DOL elements, etc. In at least one embodiment, the list of KeyPhrase candidates which may be considered and/or used to score the pages in topics/categories may be automatically and dynamically expanded using at least one of the various dynamic taxonomy techniques described herein. Similarly, the list of KeyPhrase candidates which may be considered and/or used for source page markup and/or linking (e.g., to ads and/or related content) may be automatically and dynamically expanded using at least one of the various dynamic taxonomy techniques described herein.

It will be appreciated that different embodiments of the hybrid contextual analysis and markup techniques described or referenced herein may be configured or designed to initiate or perform at least a portion of their respective operations relating to relevancy/scoring analysis, markup/highlight analysis, ad bidding, and/or ad selection at different stages of the contextual analysis and markup process (e.g., relative to each other). For example, depending upon the particular implementation-specific configuration(s) of the hybrid contextual analysis and markup technique being utilized, at least some of the operations relating to relevancy/scoring analysis, markup/highlight analysis, ad bidding, and/or ad selection may be initiated or performed in accordance with one or more of the following constraints:
before page modification instructions/information is implemented at the client system;
before selected KeyPhrases are marked up/highlighted at the client system;
after selected KeyPhrases have been marked up/highlighted at the client system;
before a cursor click/hover event is detected at the client system;
in response to detecting a cursor click/hover event over a marked up portion of displayed content at the client system;
before display of a DOL layer at the client system;
etc.

In at least one embodiment, the page modification instructions/information may include information for marking up at least one identified KeyPhrase which corresponds to originally displayed web page content. Additionally, the page modification instructions/information may also include ad information relating to multiple different ads (and/or multiple different ad servers) which have been selected (e.g., based on computed relevancy and/or scoring values and/or other criteria) as ad candidates for presentation at the client system display in association with a given web page that is (or will be) displayed at the client system.

In at least one embodiment, the client system may perform markup operations on the identified KeyPhrase to cause a keyphrase to be highlighted on the client system display. Upon detecting a cursor click/hover event over a portion of the highlighted KeyPhrase, the client system may respond by sending a notification message to the Hybrid System, informing the Hybrid System of the detected cursor click/hover event over the highlighted KeyPhrase. The Hybrid System may then take appropriate action at that time to select the final ad (e.g., from the multiple different ad candidates) to be linked to the highlighted KeyPhrase at the client system.

In at least one embodiment, during the process of selecting the final ad, the Hybrid System may obtain (e.g., in real-time) updated ad inventory information, which, for example, may include querying one or more of the ad servers for real-time updates of available ad inventory. In at least one embodiment, during the process of selecting the final ad, the Hybrid System may re-compute and/or update (e.g., in real-time) at least a portion of the associated relevancy and scoring values relating to one or more ad candidates. In at least one embodiment, the Hybrid System may use the updated relevancy and scoring values to select, as the final ad, an ad candidate which was not included in the original list of multiple different ad candidates. In some embodiments, the Hybrid System may use the updated relevancy and scoring values and/or updated ad inventory information to select a final ad from the remaining ad candidates still available from the list of multiple different ad candidates.

It will be appreciated that, in at least one embodiment, selection of the final list of ad candidates to be considered (e.g., for presentation in association with a given web page that is to be displayed at the client system) may occur before the final selection of KeyPhrases (to be marked up and converted to hyperlinks) has been determined. An example of this is illustrated, for example, in FIG. 16A.

FIG. 16A shows an example of a Hybrid Ad Selection Process 1600 in accordance with a specific embodiment. FIG. 16B shows an example of a Hybrid Related Content Selection Process 1650 in accordance with a specific embodiment.

In at least one embodiment, during the Hybrid Ad Selection Process, each potential ad candidate which is considered for placement in connection with an identified source page may be assigned a respective Ad Final_Score value which, for example, may be automatically and dynamically computed (e.g., in real-time) according to:

Ad Final_Score=α*EMV+β*(Ad Quality Score),

where EMV=expected monitory value.

Similarly, during the Hybrid Related Content Selection Process, each potential Related Content element candidate which is considered for placement (e.g., within a DOL) in connection with an identified source page may be assigned a respective RC Final_Score value which, for example, may be automatically and dynamically computed (e.g., in real-time) according to:

RC Final_Score=α*ERV+β*(RC Relevancy Score),

where ERV=expected return value.

As illustrated in the example embodiment of FIG. 16A, an Ad Selection Process 1600 is illustrated in which it is desired to select and/or rank the top three most desirable and/or suitable ad candidates (e.g., 1620) for an identified source web page (e.g., 1602). In this particular example embodiment, it is assumed that the content of the source web page 1602 has already been analyzed and parsed and processed for page topic classification, and topic relevancy scoring. Thus, for example, in at least one embodiment, the main content block (MCB) portion of the source web page content may be identified, parsed, and processed for page topic classification along with other associated source page information (such as, for example, title of source page, meta information, etc.). During the page topic classification processing, the parsed source page information (including, for example, title, main content block, and/or meta information) is analyzed (e.g., at the Hybrid System) and evaluated for its relatedness to each (or selected) of the topics identified in the dynamic taxonomy database (DTD). In at least one embodiment, the output of the page topic classification processing includes a distribution of topics and associated relatedness scores representing each topic's respective relatedness to the main content block of the source web page (as well as other types of parsed source page information (e.g., source page title, meta data, etc.) which may have also been considered during the page topic classification processing).

Thus, for example, as illustrated in the example embodiment of FIG. 16A, a portion of the page topic classification output data is shown at 1602, in which four different topics (e.g., 1602a-d) have been identified along with their respective relatedness scores to the identified MCB of the source web page. It will be appreciated that other portions of the page topic classification output data (not shown) may include other identified topics and their respective relatedness scores. However, for purposes of simplification and ease of explanation, the present discussion will be limited to primarily to identified topics 1602a-d.

Accordingly, as illustrated in the example embodiment of FIG. 16A:
the topic “Golf” (1602a) has an associated relatedness score of 0.6 relative to source page 1602;
the topic “Golf Products” (1602b) has an associated relatedness score of 0.4 relative to source page 1602;
the topic “Golf Vacations” (1602c) has an associated relatedness score of 0.5 relative to source page 1602; and
the topic “Vacations” (1602d) has an associated relatedness score of 0.3 relative to source page 1602.

Additionally, as illustrated in the example embodiment of FIG. 16A, it is assumed that a plurality of different ads (e.g., 1604, 1606, 1608, and possibly additional ads (not shown)) have been identified as ad candidates to be considered for selection and presentation (e.g., at the client system) in association with the display of the source web page content at the client system.

As described in greater detail in other sections of the present disclosure, one or more different types of ad analysis processes may be utilized for identifying and/or determining at least a portion of the ad candidates which may be considered for selection and presentation at the client system.

In at least one embodiment, the Hybrid System may be operable to automatically and dynamically perform ad topic classification processing on each (or selected ones) of the ad candidates. Examples of various different types of operations which may be initiated or performed during the ad topic classification processing may include, but are not limited to, one or more of the following (or combinations thereof):
Performing ad topic classification processing on at least a portion of the input ad data associated with each ad candidate (e.g., Landing URL, Title of Ad, Description of Ad, Graphics/Rich, Media, CPC, etc.). I;
Analyzing or evaluating each of the ad candidates for its relatedness to each (or selected ones) of the topics identified in the dynamic taxonomy database (DTD);
Analyzing the landing URL page content associated with each of the ad candidates for its relatedness to each (or selected ones) of the topics identified in the dynamic taxonomy database (DTD);
Generating, for an identified ad candidate, ad ad-topic relatedness score values representing each topic's respective relatedness to the identified ad candidate. In at least one embodiment, calculation of the ad-topic relatedness score value(s) for an identified ad may be based, at least in part, upon classification ad elements, including, for example, the ad title, ad description, and content associated with the ad landing URL.

In at least one embodiment, the output of the ad topic classification processing includes a distribution of topics and associated relatedness scores representing each topic's respective relatedness to each of the advertiser's ad candidates. (see, e.g., 1604, 1606, 1608, FIG. 16A).

For example, as illustrated in the example embodiment of FIG. 16A, with respect to Ad1 (1604):
the topic “Sports” has an associated relatedness score of 0.6 relative to Ad1 1604;
the topic “Golf” has an associated relatedness score of 0.6 relative to Ad1 1604; and
the topic “Golf Products” has an associated relatedness score of 0.4 relative to Ad1 1604.

For example, as illustrated in the example embodiment of FIG. 16A, with respect to Ad2 (1606):
the topic “Sport” has an associated relatedness score of 0.3 relative to Ad2 1606;
the topic “Fitness” has an associated relatedness score of 0.2 relative to Ad2 1606;
the topic “Health” has an associated relatedness score of 0.1 relative to Ad2 1606; and
the topic “Diet” has an associated relatedness score of 0.05 relative to Ad2 1606.

For example, as illustrated in the example embodiment of FIG. 16A, with respect to Ad3 (1608):
the topic “Travel” has an associated relatedness score of 0.2 relative to Ad3 1608;
the topic “Air Travel” has an associated relatedness score of 0.05 relative to Ad3 1608; and
the topic “Golf Vacations” has an associated relatedness score of 0.2 relative to Ad3 1608.

As described in greater detail herein, the Hybrid System may be operable to automatically and dynamically calculate additional scoring and/or relevancy values (e.g., as part of the Ad Selection process and/or Related Content selection process) such as, for example, one or more of the following (or combinations thereof):
EMV values (e.g., 1604d, 1606d, 1608d) (e.g., for each of the identified ad candidates);
Ad Quality Score values (e.g., 1604e, 1606e, 1608e) (e.g., for each of the identified ad candidates). In at least one embodiment, the Ad Quality Score value (e.g., for a selected ad or ad candidate) may represent the amount or degree of relatedness (or similarity) between the vector of topics of the source page and the vector of topics of the selected ad.
Final Score Values (e.g., 1604f, 1606f, 1608f) (e.g., for each of the identified ad candidates)
ERV values (e.g., 1654d, 1656d, 1658d) (e.g., for each of the identified related content element candidates);
Ad Quality Score values (e.g., 1654e, 1656e, 1658e) (e.g., for each of the identified related content element candidates);
Final Score Values (e.g., 1654f, 1656f, 1658f) (e.g., for each of the identified related content element candidates)
etc.

In at least one embodiment, the relevancy and/or scoring values may be used to select and/or rank the most desirable and/or suitable ad candidates (e.g., 1620) for an identified source web page (e.g., 1602). More specifically, as illustrated in the example embodiment of FIG. 16A, the final result (1620) of the ad selection process 1600 includes ad information (and related ranking information 1622) corresponding to 3 potential ad candidates (e.g., Ad2, Ad1, Ad3).

### Example Embodiments of Hybrid Contextual Advertising Techniques

According to specific embodiments, various hybrid contextual advertising techniques described herein may be used to enable online content providers OCPs to increase revenue while providing valuable services that will keep users coming back to their site and possible viewing more pages.

In at least one embodiment, various hybrid contextual advertising techniques described herein may be configured or designed to work on top of an on-line ad campaign provider's contextual analysis platform (such as, for example, Hybrid's contextual analysis platform). In at least one embodiment, the hybrid contextual advertising techniques may be configured or designed to offer the user a combination of content and ads that match the user's interest as inferred from the content (e.g., web page content) that the user is currently viewing.

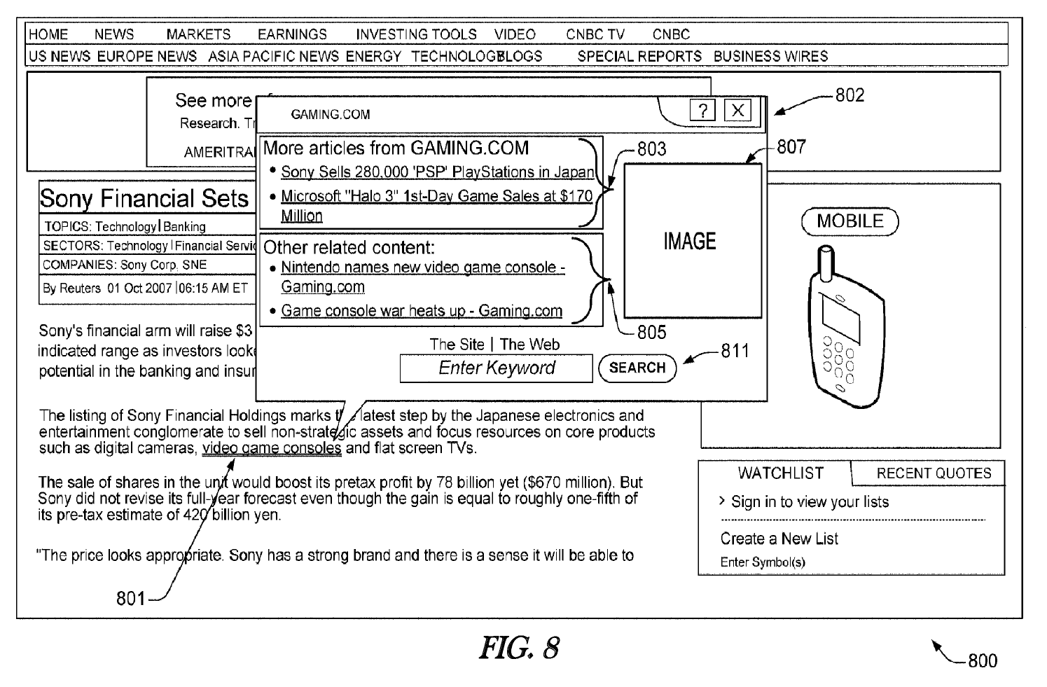

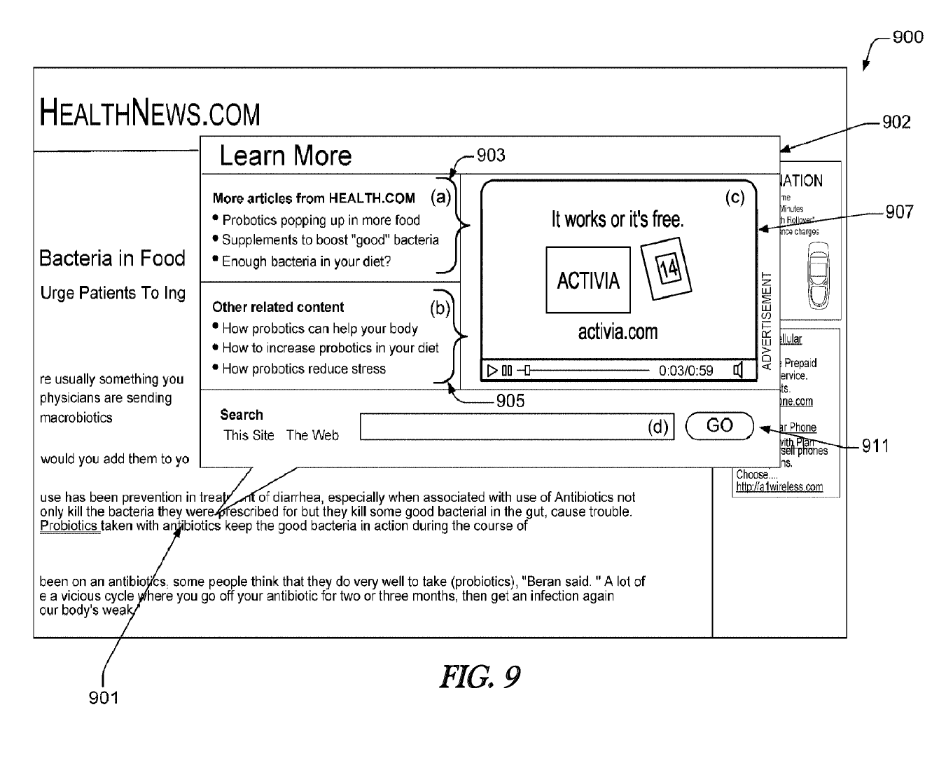

FIG. 8 shows an example of an alternate embodiment of a graphical user interface (GUI) which may be used for implementing various aspects of the hybrid contextual advertising techniques described herein. In the example of FIG. 8, it is assumed that the content of document 800 has been analyzed in accordance with a contextual analysis technique, and that selected KeyPhrases of the document have been identified. It is further assumed that at least a portion of the selected KeyPhrases have been linked to other selected resources (e.g., web pages, URLs, articles, etc.) using predetermined selection criteria. Thus, for example, as shown in FIG. 8, when a user hovers a cursor over the KeyPhrase phrase “video game console” (501), a pop-up window or GUI 802 may be displayed to the user. In the embodiment of FIG. 8, the GUI 802 includes various types of advertiser sponsored information relating to the KeyPhrase phrase “video game console.” According to specific embodiments, GUI 802 may include information such as, for example, images, text descriptions, links, video content, search interfaces, dialog boxes, etc. For example, according to specific embodiments:
Related content links (e.g., 803) could be contextually related to content from the current site (e.g., that the user is currently browsing), and/or from additional sites (e.g., 805) that can be affiliated or not affiliated with the current site.
The related content links could lead to content of different format; text, images, video, audio, etc.
The ads could be of different format; text, images (e.g., 807), animations, video, and more.
The ads can originate from any ad server that can provide ads that can be displayed within the campaign provider's contextual analysis platform (such as, for example, Hybrid's contextual analysis platform). In at least one embodiment, the Hybrid contextual analysis platform may analyze and classify pages into clusters.
An optional search bar/interface (e.g., 811) may be provided that allows the user to search content on the site and/or on affiliated sites. In at least one embodiment, a general web search could be present as well.

Analysis Process

According to a specific embodiment, the OCP may place customized “tags” (herein referred to as Hybrid tags) on each page that could be either an origin page, a destination page, or both. FIG. 7 shows an example embodiment of a customized JavaScript (“JS”) Hybrid Tag portion 700.

According to a specific embodiment, once a Hybrid tag is placed on a page, the page may be analyzed by Hybrid's server application when the user browses to this page. In at least one embodiment, a first user that browses and views the page may automatically trigger an analysis process for the page by the Hybrid server application (such as, for example, in circumstances where it is the first time that the Hybrid server application encounters a page). In at least one embodiment, subsequent instances of additional users that view the page may not require another analysis process to be performed unless, for example, the page's content has changed.

In the analysis process, Hybrid's server application may perform a variety of processes such as, for example, one or more of the following (or combinations thereof):
1. Contextual Analysis—This process, for example, may be used to find the preferred or best matching topics and KeyPhrases for the page. These may be the topics and/or KeyPhrases which may be used to characterize the page's theme.
2. Text Classification Analysis—This process, for example, may be used to compare the page's text and/or other page content to the text/content of other related pages. In at least one embodiment, the related pages may be part of a network of sites and/or pages which may be collectively referred to as a corpus. In at least one embodiment, a corpus may include a plurality of different web pages such as, for example, other web pages associated with the current domain, web pages from other sites affiliated with the current domain, web pages from other sites relating to KeyPhrases and/or topics of the current web page, web pages which are neither associated with nor affiliated with the current domain, etc. In some embodiments there may be several different corpuses which may include different (and, in some embodiment, overlapping) networks of sites/pages. In at least one embodiment, the process may include “translating” each (or selected) pages into a respective vector which may be used to represent that page. The vectors may then compared to each other and scored based on the relevance they have to each other.

As a result of implementing the various processes, the Hybrid System may generate clusters of content sources of different type (e.g., text, video, etc.) that have a relevance score to each other. Each cluster can have one or more associated topics and/or KeyPhrases. In at least one embodiment, each page is compared to other pages and the text of each page may be scored against the text of all (or selected) other pages in the same corpus. In at least one embodiment, the process may also assign a similarity score from each page to a list of other pages.

Further, as a result of implementing the various process, the Hybrid System may generate a list of destination pages for each origin page with a specific relevancy score. The relevancy score tells the Hybrid System how relevant is the destination page for each origin page. In at least one embodiment, origin pages can also be destination pages.

Content Sites

In at least one embodiment, the analysis processes may be utilized to analyze pages from the current site, affiliated sites, and/or external sites. For example, if the hybrid contextual advertising technique is currently run on the web page associated with the URL: www.theboyswebsite.com, it can show and link to related content on the that site, and/or it could also link to content on other sites such as, for example, www.thegirlswebsite.com. In at least one embodiment, both sites could display links to each others' content.

In at least one embodiment, the analysis processes may also analyze and cluster content that does not include the customized Hybrid tags such as those described above. In such situations, for example, the analysis processes may also analyze and cluster content via remote crawling and analysis of the content. In at least one embodiment, under this mode of operation, there is essentially no limit to the related content that could be featured and it could come from any online site or content repository. For example, related links associated with web pages of the site www.thegirlswebsite.com could feature links to www.ellemagazine.com, www.ivillage.com, etc. without requiring the running or inclusion of Hybrid tags on those sites/pages.

In at least one embodiment, the hybrid contextual advertising technique may be configured or designed to such that, without running the Hybrid tags on the site, no related links appear on those sites, and therefore such sites may only correspond to destination sites and not origin sites. Thus, for example, in at least one embodiment, a page that includes a Hybrid tag may include (or may be modified to display) related links in accordance one or more of the hybrid contextual advertising techniques described herein. Such links may lead the user to additional pages that either include Hybrid tags on them or do not include Hybrid tags. In one embodiment, a page that does not include a Hybrid tag may be used as a destination page, but may be prevented from being used as an origin page (such as those which in which may include or may be modified to display related links in accordance one or more of the hybrid contextual advertising techniques described herein).

Content Type and Format

According to specific embodiments, various types of content may be analyzed, clustered, and/or displayed as related links. In at least one embodiment it is preferable that the content include either text-based content and/or include textual meta and/or other descriptive data to help classify it (such as, for example, meta tags or tags that classify video, images, and/or audio).

The related content could be displayed within the layer and/or offered as a link to the content destination. For example, in one embodiment, a related video could be displayed within the layer, but the user could also click and view the video in larger format on the destination site.

KeyPhrase Analysis

In at least one embodiment, a variety of different processes may be implemented during KeyPhrase analysis for a given page. Examples of such processes may include, but are not limited to, one or more of the following (or combinations thereof): dynamic KeyPhrase discovery analysis, dynamic KeyPhrase selection analysis, etc.

Dynamic KeyPhrase Discovery

In at least one embodiment, as a result of the contextual and/or classification analysis processes described above, the Hybrid System may generate clusters of content sources of different type (e.g., text, video, etc.) which have been assigned relevance scores with respect to each other. At this stage, the Hybrid System may preferably select KeyPhrases on the page that will serve as the linking agent on the origin page to show the user the layer and links to the related content.

In one embodiment, KeyPhrases may be discovered or identified on a selected page using one or more KeyPhrase identification techniques such as, for example, one or more of the following (or combinations thereof):
Static KeyPhrase Analysis—KeyPhrases in the page may be identified using a static KeyPhrase list and/or hierarchical KeyPhrase taxonomy.
Dynamic KeyPhrase Analysis—KeyPhrases in the page may be discovered on the fly when analyzing the page using different methods such as part of speech tagging, natural language processing, heuristics, etc. In at least one embodiment, at least a portion of the identified KeyPhrases may not have been available or known before performing the dynamic KeyPhrase analysis.

Dynamic KeyPhrase Selection

In at least one embodiment, once one or more KeyPhrases are found and discovered on the origin page, they may be scored according to their relationship to the origin and/or destination pages. In order for the KeyPhrases to perform well, it is preferable that the finally selected KeyPhrases serve as a contextual connector between the origin and destination pages. Accordingly, in at least one embodiment, it is preferable to select KeyPhrases which may be relevant to both the origin and destination pages.

FIG. 9 shows an example of an alternate embodiment of a graphical user interface (GUI) which may be used for implementing various aspects of the hybrid contextual advertising techniques described herein. In the example of FIG. 9, it is assumed that the content of document 900 has been analyzed in accordance with a contextual analysis technique, and that selected KeyPhrases of the document have been identified. It is further assumed that at least a portion of the selected KeyPhrases have been linked to other selected resources (e.g., web pages, URLs, articles, etc.) using predetermined selection criteria. Thus, for example, as shown in FIG. 9, when a user hovers a cursor over the KeyPhrase phrase “Probotics” (601), a pop-up window or GUI 902 may be displayed to the user. In the embodiment of FIG. 9, the GUI 902 includes various types of advertiser sponsored information relating to the KeyPhrase phrase “Probotics.” According to specific embodiments, GUI 902 may include information such as, for example, images, text descriptions, links, video content, search interfaces, dialog boxes, etc. For example, according to specific embodiments:
Related content from current site (e.g., 903)—the content can be of different format (textual, images, video, audio, etc.). Related content links could be contextually related to content from the current site (e.g., that the user is currently browsing).
Related content from other sites (e.g., 905)—the list of additional sites could change dynamically and could include a relatively large amount (e.g., network of sites). Such related content may be associated with additional sites that can be affiliated with and/or not affiliated with the current site. In at least one embodiment, the related content information may include or may consist entirely of content which is not provided by the advertiser.
The related content links could lead to content of different format; text, images, video, audio, etc. In one embodiment, related content in the layer could include video and/or images that may be shown in the layer.
The ads could be of different format; text, images, animations, video (e.g., 907), and more.
The ads can originate from any ad server that can provide ads that can be displayed within the campaign provider's contextual analysis platform (such as, for example, Hybrid's contextual analysis platform). In at least one embodiment, the Hybrid contextual analysis platform may analyze and classify pages into clusters.
An optional search bar/interface (e.g., 911) may be provided that allows the user to search content on the site and/or on affiliated sites. In at least one embodiment, a general web search could be present as well.

### Example DOL Layout Types and Ad Types

According to different embodiments, different types of DOL layouts may be dynamically generated and used for display of different types of advertisements at the client system.

Examples of different types of ads may include, but are not limited to, one or more of the following (or combinations thereof):
floating-type ads
non-floating-type ads
text type ads
image type ads
video type ads
audio type ads
etc.

Examples of different types of DOL layouts may include, but are not limited to, one or more of the following (or combinations thereof):
mini content layer type DOLs
mini action layer type DOLs
compact type DOLs
expanded type DOLs
floating ad DOLs
etc.

In at least one embodiment, selection of DOL layout may be based, at least in part, upon criteria such as, for example, one or more of the following (or combinations thereof):
Publisher ID,
Channel ID,
Publisher preferences,
Ad type,
Advertiser preferences,
etc.

One type of innovative advertizing technique relates to the generation and display of “floating-type ads.” In at least one embodiment, floating ads may be characterized as a type of rich media Web-based advertisement that may be displayed on a user's computer system (e.g., a user's client system).

In at least one embodiment, a client system may be defined to include a variety of different types of computer systems such as, for example, one or more of the following (or combinations thereof):
a user's personal computer system (e.g., PC, MAC, etc.)
a publically accessible computerized display system (e.g., kiosk, terminal, remote display, etc.)
an enterprise computing system
a server system
a distributed computing system having a display and internet connection
a portable computing device such as, for example, a laptop computer, netbook computer, iPhone™, mobile phone, PDA, etc.
and/or other types of electronic devices/systems having at least one display and an interface for connecting to the internet.

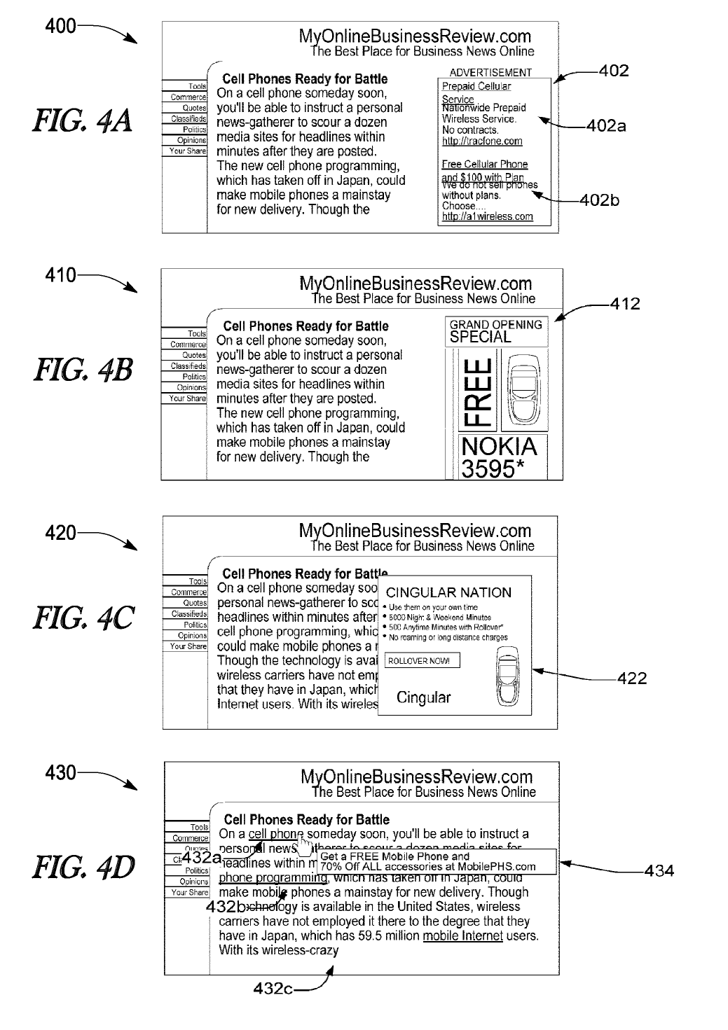

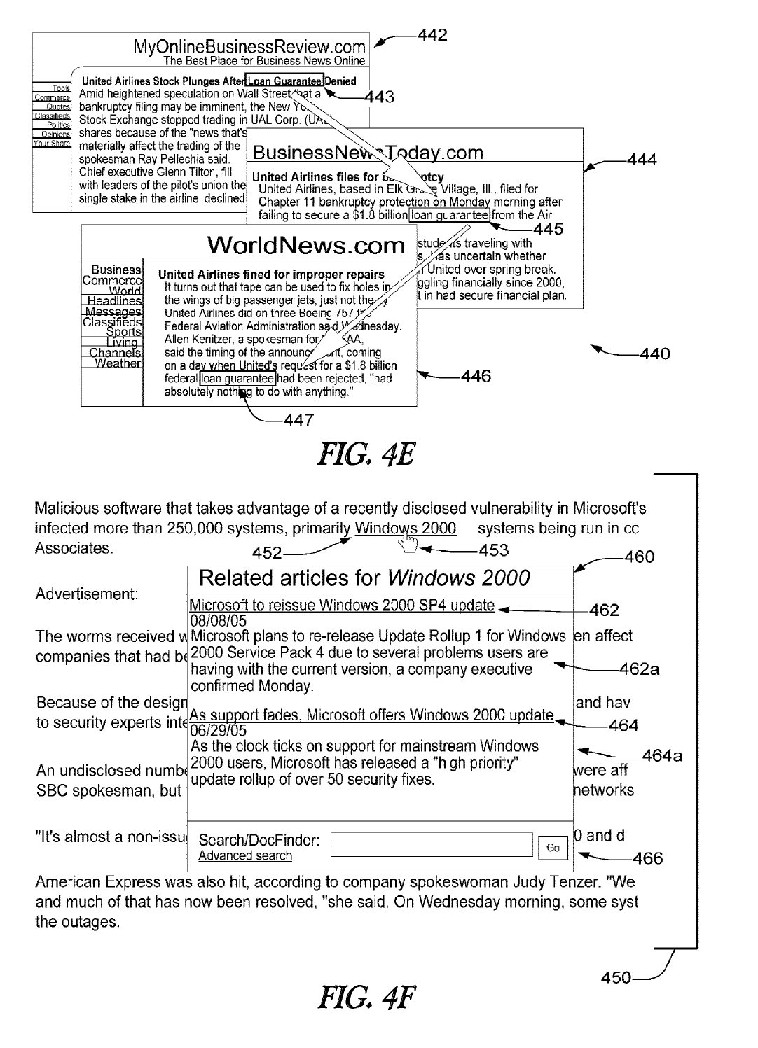

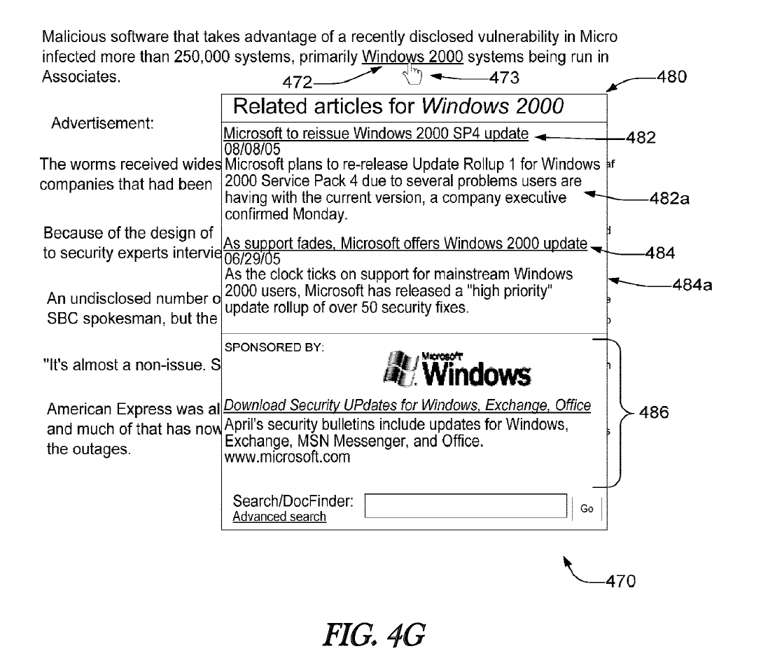

FIGS. 4A-G provide examples of various screen shots which illustrate different techniques which may be used for modifying web page displays in order to present additional contextual advertising information.

FIGS. 4A-G provide examples of various screen shots which illustrate different techniques which may be used for modifying web page displays in order to present additional contextual advertising information.

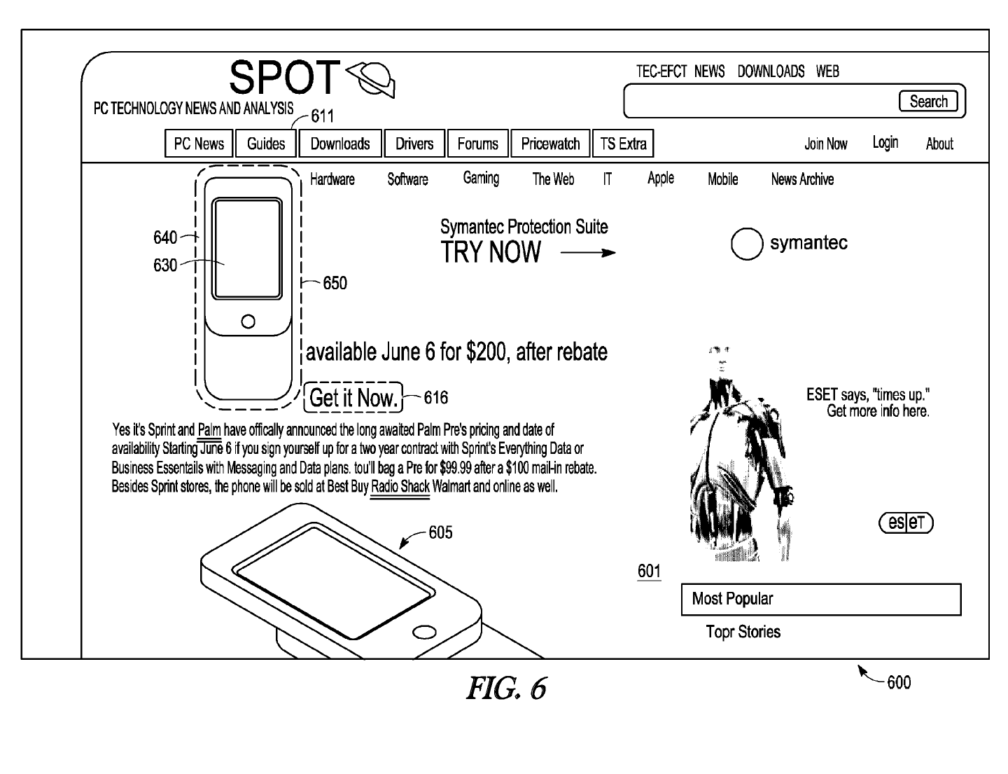

FIGS. 6 and 7A-B illustrate specific example embodiments of different examples of floating type ads which may be displayed to a user via at least one electronic display.

In at least one embodiment, floating type ads may include floating ad objects which are visually displayed as not being within (or contained within) the borders or boundary an overlay or pop-up window, but rather are displayed to visually appear as independent objects (or grouping of objects) that may be floating or hovering over the content of the page being displayed. Additionally, in at least one embodiment, the shapes and/or boundaries of the displayed floating ad units may be configured or designed to be substantially similar to the shapes of the objects which are being advertised (e.g., television shape, cell phone shape, shampoo bottle shape, etc.).

For example, as illustrated in the example embodiment of FIG. 6, a floating-type advertisement 650 for a Palm Pre handheld device is displayed (e.g., via the use of a borderless overlay layer) over a portion of web page content 601. In at least one embodiment, one or more floating-type advertisements may be automatically and/or dynamically displayed (e.g., over the displayed content of a user-requested web page) in response to detection of a mouse over event at the client system. For example, in one embodiment, the user may perform a mouse over operation in which the cursor is caused to move over (or hover over) a specific keyphrase or keyphrase (e.g., “Palm” 602). In one embodiment, this action may trigger display of the floating-type advertisement 650, as illustrated in FIG. 6, for example. In at least one embodiment, floating-type advertisement 650 may be temporarily displayed on the client system while the cursor remains hovered or positioned over a specified keyphrase/keyphrase 602 (or portion thereof), and may automatically disappear when the cursor is no longer positioned over the specified keyphrase/keyphrase.

Unlike the non floating-type advertisements, different embodiments of the floating ad objects may have different display characteristics such as, for example, one or more of the following (or combinations thereof):
Variable shapes which, for example, may be configured or designed to be similar or substantially similar to (or to have the appearance of) the various shapes, branding, and/or appearances of the objects, logos, products, etc. which are being advertised. In at least one embodiment, the shape of a specific floating-type advertisement (or portion thereof) may be configured or designed to match the contours of a specific logo or product. For example, as illustrated in the example embodiment of FIG. 6, the shape of the displayed floating-type advertisement 650 (for a Palm Pre handheld device) is substantially similar to the shape of an actual Palm Pre handheld device.
Visual depth characteristics. According to different embodiments, different floating-type advertisements may be configured or designed to have different depth-related visual display properties and/or appearances such as, for example, 2D appearance, 2D with perspective/shading/depth enhancements, 3D appearance, rotatable 3D appearance, etc. For example, as illustrated in the example embodiment of FIG. 6, the displayed floating-type advertisement 650 includes a 2-D representation of a handheld device 630, and includes shadowing content 640 which, for example, is used to enhance the depth-related appearance of the displayed handheld device object 630 (e.g., a perceived by the user).
Non-visible borders or boundaries (e.g., of the overlay layer, frame, window, etc. used to display the floating ad).
Different types of floating-type advertisement mobility or movement characteristics. For example, in some embodiments, the position or coordinates of a displayed floating-type advertisement may not be modified or changed by the user. In some embodiments, the user may be permitted to dynamically move or change the position/coordinates of the displayed floating-type advertisement. In some embodiments, the user may be permitted to dynamically move or change the position/coordinates of the displayed floating-type advertisement, but only within predetermined region(s) or zone(s) of the display. For example, in one embodiment, the user may be permitted to dynamically move or change the position/coordinates of the displayed floating-type advertisement, but may be prevented from positioning the displayed floating-type advertisement over any other displayed advertisement on that page.
Different types of transparency characteristics. For example, in some embodiments, the transparency properties of the displayed floating-type advertisements and/or the displayed web page content may be predetermined, and may not be adjustable by the user. In some embodiments, the transparency properties of the displayed floating-type advertisements and/or the displayed web page content may be automatically and/or dynamically determined and/or adjusted (e.g., by the client system) in response to different types of detected user activities. For example, in one embodiment, the displayed web page content may be automatically and dynamically changed to be more transparent when it is detected that the user has positioned the cursor over a portion of the displayed floating-type advertisement. Similarly, the displayed web page content may be dynamically changed to be more opaque when it is detected that the user's cursor is no longer positioned over the displayed floating-type advertisement. In some embodiments, the transparency properties of the displayed floating-type advertisements and/or the displayed web page content may be automatically and/or dynamically determined and/or adjusted (e.g., by the client system) in response to other types of detected events and/or conditions. For example, in at least one embodiment, the transparency properties of the displayed floating-type advertisement may be automatically and/or dynamically changed over time. For example, in one embodiment, the transparency properties of a displayed floating-type advertisement may be set to a first transparency value during a first time interval (e.g., during the first 15 seconds of the display of the floating-type advertisement, set opacity of displayed floating-type advertisement to 100%), and may be set to a second transparency value during a second time interval (e.g., after the floating-type advertisement has been continuously displayed for at least 15 seconds, set opacity of displayed floating-type advertisement to 50%). In another example, the transparency of displayed web page content may be automatically and dynamically increased when it is detected that at least one floating-type advertisement is currently being displayed. Similarly, in at least one embodiment, the transparency of displayed web page content may be automatically and dynamically decreased when it is detected that no floating-type advertisement is currently being displayed. In some embodiments, the user may be permitted to dynamically adjust or modify the transparency properties of selected floating-type advertisements which are displayed at the client system.
Different types of Triggering Events/Conditions. In at least one embodiment, various types of different events and/or conditions may be used to trigger different types of responses, actions, and/or operations performed at the client system, such as, for example, one or more of the following (or combinations thereof):
   Cursor hover/mouseover (e.g., over a highlighted keyphrase or keyphrase)
   Cursor/mouse click
   Hover+click
   Different combinational sequences of hovers and/or clicks
   Hover+hold (e.g., for minimum of T seconds)
   Click+hold (e.g., for minimum of T seconds)
   Different combinational sequences of hovers, clicks and/or holds
   Hover and/or click event(s) detected at or over portion of highlighted KeyPhrase
   Hover and/or click event(s) detected at or over portion of displayed DOL icon
   Hover and/or click event(s) detected at or over portion of mini DOL
   Hover and/or click event(s) detected at or over portion of DOL
   Cursor detected as being within vicinity of KeyPhrase
   Cursor detected as being within vicinity of DOL
   Detected cursor gesture(s)
   Detected input gesture(s) (e.g., via touchscreen and/or touchpad)
   Window activation events (e.g., which may occur when the user moves the cursor to a different window of the display screen)
   Browser tab activation event(s) (e.g., which may occur when the user moves the cursor to a different tab within the browser window)
   Verbal input
   Etc.
Different types Responses to different types of triggering events/conditions. In at least one embodiment, detection of events or conditions relating to one or more of the above-described triggering events/conditions may result in the initiation of different types of responses/activities (e.g., performed at the client system), such as, for example, one or more of the following (or combinations thereof):
   Highlight/Unhighlight KeyPhrase (e.g., based on proximity of cursor to KeyPhrase)
   Temporarily open display one or more types of floating-type advertisements (e.g., for specified time interval, while specified conditions are satisfied, etc.)
   Pin open display of one or more types of floating-type advertisements (e.g., in response to click on highlighted KeyPhrase, in response to user click on “Pin” GUI, etc.)
   Toggle or Unpin (opened) display of one or more types of floating-type advertisements (e.g., in response to user click on “Pin” GUI, etc.)
   Dynamically modify characteristic(s) and/or type(s) of floating-type advertisement(s) being displayed
   Dynamically modify shape of floating-type advertisement(s) being displayed
   Dynamically modify content of floating-type advertisement(s) being displayed
   Dynamically change a floating-type advertisement(s) being displayed
   Concurrently display an additional floating-type advertisement
   Dynamically remove a selected floating-type advertisement from display
   Dynamically modify types of content associated with one or more displayed floating-type advertisements
   Dynamically modify size of floating-type advertisement(s) being displayed
   Close display of one or more types of displayed floating-type advertisements
   Dynamically alter visual/appearance characteristics of floating-type advertisement(s) (e.g., based on detected user interaction)
   Different types of responses may be based on different combinations, sequences and/or series of triggering events
   Different types of responses may be based on different locations of detected hover(s) and/or click(s)
   Lock displayed position of floating-type advertisement
   Unlock displayed position of floating-type advertisement
   Lock displayed properties/features of floating-type advertisement
   Unlock displayed properties/features of floating-type advertisement
   Direct or redirect the client system browser to an identified landing URL
   Open, close, and/or modify a browser window or layer at the client system
   Open, close, and/or modify a browser tab at the client system
   Etc.
Different types of user interactive GUIs. In at least one embodiment, different types of user interactive GUIs may be displayed to the user. In at least one embodiment, at least a portion of these different types of interactive GUIs may enable the user to dynamically interact with the displayed floating-type advertisement, and/or may enable the user to dynamically change or modify displayed content relating to one or more floating-type advertisements.

In at least one embodiment, different types of combinational advertising techniques may be implemented on specific web page(s), which, for example, may include the display of both floating-type advertisements and non floating-type advertisements (e.g., over the content of a web page which is currently being displayed on the client system display). In some embodiments, floating-type advertisements and non floating-type advertisements may be displayed over a currently displayed web page at different times (e.g., serially and/or consecutively) in response to the user's activities.

For example, as illustrated in the example embodiment of FIGS. 7A-B, a multi-step combinational advertising technique may be employed at the client system in which, at a first time (T1), a first type of DOL layout may be used to present a mini or “teaser” floating-type advertisement (e.g., 710, FIG. 7A) over the displayed web page portion 701 in response to a first set of condition(s) or event(s) (such as, for example, in response to the user performing a mouse over or cursor click on (or over) a portion of highlighted keyphrase 702). Thereafter, at a second time (T2), a second type of DOL layout may be displayed (e.g., 720, FIG. 7B) in response to a second set of condition(s) or event(s) (such as, for example, in response to the user performing a mouse over or cursor click on (or over) a portion of the displayed floating-type advertisement (e.g., 710)).

For example, in one embodiment, the dynamic overlay layer (DOL) 720 may be dynamically and automatically generated, rendered and/or displayed in response to the user performing a mouse over action at/over at least a portion of the displayed floating-type advertisement (e.g., 710). In some embodiments, if the user were to perform a mouse or cursor click at/over at least a portion of the displayed floating-type advertisement (e.g., 710), the client system browser may be directed to a web page associated with a landing URL that is associated with the floating-type advertisement 710. In yet other embodiments, a mouse click action on the CTA portion of the floating-type advertisement may result in the user's browser being automatically directed (or redirected) to a web page corresponding to a landing URL that is associated with the CTA portion of the floating-type advertisement 710. However, in at least some embodiments, a mouse click action on a non-CTA portion of the floating-type advertisement may result in the automatic and dynamic display of a DOL (e.g., 720) at the client system.

As illustrated in the example embodiment of FIG. 7B, the second type of dynamic overlay layer (DOL) 720 may include one or more non floating-type advertisement(s) and/or other types of related content. Additionally, as illustrated in the example embodiment of FIG. 7B, the second type of DOL 720 may include a border and a callout.

It will be appreciated that other embodiments of the combinational advertising techniques (not explicitly disclosed herein) may be configured or designed to initiate different types of actions in response to the detection of different sets of event(s), condition(s) and/or other activities at the client system, as desired.

### Example Features of Hybrid DOL Embodiments

### Appearance

1. Related content may appear embedded in the source page or in a pop-up window Related content may be displayed fixed as part of the source page. Alternatively related content will display in a pop-up window in response to user action, e.g. mouse hover a highlighted link in the page.
2. Related content links could be bold Terms leading to related content may appear in a bold font weight.
3. Related content links could have bullet icon on the left side of the link Terms leading to related content may have an icon appear immediately after them.
4. Related content link could be underlined Terms leading to related content may appear underlined.
5. Borders and titles may be of different colors, width (rounded corners of variable radius). Look & feel may match publisher's/advertiser's/Hybrid's A pop-up window displaying related content may have a border. Borders may vary in width, color, and corner-rounding. Border visual settings may be modified to resemble the design of the current page, the site, the advertisement or Hybrid.
6. Related content window may have a callout pointing to the originator KeyPhrase The border of a pop-up window displaying related content may include an extension pointing at the originating term.
7. Related content window may be moved by the user A pop-up window displaying related content may have an area which responds to mouse click and drag action by changing the position of the window.
8. Related content window may change transparency while being moved While a pop-up window displaying related content is being ‘dragged’ it may change its opacity to appear semi-transparent.
9. Related content window may be closed on mouse out A pop-up window displaying related content may be hidden once the user moves the mouse pointer out of the borders of the window.
10. Related content window may be pinned (not closed until user explicitly closes it) A pop-up window displaying related content may remain visible until its ‘close’ button has been pressed, even after the user moves the mouse pointer out of the borders of the window.
11. Related content window may be of different transparency or sizes, and may change size, transparency or appearance after a certain time period or in response to user action (drag, mouse over, etc.)
A pop-up window displaying related content may appear initially small or semi-transparent, and after a certain time or in response to different events, such as the mouse pointer hovering over it, become opaque or increase in size.
12. Related content elements may be ordered on the window by relevancy, by date, by popularity or by any other metric Related articles, videos or other type of related information may be ordered according to their relevancy to the current page or the highlighted term, by the date of the related item, by items' popularity or by other metrics.
13. Related content window may appear on any computer-based system, including workstation-, desktop-, laptop-, and handheld-computers, PDA or any mobile device.

### Action

1. Open window on mouse roll over or clicks
A pop-up window displaying related content may appear in response to a user rolling his mouse over a highlighted term or the user clicking the highlighted term.
2. Clicking on related content may redirect the browser window to related information
Clicking on a pop-up window displaying related content may cause the browser to navigate away from the current page and into a page expanding on the clicked item.
3. Clicking on related content may open a new browser window showing related information
Clicking on a pop-up window displaying related content may open a new browser window in which a page expanding on the clicked item is displayed.
4. Video may start playing when the window appears, or when user requests it.
A pop-up window displaying related video may be initially displayed with the movie paused on the first frame and play the video only after the user clicks on the layer. Alternatively the video may start playing immediately as the layer appears.

### Content

1. Related content window may contain several components of different types: textual, video, advertisement etc. in different sizes and shapes
Related content may be a textual article, a video, or an advertisement. A pop-up window displaying related content may show several related content items of different types. The items may be of different sizes and shapes.
2. Related content links could have the following attributes: title, description or beginning of related article, date, thumbnail
A pop-up window displaying related content may display for each item different types of information including article or video title, the description of the item, the date of the item and an image related to the item.
3. Related content could be a page from the site
The product may lead a user to different pages within the site he is currently browsing
4. Related content could be a page from one or more specific sections of a site
If a site has different sections, e.g. finance, entertainment, international news etc., the product may lead a user to different pages in different sections of the site.
5. Related content could be a page from a different site
The product may lead a user to pages outside the site he is currently browsing
6. Related content could be a page from a dictionary, encyclopedia or other type of glossary, or any information provider (3rd party or other)
Related content is not necessarily a web page. It could be a descriptive textual snippet out of a general information source such as a dictionary, an encyclopedia etc.
7. Related content may be textual (article, blog post), image, animation clip, video, audio, odor or other type of sensory stimulation
8. Related content may include links to other types of information
9. Related content may be determined by the site publisher, including white label advertisements
A site publisher may choose which types of related content may be displayed and select the sources for the different content types.
10. Sensitive related content may blocked from appearing on specific source page topic Content which may be considered as hurtful (e.g., of a sexual or violent nature or pertaining to drug use, gambling and so on) may be filtered.
11. Pages on which to display related content be from a white list or blocked (black list)
A site owner may choose to display related content for a predefine collection of pages only, or define that content may be displayed on all (or selected ones of) pages excluding a predefined collection of pages.
12. Pages which may be displayed as related content be from a white list or blocked (black list)
A site owner may define that only pages from a predefined list may be considered as related content, or define that all (or selected ones of) pages may be considered as related content, except from pages from a predefined list.
13. Related content may be disabled by user
A pop-up window displaying related content may have an option to allow the user to indicate he does not whish to see related content.
14. Related content may be selected according to user preferences, as specified by the user A pop-up window displaying related content may have an option to allow the user to choose what types of related content he would wish to see.

### Source Page

1. Related content may appear for KeyPhrases related to the source page topic, to the target page topic or by any other criteria
A term leading to related content may be related to the page the user is currently browsing, or to the related content displayed.
2. Pages with sensitive content may be blocked from displaying related content
3. KeyPhrases for displaying related content be from a white list or blocked (black list)
A site owner may specify that terms leading to related content may be selected from a predefined set of terms only, or that all (or selected ones of) terms may be lead to related content except from terms appearing in a predefined set of terms.

### Algorithm

1. Related content may be pre-calculated or calculated on the fly dynamically Items related to a certain term on a certain KeyPhrase may be calculated periodically, or they may be calculated on demand once a user is shown a certain page.
2. Related content could be related to page's topics and KeyPhrase, or to KeyPhrase only, or to site, or to site section, or to a publisher-set topic or to a user-set topic
3. Related content may be based on real-time or off-line analysis of the source page
4. KeyPhrases for displaying related content may be selected according to their ‘quality’, where quality metrics may include KeyPhrase size, rarity in site or topic, whether they may be proper nouns, whether they contain numbers, whether they may be location names, person names
5. KeyPhrases for displaying related content may be selected according to the probability of the specific user, site users, users interested in sites of this topic, users from the specific geographical location, users active in the specific time of day being interested in the term
6. Related content may be selected according to the probability of the specific user, site users, users interested in sites of this topic, users from the specific geographical location, users active in the specific time of day being interested in the term
7. KeyPhrases for displaying related content may be selected according to their relevant to the different related content elements and/or the ad appearing on the window
8. Related content may be selected according to the CPC, CPM, CPA of the related advertisements
9. Related content could be blocked from one or more specific sections of a site
10. KeyPhrases for displaying related content may be selected according to their positions on the page, be it distance from the start of the source page, distribution on the page, distribution between viewable folds of the page, spacing between KeyPhrases, maximum KeyPhrases per page.

### EXAMPLE SCREENSHOTS

FIGS. 17-70B generally show examples of various screenshot embodiments which, for example, may be used for illustrating various different aspects and/or features of one or more Hybrid contextual advertising, relevancy and/or markup techniques described are referenced herein.

FIG. 17 shows an embodiment of a portion of an example screenshot which may be used for illustrating various different aspects and/or features of one or more Hybrid contextual advertising, relevancy and/or markup techniques described are referenced herein. In at least one embodiment, the portion of the example screenshot illustrated in FIG. 17 may correspond to a portion of content which may be displayed to an end-user at a client system. As illustrated in the example embodiment of FIG. 17, the illustrated screenshot portion shows an example of one embodiment of a Hybrid Dynamic Overlay Layer (DOL) 1701, which, for example, may be used to combine Ad revenues with additional value to end user(s). For example, as illustrated in the example embodiment of FIG. 17, the illustrated screenshot portion includes a highlighted keyphrase 1706, which is visually associated with displayed at DOL layer 1701. In at least one embodiment, DOL layer 1701 may include, but is not limited to, one or more of the following (or combinations thereof):
one or more portions of related content 1702
one or more advertisements 1704
what are more portions of related information 1708
one or more embedded user interactive search interfaces 1710
etc.

FIGS. 18A, 18B show different embodiments of example screenshots which may be used for illustrating various different aspects and/or features of one or more Hybrid contextual advertising, relevancy and/or markup techniques described are referenced herein. In at least one embodiment, the portion of the example screenshots illustrated in FIGS. 18A, 18B may correspond to a portion of content which may be displayed to an end-user at a client system. As illustrated in the example embodiments of FIGS. 18A, 18B, the illustrated screenshot portions show examples of different types of markup techniques which may be utilized for marking up, highlighting, and/or otherwise modifying one or more identified words or phrases of a source page document which for example, may be displayed at the client system.

According to different embodiments, different types of features, formatting, and/or other types of display techniques may be utilized for performing source page content highlighting, markup, hyperlinking, etc. For example, in at least one embodiment, different types of visual appearance characteristics of markup/highlight may be used such as, for example, one or more of the following (or combinations thereof):
Colors
Text formatting
Font size
Underline formatting
Animation
etc.

Additionally, in at least one embodiment, different types of hyperlinking techniques may be utilized such as, for example:
selected keyphrase type hyperlinking 1802
icon type hyperlinking 1856;
etc.

FIGS. 19A-22B show different embodiments of example screenshots which may be used for illustrating various different aspects and/or features of one or more Hybrid contextual advertising, relevancy and/or markup techniques described are referenced herein. In at least one embodiment, the portion of the example screenshots illustrated in FIGS. 19A-22B may correspond to a portion of content which may be displayed to an end-user at a client system. As illustrated in the example embodiments of FIGS. 19A-22B, the illustrated screenshot portions show examples of different types of DOL layer display techniques which may be utilized for display of one or more Hybrid DOL layers at one or more client systems, for example.

For example, as illustrated in the example embodiment of FIGS. 19A-22B, some examples of different types of DOL layer display techniques may include, but are not limited to, one or more of the following (or combinations thereof):
Mini type DOL layers which, for example, may include one or more of the following (or combinations thereof):
   Mini content layer types, e.g. 1906
   Mini action layer types, e.g. 1922, 1932
In at least one embodiment, one or more Mini type DOL layers may be configured or designed to automatically display a mini or reduced size DOL layer at the user's displayed in response to one or more events such as, for example, an event in which it is detected that a mouseover operation or mouse hover operation (e.g., 1902) being performed over a portion of a marked-up or highlighted keyphrase or keyphrase. (e.g., 1904). In at least one embodiment, the detection of such an event may initiate the automated display of various different types of mini content layers and/or mini action layers such as those illustrated, for example, in FIGS. 19A., 19B., and 19C. of the drawings.
Compact type DOL layer, e.g. FIG. 20A
Expanded type DOL layer, e.g. FIG. 20B
Dynamically expandable type DOL layer, e.g. FIGS. 21A-B
Dynamically collapsible type DOL layers, e.g. FIGS. 22A-B
etc.

FIG. 23 shows an embodiment of a portion of another example screenshot which may be used for illustrating various types of different DOL elements which may be included or displayed within one or more DOL layers. For example, as illustrated in the example embodiment of FIG. 23, DOL layer 2301 may include, but is not necessarily limited to, one or more of the following types of DOL elements (and/or different combinations thereof):
related articles, e.g. 2314
related videos 2312
topical type advertisements 2320
and/or other types of DOL element such as those described are referenced herein.

FIG. 24 shows an embodiment of a portion of another example screenshot which may be used for illustrating various types of different DOL elements which may be included or displayed within one or more DOL layers. For example, as illustrated in the example embodiment of FIG. 24, DOL layer 2401 may include, but is not necessarily limited to, one or more of the following types of DOL elements (and/or different combinations thereof):
related articles, e.g. 2414
related videos, e.g. 2412
DART type advertisements 2420
etc.

FIG. 25 shows an embodiment of a portion of another example screenshot which, for example, may be used for illustrating various types of different DOL layer customizations which may be utilized or applied at one or more Hybrid DOL layers. For example, as illustrated in the example embodiment of FIG. 25, it is assumed that a user is viewing a portion 2500 of a source webpage associated with the online publishers website CNN.com. In at least one embodiment, at least a portion of the content which is displayed within DOL layer 2501 may include various different types of DOL elements, advertisements, related content, formatting, branding, etc. which have been specifically selected and/or customized in accordance with the publisher's specified preferences.

For example, as illustrated in the example embodiment of FIG. 25, DOL layer 2501 may be specifically configured or design to include customized content such as, for example, one or more of the following (or combinations thereof):
company logos, trademarks, and/or other types of branding or marketing content, e.g. 2505
related articles which, for example, may relate specifically to the publisher's company, e.g. 2514
related videos which, for example, may relate specifically to the publisher's company, e.g. 2512
etc.

FIGS. 26A-B show different embodiments of example screenshots which may be used for illustrating a specific example embodiment of a dynamically expandable type DOL layer. According to various embodiments, different types of DOL layers may be utilized for display at a client system in response to various different sets of events and/or conditions which are detected at the client system. For example, in at least one embodiment, a first type of DOL layer may be displayed at the client system in response to detection of a first set of events (such as, for example, detection of a cursor mouseover operation or mouse hover operation being performed over a portion of a marked-up or highlighted keyphrase or keyphrase), and a second type of DOL layer may be displayed at the client system in response to detection of a second set of events (such as, for example, detection of a cursor click operation or user selection action being performed at or over a portion of a marked-up or highlighted keyphrase or keyphrase).

For example, as illustrated in the example embodiment of FIGS. 26A-B, a dynamically expandable type DOL layer display technique may be utilized, wherein, for example:
a compact type DOL layer (e.g. 2601, FIG. 20A) is displayed in response to detection of a cursor hover or mouseover event at or over a portion of highlighted keyphrase 2602; and
an expanded type DOL layer (e.g. 2651, FIG. 20B) is displayed in response to detection of a cursor click or selection event at or over a portion of highlighted keyphrase 2602

FIG. 27 shows an embodiment of a portion of another example screenshot which may be used for illustrating at least one type of DOL layer user interaction technique which may be implemented in accordance with a specific embodiment. According to different embodiments, the displayed content and/or DOL element types which are displayed within a given DOL layer may be configured or designed to automatically and dynamically change in response to various detected conditions and/or events which, for example, may include events relating to user interaction with selected portions of the DOL layer.

For example, as illustrated in the example embodiment of FIG. 27, DOL layer 2701 may display one or more related video elements as shown, for example, at 2370. In at least one embodiment, when the user clicks (e.g., 2731) on one of the displayed related video elements (e.g., 2732), the DOL layer 2701 may respond by displaying the selected video within the DOL layer, as shown, for simple, at 2720. In at least one embodiment, the video content which is displayed within video display portion 2720 may be automatically retrieved and/or served, in real time, in response to the user's action(s).

As shown at 2802 of FIG. 28, different types of static and/or dynamically changing content may be displayed within a portion of the DOL layer to indicate to the user that content (e.g., the user's selected video content) is being loaded and/or retrieved.

In at least one embodiment, one or more DOL layers may be configured or designed to play video content within the DOL layer. In some embodiments, user selection of a portion of related video content displayed within DOL layer may trigger playing of the video in a new layer or window.

Examples of different types of triggering events and/or conditions may be used to trigger different types of responses, actions, and/or operations performed at the client system may include, but are not limited to, one or more of the following (or combinations thereof):
Cursor hover/mouseover (e.g., over a highlighted keyphrase or keyphrase)
Cursor/mouse click
Hover+click
Different combinational sequences of hovers and/or clicks
Hover+hold (e.g., for minimum of T seconds)
Click+hold (e.g., for minimum of T seconds)
Different combinational sequences of hovers, clicks and/or holds
Hover and/or click event(s) detected at or over portion of highlighted KeyPhrase
Hover and/or click event(s) detected at or over portion of displayed DOL icon
Hover and/or click event(s) detected at or over portion of mini DOL
Hover and/or click event(s) detected at or over portion of DOL
Cursor detected as being within vicinity of KeyPhrase
Cursor detected as being within vicinity of DOL
Detected cursor gesture(s)
Detected input gesture(s) (e.g., via touchscreen and/or touchpad)
Window activation events (e.g., which may occur when the user moves the cursor to a different window of the display screen)
Browser tab activation event(s) (e.g., which may occur when the user moves the cursor to a different tab within the browser window)
Verbal input
Etc.

Examples of different types of responses, actions, and/or operations performed at the client system (e.g., in response to detection of one or more triggering events/conditions) may include, but are not limited to, one or more of the following (or combinations thereof):
Highlight/Unhighlight KeyPhrase (e.g., based on proximity of cursor to KeyPhrase)
Temporarily open display one or more types of floating-type advertisements (e.g., for specified time interval, while specified conditions are satisfied, etc.)
Pin open display of one or more types of floating-type advertisements (e.g., in response to click on highlighted KeyPhrase, in response to user click on “Pin” GUI, etc.)
Toggle or Unpin (opened) display of one or more types of floating-type advertisements (e.g., in response to user click on “Pin” GUI, etc.)
Dynamically modify characteristic(s) and/or type(s) of floating-type advertisement(s) being displayed
Dynamically modify shape of floating-type advertisement(s) being displayed
Dynamically modify content of floating-type advertisement(s) being displayed
Dynamically change a floating-type advertisement(s) being displayed
Concurrently display an additional floating-type advertisement
Dynamically remove a selected floating-type advertisement from display
Dynamically modify types of content associated with one or more displayed floating-type advertisements
Dynamically modify size of floating-type advertisement(s) being displayed
Close display of one or more types of displayed floating-type advertisements
Dynamically alter visual/appearance characteristics of floating-type advertisement(s) (e.g., based on detected user interaction)
Different types of responses may be based on different combinations, sequences and/or series of triggering events
Different types of responses may be based on different locations of detected hover(s) and/or click(s)
Lock displayed position of floating-type advertisement
Unlock displayed position of floating-type advertisement
Lock displayed properties/features of floating-type advertisement
Unlock displayed properties/features of floating-type advertisement
Direct or redirect the client system browser to an identified landing URL
Open, close, and/or modify a browser window or layer at the client system
Open, close, and/or modify a browser tab at the client system
Etc.

In at least one embodiment, an excerpt or abstract of one or more related articles or documents may be displayed within the DOL layer. Subsequent user selection of related excerpt/abstract may trigger opening of new page corresponding to URL of full article/document.

According to different embodiments, one or more features relating to automatic and dynamically customizable configuration(s) of the various different types of DOL characteristics of one or more DOL layer(s) may be based, for example, on various types of criteria such as, for example, business rules, publisher preferences, and/or other constraints. Examples of various customizable DOL characteristics may include, but are not limited to, one or more of the following (or combinations thereof):
Size of DOL layer
Displayed position of DOL
Colors, formatting, and/or other types of appearance characteristics of DOL
“Look and Feel” of DOL (e.g., use of logos, branding, headers, footers, etc.)
Types of DOL elements (e.g., included or displayed at DOL)
Triggering events
DOL layout characteristics
Content formatting characteristics
Visual and/or audio characteristics
Related Content options (e.g., Related, Related+image, Title, description, date, etc.)
Related Video option (e.g., Video, Title, description, date)
Ad options (e.g., text, rich media, text+logo, image, etc.)
etc.

In at least one embodiment, any combination of the above may be presented in a given Hybrid DOL layer.

FIGS. 30A-35D illustrate various example screenshots of different types of DOL layers which may be displayed at a client system in response to various types of user-DOL layer interactions.

As illustrated in the example embodiment of FIGS. 30A-C, when the user rolls over the highlighted keyphrase, the Hybrid DOL layer appears. Upon rolling over the ad, the ad expands to a full size (e.g., 300×250).

As illustrated in another example embodiment of FIG. 31, an icon of a layer appears next to the highlighted keyphrase. When the user clicks on the icon, the Hybrid DOL layer appears.

As illustrated in another example embodiment of FIGS. 32A-B, when the user rolls over the highlighted keyphrase, a tooltip describing the layer appears. A click on the keyphrase opens the Hybrid DOL layer.

As illustrated in another example embodiment of FIGS. 33A-C, when the user rolls over, an icon of a layer with a call to action “Lear More” appears. A click on the icon expands the Hybrid DOL layer.

As illustrated in another example embodiment of FIGS. 34A-C, when the user rolls over the highlighted keyphrase, a mini-layer, which displays one related article appears. A click on the mini-layer opens the full layer.

As illustrated in another example embodiment of FIGS. 35A-D, when the user clicks on the highlighter keyphrase, the Hybrid DOL layer appears and floats to the right. After a few seconds the layer is condensed to an icon. A click on the icon expands the layer again.

FIGS. 36-63 illustrate example screenshots of different example DOL layer embodiments which, for example, are used to illustrate various different types of possible features, functionalities, DOL layer elements, and/or other DOL layer characteristics which may be provided or utilized at one or more DOL layers.

For example, as illustrated in the example embodiment of FIG. 36, DOL layer 3600 may reference and/or display content relating to one or more related article elements (e.g., 3610) which, for example, may display the article's title and its first (n) line(s) of text. Additionally, as illustrated in the example embodiment of FIG. 36, DOL layer 3600 may reference and/or display content relating to text and/or logo advertisement(s) (e.g., 3620) which, for example, may include one or more of the following (or combinations thereof): image(s), ad title, ad description, landing URL, UI button, etc.

As illustrated in the example embodiment of FIG. 37, DOL layer 3700 may reference and/or display content relating to, for example, multiple different Related Articles (e.g., 3711, 3713) that display each article's title and it's first (n) lines of text. Additionally, as illustrated in the example embodiment of FIG. 37, DOL layer 3700 may reference and/or display content relating to multiple different Related Videos (e.g., 3721, 3723) which display each video's title. A Textual advertisement (e.g., 3730) may also be displayed which includes ad title, ad description and landing URL.

As illustrated in the example embodiment of FIG. 38, DOL layer 3800 may reference and/or display content relating to, for example, multiple different Related Articles (e.g., 3811, 3813) that include article titles and their first line(s). A Text and Logo advertisement (e.g., 3820) may also be displayed which includes ad title, ad description and landing URL, and button.

As illustrated in the example embodiment of FIG. 39, DOL layer 3900 may reference and/or display content relating to, for example, multiple different Related Videos (e.g., 3911, 3913) that includes videos' titles. A Textual advertisement (e.g., 3920) may also be displayed which includes ad title, ad description and landing URL.

As illustrated in the example embodiment of FIG. 40, DOL layer 4020 may reference and/or display content relating to, for example, multiple different Related Articles (e.g., 4022a, 4022b) that includes articles' titles and their first lines. A Text and Logo advertisement (e.g., 4024) may also be displayed which includes ad title, ad description and landing URL, and button.

As illustrated in the example embodiment of FIG. 41, DOL layer 4120 may reference and/or display content relating to, for example, multiple different Related Articles (e.g., 4122a, 4122b) that includes articles' titles and their first lines. A Text and Logo advertisement (e.g., 4124) may also be displayed which includes ad title, ad description and landing URL, and button.

As illustrated in the example embodiment of FIG. 42, DOL layer 4204 may reference and/or display content relating to, for example, a plurality of related articles and associated images In at least one embodiment, each related article DOL elements may include display of the title, description, date, abstract, summary, selected lines of text, etc. In at least one embodiment, clicking on a portion of a displayed related article element leads to the target page associated with that particular related article.

As illustrated in the example embodiment of FIG. 43, DOL layer 4304 may reference and/or display content relating to, for example, one or multiple different related videos. In at least one embodiment, each displayed related video element may include information such as, for example, title, date, brief description, textual ad component, etc. In at least one embodiment, clicking on a portion of a displayed related article element causes the selected video to be played within the DOL layer.

As illustrated in the example embodiment of FIGS. 44A-B, a displayed DOL layer may reference and/or display content relating to multiple different related videos. In at least one embodiment, each displayed related video element may include information such as, for example, title, date, brief description, image/still frame of video, etc. In at least one embodiment, clicking on a portion of a displayed related article element causes the selected video to be played within the DOL layer (e.g., as shown at FIG. 44A). In at least one embodiment, when the video has finished playing, an Ad may appear within the DOL layer portion where the video had played (e.g., as shown, for example, at 44B).

In at least one embodiment, automatic and dynamic configuration and/or selection of at least a portion of the above referenced DOL characteristics of a given DOL layer may be based, at least in part, on one or more different types of rules, constraints, and/or preferences relating to one or more of the following (or combinations thereof):
Network level based rules, constraints, and/or preferences
Publisher level based rules, constraints, and/or preferences (e.g., each publisher may specify their own preferred preferences/criteria for customized DOLs to be displayed in association with that publisher's web pages)
Channel level based rules, constraints, and/or preferences (e.g., different specified preferences/criteria may be for generating customized DOLs to be displayed in association with different channels of a given publisher (and/or different channels of multiple different publishers)
Cross-Channel level based rules, constraints, and/or preferences (e.g., different specified preferences/criteria may be for generating customized DOLs to be displayed in association with selected channels associated with multiple different publishers)
Vertical level based rules, constraints, and/or preferences
etc.

According to different embodiments, examples of different types of DOL Elements which may be included or displayed at a given DOL layer may include, but are not limited to, one or more of the following (or combinations thereof):
Ads
   Optionally included in DOL based on preferences of publisher (e.g., source page publisher)
   Run-of-Site AdGroup placement
   Channel campaign placement
Video (e.g., streamed video)
   May be played/displayed within DOL
   May be played/displayed in new window/layer
   May be played/displayed in new document
Audio
Related information (e.g., related page)
Related content
Related articles
Related links
Images
Animation (e.g., Flash)
External feeds (e.g., RSS)
etc.

According to different embodiments, the selection, use, and/or configuration each different type of DOL element (and/or combinations) of a given DOL layer may be based, at least in part, on one or more of the following (or combinations thereof):
Network level based rules, constraints, and/or preferences
Publisher level based rules, constraints, and/or preferences
Channel level based rules, constraints, and/or preferences
Cross-Channel level based rules, constraints, and/or preferences
Vertical level based rules, constraints, and/or preferences
etc.

### Examples of Hybrid Advertiser and Publisher GUIs

FIGS. 64A-66F illustrate various example embodiments of different graphical user interfaces (GUIs) to the Hybrid System which, for example, may be used for providing or enabling access to entities such as, for example, advertisers, campaign providers, publishers, etc.

In at least one embodiment, as illustrated, for example, at 6652 of FIG. 66F, a Publisher Relevancy Threshold component (6642b) may be provided to enable publisher to specify, if desired, desired minimum threshold criteria for KeyPhrase relevancy for allowing KeyPhrase match/markup on one or more of the publisher's webpages.

In at least one embodiment, relevancy thresholds may be set on a per campaign basis—allowing different campaigns to be displayed with different rules. This provides for a number of benefits and advantages such as, for example”
allows for more tailored targeting of different types of advertisers
   narrow−relevancy threshold=high;
   wide−relevancy thresh=low (for greater exposure)
allows for extra level of differentiation from
relevancy threshold per publisher
relevancy threshold per page

In at least one embodiment, relevancy thresholds may be specified by advertiser and/or publisher (e.g., via Advertiser GUI(s), Publisher GUI(s)), such as that illustrated, for example, and FIGS. 66E and 66F.

### EXAMPLE

Assume we have a campaign with thresh of 0.5 and 2 potential source pages. On one of the pages it has score of 0.4 and on the other it has score of 0.6. In at least one embodiment, KeyPhrase highlighting/markup may be performed on the 0.6 page.

### Campaign Targeting Using Exact Match, Broad Match, Extended Match, Topical Match

As described in greater detail herein (such as, for example, with respect to FIG. 10), one or more different types of ad bidding processes may be utilized for acquiring and/or identifying a portion of the ad candidates which may be considered for selection and presentation at the client system. Examples of the various types of ad bidding processes which may be utilized may include, but are not limited to, one or more of the following (or combinations thereof):
Manual-type Ad Bidding Process—Advertiser (or ad campaign provider) manually inputs and/or selects Keyphrases or KeyPhrases (KPs) to be associated with each given Ad. In at least one embodiment of the Manual-type Ad Bidding Process, the advertiser may upload a list of KeyPhrases and may bid a desired CPC amount for each KeyPhrase. In at least one embodiment, in order to facilitate performance tracking, KeyPhrases which are to be associated with a given ad may each be associated with a respectively different copy or version of the ad, wherein each different ad version or copy has associated therewith a respectively different landing URL. According to different embodiments, the Hybrid System and/or client system(s) may make selection of preferred Ad candidates for a given KeyPhrase via separate asynchronous process(es) (which, for example, may be initiated or performed before the end user initiates a source page URL request at the client system).
Topic-type Ad Bidding Process—Advertiser (or ad campaign provider) inputs or selects one or more topic(s) relating to a given Ad. In at least one embodiment of the topic-type ad bidding process, the advertiser may provide topic input regarding one or more selected page topics which the advertiser has determined (and/or desires) to be related to a given Ad. In at least one embodiment, the advertiser may provide (e.g., via one or more of the Hybrid Advertiser GUIs illustrated and/or described herein) at least a portion of it's topic input data (e.g., in addition to other Ad data provided by Advertiser) to the Hybrid System during the ad campaign configuration process. In at least one embodiment, the Hybrid System performs analysis, and provides recommended, contextually relevant KeyPhrases (KPs) (e.g., from DTD) based on topic input data provided by Advertiser. Advertiser may chose to select/approve all (or selected ones of) recommended KPs, may chose to select/approve specific recommended KPs, may chose to select one or more KPs provided by the advertiser, and/or various combinations of the above. In at least one embodiment, the advertiser may provide a different CPC bid for each topic selected/approved by the advertiser. According to different embodiments, any (or only selected ones) of the KPs associated with a given topic may be potential KP candidates for highlight, markup, and linking to the advertiser Ad. In at least one embodiment, the advertiser may remove, add, update and/or modify the list of approved KPs (e.g., for one or more specified ads) based on the advertiser preference criteria provided by the advertiser.
Automated-Type Ad Bidding Process—In at least one embodiment of the automated-type ad bidding process, the advertiser (or ad campaign provider) provides Ad data (e.g., corresponding to one or more ads), and the Hybrid System uses the input ad data (provided by the advertiser) to automatically perform all other operations which may be needed/desired for creating and implementing a successful ad campaign using at least a portion of the advertiser's ads. For example, in at least one embodiment, the Hybrid System may be operable to automatically and dynamically perform one or more of the following (e.g., for creating and implementing a successful ad campaign for the advertiser):
   Analyze the ad data provided by the advertiser;
   Perform ad topic classification processing on at least a portion of the input ad data, which, for example, may include analyzing or evaluating each of the ads (e.g. provided by the advertiser) for its relatedness to each (or selected ones) of the topics identified in the dynamic taxonomy database (DTD). In at least one embodiment, the ad topic classification processing may include analyzing the landing URL page content associated with each of the ads for its relatedness to each (or selected ones) of the topics identified in the dynamic taxonomy database (DTD). In at least one embodiment, the output of the ad topic classification processing includes a distribution of topics and associated relatedness scores representing each topic's respective relatedness to each of the advertiser's ads. (see, e.g., 1604, 1606, 1608, FIG. 16A);
   Analyze and classify selected pages of the advertiser's website;
   Automatically select, based at least in part upon the analysis/classification of selected pages of the advertiser's website, at least one set of contextually relevant KeyPhrases which best match or relate to the content on the advertiser's site. In at least one embodiment, the Hybrid System may automatically identify and/or select different sets of contextually relevant KeyPhrases to be associated with respectively different portions or channels of the advertiser's site.
   Determine, identify and select, using at least a portion of the ad data provided by the advertiser, a respective set of contextually relevant KeyPhrases (KPs) to be associated with each of the advertiser's ads. In at least one embodiment, a different set of contextually relevant KeyPhrases (KPs) may be associated with a respective ad of the advertiser's ads. Additionally, in some embodiments, some of the different sets of contextually relevant KeyPhrases (KPs) may include one or more similar and/or identical KeyPhrases.

In at least one embodiment of the automated-type ad bidding process, the advertiser may specify a range of minimum and maximum CPC values that the advertiser is willing to pay. In at least some embodiments, the advertiser's bidding information may be applied globally (e.g., across all of the advertiser's ads). Additionally, in at least some embodiments, the advertiser's bidding information may be applied selectively to one or more different sets of ads. For example, in one embodiment, the advertiser may specify a first range of minimum and maximum CPC values that the advertiser is willing to pay for a first set of the advertiser's ad(s), and may specify a second range of minimum and maximum CPC values that the advertiser is willing to pay for a second set of the advertiser's ad(s).

It will be appreciated that, in at least some embodiments of the Ad-KeyPhrase bidding process and/or ad campaign configuration process, the Advertiser is not required to provide any Keyphrase or KeyPhrase input or data, if desired. Further, in other embodiments of the Ad-KeyPhrase bidding process and/or ad campaign configuration process, the Advertiser is permitted to provide any Keyphrase or KeyPhrase input or data (e.g., regarding keyphrases or keyphrases which the advertiser desires to be associated with one or more ads). However, in at least some embodiments, the advertiser may elect (if desired) provide Negative KeyPhrase information, which, for example, may include a list of negative KeyPhrase that are not to be used (e.g., for all or selected ones of the advertiser's ads).

In at least one embodiment, each ad may include or have associated therewith a respective set of ad information (also referred to as “ad data”) which, for example, may include, but is not limited to, one or more of the following (or combinations thereof): Landing URL, Title of Ad, Description of Ad, Graphics/Rich Media, CPC (e.g., cost-per-click or amount bidder willing to pay per click), etc.

One advantage of this feature is that it provides a mechanism for allowing for different types of targeted advertising. Several examples of this are illustrated below.

### Example #1

Advertiser bids on KeyPhrase: “credit card”
exact match-must match exactly to phrase
broad match—matches to either “credit” or “card” would be candidates for markup
extended match—identifies and matches to additional keyphrases/phrases adjacent to “bidded” KW (“credit card”)
   eg. “student credit card” could be identified and marked up (or may be considered candidate for markup).
topical match—advertiser buys topics (instead of or in addition to buying KWs)
   source phrases matching to bidded topic may be candidates for markup
   different from fuzzy search—e.g., Topic match provides at least 4 different ways to match: 3 are related to the phrases, and one is on a topic level
   topical matching allows for identification and/or matching of KeyPhrase beyond mere truncation matching.

### Example #2

An example of this is illustrated below with reference to FIG. 67.

FIG. 67 shows an example portion of content which includes one or more key phrases (e.g., 6703) which may be marked up in accordance with one or more of the Hybrid advertising techniques described herein.

Referring to the example illustrated in FIG. 67:
In Exact match only if advertiser bought ‘health coverage’ it will be highlighted.
In Extended match even if advertiser bought ‘health’, Hybrid System can still highlight ‘health coverage’

Another feature which may be implemented in at least some embodiments disclosed herein relates to the combining regular content link and hybrid product on same page. For example, in at least one embodiment, it is possible to highlight some phrases and show:
Just ads
Just related content
   Combination of both (e.g., may be mixed on the same source page)
May be based on:
   Type of phrase
   Properties or heuristics of the phrase such as, for example:
      Verb in phrase
      Proper noun that

The following example is intended to help illustrate this feature.

Example:
if the phrase “buy computer online” is identified—markup for showing AD
if phrase “barak obamma” identified—markup for showing related content

Consideration of Keyphrase Properties Phrases have different properties. Named entities (people) typically don't have much commercial value, but have informational values (ie Bill Gates—is a good phrase for information such as biography, related articles etc.). Company names are also better for information for example ‘microsoft’ can trigger stock quotes, related articles about microsoft etc. Phrases that are noun phrases or verb phrases like ‘buy online computer’ or ‘cheap laptop’ are usually better for commercial purposes such and will usually serve for advertising purposes.

Displaying Content Link or Hybrid Based on User Behavior

(may take into account user related behaviour)

Examples:
If the Hybrid System learns that user a clicks on related content but not ads, show that user more related content and less ads
If the Hybrid System learns that user b clicks on ads but not related content, show that user more ads and less related content

Examples of:
User behaviours which may be tracked: clicks, mouseovers, pages user visited.
Types of responses performed by hybrid system: based on user response to specific phrases, decide if to highlight them the next time or not
Additional details relating to how individual user behaviors are tracked—in at least one embodiment, using a unique cookie, either in the client or the server side, keep track of all users actions such as pageviews, mouseovers, clicks.

Displaying Content Link or Hybrid Based on Page Properties

(may take into account page properties)
I. Content of page (e.g. Page properties)
ii. type of site (e.g., site properties)
iii. historical use of site by users

### Hybrid Crawling Operations

FIG. 89 shows a example block diagram visually illustrating various aspects relating to the Hybrid Crawling Operations. A brief description of at least some of the various objects represented in the specific example embodiment of FIG. 89 is provided below.

In at least one embodiment, the Hybrid System is operable to automatically and dynamically crawl large corpus of documents to extract phrases and gather information. For example, as illustrated in the example embodiment of FIG. 89, the Hybrid System may be configured or designed to crawl various different networks such as, for example, one or more of the following (or combinations thereof):
Private networks 8910 (e.g., Kontera network, Hybrid network, etc.)
Authority sites 8920 such as news papers, universities, sites that may be known to be authority on specific subjects such as www.nfl.com, www.nba.com, www.econ.berkeley.edu, etc.
Vertical sites (sports, tech, etc)
All or selected portions of the World Wide Web 8930 (such as, for example, general/random sites from web)
etc.

As illustrated in the example embodiment of FIG. 89, phrase analysis may be performed on the crawl data/content, which, for example, may include the parsing of document, extraction of phrases, and classification of context. In at least one embodiment, the extracted and classified phrase data (e.g., 8914, 8924, 934) may be aggregated and stored at appropriate locations of the Related Repository. In at least one embodiment, the aggregation operations may be implemented using parallelization techniques such as, for example, (see, e.g., http://en.wikipedia.org/wiki/MapReduce).

In at least one embodiment, the DTD portion of Hybrid Related Repository may be populated with information relating to each word or phrase that is processed. Examples of such information may include, for example, one or more of the following (or combinations thereof):
reference to all (or selected ones of) pages the phrase appeared in
Extraction reason
Related phrases
Topics and their scores in all (or selected ones of) these pages
Summary of topic distribution for each phrase
Frequency of phrase within the different corpuses

FIGS. 91-93 show different examples of hybrid phrase matching features in accordance with a specific embodiment.

FIG. 90 shows a example block diagram visually illustrating an example of a hybrid phrase matching operation in accordance with a specific embodiment. A brief description of at least some of the various objects represented in the specific example embodiment of FIG. 90 is provided below.

Matching phrases to documents
Phrases may be matched to publisher site
Phrases may be matched to advertiser site
Phrases may be matched to any content

Phrase matching algorithm—scoring a phrase to a document
Each phrase is fetched from a database or a distributed cache (such as http://www.scaleoutsoftware.com)
Each document is classified into the taxonomy. Input document, output vector of topics representing the document
Vector space comparison may be performed between the topics of the phrase and the topics of the document resulting in a score that reflects the relevancy of the phrase to the specific document. Comparison may be done using algorithms such as: Cosine Similarity http://en.wikipedia.org/wiki/Cosine_similarity or Jaccard index http://en.wikipedia.org/wiki/Jaccard_index

Highlighting phrases for Content link, Related link or Hybrid link

Document to target site matching
Both source document and target document may be classified into taxonomy producing a vector of topics for each document
Comparison of the vectors (described above) creates a score of relevancy between the source and target page
Comparison between the phrase and the source page (as described above)
Comparison between the phrase and the target page (as described above)
Using the 3 scores (source—target, phrase—source, phrase—target) decide which terms may be good potential for highlight.

In at least one embodiment, phrases may be used to augment search and other queries. The expanded query can contain the original phrase, or be from a similar dynamic topic distribution. An example of this feature is illustrated in FIG. 91, a specific example of which is described below for purposes of illustration and by way of example with reference to FIG. 91.

In this particular example, the following search scenario is assumed:
User enters search query in the search box
Search system queries dynamic taxonomy via web-service
Dynamic taxonomy suggest additional phrases that may be related to original query, in order to improve precision and recall of search request (http://en.wikipedia.org/wiki/Precision_and_recall)
In the above example, user enters the term ‘credit’ after querying the dynamic taxonomy, the search engine can search queries such as ‘debit’, ‘personal finance’ and credit card to obtain better results for user. This data is novel, and can not be extracted from search query logs alone.
Dynamic taxonomy can help solve ambiguities. For example when a user searches for ‘Jaguar’ search engine cannot know if user means Jaguar (cat) or Jaguar (car). Using the dynamic taxonomy, search engine can understand the term is ambiguous (since it has skewed distribution of topics in different areas),
   Search engine can ask user if he wants results for Jaguar the car or the cat.
   Search engine can group results into several clusters depending on their context

As illustrated in the example embodiment of FIG. 92, phrases may be used for KeyPhrase advertising. For example, as shown at 9202, the advertiser website is crawled, and KeyPhrases are extracted (9210) and matched (9220) to the dynamic taxonomy, and new words may be bided for online advertising. Another example of this feature is described below for purposes of illustration.

Example Hybrid Keyphrase Suggestion Process
Advertiser insert his website URL, and any other textual information that describes his business. This may be done via Hybrid's website, or through web services provided by Hybrid System.
Hybrid crawls the advertiser website, and classify its different pages
Hybrid extracts phrases from the advertiser website based on the technologies mentioned above.
Hybrid can suggest the advertiser phrases that were extracted from his site.
Hybrid can suggest the advertiser phrases that will fit his web site, but that were not found on his site originally, by scoring their relatedness to his website. The vector of topics of each phrase in the Hybrid Repository is compared to the vector of topics of the specific advertiser, phrases that path a certain threshold may be potential suggestions.
The KeyPhrase suggested may be used for:
   Generating more content for the advertiser web site, for better search ranking
   Bidding KeyPhrases in the Hybrid System
   Bidding phrases in any paid search application

As illustrated in the example embodiment of FIG. 93, phrases May be used for related links implementations. For example, in one embodiment, the original page is analyzed via Dymamic Taxonomy, and main phrases may be extracted and may be displayed as related results.

In at least some embodiments, the Hybrid System may be configured or designed to provide various other types of features and/or functionalities such as, for example, one or more of the following (or combinations thereof):
Hybrid System provides the website a solution for outside related information. Integration may be done via:
   Iframe on website
   Javascript on website
   Widget provided by Hybrid System
Hybrid System extracts page, classify it, and extract its phrases
Hybrid System suggests additional phrases to the user (links, images etc) that may be related for the specific page, and may interest the user based on the semantic and contextual analysis.
Phrases suggested may be part of the original text
Phrases suggested may be related to original text, but don't need to appear in original text
For example, user reads a page about personal finance and Debit cards. The Hybrid System suggest related links about ‘Debit Card’ that was part of the original page, and ‘Saving account’ that didn't appear on original page.
Results may be presented in a box outside the text, and may include text links, images, videos etc.
Results may be presented in a cloud formation, with more related phrases appearing in a more distinct manner.
Phrases may be used for cloud tag implementation
Phrases may be used for automatic content tagging
   Hybrid System automatic tagging of content
   Hybrid System offers integration via web-services where a user submit any html content for automatic tagging
   Hybrid System analyzes original source of information as described above
   Hybrid System classify the content and extracts keyphrases.
   Hybrid System suggest phrases that were extracted from original content, and from the Hybrid System dynamic repository to the user.
   The phrases extracted may be used by the user to tag or index its content. (see tagging: http://en.wikipedia.org/wiki/Tag_(metadata))

### EXAMPLE EMBODIMENTS OF HYBRID SYSTEM COMPONENT INTERACTIONS

As discussed previously (e.g., with respect to FIGS. 1, 2A, 2B) Front End and/or Back End may be responsible for serving of different type of requests. In at least one embodiment, the Front End is responsible for handling pages that were processed, and to select in real time the different components the user will see based on its Geo location, the ERV values, the ad inventory, etc. (See layout in U.S. patent application Ser. No. 11/732,694 (Attorney Docket No. KABAP011B)). When a new page arrives, it is not in the cache, and it is sent for further processing in the Back End, which does the parsing, classification, phrase extraction, indexing, and matching of related phrases and content.

FIGS. 83-86 illustrated example block diagrams illustrating additional features, alternative embodiments, and/or other aspects of various different embodiments of the Hybrid contextual advertising and related content analysis and display techniques described herein.

Front End Analysis

A brief description of at least some of the various objects represented in the specific example embodiment of FIG. 83 is provided below.

8302—JavaScript—the client side script that sends the URL to the server

8304—Front End—the module responsible for handling a concrete user request, after it was processed and cached by the Back End

8306—Cache—a distributed repository that holds selected pages, phrases, and/or related content that has been analyzed in the past.

8308—Back End—the module responsible for analyzing a page the first time the Hybrid System sees it. Analysis includes parsing, phrase extraction, classification, indexing and retrieving all (or selected ones of) related documents.

A brief description of at least some of the various objects represented in the specific example embodiment of FIG. 84 is provided below.

8401—getResults—input key representing page

8403—output—results from cache for that page (if in Cache=true) results include all (or selected ones of) the potential phrases, their scores, their topics and their related pages.

8405—getERVResults—input: URL, phrase, target URLs

8407—return ERV score for each phrase based on past performance

8409—select highlights input: all (or selected ones of) phrases, their scores, and locations

8411—output—the specific phrases to highlight

8413—Report—input URL, and phrases highlighted

8415—if page isn't in the cache—send a processing request via Queue to Back End.

In at least one embodiment, the Front End is responsible for handling user request/response. The input to the front end, is a URL sent by the Javascript from the Hybrid System may User, this initiates the calculation of the concrete response that is returned to the user. The responses may be javascript instructions that may be sent back to the client in order to present the layers (the previous Hybrid Patent)

In at least one embodiment, the cache is responsible for holding the pre calculated phrases and related pages from the Back End. When the Front End gets a request, it checks if the page details may be in the cache. If the cache doesn't have details, it sends a request to the Back End queue for page analysis. The cache is a 3-level cache which holds information in memory, in memory outside the process and on disk. This enables the cache to be scalable, distributed and redundant.

In at least one embodiment, ERV component may assign value for each phrase, target combination. This is based on a Click-Through-Rate (CTR) prediction algorithm such as that described, for example, in U.S. patent application Ser. No. 11/732,694 (Attorney Docket No. U.S. patent application Ser. No. 11/732,694 (Attorney Docket No. KABAP011B)). The CTR is than multiplied by a value parameter that may be the CPC/CPM of the ad component, the CPM of the target page, or any other value the publisher select to give pages in his site. For example if a publisher wants to move traffic from one area of his site to another, he will give higher value to the preferred channel.

In at least one embodiment, the Layout component is responsible for selecting the actual highlights, related content, related video and related ads. The layout uses input from the ERV and the relevancy score for each origin/target in order to select the optimal highlights and information based on spatial arrangement and scores. The layout is such as that described, for example, in U.S. patent application Ser. No. 11/732,694 (Attorney Docket No. U.S. patent application Ser. No. 11/732,694 (Attorney Docket No. KABAP011B))

In at least one embodiment, the Reporter component may be configured or designed as an engine that collects all (or selected ones of) the user behavior (clicks, mouse over) for each URL, highlights, target choices and feeds them into the ERV engine. See U.S. patent application Ser. No. 11/732,694 (Attorney Docket No. KABAP011B) for the collection of statistics.

A brief description of at least some of the various objects represented in the specific example embodiment of FIG. 85 is provided below.

8501—getJob—input: none

8503—output—a URL from the Queue that need to be processed

8505—getText(URL)—input:URL to be processed

8507—output: clean text after fetching the URL html, and parsing the main content block from it (MCB Detector)

8509—classifyText input: cleanText

8511—output: list of topics and scores for the text

8513—extract phrases: input clean text

8515—output—all (or selected ones of) the phrases found in the clean text. Each phrase has a list of topics associated with it.

8517—index—input: the clean text, the phrases found on page, and the page topics

8519—getRelatedpages—input: the original URL, the original text, the phrases and the topics

8521—output: for each phrase: the list of target pages that may be the best related pages for the specific phrase and original page, target combination.

8522—update Repository: update repository with all (or selected ones of) the phrases, and related pages for each of those phrases based on the output of 6a.

In at least one embodiment, Manager 8502 may be implemented as a process that is responsible for running the Back End tasks. It retrives jobs from the queue, and sends them to the correct Back End component. When the analysis is complete it updates the disk repository, which enables the front end to get information regarding the specific page.

In at least one embodiment, Job Queue 8504 may be implemented as a Queue of URLs that either need to be analyzed for the first time, or need to be refreshed. The queue enables a distribution of the Back End jobs to several physical machines.

In at least one embodiment, Parser 8506 may be configured or designed to Parse document and extract phrases from a plain text based on POS tagging, chunking, NGram analysis, etc. It is described in details in the dynamic taxonomy

In at least one embodiment, Classifier 8508 may be configured or designed to classify a document or a paragraph to taxonomy topics. The input may include text and the output may include a vector of topics and weights representing the document. A description is found in KBAP011B

In at least one embodiment, Phrase Extractor 8510 may be configured or designed to extract phrases from main content block of target document.

In at least one embodiment, Indexer 8512 may be implemented as a software component that indexes the pages, titles, topics and phrases. It enables a quick retrieval of similar pages (based on TF-IDF scoring http://en.wikipedia.org/wiki/Tf-idf) based on the different query field. In the Back End it is used to get all (or selected ones of) related content for a specific page, phrase combination.

In at least one embodiment, Manager uses the analysis results for specific source page (phrases to highlight, and related information for each phrase) to continuously update the repository (230). The Front end can then read the updated information for a given page (e.g, using unique ID for page) from Repository 8514 or cache (244) (if available in cache).

### REFRESH Process

FIG. 82 shows a example block representation of a Refresher Process in accordance with a specific embodiment. In at least one embodiment, the Refresher may be implemented as a background process that goes over the repository and decides if specific URLs need to be refreshed based on their age, the last time they were refreshed, the type of content (e.g., news need to be more up-to-date while more static content doesn't need to be refreshed often).

For example, as illustrated in the example embodiment of FIG. 82, the Refresher Process process may perform one or more of the following operations:
8201—Find Stale Pages.
8203—List returned of pages that may be old and need to be refreshed. In at least one embodiment, the publisher can define how often pages should be refreshed (e.g., default=1 day)
8205—Send the URLs that need to be refreshed to the Back End. Back End process them like it processes a new page.

### Dynamic Taxonomy Database and Related Content Corpus

### Example Dynamic Taxonomy Database Embodiments

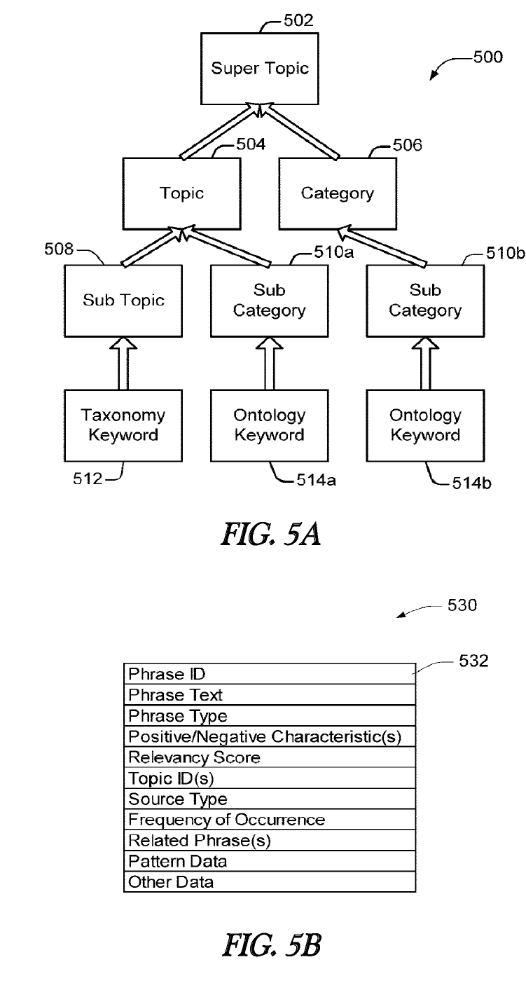

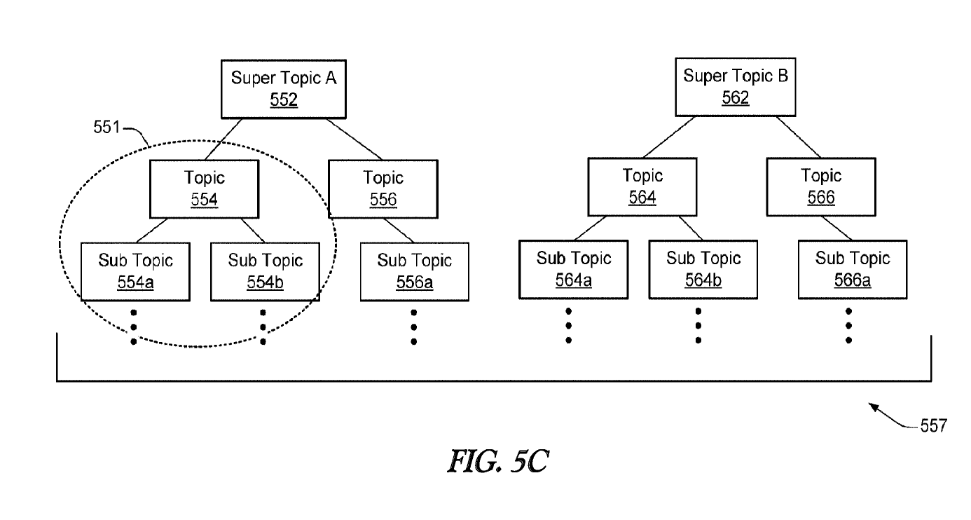

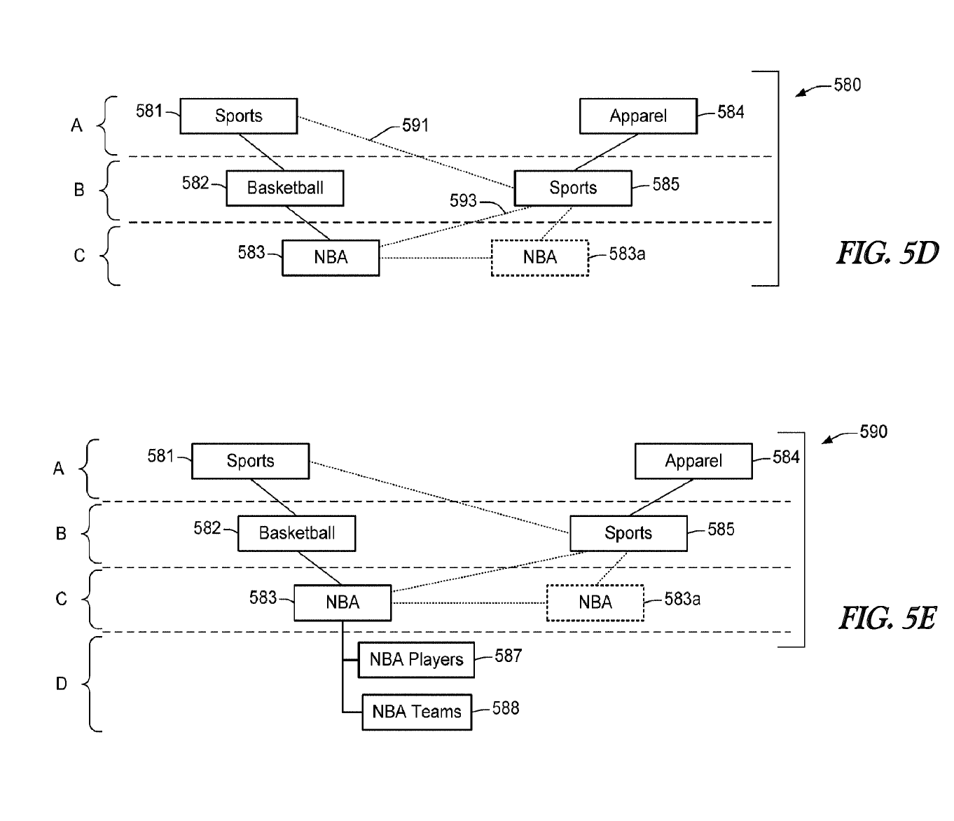

FIG. 5A shows an example of a taxonomy structure 500 in accordance with a specific embodiment.

Referring to the example Dynamic Taxonomy Database structure of FIG. 5A, the taxonomy's root node is called Super Topic. Under the root node, there is another node that is called Topic, and under Topic, there are nodes called Sub Topic. The KeyPhrases may be classified in the taxonomy per level. For example, in one implementation, general KeyPhrases may be classified under SuperTopic, more specific KeyPhrases may be classified under Topic, and even more specific KeyPhrases may be classified under SubTopic.

According to a specific embodiment, each KeyPhrase may have several properties, such as, for example, location based properties, KeyPhrase specific properties, etc. For example, in one implementation, a KeyPhrase may include one or more of the following properties:
Negative/Positive KeyPhrase filtering
KeyPhrase weight
KeyPhrase type
KeyPhrase attribute
Other properties Such properties enable one to fine-tune contextual relevancy and analysis usage with respect to analyzed content.

As illustrated in the example of FIG. 5A, the KeyPhrase/topic classification scheme may include a plurality of hierarchical classifications (e.g., KeyPhrases, subtopics, subcategories, topics, categories, super topics, etc.). The highest level of the hierarchy corresponds to super topic information 502. In one implementation, the super topic may correspond to a general topic or subject matter such as, for example, “sports”. The next level in the hierarchy includes topic information 504 and category information 506. In one implementation, topic information may correspond to subsets of the super topic which may be appropriate for contextual content analysis. For example, “basketball” is an example of a topic of the super topic “sports”. Category information, on the other hand, may correspond to subsets of the super topic which may be appropriate for advertising purposes, but which may not be appropriate for contextual content analysis. For example, “sports equipment” is an example of a category of the super topic “sports”.

The next level in the hierarchy includes sub-topic information 508 and sub-category information 510a, 510b. In one implementation, sub-topic information may correspond to subsets of topics which may be appropriate for contextual content analysis. For example, “NBA” is an example of a sub-topic associated with the topic “basketball”. Sub-category information may correspond to subsets of topics and/or categories which may be appropriate for advertising purposes, but which may not be appropriate for contextual content analysis. For example, “NBA merchandise” is an example of a sub-category of topic “basketball”, and “foosball” is an example of a sub-category associated with the category “sports equipment”. The lowest level of the hierarchy corresponds to KeyPhrase information, which may include taxonomy KeyPhrases 512, ontology KeyPhrases 514a, 514b, and/or KeyPhrases which may be classified as both taxonomy and ontology. In at least one embodiment, taxonomy KeyPhrases may correspond to words or phrases in the web page content which relate to the topic or subject matter of a web page. Ontology (or “KeyPhrase link”) KeyPhrases may correspond to words or phrases in the web page content which are not to be included in the contextual content analysis but which may have advertising value. For example, “LA Lakers” is an example of a taxonomy KeyPhrase of sub-topic “NBA”, “Air Jordan” is an example of an ontology KeyPhrase associated with the sub-category “NBA merchandise”, and “foosball table” is an example of an ontology KeyPhrase associated with the sub-category “foosball”.

FIG. 5B shows an example of various types of information which may be stored at node of the DTD.

According to one embodiment, one aspect of at least some of the various technique(s) described herein provides content providers with an efficient and unique technique of presenting desired information to end users while those users are browsing the content providers' web pages. Moreover, at least some of the various technique(s) described herein enable content providers to proactively respond to the contextual content on any given page that their customers/users are currently viewing. According to at least one implementation, at least some of the various technique(s) described herein allow a content provider to present links, advertising information, and/or other special offers or promotions which that are highly relevant to the user at that point in time, based on the context of the web page the user is currently viewing, and without the need for the user to perform any active action. As described previously, the additional information to be displayed to the user may be delivered using a variety of techniques such as, for example, providing direct links to other pages with relevant information; providing links that open layers with link(s) to relevant information on the page that the user is on; providing links that open layers with link(s) to relevant information on the page that the user is on; providing layers that open automatically once the user reaches a given page, and presenting information that is relevant to the context of the page; providing graphic and/or text promotional offers, etc.; providing links that open layers with content that is served from an external (third party content server) location, etc.

Moreover, it will be appreciated that at least some of the various technique(s) described herein provide a contextual-based platform for delivering to an end user in real-time proactive, personalized, contextual information relating to web page content currently being displayed to the user. In addition, the contextual information delivery technique(s) described herein may be implemented using a remote server operation without any need to modify content provider server configurations, and without the need for any conducting any crawling, indexing, and/or searching operations prior to the web page being accessed by the user. Furthermore, because at least some of the various technique(s) described herein are able to deliver additional contextual information to the user based upon real-time analysis of web page content currently being viewed by the user, the contextual information delivery technique(s) described herein may be compatible for use with static web pages, customized web pages, personalized web pages, dynamically generated web pages, and even with web pages where the web page content is continuously changing over time (such as, for example, news site web pages).

One advantage of using the taxonomy technique(s) described herein for the purpose of contextual advertising is the ability to classify content based on the taxonomy structure. This property provides a mechanism for matching related terms and advertisements from related taxonomy nodes. Thus, for example, using a KeyPhrase taxonomy expansion mechanism described or referenced herein, at least some of the various technique(s) described herein may be adapted to automatically and/or dynamically bring related advertising from sibling taxonomy nodes, and then use self learning automated optimization algorithms to automatically assign more impressions to the terms that may be identified as being relatively better performers.

In one implementation, the Dynamic Taxonomy Database may be adapted to be generically adaptable so that it can handle dynamic content from different content categories without special setup or training sets. For example, using at least some of the various technique(s) described herein, new terms that are discovered on the page (e.g., new products, movie titles, personalities, etc.) may be matched to base topics that include similar terms (e.g., using a “fuzzy match” algorithm), thereby resulting in a virtual expansion of the Dynamic Taxonomy Database in order to successfully handle and process the new content. Utilizing such virtual expansion capability allows the Dynamic Taxonomy Database to remain relatively compact, without compromising classification quality, thereby allowing one to maintain optimal performance which, for example, may be considered to be an important factor when implementing such techniques in a real time system.

It will be appreciated that different embodiments of taxonomy data structures may differ from the data structures illustrated, for example, in FIGS. 5A, 5B and 5C of the drawings. For example, in at least one embodiment, a “dynamic node taxonomy” data structure may be utilized in which there is no restriction on the number of hierarchical levels and/or nodes which may be utilized, for example, to capture the contextual essence of a specific topic, KeyPhrase and/or category and its relation to other topics, KeyPhrases, and/or categories. For example, in one embodiment, it would be possible to add as many nodes and/or sub-nodes as desired in order to capture the contextual essence of a topic and its relation to other topics. Additionally, in at least one embodiment, the dynamic node taxonomy data structure may provide the ability to cross reference specific nodes and/or sub-nodes in order, for example, to enable a specific node or sub-node to be linked to (or referenced by) more than one other node and/or sub-node.

FIGS. 5E and 5F illustrate examples of portions of dynamic node taxonomy data structure in accordance with a specific embodiment. In the example of FIG. 5E, a portion 580 of a dynamic node taxonomy data structure is illustrated as including a plurality of nodes (e.g., 581-585), wherein each node is associated with at least one hierarchical level (e.g., A, B, C). In the example of FIG. 5E, node 581 (“Sports”) and node 584 (“Apparel”) are associated with a relatively highest level (e.g., Level “A”) of taxonomy portion 580. Node 582 (“Basketball”) and node 585 (“Sports”) are associated with Level “B”, which is subordinate to Level A. Accordingly in one embodiment, node 582 (“Basketball”) may be considered a sub-node of node 581 (“Sports”), and node 585 (“Sports”) may be considered a sub-node of node 584 (“Apparel”). Node 583 (“NBA”) is associated with Level “C”, which is subordinate to Level B. Accordingly in one embodiment, node 583 (“NBA”) may be considered a sub-node of node 582 (“NBA”).

As illustrated in the example of FIG. 5E, the dynamic node taxonomy data structure provides the ability to cross reference specific nodes and/or sub-nodes in order, for example, to enable a specific node or sub-node to be linked to or referenced by more than one other node and/or sub-node. For example, as illustrated in the example of FIG. 5E, node 583 (“NBA”) may be linked to (or otherwise associated with) both node 582 (“Basketball”) and node 585 (“Sports). In one embodiment, node 583 (“NBA”) may be directly linked to node 585 (“Sports) via a pointer or link (e.g., 593). In other embodiments, node 583 (“NBA”) may be linked to node 585 (“Sports) via a mirror node 583a which, for example, may be specifically configured or designed to represent crossed referenced associations.

Additionally, as shown in the example of FIG. 5E, linked relationships may be established between specific nodes and/or sub-nodes which are members of different levels of the taxonomy hierarchy. For example, as shown in the example of FIG. 5E, node 581 (“Sports”) may be linked to (or associated with, e.g., via link 591) node 585 (“Sports”). In at least one embodiment, node 581 (“Sports”) may be interpreted as relating generally to any type of sports-related topics or subtopics, whereas node 585 (“Sports”) may be interpreted as relating more specifically to sport apparel.

As mentioned previously, in at least some one embodiments, it may also be possible to add as many nodes and/or sub-nodes as desired in order to capture the contextual essence of a specific topic, KeyPhrase and/or category and its relation to other topics, KeyPhrases, and/or categories. For example, referring to the example of FIG. 5E, it would be possible, if desired, to add additional nodes representing “NBA Players” and “NBA Teams” as sub-nodes of node 583 (“NBA”). An example of this is illustrated and FIG. 5F.

As shown in the example of FIG. 5F, node 587 (“NBA Players”) and node 588 (“NBA Teams”) have been added to the dynamic node taxonomy data structure (e.g., of FIG. 5E) as sub-nodes of node 583 (“NBA”). The addition of nodes 587 and 588 includes the creation of a new hierarchical level (e.g., Level “D”), which is subordinate to Level C. If desired, additional nodes and/or levels may also be added to the data structure in order to capture the contextual essence of a specific topic, KeyPhrase and/or category and its relation to other nodes in the data structure (which, for example, may represent different topics, KeyPhrases, and/or categories). In at least one embodiment additional links (and/or other related-node linking mechanisms such as, for example, mirror nodes, pointers, etc.) may also be created, for example, in order to associate or link node 587 (“NBA Players”), node 588 (“NBA Teams”) and/or node 583 (“NBA”) with node 585 (“Sports”).

Another aspect of at least some of the various technique(s) described herein relates to an improved advertisement selection technique based on contextual analysis of document content.

FIG. 5D shows a block diagram of a specific embodiment graphically illustrating various data flows which may occur during selection of one or more KeyPhrases and/or topics. As shown in the example of FIG. 5D, document content 571 (e.g., text, HTML, XML, and/or other content) may be provided to KeyPhrase link Selection Engine 572. In one embodiment, the KeyPhrase link Selection Engine may perform a contextual analysis of the input content 571 using information from Taxonomy Database 574, which, for example, may result in the identification and/or selection of one or more KeyPhrases and/or topics 576. In one embodiment, the identified KeyPhrases/topics may be used to select one or more ads to be displayed to the user, for example, via one or more KeyPhrase links.

### Example Embodiments of Hybrid System Data Structures and Relationships

FIGS. 94 and 95 illustrate a pictorial representation of various example nodes of a Keyphrase Taxonomy (FIG. 94) and Page Taxonomy (FIG. 95), in accordance with a specific embodiment.

FIG. 97 shows a specific example embodiment of various types of data structures which may be used to represent various entity types and their respective relationships to other entity types in the DTD. For example, as illustrated in the example embodiment of FIG. 97, each of the data structures illustrated in solid lines (e.g., 9702, 9704, 9706) represent entity type nodes which, for example, may be used to represent data such as, for example, phrases 9702, pages 9706, topics 9704, etc. Each of the data structures illustrated in dashed lines (e.g., 9703, 9705, 9707) may represent relationship-type nodes, which, for example, may represent different respective relationships between each of the entity type nodes. In at least one embodiment, at least a portion of the relationship-type nodes may be implemented using one or more reference tables.

For example, referring to the specific embodiment of FIG. 97, each phrase in the DTD may be represented by a unique phrase node 9702 having a unique phrase ID value. Similarly, each topic in the DTD may be represented by a unique topic node 9704 having a unique topic ID value, and each page in the DTD may be represented by a unique page node 9706 having a unique page ID value. The various relationships which exist between each of the phrases, pages, and topics of the DTD may be represented by respectively unique relationship-type nodes (e.g., reference tables), each having a unique ID. Additional details relating to the various data structures illustrated in FIG. 97 are provided below, and therefore will not be repeated in the section.

9707: Agg_phrase_topics

All (or selected ones of) the topics that were found for a given phrases in any document the Hybrid System saw in the past. Each entry as the aggregation of all (or selected ones of) the votes, and avg of all (or selected ones of) the scores the phrase,topic combination had in the past. For example if the Hybrid System found the phrase ‘new jaguar’ under topic ‘luxury car’ with 1 vote, and score of 0.65 this is going to be added to the agg_phrase_topics.

9702: Phrases—The specific phrase, includes the text of the phrases, and other properties, such as the sources from which it was extracted, its type, related phrases, etc

9703: Page_phrases—For each page the Hybrid System saw in the past, the list of all (or selected ones of) phrases that were extracted for the page.

9706: Pages—All (or selected ones of) the pages the Hybrid System saw in the past, including their URL, key (unique identifier) and body of text

9705: Page_topic—All (or selected ones of) the topics that were assigned to a specific page, or paragraph based on the classification for this page.

9704: Topics—The list of topics the classifier can assign to a page.

Example: page www.sports.com

Phrases: extracted: ‘basketball match’, ‘watch sport online’

Topics: Sport, NBA, Basketball

Actions taken:
(pages) add entry www.sports.com
(topics) add entries for Sport, NBA, Basketball
(page_topics) add entries referencing Sport, NBA, Basketball referencing www.sports.com
(phrases) add entries for ‘basketball match’, ‘watch sport online’
(page_phrases) reference between www.sports.com to ‘basketball match’ and ‘watch sport online’
(agg_phrase_topics)—update the accumulated counts and topics for ‘basketball match and ‘watch sport online’

Phrases 9702
id—unique identifier of phrase
terms—the actual text of phrase
proper—is proper noun
plural—is plural or singular
person—is a person
location—is a location
organization—is an organization
doc_count—number of different documents in which the term appeared.

Example: Assume phase=“Bank of America”

| Name | Value |
|---|---|
| Id | 12 |
| Terms | ‘Bank of America’ |
| proper | True |
| Plural | False |
| Person | False |
| Location | False |
| Organization | True |

Pages 9706
Id—the unique id of the page
URL—the URL of the page
page_key—unique identifier for the page
body—the text of the page

| Name | Value |
|---|---|
| Id | 13432 |
| URL | www.cnn.com |
| Page_key | Az#RQAFSDFXasdfsdec_cnn.com |
| Body | Content of www.cnn.com |

Topics 9704
Id—the unique id of the topic
parent_id—the id of the parent node
Name—name of topic
Doc_count—how many documents classified under topic
Last_update—when was the topic updated

| Name | Value |
|---|---|
| Id | 1343 |
| parent_id | 199 |
| Name | NBA Teams |
| Doc_count | 1503 |
| Last_update | 12/11/20083 |

Page phrases 9703
Id—unique id of entry
Page_id—the reference to the page where the phrase was found
Phrase_id—the phrase
Freq—number of times phrase was found in document

For the above example if ‘Bank of America’ was found 5 times in www.cnn.com

| Name | Value |
|---|---|
| Id | 33413 |
| Page_id | 13432 |
| Phrase_id | 12 |
| Freq | 5 |

Page topics 9705
Id—the unique id of the entry
Page_id—the page
Topic_id—the topic
Votes—how many documents from the topic matched the source page
Score—the relatedness score of the document to topic

For the above example if ‘NBA Teams’ is one of the topics of www.cnn.com

| Name | Value |
|---|---|
| Id | 53132 |
| Page_id | 13432 |
| Topic_id | 1343 |
| Votes | 8 |
| Score | 0.45 |

Agg phrase topics 9707
id—the unique id of the field **unique number with no significance***
phrase_id—reference to phrase—unique ID for each phrase in DTD—value is same as ID in Phrase node
topic_id—reference to topic—used for ID unique topic
votes—number of times phrase found for that topic—COUNT
score—score for phrase for topic—score (frequency of appearance of phrase on page, where it appeared (URL, title, MCB)—computed by classifier during classification—corresponds to score shown in FIG. 74.

Example of the phrase ‘Bank of America’ in topic NBA Teams

| Name | Value |
|---|---|
| Id | 134123423 |
| Phrase_id | 12 |
| Topic_id | 1343 |
| Votes | 1 |
| Score | 0.0043 |

Example Information kept for each phrase/phrases:
text
source (manual, automatic, meta KeyPhrases, title)
frequency (number of docs the phrase appeared in)
related phrases (e.g., Bush, George Bush, President of the United States)
pattern (chunks and POS tags—e.g., N N, ADJ N, etc.)
type (Noun Phrase, Proper Noun Phrase, PERSON, LOCATION, ORGANIZATON, ETC).
score (relevancy score)

In at least one embodiment, the list of information above applies to information which may be stored at a Phrase (type) node (e.g., Node 2) of the Dynamic Taxonomy Database (DTD)

In at least one embodiment, entity type nodes of the DTD may correspond to:
phrases
pages
topics

The other nodes of the DTD may be implemented as relationship type nodes (e.g., relationship tables) to create a many-to-many relation between phrases to pages, phrases to topics etc.

For example, a main entity is the Phrases node. Each phrase is an entry in the dynamic taxonomy. In at least one embodiment, a node is the topic (e.g., ‘sports’). Under each node there may be several entities (phrases) such as ‘sport games’, ‘sport uniforms’ etc. In at least one embodiment, add entry means to add a relation between a node and a phrase.

In at least one embodiment, the DTD node depth may dynamically change, and may include a potentially unlimited number of depths/levels. For example if the DTD initially includes a structure of Sports->Basketball->NBA, it may be dynamically changed or updated to include more granular classifications, for example, by adding additional level(s) to result in an updated structure of:

Sport->Basketball->NBA->Teams' and ‘Sport->Basketball->NBA->Players’

In at least one embodiment, ontology-type KeyPhrase may include phrases that may be found for analysis purposes (e.g., relationship between 2 phrases) but shouldn't be highlighted. For example ‘President George Bush’ is a phrase, while ‘President George’ is ontology phrase that would not be highlighted, but would server as a mediator for relating ‘President of the United States’ to ‘George Bush’.

In at least one embodiment, the Hybrid System and/or Related Content Corpus may be configured or designed to omit the use of ontology type keyphrases and/or keyphrases.

FIG. 96 shows a specific example embodiment of various types of data structures which may be used to represent various entity types and their respective relationships to other entity types in the Related Content Corpus. For example, as illustrated in the example embodiment of FIG. 96, each of the data structures illustrated in solid lines (e.g., 9602, 9604, 9606) represent entity type nodes which, for example, may be used to represent data such as, for example, pages 9602, phrases 9606, restricted phrases 9604, etc. Each of the data structures illustrated in dashed lines (e.g., 9603, 9605, 9607) may represent relationship-type nodes, which, for example, may represent different respective relationships between each of the entity type nodes. In at least one embodiment, at least a portion of the relationship-type nodes may be implemented using one or more reference tables. A more detailed explanation of the various data structures illustrated in FIG. 96 is provided below, and therefore will not be repeated in the section.
Phrases 9606—The tables from the dynamic taxonomy
Page 9602—a source or a target page—same as page in the dynamic taxonomy
Related_Link 9607—the actual highlighted KeyPhrase, and its source and target pages.
   link_id—unique id of the link
   page_id—where the link is found
   hl—the actual text on the page
   related_page_id—reference to the page to which the link refer
   date—when link was updated
   phrase_id—the id in the phrases table
   hl_score—the relevancy score of the link

| Name | Value |
|---|---|
| Link_id | 5553 |
| Page_id | 14 (www.cnn.com) |
| Hl | ‘Rim Blackberry’ |
| Related_page_id | 35 (www.cnn.com/tech/rim.html) |
| Date | 12/12/2008 |
| Phrase_id | 5833 |
| Score | 0.345 |

Related_Index 9603—grouping of all (or selected ones of) the publisher pages
   index_id—the unique id of the index
   name—logical name for index
   publisher_id—the publisher id of the website that is in the index
   index_group_id—reference to all (or selected ones of) connected

| Name | Value |
|---|---|
| Index_id | 15 |
| Name | ‘cnn index’ |
| Publisher_id | 535345 (cnn) |
| Index_group_id | 55 (news sites) |

Related_Index_Group 9605—group of indices that can point to each other
   index_group_id—unique identifier of the group
   name—logical name

| Name | Value |
|---|---|
| Index_group_id | 15 |
| Name | News sites |

Restricted_Phrases 9604—list of phrases that shouldn't be highlighted on the page
   id—unique id
   publisher_id—publisher for which the phrase is restricted
   text—the actual phrase

| Name | Value |
|---|---|
| Id | 434 |
| Publisher_id | 535345 (cnn) |
| Text | ‘violent crime’ (this phrase will not be |
| | highlight on cnn) |

### Other Embodiments

Generally, the contextual information delivery techniques described herein may be implemented in software and/or hardware. For example, they can be implemented in an operating system kernel, in a separate user process, in a library package bound into network applications, on a specially constructed machine, or on a network interface card. In a specific embodiment, various aspects described herein may be implemented in software such as an operating system or in an application running on an operating system.

A software or software/hardware hybrid embodiment of one or more of the Hybrid contextual advertising and related content analysis and display techniques disclosed herein may be implemented on a general-purpose programmable machine selectively activated or reconfigured by a computer program stored in memory. Such programmable machine may be a network device designed to handle network traffic, such as, for example, a router or a switch. Such network devices may have multiple network interfaces including frame relay and ISDN interfaces, for example. Specific examples of such network devices include routers and switches. A general architecture for some of these machines will appear from the description given below. In an alternative embodiment, the contextual information delivery technique of this invention may be implemented on a general-purpose network host machine such as a personal computer or workstation. Further, the invention may be at least partially implemented on a card (e.g., an interface card) for a network device or a general-purpose computing device.

Referring now to FIG. 15, a network device 1560 suitable for implementing various techniques and/or features described herein may include a master central processing unit (CPU) 1562, interfaces 1568, and a bus 1567 (e.g., a PCI bus). When acting under the control of appropriate software or firmware, the CPU 1562 may be responsible for implementing specific functions associated with the functions of a desired network device. For example, when configured as a network server, the CPU 1562 may be responsible for analyzing packets, encapsulating packets, forwarding packets to appropriate network devices, analyzing web page content, generating web page modification instructions, etc. The CPU 1562 preferably accomplishes all these functions under the control of software including an operating system (e.g. Windows NT), and any appropriate applications software.

CPU 1562 may include one or more processors 1563 such as a processor from the Motorola or Intel family of microprocessors or the MIPS family of microprocessors. In an alternative embodiment, processor 1563 is specially designed hardware for controlling the operations of network device 1560. In a specific embodiment, a memory 1561 (such as non-volatile RAM and/or ROM) also forms part of CPU 1562. However, there are many different ways in which memory could be coupled to the Hybrid System. Memory block 1561 may be used for a variety of purposes such as, for example, caching and/or storing data, programming instructions, etc.

The interfaces 1568 are typically provided as interface cards (sometimes referred to as “line cards”). Generally, they control the sending and receiving of data packets over the network and sometimes support other peripherals used with the network device 1560. Among the interfaces that may be provided are Ethernet interfaces, frame relay interfaces, cable interfaces, DSL interfaces, token ring interfaces, and the like. In addition, various very high-speed interfaces may be provided such as fast Ethernet interfaces, Gigabit Ethernet interfaces, ATM interfaces, HSSI interfaces, POS interfaces, FDDI interfaces and the like. Generally, these interfaces may include ports appropriate for communication with the appropriate media. In some cases, they may also include an independent processor and, in some instances, volatile RAM. The independent processors may control such communications intensive tasks as packet switching, media control and management. By providing separate processors for the communications intensive tasks, these interfaces allow the master microprocessor 1562 to efficiently perform routing computations, network diagnostics, security functions, etc.

Although the Hybrid System shown in FIG. 15 illustrates a specific embodiment of a network device, it is by no means the only network device architecture on which the various techniques described or referenced herein may be implemented. For example, an architecture having a single processor that handles communications as well as routing computations, etc. is often used. Further, other types of interfaces and media could also be used with the network device.

Regardless of network device's configuration, it may employ one or more memories or memory modules (such as, for example, memory block 1565) configured to store data, program instructions for the general-purpose network operations and/or other information relating to the functionality of the contextual information delivery techniques described herein. The program instructions may control the operation of an operating system and/or one or more applications, for example. The memory or memories may also be configured to store data structures, keyphrase taxonomy information, advertisement information, user click and impression information, and/or other specific non-program information described herein.

Because such information and program instructions may be employed to implement the systems/methods described herein, at least one embodiment relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

It will be appreciated that, in at least one embodiment, this method will interact with decaying counts such that all ads will eventually be reconsidered as their negative evidence decays sufficiently. This prevents the Hybrid System from “dooming” an ad to perpetual obscurity just because it performed poorly at some point.

According to different embodiments, various aspects and/or features of the hybrid contextual advertising techniques described herein may be implemented via computer hardware and/or a combination of computer hardware and software. For example, different features and/or processes may be implemented in an operating system kernel, in a separate user process, in a library package bound into network applications, on a specially constructed machine, or on a network interface card. In a specific embodiment, various aspects, features and/or processes relating to the hybrid contextual advertising techniques described herein may be implemented in software such as, for example, an application running on computer system hardware.

In one embodiment, software/hardware implementation(s) of the various techniques described herein may be implemented on a general-purpose programmable machine selectively activated or reconfigured by a computer program stored in memory. In an alternative embodiment, various techniques described here and may be implemented on a general-purpose network host machine such as a personal computer or workstation. Further, in at least some embodiments, various different aspects, features, and/or processes disclosed herein may be at least partially implemented on a card (e.g., an interface card) for a network device or a general-purpose computing device.

### Example Algorithms

### Cosine Similarity

Cosine similarity is a measure of similarity between two vectors of n dimensions by finding the cosine of the angle between them, often used to compare documents in text mining Given two vectors of attributes, A and B, the cosine similarity, θ, is represented using a dot product and magnitude as

$$similarity = cos ( θ ) = \frac{A \cdot B}{‖ A ‖ ‖ B ‖} .$$

For text matching, the attribute vectors A and B may be usually the tf-idf vectors of the documents.

The resulting similarity ranges from −1 meaning exactly opposite, to 1 meaning exactly the same, with 0 indicating independence, and in-between values indicating intermediate similarity or dissimilarity.

This cosine similarity metric may be extended such that it yields the Jaccard coefficient in the case of binary attributes. This is the Tanimoto coefficient, T(A,B), represented as

$$T ( A , B ) = \frac{A \cdot B}{{‖ A ‖}^{2} {‖ B ‖}^{2} - A \cdot B} .$$

### Jaccard Index

The Jaccard index, also known as the Jaccard similarity coefficient (originally coined coefficient de communaute by Paul Jaccard), is a statistic used for comparing the similarity and diversity of sample sets.

The Jaccard coefficient measures similarity between sample sets, and is defined as the size of the intersection divided by the size of the union of the sample sets:

$$J ( A , B ) = \frac{\vert A ⋂ B \vert}{\vert A ⋃ B \vert}$$

The Jaccard distance, which measures dissimilarity between sample sets, is complementary to the Jaccard coefficient and is obtained by subtracting the Jaccard coefficient from 1, or, equivalently, by dividing the difference of the sizes of the union and the intersection of two sets by the size of the union:

$${J}_{δ} ( A , B ) = 1 - J ( A , B ) = \frac{\vert A ⋃ B \vert - \vert A ⋂ B \vert}{\vert A ⋃ B \vert}$$

Similarity of asymmetric binary attributes

Given two objects, A and B, each with n binary attributes, the Jaccard coefficient is a useful measure of the overlap that A and B share with their attributes. Each attribute of A and B can either be 0 or 1. The total number of each combination of attributes for both A and B may be specified as follows:

M₁₁ represents the total number of attributes where A and B both have a value of 1.

M₀₁ represents the total number of attributes where the attribute of A is 0 and the attribute of B is 1.

M₁₀ represents the total number of attributes where the attribute of A is 1 and the attribute of B is 0.

M₀₀ represents the total number of attributes where A and B both have a value of 0.

Each attribute must fall into one of these four categories, meaning that

M₁₁+M₀₁+M₁₀+M₀₀=n.

The Jaccard similarity coefficient, J, is given as

$$J = \frac{{M}_{11}}{{M}_{01} + {M}_{10} + {M}_{11}} .$$

The Jaccard distance, J′, is given as

$${J}^{′} = \frac{{M}_{01} + {M}_{10}}{{M}_{01} + {M}_{10} + {M}_{11}} .$$

### Quality Score

What is ‘Quality Score’ and how is it calculated?

Quality Score is a dynamic variable calculated for each of your KeyPhrases. It combines a variety of factors and measures how relevant your KeyPhrase is to your ad text and to a user's search query.

### About Quality Score

A Quality Score is calculated every time your KeyPhrase matches a search query—that is, every time your KeyPhrase has the potential to trigger an ad. Quality Score is used in several different ways, including influencing your KeyPhrases' actual cost-per-clicks (CPCs) and estimating the first page bids that you see in your account. It also partly determines if a KeyPhrase is eligible to enter the ad auction that occurs when a user enters a search query and, if it is, how high the ad will be ranked. In general, the higher your Quality Score, the lower your costs and the better your ad position.

Quality Score helps ensure that only the most relevant ads appear to users on Google and the Google Network. The AdWords system works best for everybody—advertisers, users, publishers, and Google too—when the ads we display match our users' needs as closely as possible. Relevant ads tend to earn more clicks, appear in a higher position, and bring you the most success.

### Quality Score Formulas

The formula behind Quality Score varies depending on whether it's affecting ads on Google and the search network or ads on the content network.

I. Quality Score for Google and the Search Network

While we continue to refine our Quality Score formulas for Google and the search network, the core components remain more or less the same:
The historical clickthrough rate (CTR) of the KeyPhrase and the matched ad on Google; note that CTR on the Google Network only ever impacts Quality Score on the Google Network—not on Google
Your account history, which is measured by the CTR of all (or selected ones of) the ads and KeyPhrases in your account
The historical CTR of the display URLs in the ad group
The quality of your landing page
The relevance of the KeyPhrase to the ads in its ad group
The relevance of the KeyPhrase and the matched ad to the search query
Your account's performance in the geographical region where the ad will be shown
Other relevance factors

Note that there may be slight variations to the Quality Score formula when it affects ad position and first page bid:
For calculating a KeyPhrase-targeted ad's position, landing page quality is not a factor. Also, when calculating ad position on a search network placement, Quality Score considers the CTR on that particular search network partner in addition to CTR on Google.
For calculating first page bid, Quality Score doesn't consider the matched ad or search query, since this estimate appears as a metric in your account and doesn't vary per search query.

II. Quality Score for the Content Network

The Quality Score for calculating a contextually targeted ad's eligibility to appear on a particular content site, as well as the ad's position on that site, consists of the following factors:
The ad's past performance on this and similar sites
The relevance of the ads and KeyPhrases in the ad group to the site
The quality of your landing page
Other relevance factors

The Quality Score for determining if a placement-targeted ad will appear on a particular site depends on the campaign's bidding option.

If the campaign uses cost-per-thousand-impressions (CPM) bidding, Quality Score is based on:
The quality of your landing page

If the campaign uses cost-per-click (CPC) bidding, Quality Score is based on:
The historical CTR of the ad on this and similar sites
The quality of your landing page

### MapReduce

MapReduce is a software framework introduced by Google to support distributed computing on large data sets on clusters of computers. The framework is inspired by map and reduce functions commonly used in functional programming, although their purpose in the MapReduce framework is not the same as their original forms. MapReduce libraries have been written in C++, Java, Python and other programming languages.

Overview

MapReduce is a framework for computing certain kinds of distributable problems using a large number of computers (nodes), collectively referred to as a cluster.

“Map” operation: The master node takes the input, chops it up into smaller sub-problems, and distributes those to worker nodes. (A worker node may do this again in turn, leading to a multi-level tree structure.)

The worker node processes that smaller problem, and passes the answer back to its master node.

“Reduce” operation: The master node then takes the answers to all (or selected ones of) the sub-problems and combines them in a way to get the output—the answer to the problem it was originally trying to solve.

The advantage of MapReduce is that it allows for distributed processing of the map and reduction operations. Provided each mapping operation is independent of the other, all (or selected ones of) maps may be performed in parallel—though in practise it is limited by the data source and/or the number of CPUs near that data. Similarly, a set of ‘reducers’ can perform the reduction phase—all (or selected ones of) that is required is that all (or selected ones of) outputs of the map operation which share the same key may be presented to the same reducer, at the same time. While this process can often appear inefficient compared to algorithms that may be more sequential, MapReduce may be applied to significantly larger datasets than that which “commodity” servers can handle—a large server farm can use MapReduce to sort a petabyte of data in only a few hours. The parallelism also offers some possibility of recovering from partial failure of servers or storage during the operation: if one mapper or reducer fails, the work may be rescheduled-assuming the input data is still available.

Logical View

The Map and Reduce functions of MapReduce may be both defined with respect to data structured in (key, value) pairs. Map takes one pair of data with a type on a data domain, and returns a list of pairs in a different domain:

Map(k1,v1)->list(k2,v2)

The map function is applied in parallel to every item in the input dataset. This produces a list of (k2,v2) pairs for each call. After that, the MapReduce framework collects all (or selected ones of) pairs with the same key from all (or selected ones of) lists and groups them together, thus creating one group for each one of the different generated keys.

The Reduce function is then applied in parallel to each group, which in turn produces a collection of values in the same domain:

Reduce(k2, list (v2))->list(v2)

Each Reduce call typically produces either one value v2 or an empty return, though one call is allowed to return more than one value. The returns of all (or selected ones of) calls may be collected as the desired result list.

Thus the MapReduce framework transforms a list of (key, value) pairs into a list of values. This behavior is different from the functional programming map and reduce combination, which accepts a list of arbitrary values and returns one single value that combines all (or selected ones of) the values returned by map.

It is necessary but not sufficient to have implementations of the map and reduce abstractions in order to implement MapReduce. Furthermore effective implementations of MapReduce require a distributed file system to connect the processes performing the Map and Reduce phases.

Dataflow

The frozen part of the MapReduce framework is a large distributed sort. The hot spots, which the application defines, may be:
an input reader
a Map function
a partition function
a compare function
a Reduce function
an output writer

Input Reader

The input reader divides the input into 16 MB to 128 MB splits and the framework assigns one split to each Map function. The input reader reads data from stable storage (typically a distributed file system like Google File System) and generates key/value pairs.

A common example will read a directory full of text files and return each line as a record.

Map Function

Each Map function takes a series of key/value pairs, processes each, and generates zero or more output key/value pairs. The input and output types of the map may be (and often may be) different from each other.

If the application is doing a word count, the map function would break the line into words and output the word as the key and “1” as the value.

Partition Function

The output of all (or selected ones of) of the maps is allocated to particular reduces by the application's partition function. The partition function is given the key and the number of reduces and returns the index of the desired reduce.

A typical default is to hash the key and modulo the number of reduces.

Comparison Function

The input for each reduce is pulled from the machine where the map ran and sorted using the application's comparison function.

Reduce Function

The framework calls the application's reduce function once for each unique key in the sorted order. The reduce can iterate through the values that may be associated with that key and output 0 or more key/value pairs.

In the word count example, the reduce function takes the input values, sums them and generates a single output of the word and the final sum.

Output Writer

The Output Writer writes the output of the reduce to stable storage, usually a distributed file system, such as Google File System.

### OTHER BENEFITS/ADVANTAGES/FEATURES

Listed below are examples of other benefits, features and/or advantages described or referenced herein which may be implemented in one or more specific embodiments:

At least one embodiment may be adapted to automatically identify and/or select appropriate keyphrases to be associated with specific links based on one or more predetermined sets of parameters. Such embodiment obviate the need for one to manually select such keyphrases.

At least one embodiment may be adapted to analyze many different pages on a given web site or network of sites, determine the best matching topic for each page, and/or mark relevant keyphrases to thereby link pages of related topics. In this way, a relationship is formed between the topic that the user is currently reading and the page that the related link will lead to.

At least one embodiment may be implemented in a manner such that, when a user clicks on a word or phrase of a particular web page, results may be displayed to the user which includes information relating not only to the selected word/phrase, but also relating to the context of the entire web page. Additionally, in one embodiment, the related information may be determined and displayed to the user without performing a query to one or more search engines for the selected word/phrase.

According to a specific embodiment, when a user views the web page in his browser, and places his mouse over the hyperlink, a layer pops up near the link containing a textual advertisement. If either the hyperlink or the advertisement are clicked on, the user's browser is directed to a new page designated by the advertiser.

### Story-Level Targeting Functionality

FIG. 98 shows an example block diagram relating to one or more story level targeting processes which may be implemented using one or more techniques described herein.

Publishers and Advertisers want to reach qualified audiences efficiently and effectively, by showing additional related information and highly relevant contextual ads. Increasingly they want to do this using In-content and In-Text methods.

There are at least two challenges to making In-Text and related information and advertising highly relevant and useful to the users, at scale.

For example, Keyphrase match alone is insufficient. Given the many ways in which Keyphrases can be used (i.e. software application vs. makeup application) Keyphrase targeting often fails in providing an accurate description of a story that will match the advertisers' goals. What is lacking is an understanding of the true meaning of a page, and the actual topics represented in the story, alongside an understanding of the semantic meaning of the keyphrases and phrases that are found within the content. Without this ability it is impossible to ensure the highest degree of relevancy for the advertiser, as well as difficult to protect the advertiser and publisher brand.

Additionally, Internet content is increasingly becoming an active and growing “dialogue”. The blogging format, comments, evolving links and referrals are examples of ways in which stories and web pages continually develop after their initial posting. In many cases this evolving content enhances the story, often opening up additional advertising opportunities. Static, a priori, advertising determination does not consider these nuanced changes, nor their impact on the totality of any given story.

In at least one embodiment, the Hybrid System may be configured or designed to include Story Level Targeting functionality which provides the Hybrid System with the capabilities to fully understand, in real-time the overall theme of any given story. It does not solely rely on keyphrase and phrase matching. Instead it comprehends the true topics of the story and accurately matches the most relevant additional information and advertisements to each page by using the most appropriate keyphrase phrases to make this connection. Story Level Targeting takes into consideration all dynamic content updates, and works regardless of the general topical categorization of the site. It opens up the most relevant context across the entire web, and encompasses both topically endemic (singularly focused sites) and non endemic sites.

Example: Story Level Targeting enables the showcasing of a BlackBerry ad within a story about smartphones temporarily featured on SmartMoney.com, a financial site. Using the Hybrid System technology, BlackBerry reaches their target audience, who is researching or interested in the latest smartphone developments, even though these users are currently visiting a finance and not technology site.

Many commonly advertised keyphrases can be used for many disparate topics. Since Keyphrase targeting looks only for keyphrase and phrase matches, it often fails to deliver an accurate match between the story's context and the topic that the advertiser is targeting. Additionally, Keyphrase targeting alone cannot solve ambiguities (i.e. showing a Cisco ad on the keyphrase “networking” when the story is about social networking). Considering this, Keyphrase targeting often “misses the point” and fails to take the “big picture” into account, resulting in a sub par user experience and inconsistent conversions.

Through a dynamic analysis of the true context of the page, Story Level Targeting guarantees the highest degree of relevancy and best possible match between advertisements and the content in which they're showcased, thus increasing user engagement and interest.

In at least one embodiment, the Hybrid System may be operable to identify story level topics and then selects the most appropriate keyphrases and keyphrase phrases to highlight within the page. Our core technology is based on Natural Language Processing, Machine Learning and other proprietary linguistic, semantic and statistical algorithms.

Since the Hybrid System analyzes pages in real-time, all content updates are taken into account upon every pageview. Each time a page is served, the Hybrid System assess it's overall topics, and selects the most appropriate keyphrases and phrases to which specific and highly relevant information and ads should be linked.

Advantages of Story Level Targeting:

For Users:
The higher relevancy of related information and advertisements provided users with valuable information.

For Advertisers:
Greater engagement with the end users through a highly relevant in-context presence, delivered anywhere on the web that the users may be seeking information.
Increased reach in highly relevant stories, across qualified yet less easily categorized content sites, that results in a more qualified consumer audiences and greater efficiency within advertising buys.

For Publishers:
The Hybrid System's In Text advertisements and related information products have much greater relevancy, thereby enhancing user experience and supporting the publisher's brand.
Kontea's Story Level Targeting generates higher revenues, not only due to high click-through and conversion to action rates, but also through enhanced content targeting that goes beyond the core focus of the site.

In at least one embodiment, Online Information Interaction may be facilitated by the Hybrid System's ability to understand the true meaning of content coupled with the ability to predict users' intent. The Hybrid System selects the most relevant keyphrase phrases and turns them into hyperlinks that connect users to relevant information.

In at least one embodiment, the Hybrid System predicts the user's information intent based on content that the user is currently browsing coupled with real time information, extracted from thousands of web sites, about topics, keyphrases, content, and ads that are available and developing online.

In at least one embodiment, the Hybrid System may perform one or more of the following processes, in in real-time or near real-time, for every page:
Extraction: A typical contextual analysis process begins by extracting all the relevant publisher and page content and attributes, including: text, HTML properties, structure, location on page, URL, Title, Meta tags, custom Meta tags, etc. Every such feature has a weight used by the machine learning algorithms that analyze the data.
Discovery: using Natural Language Processing, Machine Learning, and other proprietary linguistic, semantic, and statistical algorithms, keyphrase phrases are discovered and classified based on semantic meaning and potential semantic relationships.
Page classification: using a proprietary Dynamic Taxonomy, that continues to expand and refine autonomously, Topical classes and Clusters are dynamically computed for the given page. In addition, the page sensitivity, sentiment and commercial value are analyzed.
Information Clustering: the Hybrid System uses several different content extraction and classification engines that scour the web continuously for the most up to date relevant content, information, and contextual ads. Each information type, such as articles, blog posts, videos, ads, etc., is analyzed differently in order to ensure maximum relevancy. The potential matches are scored relatively to the page and the keyphrases phrases that were discovered on the page.
Selection: Out of a potential pool of tens of keyphrase phrases and hundreds of ads and other related content objects, typically three to five keyphrase phrases are selected together with the best matching ads and information. This selection will rotate automatically over time due to the dynamic nature of online content and the system's self-learning optimization algorithms.
Online Learning & Optimization: The online learning and optimization module automatically performs yield management, optimization and tuning. This real-time analysis of users' interaction with specific keyphrases, contextual advertising, and information as they relate to specific web sites, pages and topics is used to increase yield, relevancy and usefulness of the Hybrid System's different products.

Using the various Hybrid contextual advertising and related content analysis and display techniques described herein the Hybrid System may also be operable to provide Real Time Interest Index functionality that dynamically discovers and surfaces real time information relating to concepts, webpages, social networking aspects, etc. which are currently generating the biggest “buzz” by online users, content providers, publishers, campaign providers, etc.

In addition to the various advantages features, and/or benefits described above, various embodiments of the Hybrid contextual advertising and related content analysis and display techniques described here may also include, enable, and/or or provide a number of additional advantages and/or benefits over currently existing online advertising technology such as, for example, one or more of the following (or combinations thereof):
Increased user engagement/interaction
Increased user initiated page views and time spent at advertisers and/or publisher's site(s)
Mitigate “Bounce Rate” by providing users with more immediate results and/or gratification
Facilitating user cross pollination, for example, by proactively steering users to higher RPM pages
Facilitates expansion of advertiser's inventory into new markets, channels, etc.
Enables the ability to leverage video assets
Facilitate increases in user initiated incremental page views and higher, premium RPMs
Provides for improved selection and highlighting/markup of keyphrases highlight term selection
etc.

Although several example embodiments of one or more aspects and/or features have been described in detail herein with reference to the accompanying drawings, it is to be understood that aspects and/or features are not limited to these precise embodiments, and that various changes and modifications may be effected therein by one skilled in the art without departing from the scope of spirit of the invention(s) as defined, for example, in the appended claims.

1. A computer implemented method for linking related content comprising:
obtaining a first item of content;
identifying keyphrases associated with the first item of content;
scoring the first item of content against a plurality of topics based on the keyphrases associated with the first item of content;
obtaining a plurality of target items of content;
identifying keyphrases associated with each of the target items of content;
scoring each of the target items of content against the plurality of topics based on the keyphrases associated with the respective target item of content;
using a computer to compare the topic scores for the first item of content to the topic scores for each of the target items of content; and
selecting a target item of content to be linked to the first item of content based, at least on part, on the comparison of the topic scores.

2. The method of claim 1, wherein the keyphrases associated with the first item of content include keyphrases that occur within text to be displayed as part of the first item of content.

3. The method of claim 1, wherein the keyphrases associated with each target item of content include keyphrases that occur within text to be displayed as part of the respective target item of content.

4. The method of claim 1, wherein the keyphrases associated with the first item of content include keyphrases that occur within meta data associated with the first item of content.

5. The method of claim 1, wherein the keyphrases associated with each target item of content include keyphrases that occur within meta data associated with the respective target item of content.

6. The method of claim 1, wherein the keyphrases associated with at least one target item of content include keyphrases that occur in a landing page associated with the respective target item of content.

7. The method of claim 1, wherein the keyphrases associated with at least one target item of content include keyphrases that occur on web pages associated with the subject matter of the respective target item of content.

8. The method of claim 1, wherein the target items of content include advertisements.

9. The method of claim 1, wherein at least one target item of content is an advertisement for a product and wherein the keyphrases associated with the advertisement include keyphrases that occur on web pages describing the product.

10. The method of claim 1, wherein the target items of content include advertisements provided by ad servers.

11. The method of claim 10, wherein the advertisements are provided by the ad servers in response to a request from a server system based on a keyphrase or topic of the first item of content.

12. The method of claim 11, wherein the ad servers provide a bid for placement of the advertisement in response to the request from the server system, including an indication of an amount to be paid for placement of the advertisement.

13.-14. (canceled)

15. The method of claim 1, wherein each keyphrase has a score for each topic indicating a correlation of occurrences of the keyphrase to the topic.

16.-17. (canceled)

18. The method of claim 1, wherein the keyphrase is a phrase or pattern matching a logical expression based on the text in a respective item of content.

19. The method of claim 1, wherein the topic scores for each respective item of content is determined based, at least in part, on the correlation of each keyphrase associated with the respective item of content to each topic in the taxonomy.

20. The method of claim 1, wherein the topic scores for each respective item of content comprise a vector of scores for each topic in the taxonomy.

21. The method of claim 1, wherein the comparison of the topic scores for the first item of content and each target item of content comprise calculating a cosine similarity between vectors of scores for each topic in the taxonomy.

22. The method of claim 1, further comprising scoring each keyphrase associated with the first item of content against the plurality of topics.

23. The method of claim 1, further comprising scoring each keyphrase associated with each respective target item of content against the plurality of topics.

24. The method of claim 1, further comprising selecting a keyphrase for linking the first item of content to one of the target items of content based, at least in part, on the topic score for the keyphrase.

25. The method of claim 1, further comprising selecting a keyphrase for linking the first item of content to one of the target items of content based, at least in part, on an indication of the relevancy of the keyphrase to the first item of content.

26. The method of claim 1, further comprising selecting a keyphrase for linking the first item of content to one of the target items of content based, at least in part, on an indication of the relevancy of the keyphrase to the respective target item of content.

27. The method of claim 1, further comprising selecting a target item of content to be linked to the first item of content and a keyphrase to be used for linking the first item of content to the selected target item of content based, at least in part, on:
an indication of the relevancy of the first item of content to the respective target item of content;
an indication of the relevancy of the keyphrase to the first item of content; and
an indication of the relevancy of the keyphrase to the respective target item of content.

28. The method of claim 1, wherein the indication of relevancy is based, at least in part, on a vector comparison of topic scores.

29. The method of claim 28, wherein the vector comparison is based, at least in part, on cosine similarity of the respective vectors of topic scores.

30. The method of claim 1, further comprising selecting a target item of content to be linked to the first item of content and a keyphrase to be used for linking the first item of content to the selected target item of content based, at least in part, on a historical selection rate for the keyphrase and/or the target item of content.

31. The method of claim 1, further comprising selecting a target item of content to be linked to the first item of content and a keyphrase to be used for linking the first item of content to the selected target item of content based, at least in part, on an estimated selection rate for the keyphrase and/or the target item of content.

32. The method of claim 1, further comprising selecting an advertisement as the target item of content to be linked to the first item of content and a keyphrase to be used for linking the first item of content to the advertisement based, at least in part, on an expected value for the advertisement.

33. The method of claim 1, further comprising selecting an advertisement as the target item of content to be linked to the first item of content and a keyphrase to be used for linking the first item of content to the advertisement based, at least in part, on a click through rate for the advertisement.

34.-35. (canceled)

36. The method of claim 1, wherein at least one of the selected target items of content is an item of video content.

37. The method of claim 1, wherein at least one of the selected target items of content is an advertisement.

38. The method of claim 1, wherein at least one of the selected target items of content is text.

39. The method of claim 1, wherein at least one of the selected target items of content is a link to a web page.

40. The method of claim 1, wherein a specified number of target items of content of a respective type is selected for linking to the first item of content.

41. The method of claim 1, wherein the selected target items of content are displayed or linked in a dynamic overlay layer.

42. The method of claim 1, wherein a keyphrase is highlighted on the first item of content and the dynamic overlay layer with the selected target items of content is displayed when a selection event occurs with respect to the keyphrase, the selection event being a mouse click, or the positioning of a cursor over the keyphrase.

43.-44. (canceled)

45. The method of claim 1, wherein the first item of content is a portion of a web page downloaded to a client computer system.

46. The method of claim 1, wherein the client computer system parses the web page to extract the portion of the web page and generates an identifier based on a hash or fingerprint of the portion of the web page, and then sends the portion of the web page and the identifier to the server system.

47.-49. (canceled)

50. The method of claim 45, wherein the server system performs at least the steps of comparing the topic scores for the first item of content to the topic scores for each of the target items of content, and selecting a target item of content to be linked to the first item of content.

51. The method of claim 1, wherein the server system performs the steps of identifying keyphrases associated with each item of content and scoring each item of content against the plurality of topics.

52. The method of claim 1, wherein the server system provides instructions to the client system to cause the browser on the client system to highlight or link a selected keyphrase in the web page.

53. The method of claim 52 wherein the instructions provided by the server system include instructions for causing a dynamic overlay layer to be displayed when a selection event occurs with respect to the selected keyphrase, the instructions causing the selected target items or links to the selected target items to be displayed in the dynamic overlay layer.

54. (canceled)

55. The method of claim 1, further comprising tracking a user's selection for the selected target items at the server system.

56. The method of claim 1, further comprising causing the server system to generate a redirect instruction in response to selection by a user of one of the selected target items.

57. The method of claim 56 wherein the target item selected by the user is an advertisement and the server system logs the selection and generates a redirect instruction that redirects the browser to the landing page for the advertisement.

58.-59. (canceled)

60. The method of claim 1, further comprising updating the correlation of keyphrases to topics in the taxonomy based on the processing of the first item of content by the server system.

60. (canceled)

61. The method of claim 1, further comprising designating a web page as being related to a particular topic in the taxonomy, and analyzing the occurrence of keyphrases on the designated web page to update the taxonomy for the respective topic.

62. (canceled)

63. The method of claim 1, wherein the server system crawls web pages to dynamically update the taxonomy database on the server system.

64. The method of claim 1, wherein a count of the occurrences of a keyphrase on web pages associated with a topic is used to update the correlation of the keyphrase to the topic in the taxonomy database.

65. The method of claim 1, wherein the topic scores for a web page are used to allocate the count of the occurrences of a keyphrase on a web page across a plurality of topics.

66. The method of claim 1, wherein the taxonomy database is updated based, at least in part, on the occurrences of keyphrases on web pages downloaded to client systems that are sent by the client systems to the server system for processing.

67. The method of claim 1, wherein the correlation of keyphrases to a topic is based on the occurrences of the keyphrase on web pages processed by the server system within a specified period of time.

68. The method of claim 1, further comprising discovering a new keyphrase correlated to a topic from a designated web page associated with the topic, wherein the keyphrase has not previously been correlated to the topic in the taxonomy database;
adding the new keyphrase to the taxonomy database; and
linking the first item of content to the selected target item of content using the new keyphrase that has been added to the taxonomy from the designated web site.

69.-71. (canceled)

72. A computerized data network system comprising:
a plurality of web page server systems for providing web pages;
a plurality of client computer systems, comprising:
at least one processor;
at least one memory; and
at least one program module, the program module stored in the memory and configured to be executed by the processor, the at least one program module including instructions for performing one or more of the steps of the methods set forth in claim 1 that are indicated in claim 1 as being performed by a client computer system, including parsing a web page downloaded from one of the web page server systems;
at least one server system for selecting items of related content to be linked, comprising:
at least one processor;
at least one memory; and
at least one program module, the program module stored in the memory and configured to be executed by the processor, the at least one program module including instructions for performing one or more of the steps of the methods set forth in claim 1 that are indicated in claim 1 as being performed by a server system.

73. (canceled)
